(19) United States
(12) Patent Application Publication
(10) Pub. No.: US 2025/0327149 A1
(43) Pub. Date: Oct. 23, 2025

(54) INTEGRATED SYSTEMS AND METHODS FOR LITHIUM RECOVERY

(71) Applicant: Lilac Solutions, Inc., Oakland, CA (US)

(72) Inventors: David Henry SNYDACKER, San Francisco, CA (US); David James ALT, Vancouver (CA); Amos Henokh INDRANADA, Oakland, CA (US); Nicolás Andrés GROSSO GIORDANO, Oakland, CA (US); Thomas Anthony PECORARO, Walnut Creek, CA (US)

(21) Appl. No.: 19/170,932

(22) Filed: Apr. 4, 2025

Related U.S. Application Data
(63) Continuation of application No. PCT/US2023/076285, filed on Oct. 6, 2023.
(60) Provisional application No. 63/414,356, filed on Oct. 7, 2022.

(51) Int. Cl. C22B 7/00; C22B 26/12

(52) U.S. Cl. CPC C22B 7/006; C22B 26/12

(57) ABSTRACT

The present invention relates to the extraction of lithium from liquid resources such as natural and synthetic brines, leachate solutions from clays and minerals, and recycled products.

### CROSS-REFERENCE

This application is a continuation of International Application No. PCT/US2023/076285, filed Oct. 6, 2023, which claims the benefit of U.S. Provisional Application No. 63/414,356 filed Oct. 7, 2022, which are hereby incorporated by reference in their entirety.

### BACKGROUND OF THE INVENTION

Lithium is an essential element for high-energy rechargeable batteries and other technologies. Lithium can be found in a variety of liquid solutions, including natural and synthetic brines and leachate solutions from minerals and recycled products.

### SUMMARY OF THE INVENTION

Disclosed herein is a system for lithium recovery, the system comprising:
a. an inlet configured to direct a synthetic lithium solution into a first subsystem;
b. the first subsystem configured to yield solid lithium carbonate and a carbonate mother liquor by either:
   i. adding a carbonate base to the synthetic lithium solution, or
   ii. generating carbonate in the synthetic lithium solution;
c. a second subsystem configured to remove carbonates from the carbonate mother liquor to yield a depleted carbonate mother liquor; and
d. a third subsystem configured to remove water from the depleted carbonate mother liquor to yield a concentrated lithium solution.

Disclosed herein is a system for lithium recovery from a liquid resource, the system comprising:
a. a pH modulation unit, wherein the pH of the liquid resource is modulated to a value of 5 and above with the addition of a base;
b. an ion exchange unit, the ion exchange unit comprising a lithium-selective sorbent, wherein the lithium-selective sorbent absorbs lithium ions from the liquid resource and releases lithium upon subsequent exposure to an acidic eluate to yield a synthetic lithium solution;
c. a purification unit configured to purify the synthetic lithium solution and modulate the pH of the synthetic lithium solution to 6 or above;
d. an inlet configured to direct the synthetic lithium solution into a first subsystem;
e. the first subsystem configured to yield solid lithium carbonate and a carbonate mother liquor by either:
   i. adding a carbonate base to the synthetic lithium solution, or
   ii. generating carbonate in the synthetic lithium solution;
f. a second subsystem configured to remove carbonates from the carbonate mother liquor to yield a depleted carbonate mother liquor;
g. a third subsystem configured to remove water from the depleted carbonate mother liquor to yield solid salts and a concentrated lithium solution;
h. a channel configured to add the concentrated lithium solution to the synthetic lithium solution; and
i. an optional electrochemical system configured to produce acid and hydroxide from the solid salts, wherein the acid is optionally used in the eluate of (b) or in the second subsystem of (f), and wherein the hydroxide is optionally used as the base in (a) or (c).

Disclosed herein is a system for lithium recovery from a liquid resource, the system comprising:
a. a pH modulation unit, wherein the pH of the liquid resource is modulated to a value of 5 and above with the addition of a base;
b. an ion exchange unit, the ion exchange unit comprising a lithium-selective sorbent, wherein the lithium-selective sorbent absorbs lithium ions from the liquid resource and releases lithium upon subsequent exposure to an acidic eluate to yield a synthetic lithium solution;
c. a purification unit configured to purify the synthetic lithium solution and modulate the pH of the synthetic lithium solution to 6 or above;
d. an inlet configured to direct the synthetic lithium solution into a first subsystem;
e. the first subsystem configured to yield solid lithium carbonate and a carbonate mother liquor by either:
   i. adding a carbonate base to the synthetic lithium solution, or
   ii. generating carbonate in the synthetic lithium solution; and
f. a channel configured to direct the carbonate mother liquor to the pH modulation unit, such that the base comprises the carbonate mother liquor.

Disclosed herein is a method for lithium recovery, the method comprising:
a. providing a synthetic lithium solution;
b. processing the synthetic lithium solution to yield solid lithium carbonate and a carbonate mother liquor by either:
   i. adding a carbonate base to the synthetic lithium solution, or
   ii. generating carbonate in the synthetic lithium solution;
c. removing carbonates from the carbonate mother liquor to yield a depleted carbonate mother liquor; and
d. removing water from the depleted carbonate mother liquor to yield a concentrated lithium solution.

Disclosed herein is a method for lithium recovery from a liquid resource, the method comprising:
a. modulating the pH of the liquid resource to a value of 5 and above with the addition of a base;
b. contacting the liquid resource with a lithium-selective sorbent, wherein the lithium-selective sorbent absorbs lithium ions from the liquid resource and releases lithium upon subsequent exposure to an acidic eluate to yield a synthetic lithium solution;
c. purifying the synthetic lithium solution and modulating the pH of the synthetic lithium solution to a value of 6 or above;
d. processing the synthetic lithium solution to yield solid lithium carbonate and a carbonate mother liquor by either:
   i. adding a carbonate base to the synthetic lithium solution, or
   ii. generating carbonate in the synthetic lithium solution;
e. removing carbonates from the carbonate mother liquor to yield a depleted carbonate mother liquor;
f. removing water from the depleted carbonate mother liquor to yield solid salts and a concentrated lithium solution; and
g. optionally producing acid and hydroxide from the solid salts using electrolysis, wherein the acid is optionally used in the eluate of (b) or in removing carbonates from the carbonate mother liquor of (e), and wherein the hydroxide base is optionally used in modulating the pH in (a) or (c).

Disclosed herein is a method for lithium recovery from a liquid resource, the method comprising:
a. modulating the pH of the liquid resource to a value of 5 and above with the addition of a base;
b. contacting the liquid resource with a lithium-selective sorbent, wherein the lithium-selective sorbent absorbs lithium ions from the liquid resource and releases lithium upon subsequent exposure to an acidic eluate to yield a synthetic lithium solution;
c. purifying the synthetic lithium solution and modulating the pH of the synthetic lithium solution to a value of 6 or above;
d. processing the synthetic lithium solution to yield solid lithium carbonate and a carbonate mother liquor by either:
   i. adding a carbonate base to the synthetic lithium solution, or
   ii. generating carbonate in the synthetic lithium solution;
e. recycling the carbonate mother liquor, such that the base comprises the carbonate mother liquor.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 presents a schematic of a system or plurality of subsystems configured to carry out a method of recovering water 111, solid salts 113, and lithium 114 from a mother liquor 110 to increase the efficiency of a direct lithium extraction process by recovering additional lithium from the mother liquor using lithium extraction unit 101 and providing a solution of solid salts 112 to a chloralkali plant for the production of acid and base.

FIG. 2 presents a schematic of a system or plurality of subsystems configured to carry out a method of recovering lithium from a mother liquor 213 to increase the efficiency of a direct lithium extraction process by providing the mother liquor to the inlet of a lithium extraction unit 201 as a combined stream 207 that further comprises a liquid resource 206.

FIG. 3 presents a schematic of a system or plurality of subsystems configured to carry out a method of recovering lithium from a mother liquor 305 by employing a lithium extraction unit 303 to extract lithium ions from the mother liquor and further generate a liquid stream 307 that may be (e.g., is) fed into a chloralkali plant that generates acid and base.

FIG. 4 presents a schematic of a system or plurality of subsystems configured to carry out a method of recovering water 412, solid salts 413, and a lithium stream 417 from a mother liquor 410 to increase the efficiency of a direct lithium extraction process by providing a lithium stream 417 yielded from the mother liquor that may be (e.g., is) input into a direct lithium extraction unit and providing a solution of solid salts 414 to a chloralkali plant for the production of acid and base.

FIG. 5 provides a system for the reduction or elimination of carbonates from a mother liquor 505 to generate depleted carbonate mother liquor 512, for the concentration of depleted carbonate mother liquor 512 to provide concentrated lithium solution 516, and for the recovery of lithium from concentrated lithium solution 516 by recycling 516 to the crystallizer 503.

FIG. 6 provides a system for the recovery of lithium from a liquid resource 611, yielding a purified acidic synthetic lithium solution 613 that is further processed to provide lithium carbonate solids 621 and a mother liquor 615, wherein the mother liquor 615 is further processed to provide a concentrated lithium solution, which is recycled to other portions of the system through streams 608 and 609 to recover lithium therefrom and increase the overall recovery of lithium from the liquid resource 611.

### DETAILED DESCRIPTION OF THE INVENTION

As used herein and in the appended claims, the singular forms “a,” “an,” and “the” include plural referents unless the context clearly dictates otherwise. Thus, for example, reference to “an agent” includes a plurality of such agents, and reference to “the cell” includes reference to one or more cells (or to a plurality of cells) and equivalents thereof known to those skilled in the art, and so forth. When ranges are used herein for physical properties, such as molecular weight, or chemical properties, such as chemical formulae, all combinations and subcombinations of ranges and specific embodiments therein are intended to be included. The term “about” when referring to a number or a numerical range means that the number or numerical range referred to is an approximation within experimental variability (or within statistical experimental error), and thus the number or numerical range, in some instances, will vary between 1% and 15% of the stated number or numerical range. The term “comprising” (and related terms such as “comprise” or “comprises” or “having” or “including”) is not intended to exclude that in other certain embodiments, for example, an embodiment of any composition of matter, composition, method, or process, or the like, described herein, “consist of” or “consist essentially of” the described features.

The terms “lithium”, “lithium ion”, and “Li⁺” are used interchangeably in the present specification and these terms are synonymous unless specifically noted to the contrary. The terms “hydrogen”, “hydrogen ion”, “proton”, and “H⁺” are used interchangeably in the present specification and these terms are synonymous unless specifically noted to the contrary.

As used herein, the words “column” and “vessel” are used interchangeably. In some embodiments described herein referring to a “vessel”, the vessel is a column. In some embodiments described herein referring to a “column”, the column is a vessel.

The term “the pH of the system” or “the pH of” a component of a system, for example one or more tanks, vessels, columns, pH modulating setups, or pipes used to establish fluid communication between one or more tanks, vessels, columns, or pH modulating setups, refers to the pH of the liquid medium contained or present in the system, or contained or present in one or more components thereof. In some embodiments, the liquid medium contained in the system, or one or more components thereof, is a liquid resource. In some embodiments, the liquid medium contained in the system, or one or more components thereof, is a brine. In some embodiments, the liquid medium contained in the system, or one or more components thereof, is an acid solution, an aqueous solution, a wash solution, a salt solution, a salt solution comprising lithium ions, or a lithium-enriched solution.

The term “concentration”, as used herein, refers to the amount of a chemical species within a given amount of liquid. In some embodiments, said concentration can be specified as the mass of a species dissolved in an amount of liquid (e.g. mg/L), or the number of moles of a species dissolved in an amount of liquid (e.g. mol/L). In some embodiments, concentration can be specified by the ratio of moles or mass of the species of interest to one or more other species dissolved in the same liquid. In some embodiments, only the mass concentration of an ionic species is stated; for example, a concentration of sodium (Na) is stated to be 100 milligrams per liter (mg/L). In such cases, the stated concentration refers to the mass concentration of the ion in solution, and does not include the mass of the anion; in the example stated above, such an ion may comprise (e.g., comprises) chloride (Cl⁻), nitrate (NO₃⁻), or sulfate (SO₄²⁻).

The term “direct lithium extraction,” as used herein, refers to a process involving the sorption or adsorption of lithium from solution. Direct lithium extraction can be carried out with a lithium-selective sorbent. A lithium-selective sorbent may comprise an ion exchange material.

The term “eluate,” as used herein, refers to a liquid input to employed for the removal of lithium from a lithium-selective sorbent. An eluate may be acidic. In some embodiments, an eluate is acidic (e.g., an acid solution). An eluate that has been placed in contact with a lithium-selective sorbent that releases lithium into the eluate is a lithium eluate. A lithium eluate is a synthetic lithium solution. A synthetic lithium solution is a lithium eluate. In some embodiments, wherein the lithium-selective sorbent is an ion exchange material than has been exposed to a brine comprising lithium, the eluate is an acidic solution. In such cases, the protons of the acidic eluate displace the lithium on the ion exchange material to yield a synthetic lithium eluate.

The term “mother liquor,” as used herein, is a liquid byproduct of a process for the generation of solid lithium carbonate from a lithium-containing solution. Mother liquor as described herein is an aqueous solution that comprises lithium and additional salts.

Lithium is an essential element for batteries and other technologies. Lithium is found in a variety of liquid resources, including natural and synthetic brines and leachate solutions from minerals, clays, and recycled products. Lithium is optionally extracted from such liquid resources using an ion exchange process based on inorganic ion exchange materials. These inorganic ion exchange materials absorb lithium from a liquid resource while releasing hydrogen, and then elute lithium in acid while absorbing hydrogen. This ion exchange process is optionally repeated to extract lithium from a liquid resource and yield a concentrated lithium solution. The concentrated lithium solution is optionally further processed into chemicals for the battery industry or other industries.

Ion exchange beads, including ion exchange particles, ion exchange material, ion exchange media, porous ion exchange beads, and/or coated ion exchange particles, are loaded into ion exchange devices. Alternating flows of brine, acid, and other solutions are optionally flowed through an ion exchange column or vessel to extract lithium from the brine and produce a lithium concentrate, which is eluted from the column or vessel using the acid. As brine flows through the ion exchange column or vessel, the beads absorb lithium while releasing hydrogen, where both the lithium and hydrogen are cations. After the beads have absorbed lithium, acid is used to elute the lithium from the ion exchange beads to produce an eluate, or synthetic lithium-enriched solution.

Ion exchange beads may have (e.g., have) small diameters less than about one millimeter causing a high pressure difference across a packed bed of the beads during pumping of the liquid resource and other fluids through the bed. To minimize pressure across the packed bed and to minimize associated pumping energy, vessels with optimized geometries can be used to reduce the flow distance through the packed bed of ion exchange beads. These vessels may be networked with pH modulation units to achieve adequate control of the pH of the liquid resource.

In some embodiments a network of vessels loaded with ion exchange materials may comprise (e.g., comprises) two vessels, three vessels, four vessels, five vessels, six vessels, seven vessels, eight vessels, nine vessels, 10 vessels, 11 vessels, 12 vessels, 13-14 vessels, 15-20 vessels, 20-30 vessels, 30-50 vessels, 50-70 vessels, 70-100 vessels, or more than 100 vessels.

As brine flows through the ion exchange column or vessel, the ion exchange beads absorb lithium while releasing hydrogen, causing a decrease in the pH of the brine from which lithium is being extracted. pH values of less than about 6 in said brine result in sub-optimal performance of the ion-exchange process, because the higher proton concentrations found at low pH result in the reversal of ion-exchange, where protons are absorbed while lithium is released. Said sub-optimal process performance is manifested as, but not limited to, slower uptake of lithium by the ion exchange beads, lower purity of the lithium eluted from the beads, lower lithium uptake capacity by the ion-exchange beads, degradation of the ion-exchange material, decreased lifetime of the ion-exchange material which necessitates more frequent replacement, slower elution of lithium from the ion exchange beads in the presence of acid, and higher acid consumption for elution of lithium from the ion exchange beads.

In some embodiments, the pH value of the brine can be maintained above a value of 6 by addition of an alkali. In some embodiments, said alkali is added before flow of said brine through a bed or ion exchange material, or after flow of said brine through a bed of ion exchange material, but not within the bed of ion exchange material where the lithium extraction process occurs. In some embodiments, the pH of the brine decreases to a suboptimal value of less than about 6 during the time it takes for said brine to flow through a bed of ion exchange material. Thus, systems and methods described herein are used to moderate the decrease in pH of the liquid resource during contact of said liquid resource with an ion exchange material.

In some embodiments, a system is used to adjust the concentration of lithium in the liquid resource before it contacts an ion exchange material to extract lithium while release protons. In some embodiments, said system decreases the lithium concentration, such that less lithium is absorbed by the ion exchange material, and therefore fewer protons are released during this absorption process, leading to a higher value of pH for said brine as it contacts the ion exchange material. In some embodiments, adjustment of the lithium concentration in the liquid resource is achieved by mixing the liquid resource with a raffinate stream, said raffinate stream comprising the liquid resource which has contacted ion exchange beads to absorb a portion of the lithium. Thus, any lithium remaining in the raffinate stream will be contacted with the ion-exchange material again, leading to multiple contacts of said lithium with the ion-exchange material and multiple opportunities for uptake of said lithium by the ion exchange material. The net result is an increase in the overall recovery of lithium by said system.

The lithium extracted exits the lithium extraction system as an acidic eluate solution, or synthetic lithium solution. Said solution is optionally treated to adjust its pH, remove impurities, and/or increase its lithium concentration by removing water. In some embodiments, said treated and concentrated lithium solution is further processed into lithium carbonate by treatment with sodium carbonate, followed by heating to precipitate said sodium carbonate. This results in lithium carbonate solids that are separated by solid-liquid separation, and a sodium carbonate stream comprising some remaining lithium. Said carbonate stream is termed a “mother liquor”.

Lithium remains in solution in this mother liquor in a range of about 100 to about 10,000 mg/L. The systems described herein recovers the soluble lithium from this mother liquor, to increase the overall recovery of lithium from the lithium extraction system.

### The Liquid Resource

In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from sediments, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof. In some embodiments, the liquid resource is optionally pre-treated prior to entering the ion exchange reactor to remove suspended solids, hydrocarbons, organic molecules, iron, certain metals, or other chemical or ionic species. In some embodiments, the liquid resource is optionally fed into the ion exchange reactor without any pre-treatment following from its source. In some embodiments, the liquid resource is injected into a reservoir, salt lake, salt flat, basin, or other geologic deposit after lithium has been removed from the liquid resource. In some embodiments, other species are recovered from the liquid resource before or after lithium recovery. In some embodiments, the pH of the liquid resource is adjusted before, during, or after lithium recovery.

In one embodiment, the liquid resource is a natural brine, a dissolved salt flat, seawater, concentrated seawater, a geothermal brine, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

In one embodiment, the brine is at a temperature of −20 to 20 C, 20 to 50 C, 50 to 100 C, 100 to 200 C, or 200 to 400 C. In one embodiment, the brine is heated or cooled to precipitate or dissolve species in the brine, or to facilitate removal of metals from the brine.

In one embodiment, the brine contains lithium at a concentration of less than 1 mg/L, 1 to 50 mg/L, 50 to 200 mg/L, 200 to 500 mg/L, 500 to 2,000 mg/L, 2,000 to 5,000 mg/L, 5,000 to 10,000 mg/L, 10,000 to 20,000 mg/L, 20,000 to 80,000 mg/L, or greater than 80,000 mg/L.

In one embodiment, the brine contains magnesium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains calcium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains strontium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains barium at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L.

In one embodiment, the brine contains multivalent cations at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains multivalent ions at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains non-lithium impurities at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains transition metals at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains iron at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L. In one embodiment, the brine contains manganese at a concentration of 0.01 to 0.1 mg/L, 0.1 to 1 mg/L, 1 to 10 mg/L, 10 to 100 mg/L, 100 to 1,000 mg/L, 1,000 to 10,000 mg/L, 10,000 to 50,000 mg/L, 50,000 to 100,000 mg/L, 100,000 to 150,000 mg/L, or greater than 150,000 mg/L.

In one embodiment, the brine is treated to produce a feed brine which has certain metals removed. In one embodiment, the feed brine contains iron at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the feed brine contains manganese at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the feed brine contains lead at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the feed brine contains zinc at a concentration of less than 0.01, 0.01 to 0.1 mg/L, mg/L, 0.1 to 1.0 mg/L, 1.0 to 10 mg/L, 10 to 100 mg/L, or 100 to 1,000 mg/L. In one embodiment, the feed brine contains lithium at a concentration of 1 to 50 mg/L, 50 to 200 mg/L, 200 to 500 mg/L, 500 to 2,000 mg/L, or greater than 2,000 mg/L.

In one embodiment, the feed brine is processed to recover metals such as lithium and yield a spent brine or raffinate. In one embodiment, the raffinate contains residual quantities of the recovered metals at a concentration of less than 0.01, 0.01 to 0.1 mg/L, mg/L, 0.1 to 1.0 mg/L, 1.0 to 10 mg/L, 10 to 100 mg/L, 100 to 1,000 mg/L, or 1,000 to 10,000 mg/L.

In one embodiment, the pH of the brine is corrected to less than 0, 0 to 1, 1 to 2, 2 to 4, 4 to 6, 6 to 8, 4 to 8, 8 to 9, 9 to 10, 9 to 11, or 10 to 12. In one embodiment, the pH of the brine is corrected to 2 to 4, 4 to 6, 6 to 8, 4 to 8, 8 to 9, 9 to 10, 9 to 11, or 10 to 12. In one embodiment, the pH of the brine is corrected to precipitate or dissolve metals.

In one embodiment, metals are precipitated from the brine to form precipitates. In one embodiment, precipitates include transition metal hydroxides, oxy-hydroxides, sulfide, flocculants, aggregate, agglomerates, or combinations thereof. In one embodiment, the precipitates include Li, Na, K, Rb, Cs, Fr, Be, Mg, Ca, Sr, Ba, Ra, Sc, Y, Ti, Zr, Hf, V, Nb, Ta, Cr, Mo, W, Mn, Tc, Fe, Fe, Ru, Os, Co, Rh, Ir, Ni, Pd Pt, Cu, Ag, Au, Zn, Cd, Hg, B, Al, Ga, In, Si, Ge, Sn, Pb, As, Sb, Bi, Se, Te, Po, Br, I, At, other metals, or a combination thereof. In one embodiment, the precipitates may be (e.g., are) concentrated into a slurry, a filter cake, a wet filter cake, a dry filter cake, a dense slurry, or a dilute slurry.

In one embodiment, the precipitates contain iron at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain manganese at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain lead at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain arsenic at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain magnesium at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates contain Li, Na, K, Rb, Cs, Fr, Be, Mg, Ca, Sr, Ba, Ra, Sc, Y, Ti, Zr, Hf, V, Nb, Ta, Cr, Mo, W, Mn, Tc, Fe, Fe, Ru, Os, Co, Rh, Ir, Ni, Pd Pt, Cu, Ag, Au, Zn, Cd, Hg, B, Al, Ga, In, Si, Ge, Sn, Pb, As, Sb, Bi, Se, Te, Po, Br, I, At, or other metals at a concentration of less than 0.01 mg/kg, 0.01 to 1 mg/kg, 1 to 100 mg/kg, 100 to 10,000 mg/kg, or 10,000 to 800,000 mg/kg. In one embodiment, the precipitates are toxic and/or radioactive.

In one embodiment, precipitates are redissolved by combining the precipitates with acid. In one embodiment, precipitates are redissolved by combining the precipitates with acid in a mixing apparatus. In one embodiment, precipitates are redissolved by combining the precipitates with acid using a high-shear mixer.

Lithium is an essential element for batteries and other technologies. Lithium is found in a variety of liquid resources, including natural and synthetic brines and leachate solutions from minerals, clays, and recycled products. Lithium is optionally extracted from such liquid resources using an ion exchange process based on inorganic ion exchange materials. These inorganic ion exchange materials absorb lithium from a liquid resource while releasing hydrogen, and then elute lithium into an acidic solution while absorbing hydrogen. This ion exchange process is optionally repeated to extract lithium from a liquid resource and yield a concentrated lithium solution. The concentrated lithium solution is optionally further processed into chemicals for the battery industry or other industries.

Ion exchange materials are optionally formed into beads and the beads are optionally loaded into ion exchange columns, stirred tank reactors, other reactors, or other systems for lithium extraction. Alternating flows or aliquots of brine, acidic solution, and optionally other solutions are flowed through or flowed into an ion exchange column, reactors, or reactor system to extract lithium from the brine and produce a lithium concentrate, which is eluted from the column using the acidic solution. As brine flows through the ion exchange column, reactors, or reactor system, the ion exchange material absorbs lithium while releasing hydrogen, where both the lithium and hydrogen are cations. The release of hydrogen during lithium uptake will acidify the brine and limit lithium uptake unless the pH of the brine is optionally maintained in a suitable range to facilitate thermodynamically favorable lithium uptake and concomitant hydrogen release. In one embodiment, pH of the liquid resource is maintained near a set-point through addition of base to neutralized protons released from the ion exchange material into the liquid resource.

### Treatment of the Liquid Resource

In some embodiments, the pH of the liquid resource is adjusted before, during and/or after contact with the lithium-selective ion exchange material to maintain the pH in range that is suitable for lithium uptake.

To control the pH of the brine and maintain the pHin a range that is suitable for lithium uptake in an ion exchange column, bases such as NaOH, Ca(OH)₂, CaO, KOH, or NH₃ are optionally added to the brine as solids, aqueous solutions, or in other forms. For brines that contain divalent ions such as Mg, Ca, Sr, or Ba, addition of base to the brine can cause precipitation of solids, such as Mg(OH)₂ or Ca(OH)₂, which can cause problems for the ion exchange reaction. These precipitates cause problems in at least three ways. First, precipitation can remove base from solution, leaving less base available in solution to neutralize protons and maintain pH in a suitable range for lithium uptake in the ion exchange column. Second, precipitates that form due to base addition can clog the ion exchange column, including clogging the surfaces and pores of ion exchange beads and the voids between ion exchange beads. This clogging can prevent lithium from entering the beads and being absorbed by the ion exchange material. The clogging can also cause large pressure heads in the column. Third, precipitates in the column dissolve during acid elution and thereby contaminate the lithium concentrate produced by the ion exchange system. For ion exchange beads to absorb lithium from brine, an ideal pH range for the brine is optionally 5 to 7, a preferred pH range is optionally 4 to 8, and an acceptable pH range is optionally 1 to 9. In one embodiment, an pH range for the brine is optionally about 1 to about 14, about 2 to about 13, about 3 to about 12, about 4 to about 12, about 4.5 to about 11, about 5 to about 10, about 5 to about 9, about 2 to about 5, about 2 to about 4, about 2 to about 3, about 3 to about 8, about 3 to about 7, about 3 to about 6, about 3 to about 5, about 3 to about 4, about 4 to about 10, about 4 to about 9, about 4 to about 8, about 4 to about 7, about 4 to about 6, about 4 to about 5, about 5 to about 6, about 5 to about 7, about 5 to about 8, about 6 to about 7, about 6 to about 8, or about 7 to about 8.

In one embodiment, the liquid resource is subjected to treatment prior to ion exchange. In some embodiments, said treatment comprises filtration, gravity sedimentation, centrifugal sedimentation, magnetic fields, other methods of solid-liquid separation, or combinations thereof. In some embodiments, precipitated metals are removed from the brine using a filter. In some embodiments, the filter is a belt filter, plate-and-frame filter press, pressure vessel containing filter elements, rotary drum filter, rotary disc filter, cartridge filter, a centrifugal filter with a fixed or moving bed, a metal screen, a perforated basket centrifuge, a three-point centrifuge, a peeler type centrifuge, or a pusher centrifuge. In some embodiments, the filter may use a scroll or a vibrating device. In some embodiments, the filter is horizontal, vertical, or may use a siphon.

In some embodiments, a filter cake is prevented, limited, or removed by using gravity, centrifugal force, an electric field, vibration, brushes, liquid jets, scrapers, intermittent reverse flow, vibration, crow-flow filtration, or pumping suspensions across the surface of the filter. In some embodiments, the precipitated metals and a liquid is moved tangentially to the filter to limit cake growth. In some embodiments, gravitational, magnetic, centrifugal sedimentation, or other means of solid-liquid separation are used before, during, or after filtering to prevent cake formation.

In some embodiments, a filter comprises a screen, a metal screen, a sieve, a sieve bend, a bent sieve, a high frequency electromagnetic screen, a resonance screen, or combinations thereof. In some embodiments, one or more particle traps are a solid-liquid separation apparatus.

In some embodiments, one or more solid-liquid separation apparatuses may be (e.g., are) used in series or parallel. In some embodiments, a dilute slurry is removed from the tank, transferred to an external solid-liquid separation apparatus, and separated into a concentrated slurry and a solution with low or no suspended solids. In some embodiments, the concentrated slurry is returned to the tank or transferred to a different tank. In some embodiments, precipitate metals are transferred from a brine tank to another brine tank, from an acid tank to another acid tank, from a washing tank to another washing tank, from a brine tank to a washing tank, from a washing tank to an acid tank, from an acid tank to a washing tank, or from an acid tank to a brine tank.

In some embodiments, solid-liquid separation apparatuses may use gravitational sedimentation. In some embodiments, solid-liquid separation apparatuses may include a settling tank, a thickener, a clarifier, a gravity thickener. In some embodiments, solid-liquid separation apparatuses are operated in batch mode, semi-batch mode, semi-continuous mode, or continuous mode. In some embodiments, solid-liquid separation apparatuses include a circular basin thickener with slurry entering through a central inlet such that the slurry is dispersed in to the thickener with one or more raking components that rotate and concentrate the ion exchange particles into a zone where the particles can leave through the bottom of the thickener.

In some embodiments, solid-liquid separation apparatuses include a deep cone, a deep cone tank, a deep cone compression tank, or a tank wherein the slurry is compacted by weight. In some embodiments, solid-liquid separation apparatuses include a tray thickener with a series of thickeners oriented vertically with a center axle and raking components. In some embodiments, solid-liquid separation apparatuses include a lamella type thickener with inclined plates or tubes that may be (e.g., are) smooth, flat, rough, or corrugated. In some embodiments, solid-liquid separation apparatuses include a gravity clarifier that may be (e.g., are) a rectangular basin with feed at one end and overflow at the opposite end optionally with paddles and/or a chain mechanism to move particles. In some embodiments, the solid-liquid separation apparatuses may be (e.g. are) a particle trap.

In some embodiments, the solid-liquid separation apparatuses use centrifugal sedimentation. In some embodiments, solid-liquid separation apparatuses may include a tubular centrifuge, a multi-chamber centrifuge, a conical basket centrifuge, a scroll-type centrifuge, a sedimenting centrifuge, or a disc centrifuge. In some embodiments, precipitated metals are discharged continuously or intermittently from the centrifuge. In some embodiments, the solid-liquid separation apparatus is a hydrocyclone. In some embodiments, solid-liquid separation apparatus is an array of hydrocyclones or centrifuges in series and/or in parallel. In some embodiments, sumps are used to reslurry the precipitated metals. In some embodiments, the hydrocyclones may have (e.g., have) multiple feed points. In some embodiments, a hydrocyclone is used upside down. In some embodiments, liquid is injected near the apex of the cone of a hydrocyclone to improve sharpness of cut. In some embodiments, a weir rotates in the center of the particle trap with a feed of slurried precipitated metals entering near the middle of the apparatus, and precipitated metals get trapped at the bottom and center of the apparatus due to a “teacup effect”.

### Ion Exchange Material

An aspect of the invention described herein is a system wherein the ion exchange material comprises a plurality of ion exchange particles. In an embodiment, the plurality of ion exchange particles in the ion exchange material is selected from uncoated ion exchange particles, coated ion exchange particles and combinations thereof. In an embodiment, the ion exchange material is a porous ion exchange material. In an embodiment, the porous ion exchange material comprises a network of pores that allows liquids to move quickly from the surface of the porous ion exchange material to the plurality of ion exchange particles. In an embodiment, the ion exchange material is in the form of porous ion exchange beads. In an embodiment, the liquid resource is a natural brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

Ion exchange materials are typically small particles, which together constitute a fine powder. In some embodiments small particle size minimizes the diffusion distance that lithium must travel into the core of the ion exchange particles. In some cases, these particles are optionally coated with protective surface coatings to minimize dissolution of the ion exchange materials while allowing efficient transfer of lithium and hydrogen to and from the particles.

In an embodiment, the coated ion exchange particles are comprised of an ion exchange material and a coating material wherein the ion exchange material comprises Li₄Mn₅O₁₂, Li_{1.6}Mn_{1.6}O₄, Li₂MO₃ (M=Ti, Mn, Sn), LiFePO₄, solid solutions thereof, or combinations thereof and the coating material comprises TiO₂, ZrO₂, MoO₂, Li₂TiO₃, Li₂ZrO₃, LiNbO₃, AlF₃, SiC, Si₃N₄, graphitic carbon, amorphous carbon, diamond-like carbon, or combinations thereof. The coated ion exchange particles have an average diameter less than about 100 nm, less than about 1,000 nm, or less than about 10,000 nm, and the coating thickness is less than about 1 nm, less than about 10 nm, or less than about 100 nm. The particles are created by first synthesizing the ion exchange material using a method such as hydrothermal, solid state, or microwave. The coating material is then deposited on the surface of the ion exchange material using a method such as chemical vapor deposition, hydrothermal, solvothermal, sol-gel, precipitation, or microwave. The coated ion exchange particles are treated with an acid solution prepared with hydrochloric acid, sulfuric acid, nitric acid, or combinations thereof wherein the concentration of the acid solution is greater than about 0.1 M, greater than about 1.0 M, greater than about 5 M, greater than about 10 M, or combinations thereof. During acid treatment, the particles absorb hydrogen while releasing lithium. The ion exchange material is converted to a hydrated state with a hydrogen-rich composition. The coating material allows diffusion of hydrogen and lithium respectively to and from the ion exchange material while providing a protective barrier that limits dissolution of the ion exchange material. After treatment in acid, the hydrated coated ion exchange particles are treated with a liquid resource wherein the liquid resource is a natural brine, a dissolved salt flat, a concentrated brine, a processed brine, a synthetic brine, liquid from an ion exchange process, liquid from a solvent extraction process, leachate from minerals, leachate from clays, leachate from recycled products, leachate from recycled materials, or combinations thereof. The coated ion exchange particles absorb lithium while releasing hydrogen. The lithium salt solution is then collected. The coated ion exchange particles are capable then perform the ion exchange reaction repeatedly over a number of cycles greater than about 10 cycles, greater than about 30 cycles, greater than about 100 cycles, or greater than about 300 cycles.

One major challenge for lithium extraction using inorganic ion exchange particles is the loading of the particles into an ion exchange column in such a way that brine and acid are optionally pumped efficiently through the column with minimal clogging. The materials are optionally formed into beads, and the beads are optionally loaded into the column. This bead loading creates void spaces between the beads, and these void spaces facilitate pumping through the column. The beads hold the ion exchange particles in place and prevent free movement of the particles throughout the column. When the materials are formed into beads, the penetration of brine and acid solutions into the beads become slow and challenging. A slow rate of convection and diffusion of the acid and brine solutions into the bead slows the kinetics of lithium absorption and release. Such slow kinetics can create problems for column operation. Slow kinetics can require slow pumping rates through the column. Slow kinetics can also lead to low lithium recovery from the brine and inefficient use of acid to elute the lithium.

In some embodiments, the ion exchange beads are porous ion exchange beads with networks of pores that facilitate the transport into the beads of solutions that are pumped through an ion exchange column. Pore networks are optionally strategically controlled to provide fast and distributed access for the brine and acid solutions to penetrate into the bead and deliver lithium and hydrogen to the ion exchange particles.

In some embodiments, the ion exchange beads are formed by mixing ion exchange particles, a matrix material, and a filler material. These components are mixed and formed into a bead. Then, the filler material is removed from the bead to leave behind pores. The filler material is dispersed in the bead in such a way to leave behind a pore structure that enables transport of lithium and hydrogen with fast kinetics. This method optionally involves multiple ion exchange materials, multiple polymer materials, and multiple filler materials.

Another major challenge for lithium extraction using inorganic ion exchange materials is dissolution and degradation of the materials, especially during lithium elution in acid but also during lithium uptake in liquid resources. To yield a concentrated lithium solution from the ion exchange process, it is desirable to use a concentrated acid solution to elute the lithium.

However, concentrated acid solutions dissolve and degrade inorganic ion exchange materials, which decrease the performance and lifespan of the materials. Therefore, the porous ion exchange beads optionally contain coated ion exchange particle for lithium extraction that are comprised of an ion exchange material and a coating material protecting the particle surface. The coating protects the ion exchange material from dissolution and degradation during lithium elution in acid, during lithium uptake from a liquid resource, and during other aspects of an ion exchange process. This coated particle enables the use of concentrated acids in the ion exchange process to yield concentrated lithium solutions.

In this invention, the ion exchange material is selected for high lithium absorption capacity, high selectivity for lithium in a liquid resource relative to other ions such as sodium and magnesium, strong lithium uptake in liquid resources including those with low concentrations of lithium, facile elution of lithium with a small excess of acid, and fast ionic diffusion. A coating material is optionally selected to protect the particle from dissolution and chemical degradation during lithium recovery in acid and also during lithium uptake in various liquid resources. A coating material optionally is also selected to facilitate diffusion of lithium and hydrogen between the particles and the liquid resources, to enable adherence of the particles to a structural support, and to suppress structural and mechanical degradation of the particles.

When the porous ion exchange beads are used in an ion exchange column, the liquid resource containing lithium is pumped through the ion exchange column so that the ion exchange particles absorb lithium from the liquid resource while releasing hydrogen. After the beads have absorbed lithium, an acid solution is pumped through the column so that the particles release lithium into the acid solution while absorbing hydrogen. The column is optionally operated in co-flow mode with the liquid resource and acid solution alternately flowing through the column in the same direction, or the column is optionally operated in counter-flow mode with a liquid resource and acid solution alternately flowing through the column in opposite directions. Between flows of the liquid resource and the acid solution, the column is optionally treated or washed with water or other solutions for purposes such as adjusting pH in the column or removing potential contaminants. The beads optionally form a fixed or moving bed, and the moving bed optionally moves in counter-current to the brine and acid flows. The beads are optionally moved between multiple columns with moving beds where different columns are used for brine, acid, water, or other flows. Before or after the liquid resource flows through the column, the pH of the liquid is optionally adjusted with NaOH or other chemicals to facilitate the ion exchange reaction as well as handling or disposal of the spent liquid resource. Before or after the liquid resource flows through the column, the liquid resource is optionally subjected to other processes including other ion exchange processes, solvent extraction, evaporation, chemical treatment, or precipitation to remove lithium, to remove other chemical species, or to otherwise treat the brine.

When the ion exchange particles are treated with acid, a lithium solution is produced. This lithium solution is optionally further processed to produce lithium chemicals. These lithium chemicals are optionally supplied for an industrial application. In some embodiments, an ion exchange material is selected from the following list: an oxide, a phosphate, an oxyfluoride, a fluorophosphate, or combinations thereof. In some embodiments, an ion exchange material is selected from the following list: LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, or combinations thereof. In a further aspect, an ion exchange material comprises LiFePO₄, Li₂SnO₃, Li₂MnO₃, Li₂TiO₃, Li₄Ti₅O₁₂, Li₄Mn₅O₁₂, Li_{1.6}Mn_{1.6}O₄, solid solutions thereof, or combinations thereof.

In a further aspect described herein, the coating material allows diffusion to and from the ion exchange material. In particular, the coating material facilitates diffusion of lithium and hydrogen between the particles and the liquid resources, enables adherence of the particles to a structural support, and suppresses structural and mechanical degradation of the particles. In a further aspect described herein, the coating material comprises a carbide, a nitride, an oxide, a phosphate, a fluoride, a polymer, carbon, a carbonaceous material, or combinations thereof. In a further aspect, the coating material comprises polyvinylidene difluoride, polyvinyl chloride, a fluoro-polymer, a chloro-polymer, or a fluoro-chloro-polymer. In a further aspect, a coating material comprises Nb₂O₅, Ta₂O₅, MoO₂, TiO₂, ZrO₂, SnO₂, SiO₂, Li₂O, Li₂TiO₃, Li₂ZrO₃, Li₂MoO₃, LiNbO₃, LiTaO₃, Li₂SiO₃, Li₂Si₂O₅, Li₂MnO₃, ZrSiO₄, AlPO₄, LaPO₄, ZrP₂O₇, MoP₂O₇, MO₂P₃O₁₂, BaSO₄, AlF₃, SiC, TiC, ZrC, Si₃N₄, ZrN, BN, carbon, graphitic carbon, amorphous carbon, hard carbon, diamond-like carbon, solid solutions thereof, or combinations thereof. In a further aspect, a coating material comprises TiO₂, ZrO₂, SiO₂, Li₂TiO₃, Li₂ZrO₃, Li₂MnO₃, ZrSiO₄, or LiNbO₃. In a further aspect, a coating material comprises a chloro-polymer, a fluoro-polymer, a chloro-fluoro-polymer, a hydrophilic polymer, a hydrophobic polymer, co-polymers thereof, mixtures thereof, or combinations thereof. In a further aspect, a coating material comprises a co-polymer, a block co-polymer, a linear polymer, a branched polymer, a cross-linked polymer, a heat-treated polymer, a solution processed polymer, co-polymers thereof, mixtures thereof, or combinations thereof. In a further aspect, a coating material comprises low density polyethylene, high density polyethylene, polypropylene, polyester, polytetrafluoroethylene (PTFE), types of polyamide, polyether ether ketone (PEEK), polysulfone, polyvinylidene fluoride (PVDF), poly (4-vinyl pyridine-co-styrene) (PVPCS), polystyrene (PS), polybutadiene, acrylonitrile butadiene styrene (ABS), polyvinyl chloride (PVC), ethylene tetrafluoroethylene polymer (ETFE), poly (chlorotrifluoroethylene) (PCTFE), ethylene chlorotrifluoro ethylene (Halar), polyvinylfluoride (PVF), fluorinated ethylene-propylene (FEP), perfluorinated elastomer, chlorotrifluoroethylenevinylidene fluoride (FKM), perfluoropolyether (PFPE), perfluoro-3,6-dioxa-4-methyl-7-octene-sulfonic acid (NAFION® (copolymer of perfluoro-3,6-dioxa-4-methyl-7-octene-sulfonic acid and tetrafluoroethylene)), polyethylene oxide, polyethylene glycol, sodium polyacrylate, polyethylene-block-poly(ethylene glycol), polyacrylonitrile (PAN), polychloroprene (neoprene), polyvinyl butyral (PVB), expanded polystyrene (EPS), polydivinylbenzene, co-polymers thereof, mixtures thereof, or combinations thereof. In a further aspect, a coating material comprises polyvinylidene fluoride (PVDF), polyvinyl chloride (PVC), ethylene chlorotrifluoro ethylene (Halar), poly (4-vinyl pyridine-co-styrene) (PVPCS), polystyrene (PS), acrylonitrile butadiene styrene (ABS), expanded polystyrene (EPS), polyphenylene sulfide, sulfonated polymer, carboxylated polymer, other polymers, co-polymers thereof, mixtures thereof, or combinations thereof. In a further aspect, a coating is deposited onto an ion exchange particle by dry mixing, mixing in solvent, emulsion, extrusion, bubbling one solvent into another, casting, heating, evaporating, vacuum evaporation, spray drying, vapor deposition, chemical vapor deposition, microwaving, hydrothermal synthesis, polymerization, co-polymerization, cross-linking, irradiation, catalysis, foaming, other deposition methods, or combinations thereof. In a further aspect, a coating is deposited using a solvent comprising N-methyl-2-pyrrolidone, dimethyl sulfoxide, tetrahydrofuran, dimethylformamide, dimethylacetamide, methyl ethyl ketone, ethanol, acetone, other solvents, or combinations thereof. In a further aspect, a coating is deposited using a solvent comprising N-methyl-2-pyrrolidone, dimethyl sulfoxide, tetrahydrofuran, dimethylformamide, dimethylacetamide, methyl ethyl ketone, ethanol, acetone, or combinations thereof.

In a further aspect described herein, the coated ion exchange particles have an average diameter (e.g., average particle diameter) less than about 10 nm, less than about 100 nm, less than about 1,000 nm, less than about 10,000 nm, or less than about 100,000 nm. In a further aspect, the coated ion exchange particles have an average size less than about 100 nm, less than about 1,000 nm, or less than about 10,000 nm. In a further aspect, the coated ion exchange particles are optionally secondary particles comprised of smaller primary particles that have an average diameter less than about 10 nm, less than about 100 nm, less than about 1,000 nm, less than about 10,000 nm, or less than about 100,000 nm. In a further aspect, the coating optionally coats the primary ion exchange particles. In a further aspect, the coating optionally coats the secondary ion exchange particles. In a further aspect, the coating optionally coats the secondary ion exchange particles. In a further aspect, the coating optionally coats both the primary ion exchange particles and the secondary ion exchange particles. In a further aspect, the primary ion exchange particles optionally have a first coating and the secondary ion exchange particles optionally have a second coating that is optionally identical, similar, or different in composition to the first coating.

In a further aspect described herein, the ion exchange material has a particle size of less than about 10 nm, less than about 100 nm, less than about 1,000 nm, less than about 10,000 nm, or less than about 100,000 nm. In some embodiments, the particle size of the ion exchange material is about 100 nm, about 200 nm, about 300 nm, about 400 nm, about 500 nm, about 600 nm, about 700 nm, about 800 nm, about 900 nm, about 1000 nm, about 2 microns, about 3 microns, about 4 microns, about 5 microns, about 6 microns, about 7 microns, about 8 microns, about 9 microns, or about 10 microns. In a further aspect, the coated ion exchange particles have an average size less than about 100 nm, less than about 1,000 nm, or less than about 10,000 nm.

It is recognized that measurements of average particle diameter (e.g., average diameter of a coated ion exchange particle or an uncoated ion exchange particle, particle size of an ion exchange material) can vary according to the method of determination utilized. Determination of said average particle diameter according to one method to obtain one or more values shall be understood to inherently encompass all other values that may be obtained using other methods. The average particle diameter can be determined using sieve analysis. The average particle diameter can be determined using optical microscopy. The average particle diameter can be determined using electron microscopy. The average particle diameter can be determined using laser diffraction. In some embodiments, the average particle diameter is determined using laser diffraction, wherein a Bettersizer ST instrument is used. In some embodiments, the average particle diameter is determined using a Bettersizer ST instrument. In some embodiments, the average particle diameter is determined using laser diffraction, wherein an Anton-Parr particle size analyzer (PSA) instrument is used. In some embodiments, the average particle diameter is determined using an Anton-Parr PSA instrument. The average particle diameter can be determined using dynamic light scattering. The average particle diameter can be determined using static image analysis. The average particle diameter can be determined using dynamic image analysis.

In some embodiments described herein, the coating material has a thickness less than about 1 nm, less than about 10 nm, less than about 100 nm, less than about 1,000 nm, or less than about 10,000 nm. In further embodiments, the coating material has a thickness less than about 5 nm, less than about 50 nm, or less than about 500 nm. In some embodiments, the ion exchange particles have a coating material with a thickness selected from the following list: less than 1 nm, less than 10 nm, less than 100 nm, or less than 1,000 nm. In some embodiments, the coating material has a thickness selected from the following list: less than 1 nm, less than 10 nm, or less than 100 nm. In certain embodiments, the coating material has a thickness between about 0.5 nm to about 1000 nm. In some embodiments, the coating material has a thickness between about 1 nm to about 100 nm.

In some embodiments, coating thickness may be measured by any one or more of electron microscopy, optical microscopy, couloscopy, nanoindentation, atomic force microscopy, and X-ray fluorescence. In some embodiments, coating thickness may be inferred or extrapolated from data obtained according to an analytical method that indicates the bulk composition of the coated ion exchange particle, or the ion exchange material that further comprises the coating material. In some embodiments, coating thickness may be inferred by differential analysis of data obtained by analysis of ion exchange material that further comprises a coating material and data obtained by analysis ion exchange material that does not further comprise a coating material. In some embodiments, coating thickness may be inferred by differential analysis of data obtained by analysis of one or more coated ion exchange particles and data obtained by analysis of one or more uncoated ion exchange particles.

In a further aspect described herein, the ion exchange material and the coating material form one or more concentration gradients where the chemical composition of the particle ranges between two or more compositions. In a further aspect, the chemical composition optionally varies between the ion exchange materials and the coating in a manner that is continuous, discontinuous, or continuous and discontinuous in different regions of the particle. In a further aspect, the ion exchange materials and the coating materials form a concentration gradient that extends over a thickness less than about 1 nm, less than about 10 nm, less than about 100 nm, less than about 1,000 nm, less than about 10,000 nm, or less than about 100,000 nm. In a further aspect, the ion exchange materials and the coating materials form a concentration gradient that extends over a thickness of about 1 nm to about 1,000 nm.

In a further aspect described herein, the ion exchange material is synthesized by a method such as hydrothermal, solvothermal, sol-gel, solid state, molten salt flux, ion exchange, microwave, ball milling, chemical precipitation, co-precipitation, vapor deposition, or combinations thereof. In a further aspect, the ion exchange material is synthesized by a method such as chemical precipitation, hydrothermal, solid state, or combinations thereof.

In a further aspect described herein, the coating material is deposited by a method such as chemical vapor deposition, atomic layer deposition, physical vapor deposition, hydrothermal, solvothermal, sol-gel, solid state, molten salt flux, ion exchange, microwave, chemical precipitation, co-precipitation, ball milling, pyrolysis, or combinations thereof. In a further aspect, the coating material is deposited by a method such as sol-gel, chemical precipitation, or combinations thereof. In a further aspect, the coating materials is deposited in a reactor that is optionally a batch tank reactor, a continuous tank reactor, a batch furnace, a continuous furnace, a tube furnace, a rotary tube furnace, or combinations thereof.

In some embodiments, a coating material is deposited with physical characteristics selected from the following list: crystalline, amorphous, full coverage, partial coverage, uniform, non-uniform, or combinations thereof.

In some embodiments, multiple coatings are optionally deposited on the ion exchange material in an arrangement selected from the following list: concentric, patchwork, or combinations thereof.

In some embodiments, the matrix is selected from the following list: a polymer, an oxide, a phosphate, or combinations thereof. In some embodiments, a structural support is selected from the following list: polyvinyl fluoride, polyvinylidene fluoride, polyvinyl chloride, polyvinylidene chloride, polyethylene, polypropylene, polyphenylene sulfide, polytetrafluoroethylene, polytetrofluoroethylene, sulfonated polytetrofluoroethylene, polystyrene, polydivinylbenzene, polybutadiene, sulfonated polymer, carboxylated polymer, Nafion, copolymers thereof, and combinations thereof. In some embodiments, a structural support is selected from the following list: polyvinylidene difluoride, polyvinyl chloride, sulfonated polytetrofluoroethylene, polystyrene, polydivinylbenzene, copolymers thereof, or combinations thereof. In some embodiments, a structural support is selected from the following list: titanium dioxide, zirconium dioxide, silicon dioxide, solid solutions thereof, or combinations thereof. In some embodiments, the matrix material is selected for thermal resistance, acid resistance, and/or other chemical resistance.

In some embodiments, the porous bead is formed by mixing the ion exchange particles, the matrix material, and the filler material together at once. In some embodiments, the porous bead is formed by first mixing the ion exchange particles and the matrix material, and then mixing with the filler material. In some embodiments, the porous bead is formed by first mixing the ion exchange particles and the filler material, and then mixing with the matrix material. In some embodiments, the porous bead is formed by first mixing the matrix material and the filler material, and then mixing with the ion exchange particles.

In some embodiments, the porous bead is formed by mixing the ion exchange particles, the matrix material, and/or the filler material with a solvent that dissolves once or more of the components. In some embodiments, the porous bead is formed by mixing the ion exchange particles, the matrix material, and/or the filler material as dry powders in a mixer or ball mill. In some embodiments, the porous bead is formed by mixing the ion exchange particles, the matrix material, and/or the filler material in a spray drier.

In some embodiments, the matrix material is a polymer that is dissolved and mixed with the ion exchange particles and/or filler material using a solvent from the following list: n-methyl-2-pyrrolidone, dimethyl sulfoxide, tetrahydrofuran, dimethylformamide, dimethylacetamide, methyl ethyl ketone, or combinations thereof. In some embodiments, the filler material is a salt that is dissolved and mixed with the ion exchange particles and/or matrix material using a solvent from the following list: water, ethanol, iso-propyl alcohol, acetone, or combinations thereof.

In some embodiments, the filler material is a salt that is dissolved out of the bead to form pores using a solution selected from the following list: water, ethanol, iso-propyl alcohol, a surfactant mixture, an acid a base, or combinations thereof. In some embodiments, the filler material is a material that thermally decomposes to form a gas at high temperature so that the gas can leave the bead to form pores, where the gas is selected from the following list: water vapor, oxygen, nitrogen, chlorine, carbon dioxide, nitrogen oxides, organic vapors, or combinations thereof.

In some embodiments, the porous ion exchange bead is formed from dry powder using a mechanical press, a pellet press, a tablet press, a pill press, a rotary press, or combinations thereof. In some embodiments, the porous ion exchange bead is formed from a solvent slurry by dripping the slurry into a different liquid solution. The solvent slurry is optionally formed using a solvent of n-methyl-2-pyrrolidone, dimethyl sulfoxide, tetrahydrofuran, dimethylformamide, dimethylacetamide, methyl ethyl ketone, or combinations thereof. The different liquid solution is optionally formed using water, ethanol, iso-propyl alcohol, acetone, or combinations thereof.

In some embodiments, the porous ion exchange bead is approximately spherical with an average diameter selected from the following list: less than 10 μm, less than 100 μm, less than 1 mm, less than 1 cm, or less than 10 cm. In some embodiments, the porous ion exchange bead is approximately spherical with an average diameter selected from the following list: less than 200 μm, less than 2 mm, or less than 20 mm. In certain embodiments, the porous ion exchange bead is approximately spherical with an average diameter between 10 μm and 2 mm.

In some embodiments, the porous ion exchange bead is tablet-shaped with a diameter of less than 1 mm, less than 2 mm, less than 4 mm, less than 8 mm, or less than 20 mm and with a height of less than 1 mm, less than 2 mm, less than 4 mm, less than 8 mm, or less than 20 mm. In certain embodiments, the porous ion exchange bead is tablet-shaped with a diameter between 500 μm and 10 mm.

In some embodiments, the porous ion exchange bead is embedded in a support structure, which is optionally a membrane, a spiral-wound membrane, a hollow fiber membrane, or a mesh. In some embodiments, the porous ion exchange bead is embedded on a support structure comprised of a polymer, a ceramic, or combinations thereof. In some embodiments, the porous ion exchange bead is loaded directly into an ion exchange column with no additional support structure.

In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof. In some embodiments, the liquid resource is optionally pre-treated prior to entering the ion exchange reactor to remove suspended solids, hydrocarbons, or organic molecules. In some embodiments, the liquid resource is optionally enter the ion exchange reactor without any pre-treatment following from its source.

In some embodiments, the liquid resource is selected with a lithium concentration selected from the following list: less than 100,000 ppm, less than 10,000 ppm, less than 1,000 ppm, less than 100 ppm, less than 10 ppm, or combinations thereof. In some embodiments, a liquid resource is selected with a lithium concentration selected from the following list: less than 5,000 ppm, less than 500 ppm, less than 50 ppm, or combinations thereof.

System for Extracting Lithium from a Liquid Resource

In one aspect described herein, is a system for lithium extraction from a liquid resource comprising one or more vessels independently configured to simultaneously accommodate porous ion exchange beads moving in one direction and alternately acid, brine, and optionally other solutions moving in the net opposite direction. This lithium extraction system produces an eluate which is concentrated in lithium and optionally contains other ions.

In one aspect described herein, there is a device for lithium extraction from a liquid resource comprising a stirred rank reactor, an ion exchange material, and a pH modulating setup for increasing the pH of the liquid resource in the stirred tank reactor.

In one aspect described herein, is a device for lithium extraction from a liquid resource comprising a stirred rank reactor, an ion exchange material, a pH modulating setup for increasing the pH of the liquid resource in the stirred tank reactor, and a compartment for containing the ion exchange material in the stirred tank reactor while allowing for removal of liquid resource, washing fluid, and acid solutions from the stirred tank reactor.

In one embodiment, at least one of the one or more vessels are fitted with a conveyer system suitably outfitted to move porous ion exchange beads upward and simultaneously allow a net flow of acid, brine, and optionally other solutions, downward. In one embodiment, the conveyor system comprises fins with holes. In one embodiment, wherein the fins slide upward over a sliding surface that is fixed in place. In one embodiment, the fins slide upward over a sliding surface that is fixed in place. In one embodiment, all of the one or more vessels are fitted with a conveyor system suitably outfitted to move porous ion exchange beads upward and simultaneously allow a net flow of acid, brine, and optionally other solutions, downward. In one embodiment, there are an even number of vessels. In one embodiment, there are an odd number of vessels. In one embodiment, the vessels are columns.

In some embodiments, structures with holes are used to move the ion exchange material through one or more vessels. In some embodiments, the holes in the structures may be (e.g., are) less than 10 microns, less than 100 microns, less than 1,000 microns, or less than 10,000 microns. In some embodiments, the structures may be (e.g., are) attached to a conveyer system. In some embodiments, the structures may comprise (e.g., comprises) a porous compartment, porous partition, or other porous structure. In some embodiments, the structures may contain a bed of fixed or fluidized ion exchange material. In some embodiments, the structures may contain ion exchange material while allowing brine, aqueous solution, or acid solution to pass through the structures.

In one embodiment, the porous ion exchange beads comprise ion exchange particles that reversibly exchange lithium and hydrogen and a structural matrix material and having a pore network. In one embodiment, the liquid resource comprises a natural brine, a dissolve salt flat, a concentrated brine, a processed brine, a filtered brine, a liquid from an ion exchange process, a liquid from a solvent extraction process, a synthetic brine, leachate from ores, leachate from minerals, leachate from clays, leachate from recycled products, leachate from recycled materials, or combinations thereof.

### Recirculating Batch System

In an embodiment of the system, the ion exchange material is loaded in a column. In an embodiment of the system, the pH modulating setup is connected to the column loaded with the ion exchange material. In an embodiment of the system, the pH modulating setup comprises one or more tanks.

In some embodiments of the systems described herein, the ion exchange material is loaded in a vessel. In some embodiments, the pH modulating setup is in fluid communication with the vessel loaded with the ion exchange material. In some embodiments, the pH modulating setup is in fluid communication with the column loaded with the ion exchange material.

In one embodiment of the system, one or more ion exchange columns are loaded with a fixed or fluidized bed of ion exchange beads. In one embodiment of the system, the ion exchange column is a cylindrical construct with entry and exit ports. In a further embodiment, the ion exchange column is optionally a non-cylindrical construct with entry and exit ports. In a further embodiment, the ion exchange column optionally has entry and exit ports for brine pumping, and additional doors or hatches for loading and unloading ion exchange beads to and from the column. In a further embodiment, the ion exchange column is optionally equipped with one or more security devices to decrease the risk of theft of the ion exchange beads. In one embodiment, these beads contain ion exchange material that can reversibly absorb lithium from brine and release lithium in acid. In one embodiment, the ion exchange material is comprised of particles that are optionally protected with coating material such as SiO₂, ZrO₂, or TiO₂ to limit dissolution or degradation of the ion exchange material. In one embodiment, these beads contain a structural component such as an acid-resistant polymer that binds the ion exchange materials. In one embodiment, the beads contain pores that facilitate penetration of brine, acid, aqueous, and other solutions into the beads to deliver lithium and hydrogen to and from the bead or to wash the bead. In one embodiment, the bead pores are structured to form a connected network of pores with a distribution of pore sizes and are structured by incorporating filler materials during bead formation and later removing that filler material in a liquid or gas.

In one embodiment of the system, the system is a recirculating batch system, which comprises an ion exchange column that is connected to one or more tanks for mixing base into the brine, settling out any precipitates following base addition, and storing the brine prior to reinjection into the ion exchange column or the other tanks. In one embodiment of the recirculating batch system, the brine is loaded into one or more tanks, pumped through the ion exchange column, pumped through a series of tanks, and then returned to the ion exchange column in a loop. In one embodiment, the brine optionally traverses this loop repeatedly. In one embodiment, the brine is recirculated through the ion exchange column to enable optimal lithium uptake by the beads. In one embodiment, base is added to the brine in such a way that pH is maintained at an adequate level for lithium uptake and in such a way that the amount of base-related precipitates in the ion exchange column is minimized.

In one embodiment, as the brine is pumped through the recirculating batch system, the brine pH drops in the ion exchange column due to hydrogen release from the ion exchange beads during lithium uptake, and the brine pH is adjusted upward by the addition of base as a solid, aqueous solution, or other form. In one embodiment, the ion exchange system drives the ion exchange reaction to near completion, and the pH of the brine leaving the ion exchange column approaches the pH of the brine entering the ion exchange column. In one embodiment, the amount of base added is optionally controlled to neutralize the hydrogen released by the ion exchange beads in such a way that no basic precipitates form. In one embodiment, an excess of base or a transient excess of base is optionally added in such a way that basic precipitates form.

In one embodiment, the basic precipitates form transiently and then are redissolved partially or fully by the hydrogen that is released from the ion exchange column. In one embodiment of the system, base is optionally added to the brine flow prior to the ion exchange column, after the ion exchange column, prior to one or more tanks, or after one or more tanks.

In one embodiment of the recirculating batch system, the tanks include a mixing tank where the base is mixed with the brine. In one embodiment, the tanks include a settling tank, where precipitates such as Mg(OH)₂ optionally settle to the bottom of the settling tank to avoid injection of the precipitates into the ion exchange column. In one embodiment, the tanks include a storage tank where the brine is stored prior to reinjection into the ion exchange column, mixing tank, settling tank, or other tanks. In one embodiment, the tanks include an acid recirculation tank. In one embodiment, some tanks in the recirculating batch reactor optionally serve a combination of purposes including base mixing tank, settling tank, acid recirculation tank, or storage tank. In any embodiment, a tank optionally does not fulfil two functions at the same time. For example, a tank is not a base mixing tank and a settling tank.

In one embodiment of the recirculating batch system, base is added to a mixing tank, which is optionally a continuous stirred tank system, a confluence of acidified brine flow and base flow followed by a static mixer, a confluence of acidified brine flow and base flow followed by a paddle mixer, a confluence of acidified brine flow and base flow followed by a turbine impeller mixer, or a continuous stirred tank system in the shape of a vertical column which is well mixed at the bottom and settled near the top. In one embodiment, the base is optionally added as a solid or as an aqueous solution. In one embodiment, the base is optionally added continuously at a constant or variable rate. In one embodiment, the base is optionally added discretely in constant or variable aliquots or batches. In one embodiment, the base is optionally added according to one or more pH meters, which optionally samples brine downstream of the ion exchange column or elsewhere in the recirculating batch system. In one embodiment, filters are optionally used to prevent precipitates from leaving the mixing tank. In one embodiment, the filters are optionally plastic mesh screens, small packed columns containing granular media such as sand, silica, or alumina, small packed columns containing porous media filter, or a membrane.

In one embodiment of the recirculating batch system, the settling tank is optionally a settling tank with influent at bottom and effluent at top or a settling tank with influent on one end and effluent on another end. In one embodiment, chambered weirs are used to fully settle precipitates before brine is recirculated into reactor. In one embodiment, solid base precipitates are collected at the bottom of the settling tank and recirculated into the mixer. In one embodiment, precipitates such as Mg(OH)₂ optionally settle near the bottom of the tank. In one embodiment, brine is removed from the top of the settling tank, where the amount of suspended precipitates is minimal. In one embodiment, the precipitates optionally settle under forces such as gravity, centrifugal action, or other forces. In one embodiment, filters are optionally used to prevent precipitates from leaving the settling tank. In one embodiment, the filters are optionally plastic mesh screens, small packed columns containing granular media such as sand, silica, or alumina, small packed columns containing porous media filter, or a membrane. In one embodiment, baffles are optionally used to ensure settling of the precipitate and to prevent the precipitate from exiting the settling tank and entering the column.

In one embodiment of the recirculating batch system, basic precipitates are optionally collected from the settling tank and reinjected into the brine in a mixing tank or elsewhere to adjust the pH of the brine.

In one embodiment of the recirculating batch system, one or more ion exchange columns are optionally connected to one or more tanks or set of tanks. In one embodiment of the recirculating batch system, there are optionally multiple ion exchange columns recirculating brine through a shared set of mixing, settling, and storage tanks. In one embodiment of the recirculating batch system, there is optionally one ion exchange column recirculating brine through multiple sets of mixing, settling, and storage tanks.

### Column Interchange System

An aspect of the invention described herein is a system wherein the ion exchange material is loaded in a plurality of columns. In an embodiment, the pH modulating setup comprises a plurality of tanks connected to the plurality of columns, wherein each of the plurality of tanks is immediately connected to one of the plurality of columns. In an embodiment, two or more of the plurality of tanks connected to the plurality of columns forms at least one circuit. In an embodiment, three or more of the plurality of tanks connected to the plurality of columns forms at least two circuits. In an embodiment, three or more of the plurality of tanks connected to the plurality of columns forms at least three circuits. In an embodiment, at least one circuit is a liquid resource circuit. In an embodiment, at least one circuit is a water washing circuit. In an embodiment, at least one circuit is an acid solution circuit. In an embodiment, at least two circuits are water washing circuits.

In one embodiment of the ion exchange system, the system is a column interchange system where a series of ion exchange columns are connected to form a brine circuit, an acid circuit, a water washing circuit, and optionally other circuits. In one embodiment of the brine circuit, brine flows through a first column in the brine circuit, then into a next column in the brine circuit, and so on, such that lithium is removed from the brine as the brine flows through one or more columns. In one embodiment of the brine circuit, base is added to the brine before or after each ion exchange column or certain ion exchange columns in the brine circuit to maintain the pH of the brine in a suitable range for lithium uptake by the ion exchange beads. In one embodiment of the acid circuit, acid flows through a first column in the acid circuit, then into the next column in the acid circuit, and so on, such that lithium is eluted from the columns with acid to produce a lithium concentrate. In one embodiment of the acid circuit, acid flows through a first column in the acid circuit, then optionally into a next column in the acid circuit, and so on, such that lithium is eluted from the columns with acid to produce a lithium concentrate. In one embodiment of the water washing circuit, water flows through a first column in the water washing circuit, then optionally into a next column in the water washing circuit, and so on, such that brine in the void space, pore space, or head space of the columns in the water washing circuit is washed out.

In one embodiment of the column interchange system, ion exchange columns are interchanged between the brine circuit, the water washing circuit, and the acid circuit. In one embodiment, the first column in the brine circuit is loaded with lithium and then interchanged into the water washing circuit to remove brine from the void space, pore space, or head space of the column. In one embodiment, the first column in the water washing circuit is washed to remove brine, and then interchanged to the acid circuit, where lithium is eluted with acid to form a lithium concentrate. In one embodiment, the first column in the acid circuit is eluted with acid and then interchanged into the brine circuit to absorb lithium from the brine. In one embodiment of the column interchange system, two water washing circuits are used to wash the columns after both the brine circuit and the acid circuit. In one embodiment of the column interchange system, only one water washing circuit is used to wash the columns after the brine circuit, whereas excess acid is neutralized with base or washed out of the columns in the brine circuit.

In one embodiment of the column interchange system, the first column in the brine circuit is interchanged to become the last column in the water washing circuit. In one embodiment of the column interchange system, the first column in the water washing circuit is interchanged to become the last column in the acid circuit. In one embodiment of the column interchange system, the first column in the acid circuit is interchanged to become the last column in the brine circuit.

In one embodiment of the column interchange system, each column in the brine circuit contains one or more tanks or junctions for mixing base into the brine and optionally settling any basic precipitates that form following base addition. In one embodiment of the column interchange system, each column in the brine circuit has associated one or more tanks or junctions for removing basic precipitates or other particles via settling or filtration. In one embodiment of the column interchange system, each column or various clusters of columns have associated one or more settling tanks or filters that remove particles including particles that detach from ion exchange beads.

In one embodiment of the column interchange system, the number of the columns in the brine circuit is optionally less than about 3, less than about 10, less than about 30, or less than about 100. In one embodiment of the column interchange system, the number of the columns in the acid circuit is optionally less than about 3, less than about 10, less than about 30, or less than about 100. In one embodiment of the column interchange system, the number of the columns in the water washing circuit is optionally less than about 3, less than about 10, less than about 30, or less than about 100. In certain embodiments, the number of columns in the brine circuit is 1 to 10. In some embodiments, the number of columns in the acid circuit is 1 to 10. In some embodiments, the number of columns in washing circuit is 1 to 10.

In one embodiment of the column interchange system, there is optionally one or more brine circuits, one or more acid circuits, and one or more water washing circuits. In one embodiment of the column interchange system, ion exchange columns are optionally supplied with fresh ion exchange beads without interruption to operating columns. In one embodiment of the column interchange system, ion exchange columns with beads that have been depleted in capacity is optionally replaced with ion exchange columns with fresh ion exchange beads without interruption to operating columns.

In one embodiment of the column interchange system, the columns contain fluidized beds of ion exchange material. In one embodiment of the column interchange system, the columns have means of created a fluidized bed of ion exchange material such as overhead stirrers or pumps. In one embodiment of the column interchange system, the columns contain fluidized beds of ion exchange material. In one embodiment of the ion exchange system, the system is an interchange system and the vessels are stirred tank reactors. In one embodiment of the interchange system, base may be (e.g., is) added directly to the columns or other tanks containing the ion exchange material. In one embodiment of the interchange system, base may be (e.g., is) added to the brine or another solution in a separate mixing tank and then added to the columns or other tanks containing the ion exchange material.

In one embodiment of the ion exchange system, ion exchange beads are loaded into ion exchange columns and following lithium uptake from brine, lithium is eluted from the ion exchange columns using an acid recirculation loop. In one embodiment of the acid recirculation loop, acid is flowed through an ion exchange column, into a tank, and then recirculated through the ion exchange column to optimize lithium elution. In one embodiment of the ion exchange system, ion exchange beads are loaded into ion exchange columns and following lithium uptake from brine, lithium is eluted from each ion exchange column using a once-through flow of acid. In one embodiment of the ion exchange system, ion exchange beads are loaded into an ion exchange column and following lithium uptake from brine, lithium is eluted from the ion exchange column using a column interchange circuit.

In one embodiment of the ion exchange system, ion exchange columns are loaded with lithium by flowing brine through the columns using a recirculating batch system and then lithium is eluted from the columns using a column interchange system. In one embodiment of the ion exchange system, ion exchange columns are loaded with lithium by flowing brine through the columns using a column interchange system and then lithium is eluted from the columns using a recirculating batch system. In one embodiment of the ion exchange system, ion exchange columns are loaded with lithium by flowing brine through the columns using a recirculating batch system and then lithium is eluted from the columns using a recirculating batch system. In one embodiment of the ion exchange system, ion exchange columns are loaded with lithium by flowing brine through the columns using a column interchange system and then lithium is eluted from the columns using a column interchange system.

### Stirred Tank System

An aspect of the invention described herein is a system wherein the pH modulating setup is a tank comprising: a) one or more compartments; and b) a means for moving the liquid resource through the one or more compartments. In an embodiment, the ion exchange material is loaded in at least one compartment. In an embodiment, the means for moving the liquid resource through the one or more compartments is a pipe. In a further embodiment, the means for moving the liquid resource through the one or more compartments is a pipe and suitably a configured pump. In an embodiment, the tank further comprises a means for circulating the liquid resource throughout the tank. In an embodiment, the means for circulating the liquid resource throughout the tank is a mixing device. In an embodiment, the tank further comprises an injection port.

In some embodiments, the tank further comprises one or more injection ports. In some embodiments, the tank further comprises a plurality of injection ports.

An aspect described herein is a system for the extraction of lithium ions from a liquid resource, comprising a tank, wherein the tank further comprises: a) one or more compartments; b) an ion exchange material; c) a mixing device; and d) a pH modulating setup for changing the pH of the system, wherein the ion exchange material is used to extract lithium ions from the liquid resource. In one embodiment, the pH modulating setup changes the pH of the liquid resource in the system.

In some embodiments, the ion exchange material is loaded in at least one of the one or more compartments. In some embodiments, the ion exchange material is fluidized in at least one of the one or more compartments. In some embodiments, the ion exchange material is non-fluidized in at least one of the one or more compartments. In some embodiments, the ion exchange material occupies a fixed position in at least one of the one or more compartments.

In some embodiments, the pH modulating setup comprises a pH measuring device and an inlet for adding base. In some embodiments, the pH measuring device is a pH probe. In some embodiments, the inlet is a pipe. In some embodiments, the inlet is an injection port.

In some embodiments, the tank further comprises a porous partition. In some embodiments, the porous partition is a porous polymer partition. In some embodiments, the porous partition is a mesh or membrane. In some embodiments, the porous partition is a polymer mesh or polymer membrane. In some embodiments, the porous partition comprises one or more layers of mesh, membrane, or other porous structure. In some embodiments, the porous partition comprises one or more coarse meshes that provide structural support and one or more fine meshes and/or membranes that provide filtration. In some embodiments, the porous partition comprises a polyether ether ketone mesh, a polypropylene mesh, a polyethylene mesh, a polysulfone mesh, a polyester mesh, a polyamide mesh, a polytetrafluoroethylene mesh, an ethylene tetrafluoroethylene polymer mesh, a stainless steel mesh, a stainless steel mesh coated in polymer, a stainless steel mesh coated in ceramic, or a combination thereof, wherein the mesh is a course mesh, a fine mesh, or a combination thereof. In some embodiments, the porous polymer partition comprises a mesh comprising one or more blends of two or more of a polyether ether ketone, a polypropylene, a polyethylene, a polysulfone, a polyester, a polyamide, a polytetrafluoroethylene, or an ethylene tetrafluoroethylene polymer. In some embodiments, the porous partition comprises a polyether ether ketone membrane, a polypropylene membrane, a polyethylene membrane, a polysulfone membrane, a polyester membrane, a polyamide membrane, a polytetrafluoroethylene membrane, an ethylene tetrafluoroethylene polymer membrane, or combinations thereof.

In one embodiment of the ion exchange system, the system is a stirred tank system comprised of a tank of brine containing permeable bead compartments such as permeable pallets, cases, boxes, or other containers that are loaded with ion exchange beads, and the brine is stirred through the tank in a batch process. In one embodiment of the stirred tank system, the base is optionally added directly to the tank gradually or all at once as a solid or in an aqueous solution. In one embodiment of the stirred tank system, after a brine uptake stage is complete, the permeable bead containers are optionally moved to another tank for acid elution. In one embodiment of the stirred tank system, the permeable bead compartments are located at the bottom of the stirred tank during the brine stage and after the brine stage is completed, then brine is removed, and the bottom of the stirred tank is filled with acid to elute lithium in such a way that the permeable bead compartments are covered with an optimal volume of acid.

In one embodiment of the stirred tank system, the ion exchange beads are suspended using plastic structural supports in a tank with an internal mixing device. In one embodiment of the stirred tank system, a stream of brine is removed from the tank and passed through a column where hydrogen ions in the brine produced by ion exchange are neutralized using sacrificial base in solution or added as solid, or by an ion exchange resin. This pH-corrected stream is sent back into the system where the lithium can continue to be removed. In one embodiment of the stirred tank system, brine that has passed through the bead compartment is returned to the opposite end of the tank through a pipe that is optionally internal or external to the tank. In one embodiment of the stirred tank system, base is optionally added to the brine inside the tank or in a base addition tank outside the tank.

In one embodiment of the stirred tank system, fresh brine is fed to the system so as to operate in continuous stirred tank system mode instead of batch mode. In one embodiment of the recirculating batch system, fresh brine is fed to the system so as to operate in continuous stirred tank system mode instead of batch mode.

In one embodiment of the ion exchange system, the ion exchange material is mixed with a liquid resource in a stirred tank reactor. In one embodiment, the ion exchange material may be (e.g., is) comprised of coated particles, uncoated particles, porous beads, or combinations thereof.

In one embodiment of the ion exchange system, a stirred tank reactor is used to fluidize the ion exchange material in a liquid resource to enable absorption of lithium from the liquid resource into the ion exchange material. In one embodiment, a stirred tank reactor is used to fluidize the ion exchange material in a washing fluid to remove residual brine, acid, or other contaminants from the ion exchange materials. In one embodiment, a stirred tank reactor is used to fluidize the ion exchange material in an acid solution to elute lithium from the ion exchange material while replacing the lithium in the ion exchange material with protons. In one embodiment, a single stirred tank reactor is used to mix ion exchange material with a liquid resource, washing fluid, and acid solution.

In some embodiments, the system for the extraction of lithium ions from a liquid resource, comprising a tank, wherein the tank further comprises: a) one or more compartments; b) an ion exchange material; c) a mixing device; and d) a pH modulating setup for changing the pH of the liquid resource in the system, wherein the ion exchange material is used to extract lithium ions from the liquid resource, further comprises another tank, wherein the other tank further comprises: a) one or more compartments; b) an ion exchange material; c) a mixing device; and d) a pH modulating setup for changing the pH of the liquid resource in the system. In some embodiments, the tank is in fluid communication with the other tank.

In some embodiments, the system for the extraction of lithium ions from a liquid resource, comprising a tank, wherein the system further comprises another tank, wherein the other tank further comprises: a) one or more compartments; b) an ion exchange material; c) a mixing device; and d) an acid inlet for adding acid to the system. In a further embodiment, the ion exchange material is moved between the tank and the other tank.

In some embodiments, the system for the extraction of lithium ions from a liquid resource, comprising a tank, wherein the tank further comprises: a) one or more compartments; b) an ion exchange material; c) a mixing device; and d) a pH modulating setup for changing the pH of the liquid resource in the system, wherein the ion exchange material is used to extract lithium ions from the liquid resource, further comprises a plurality of tanks, each tank further comprising: a) one or more compartments; b) an ion exchange material; c) a mixing device; and d) a pH modulating setup for changing the pH of the liquid resource in the system. In some embodiments, each tank of the system is in fluid communication with each other tank of the system.

In some embodiments, the system further comprises another plurality of tanks, wherein each tank further comprises: a) one or more compartments; b) an ion exchange material; and c) a mixing device.

In some embodiments, the system is configured to operate in a batch mode. In some embodiments, the system is configured to operate in a continuous mode. In some embodiments, the system is configured to operate in a batch mode and a continuous mode. In some embodiments, one or more tanks in the system are configured to operate in a batch mode and one or more tanks in the system are configured to operate in a continuous mode. In some embodiments, one or more tanks in the system are configured to operate in a batch mode and one or more tanks in the system are configured to operate in a semi-continuous mode. In some embodiments, one or more tanks in the system are configured to operate in a semi-continuous mode and one or more tanks in the system are configured to operate in a continuous mode. In some embodiments, one or more tanks in the system are configured to operate in a batch mode, one or more tanks in the system are configured to operate in a semi-continuous mode, and one or more tanks in the system are configured to operate in a continuous mode. In some embodiments, the system is configured to operate in a semi-continuous mode, a batch mode, a continuous mode, or combinations thereof.

In one embodiment of the ion exchange system, a plurality of stirred tank reactors are used to mix ion exchange material with a liquid resource, washing fluid, and acid solution. In one embodiment, the stirred tank reactors may be (e.g., are) different sizes and may contain different volumes of a liquid resource, washing fluid, and acid solution. In one embodiment, the stirred tanks may be (e.g., are) cylindrical, conical, rectangular, pyramidal, or a combination thereof. In one embodiment of the ion exchange system, the ion exchange material may move through the plurality of stirred tank reactors in the opposite direction of the liquid resource, the washing fluid, or the acid solution.

In one embodiment of the ion exchange system, a plurality of stirred tank reactors may be (e.g., are) used where one or more stirred tank reactors mix the ion exchange material with a liquid resource, one or more stirred tank reactors mix the ion exchange material with a washing fluid, and one or more stirred tank reactors mix the ion exchange material with an acid solution.

In one embodiment of the ion exchange system, stirred tank reactors may be (e.g., are) operated in a continuous, semi-continuous, or batch mode where a liquid resource flows continuously, semi-continuously, or batch-wise through the stirred tank reactor. In one embodiment of the ion exchange system, stirred tank reactors (e.g., are) may be operated in a continuous, semi-continuous, or batch mode where the ion exchange material flows continuously, semi-continuously, or batch-wise through the stirred tank reactor. In one embodiment of the ion exchange system, stirred tank reactors may be (e.g., are) operated in a mode where the ion exchange material remains in the tank while flows of liquid resource, washing fluid, or acid solution are flowed through the tank in continuous, semi-continuous, or batch flows.

In one embodiment, ion exchange material may be (e.g., is) loaded into or removed from the stirred tank reactors through the top, the bottom, or the side of the tank.

In one embodiment of the ion exchange system, stirred tank reactors may comprise (e.g., comprises) one or more compartments. In one embodiment, the compartments may contain (e.g., contain) ion exchange material in a bed that is fluidized, fixed, partially fluidized, partially fixed, alternatively fluidized, alternatively fixed, or combinations thereof. In one embodiment, the compartments may be (e.g., are) comprised of a porous support at the bottom of the compartment, the sizes of the compartment, the top of the compartment, or combinations thereof. In one embodiment, the compartments may be (e.g., are) conical, cylindrical, rectangular, pyramidal, other shapes, or combinations thereof. In one embodiment, the compartment may be located at the bottom of the tank. In one embodiment, the shape of the compartment may conform (e.g., conforms) to the shape of the stirred tank reactor. In one embodiment, the compartment may be (e.g., is) partially or fully comprised of the tank of the stirred tank reactor.

In one embodiment, the compartment may be (e.g., is) comprised of a porous structure. In one embodiment, the compartment may be (e.g., is) comprised of a polymer, a ceramic, a metal, or combinations thereof. In one embodiment, the compartment may be (e.g., is) comprised be comprised partially or fully of a porous material or a mesh. In one embodiment, the compartment may be at the top of the tank. In one embodiment, the compartment may be (e.g., is) separated from the rest of the tank with one or more porous materials. In one embodiment, the compartment may be (e.g., is) at the top of the tank. In one embodiment, the compartment may be (e.g., is) separated from the rest of the tank with a bilayer mesh comprising one layer of coarse mesh for strength and one layer of fine mesh to contain smaller particles in the compartment. In one embodiment, the compartment may allow (e.g., allows) liquid to flow freely through the stirred tank reactor and through the compartment. In one embodiment, the compartment may be (e.g., is) open on the top. In one embodiment, the compartment may contain (e.g., contains) the ion exchange material in the tank but allow the ion exchange material to move throughout the tank. In one embodiment, the compartment may comprise (e.g., comprises) a majority or minority of the tank volume. In one embodiment, the compartment may represent a fraction of the volume of the tank that is greater than 1 percent, greater than 10 percent, greater than 50 percent, greater than 90 percent, greater than 99 percent, or greater than 99.9 percent. In one embodiment, one or more devices for stirring, mixing, or pumping may be (e.g., is) used to move fluid through the compartment, the stirred tank reactor, or combinations thereof.

In one embodiment of the ion exchange system, stirred tank reactors may be (e.g., are) arranged into a network where flows of brine, washing fluid, and acid solutions are directly through different columns. In one embodiment, a network of stirred tank reactors may involve physical movement of the ion exchange material through the various stirred tank reactors. In one embodiment, a network of stirred tank reactors may involve no physical movement of the ion exchange material through the various stirred tank reactors. In one embodiment, a network of stirred tank reactors may involve switching of flows of brine, washing fluid, and acid solutions through the various stirred tank reactors. In one embodiment, brine may into stirred tank reactors in continuous or batch mode. In one embodiment, brine may be (e.g., is) mixed with ion exchange material in one or more reactors before exiting the system. In one embodiment, a network of stirred tank reactors may involve a brine circuit with counter-current exposure of ion exchange material to flows of brine. In one embodiment, a network of stirred tank reactors may involve a washing circuit with counter-current exposure of ion exchange material to flows of washing fluid. In one embodiment, a network of stirred tank reactors may involve an acid circuit with counter-current exposure of ion exchange material to flows of acid solution. In one embodiment, the washing fluid may be (e.g., is) water, an aqueous solution, or a solution containing an anti-scalant.

In one embodiment of the stirred tank reactor, acid is added at the beginning of elution. In one embodiment of the stirred tank reactor, acid is added at the beginning of elution and again during elution. In one embodiment of the stirred tank reactor, an acid of lower concentration is added at the start of elution and additional acid of high concentration is added to continue elution.

An aspect described herein is a system for the extraction of lithium ions from a liquid resource, comprising: a) an ion exchange material; b) a tank comprising one or more compartments; and c) a mixing device, wherein the ion exchange material is used to extract lithium ions from the liquid resource.

In some embodiments, the ion exchange material is loaded in at least one of the one or more compartments. In some embodiments, the ion exchange material is fluidized or partially fluidized in at least one of the one or more compartments. In some embodiments, the ion exchange material occupies a fixed position in at least one of the one or more compartments. In some embodiments, the ion exchange material is mounted in at least one of the one or more compartments.

An aspect described herein is a system for the extraction of lithium ions from a liquid resource, comprising: a) a column comprising an ion exchange material; and b) a pH modulating setup for changing the pH of the liquid resource in the system, wherein the pH modulating setup is in fluid communication with the column, wherein the ion exchange material is used to extract lithium ions from the liquid resource.

### Other Types of Systems

An aspect described herein is a system for the extraction of lithium ions from a liquid resource, comprising: a) a plurality of columns, wherein each of the plurality of columns comprises an ion exchange material; and b) a pH modulating setup for changing the pH of the liquid resource in the system, wherein the pH modulating setup is in fluid communication with each of the plurality of columns, wherein the ion exchange material is used to extract lithium ions from the liquid resource.

In some embodiments, the pH modulating setup comprises a plurality of tanks, wherein each of the plurality of tanks is immediately connected to one of the plurality of columns. In one embodiment, the pH modulating setup comprises a plurality of tanks, wherein each of the plurality of tanks is in immediate liquid communication with one of the plurality of columns. In some embodiments, two or more of the plurality of tanks connected to two or more of the plurality of columns forms at least one circuit. In some embodiments, two or more of the plurality of tanks connected to two or more of the plurality of columns forms at least two circuits. In some embodiments, three or more of the plurality of tanks connected to three or more of the plurality of columns forms at least two circuits. In some embodiments, three or more of the plurality of tanks connected to three or more of the plurality of columns forms at least three circuits.

In some embodiments, the pH modulating setup comprises a plurality of tanks, wherein each of the plurality of tanks is connected to the of the plurality of columns through a filtration system. In some embodiments, two or more of the plurality of tanks are connected to two or more of the plurality of columns through a filter system to form at least one circuit. In some embodiments, two or more of the plurality of tanks are connected to two or more of the plurality of columns through a filter system to form at least two circuits. In some embodiments, three or more of the plurality of tanks are connected to two or more of the plurality of columns through a filter system to form at least two circuits. In some embodiments, three or more of the plurality of tanks are connected to two or more of the plurality of columns through a filter system to form at least three circuits.

In some embodiments, the filtration system comprises a bag filter, a candle filter, a cartridge filter, a media filter, a depth filter, a sand filter, a membrane filter, an ultrafiltration system, a microfiltration filter, a nanofiltration filter, a cross-flow filter, a dead-end filter, a drum filter, a filter press, or a combination thereof. In some embodiments, the openings in this filter are of less than about 0.02 μm, less than about 0.1 μm, less than about 0.2 μm, less than about 1 μm, less than about 2 μm, less than about 5 μm, less than about 10 μm, less than about 25 μm, less than about 100 μm, less than about 1000 μm. In some embodiments, the perforated openings in outer-perforated walls are of dimension of more than about 0.02 μm, more than about 0.1 μm, more than about 0.2 μm, more than about 1 μm, more than about 2 μm, more than about 5 μm, more than about 10 μm, more than about 25 μm, more than about 100 μm. In some embodiments, the perforated openings in outer-perforated walls are of dimension of about 0.02 μm to about 0.1 μm, from about 0.1 μm to about 0.2 μm, from about 0.2 μm to about 0.5 μm, from about 0.5 μm to about 1 μm, from about 1 μm to about 5 μm, from about 5 μm to about 10 μm, from about 10 μm to about 25 μm, from about 25 μm to about 100 μm. In some embodiments, the filter martial comprises low density polyethylene, high density polyethylene, polypropylene, polyester, polytetrafluoroethylene (PTFE), types of polyamide, polyether ether ketone (PEEK), polysulfone, polyvinylidene fluoride (PVDF), poly (4-vinyl pyridine-co-styrene) (PVPCS), polystyrene (PS), polybutadiene, acrylonitrile butadiene styrene (ABS), polyvinyl chloride (PVC), ethylene tetrafluoroethylene polymer (ETFE), poly(chlorotrifluoroethylene) (PCTFE), ethylene chlorotrifluoro ethylene (Halar), polyvinylfluoride (PVF), fluorinated ethylene-propylene (FEP), perfluorinated elastomer, chlorotrifluoroethylenevinylidene fluoride (FKM), perfluoropolyether (PFPE), perfluoro-3,6-dioxa-4-methyl-7-octene-sulfonic acid (NAFION® (copolymer of perfluoro-3,6-dioxa-4-methyl-7-octene-sulfonic acid and tetrafluoroethylene)), polyethylene oxide, polyethylene glycol, sodium polyacrylate, polyethylene-block-poly(ethylene glycol), polyacrylonitrile (PAN), polychloroprene (neoprene), polyvinyl butyral (PVB), expanded polystyrene (EPS), polydivinylbenzene, co-polymers thereof, mixtures thereof, or combinations thereof. In a further aspect, a coating material comprises polyvinylidene fluoride (PVDF), polyvinyl chloride (PVC), ethylene chlorotrifluoro ethylene (Halar), poly (4-vinyl pyridine-co-styrene) (PVPCS), polystyrene (PS), acrylonitrile butadiene styrene (ABS), expanded polystyrene (EPS), polyphenylene sulfide, sulfonated polymer, carboxylated polymer, other polymers, co-polymers thereof, mixtures thereof, or combinations thereof. In some embodiments, the filter martial comprises iron, stainless steel, nickel, carbon steel, titanium, Hastelloy, Inconel, zirconium, tantalum, alloys thereof, mixtures thereof, or combinations thereof.

In some embodiments, at least one circuit is a liquid resource circuit. In some embodiments, at least one circuit is a water washing circuit. In some embodiments, at least two circuits are water washing circuits. In some embodiments, at least one circuit is an acid solution circuit.

An aspect described herein is a system for the extraction of lithium ions from a liquid resource comprising an ion exchange material and a plurality of vessels, wherein each of the plurality of vessels is configured to transport the ion exchange material along the length of the vessel and the ion exchange material is used to extract lithium ions from the liquid resource. In some embodiments, at least one of the plurality of vessels comprises an acidic solution. In some embodiments, at least one of the plurality of vessels comprises the liquid resource. In some embodiments, each of the plurality of vessels is configured to transport the ion exchange material by a pipe system or an internal conveyer system.

An aspect described herein is a system for the extraction of lithium ions from a liquid resource comprising an ion exchange material and a plurality of columns, wherein each of the plurality of columns is configured to transport the ion exchange material along the length of the column and the ion exchange material is used to extract lithium ions from the liquid resource.

In some embodiments, at least one of the plurality of columns comprises an acidic solution. In some embodiments, at least one of the plurality of columns comprises the liquid resource. In some embodiments, each of the plurality of columns is configured to transport the ion exchange material by a pipe system or an internal conveyer system.

In some embodiments, the ion exchange material comprises ion exchange particles. In some embodiments, at least a portion of the ion exchange material is in the form of ion exchange particles. In some embodiments, the ion exchange particles are selected from uncoated ion exchange particles, coated ion exchange particles, and combinations thereof. In some embodiments, the ion exchange particles comprise uncoated ion exchange particles. In some embodiments, the ion exchange particles comprise coated ion exchange particles. In some embodiments, the ion exchange particles comprise a mixture of uncoated and coated ion exchange particles.

In some embodiments, the coated ion exchange particles comprise an ion exchange material and a coating material.

In some embodiments, the coating material of the coated ion exchange particles comprises a carbide, a nitride, an oxide, a phosphate, a fluoride, a polymer, carbon, a carbonaceous material, or combinations thereof. In some embodiments, the coating material of the coated ion exchange particles is selected from the group consisting of TiO₂, ZrO₂, MoO₂, SnO₂, Nb₂O₅, Ta₂O₅, SiO₂, Liz TiO₃, Li₂ZrO₃, Li₂SiO₃, Li₂MnO₃, Li₂MoO₃, LiNbO₃, LiTaO₃, AlPO₄, LaPO₄, ZrP₂O₇, MoP₂O₇, MO₂P₃O₁₂, BaSO₄, AlF₃, SiC, TiC, ZrC, Si₃N₄, ZrN, BN, carbon, graphitic carbon, amorphous carbon, hard carbon, diamond-like carbon, solid solutions thereof, and combinations thereof.

In some embodiments, the ion exchange material of the coated ion exchange particles comprises an oxide, a phosphate, an oxyfluoride, a fluorophosphate, or combinations thereof. In some embodiments, the ion exchange material of the coated ion exchange particles is selected from the group consisting of Li₄Mn₅O₁₂, Li₄Ti₅O₁₂, Li₂TiO₃, Li₂MnO₃, Li₂SnO₃, LiMn₂O₄, Li_{1.6}Mn_{1.6}O₄, LiAlO₂, LiCuO₂, LiTiO₂, Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, and combinations thereof; wherein λ is from 0.1-10; and y is from 0.1-10.

In some embodiments, the uncoated ion exchange particles comprise an ion exchange material. In some embodiments, the ion exchange material of the uncoated ion exchange particles comprises an oxide, a phosphate, an oxyfluoride, a fluorophosphate, or combinations thereof. In some embodiments, the ion exchange material of the uncoated ion exchange particles is selected from the group consisting of Li₄Mn₅O₁₂, Li₄Ti₅O₁₂, Li₂TiO₃, Li₂MnO₃, Li₂SnO₃, LiMn₂O₄, Li_{1.6}Mn_{1.6}O₄, LiAlO₂, LiCuO₂, LiTiO₂, Li₄TiO₄, Li₂Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, and combinations thereof, wherein x is from 0.1-10; and y is from 0.1-10.

In some embodiments, the ion exchange material is porous. In some embodiments, the porous ion exchange material comprises a network of pores that allows liquids to move quickly from the surface of the porous ion exchange material to a plurality of ion exchange particles. In some embodiments, the porous ion exchange material comprises a network of pores that allows a liquid to move from the surface of the porous ion exchange material to a plurality of ion exchange particles. In some embodiments, the porous ion exchange material comprises a network of pores that allows a liquid to move quickly from the surface of the porous ion exchange material to a plurality of ion exchange particles. In some embodiments, the porous ion exchange material is porous ion exchange beads. In some embodiments, the porous ion exchange material is comprised of porous ion exchange beads.

In some embodiments of the systems described herein, the liquid resource is a natural brine, a dissolved salt flat, seawater, concentrated seawater, a desalination effluent, a concentrated brine, a processed brine, waste brine from a bromine-extraction process, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof. In some embodiments of the systems described herein, the liquid resource is a brine. In some embodiments of the systems described herein, the liquid resource comprises a natural brine, a synthetic brine, or a mixture of a natural and a synthetic brine. In some embodiments of the systems described herein, the liquid resource is a natural brine, a dissolved salt flat, seawater, concentrated seawater, a desalination effluent, a concentrated brine, a processed brine, waste brine from a bromine-extraction process, an oilfield brine, a liquid from an ion exchange process, or combinations thereof.

An aspect of the invention described herein is a system, wherein the column further comprises a plurality of injection ports, wherein the plurality of injection ports are used to increase the pH of the liquid resource in the system

In one embodiment of the ion exchange system, the system is a mixed base system comprising an ion exchange column and a mixing chamber where base is mixed into the brine immediately prior to injection of the brine into the column.

In one embodiment of the ion exchange system, the system is a ported ion exchange column system with multiple ports for injection of aqueous base spaced at intervals along the direction of brine flow through the column. As brine flows through the column, there is a region of the column where the beads experience the greatest rate of lithium absorption, and this region moves through the column in the direction of brine flow. In the ported ion exchange column system, base is injected near that region to neutralize protons released by the ion exchange reaction. In regions of the columns where the beads have been saturated with lithium and the rate of release of protons has slowed, base injected is decreased or terminated to avoid formation of basic precipitates.

In one embodiment of the ion exchange system, the system has a moving bed of beads that moves in a direction opposite to the flow of brine and base is injected at one or more fixed points in the column in a region near where the ion exchange reaction occurs at a maximum rate in the column to neutralize the protons released from the ion exchange reaction. In one embodiment of the ion exchange system, the base added to the brine is optionally NaOH, KOH, Mg(OH)₂, Ca(OH)₂, CaO, NH₃, Na₂SO₄, K₂SO₄, NaHSO₄, KHSO₄, NaOCl, KOCl, NaClO₄, KClO₄, NaH₂BO₄, Na₂HBO₄, Na₃BO₄, KH₂BO₄, K₂HBO₄, K₃BO₄, MgHBO₄, CaHBO₄, NaHCO₃, KHCO₃, NaCO₃, KCO₃, MgCO₃, CaCO₃, Na₂O, K₂O, Na₂CO₃, K₂CO₃, Na₃PO₄, Na₂HPO₄, NaH₂PO₄, K₃PO₄, K₂HPO₄, KH₂PO₄, CaHPO₄, MgHPO₄, sodium acetate, potassium acetate, magnesium acetate, poly(vinylpyridine), poly(vinylamine), polyacrylonitrile, other bases, or combinations thereof. In one embodiment, the base is optionally added to the brine in its pure form or as an aqueous solution. In one embodiment, the base is optionally added in a gaseous state such as gaseous NH₃. In one embodiment, the base is optionally added to the brine in a steady stream, a variable stream, in steady aliquots, or in variable aliquots. In one embodiment, the base is optionally created in the brine by using an electrochemical cell to remove H₂ and Cl₂ gas, which is optionally combined in a separate system to create HCl acid to be used for eluting lithium from the system or for other purposes.

In some embodiments, a solid base is mixed with a liquid resource to create a basic solution. In some embodiments, a solid base is mixed with a liquid resource to create a basic solution, and the resulting basic solution is added to a second volume of a liquid resource to increase the pH of the second volume of the liquid resource. In some embodiments, solid base is mixed with a liquid resource to create a basic solution, wherein the resulting basic solution is used to adjust or control the pH of a second solution. In some embodiments, a solid base is mixed with a liquid resource to create a basic slurry. In some embodiments, a solid base is mixed with a liquid resource to create a basic slurry, and the resulting basic slurry is added to a second volume of a liquid resource to increase the pH of the second volume of the liquid resource. In some embodiments, solid base is mixed with a liquid resource to create a basic slurry, wherein the resulting basic slurry is used to adjust or control the pH of a second solution. In some embodiments, base may be (e.g., is) added to a liquid resource as a mixture or slurry of base and liquid resource.

In one embodiment of the ion exchange system, the brine flows through a pH control column containing solid sacrificial base particles such as NaOH, CaO, or Ca(OH)₂, which dissolve into the brine and raise the pH of the brine. In one embodiment of the ion exchange system, the brine flows through a pH control column containing immobilized regeneratable OH-containing ion exchange resins which react with hydrogen ions, or regeneratable base species such as immobilized polypyridine, which conjugate HCl, thereby neutralizing the acidified brine. When the ion exchange resin has been depleted of its OH groups or is saturated with HCl, it is optionally regenerated with a base such as NaOH.

In one embodiment of the ion exchange system, pH meters are optionally installed in tanks, pipes, column, and other components of the system to monitor pH and control the rates and amounts of base addition at various locations throughout the system.

In one embodiment of the ion exchange system, the columns, tanks, pipes, and other components of the system are optionally constructed using plastic, metal with a plastic lining, or other materials that are resistant to corrosion by brine or acid.

In one embodiment of the ion exchange system, the ion exchange columns are optionally washed with water that is mildly acidic, optionally including a buffer, to remove any basic precipitates from the column prior to acid elution.

After the ion exchange column is saturated or nearly saturated with lithium, the lithium is flushed out of the ion exchange column using acid. The acid is optionally flowed through the column one or more times to elute the lithium. In one embodiment, the acid is optionally flowed through the ion exchange column using a recirculating batch system comprised of the ion exchange column connected to a tank. In one embodiment, the tank used for acid flows is optionally the same tank used for the brine flows. In a further embodiment, the tank used for acid flows is optionally a different tank than the one used for brine flows. In a further embodiment, the acid is distributed at the top of the ion exchange column and allowed to percolate through and immediately recirculated into the column with no extra tank. In an embodiment, acid addition optionally occurs without a tank used for acid flows.

In one embodiment of the ion exchange system, the column is optionally washed with water after the brine and/or acid steps, and the effluent water from washing is optionally treated using pH neutralization and reverse osmosis to yield process water.

In one embodiment of the ion exchange system, the ion exchange column is optionally shaped like a cylinder, a rectangle, or another shape. In one embodiment, the ion exchange column optionally has a cylinder shape with a height that is greater or less than its diameter. In one embodiment, the ion exchange column optionally has a cylinder shape with a height that is less than 10 cm, less than 1 meter, or less than 10 meters. In one embodiment, the ion exchange column optionally has a cylinder shape with a diameter that is less than 10 cm, less than 1 meter, or less than 10 meters.

In one embodiment of the ion exchange system, the system is optionally resupplied with fresh ion exchange beads by swapping out an ion exchange column with a new column loaded with fresh ion exchange beads. In one embodiment of the ion exchange system, the system is optionally resupplied with fresh ion exchange beads by removing the beads from the column and loading new beads into the column. In one embodiment of the ion exchange system, new beads are optionally supplied to all columns in the system simultaneously. In one embodiment of the ion exchange system, new beads are optionally supplied to one or more columns at a time. In one embodiment of the ion exchange system, new beads are optionally supplied to one or more columns without interruption to other columns that optionally continue operating.

In one embodiment of the ion exchange system, brine pumping optionally continues until the ion exchange beads approach a point of lithium saturation over a period of time that is optionally less than about 1 hours, less than about 2 hours, less than about 4 hours, less than about 8 hours, less than about 24 hours, less than about 48 hours, or less than about one week. In one embodiment of the ion exchange system, brine pumping optionally continues until the ion exchange beads approach a point of lithium saturation over a period of time that is optionally greater than about one week. In certain embodiments of the ion exchange system, brine pumping optionally continues until the ion exchange beads approach a point of lithium saturation over a period of time that is optionally between 30 minutes and 24 hours. In one embodiment of the ion exchange system, acid pumping optionally continues until the ion exchange beads approach a point of hydrogen saturation over a period of time that is optionally less than about 1 hours, less than about 2 hours, less than about 4 hours, less than about 8 hours, less than about 24 hours, or less than about 48 hours. In one embodiment of the ion exchange system, brine pumping optionally continues until the ion exchange beads approach a point of hydrogen saturation over a period of time that is optionally greater than about one 48 hours. In certain embodiments of the ion exchange system, brine pumping optionally continues until the ion exchange beads approach a point of hydrogen saturation over a period of time that is optionally between 30 minutes and 24 hours.

For commercial production of lithium using ion exchange, it is desirable to construct large-scale ion exchange modules containing large quantities of ion exchange beads. However, most large vessels capable of holding about one tonne or more of ion exchange beads have large fluid flow distances of about one meter or more. These fluid flow distances cause large pressure drops. To reduce the pressure drop across the ion exchange bed, the ion exchange beads can be loaded into vessels facilitating flow across the ion exchange beads with a shorter fluid flow distance. These vessels can be designed to evenly distribute flow of the liquid resource and other fluids through the ion exchange beads.

In some embodiments, ion exchange vessels are designed to facilitate flow across the ion exchange beads with a shorter fluid flow distance. In some embodiments, the vessel can be oriented vertically, horizontally, or at any angle relative to the horizontal axis. In some embodiments, the vessel can be cylindrical, rectangular, spherical, another shape, or a combinations thereof. In some embodiments, the vessel can have a constant cross-sectional area or a varying cross-sectional area.

In some embodiments, the typical thickness of the distribution compartment within the vessel containing the ion-exchange compartments is less than about 1 cm, less than about 2 cm, less than about 4 cm, less than about 6 cm, less than about 8 cm, less than about 10 cm, less than about 20 cm, less than about 40 cm, less than about 60 cm, less than about 80 cm, less than about 1 m, less than about 2 m, less than about 4 m. In some embodiments, the typical thickness of the distribution compartment within the vessel containing the ion-exchange compartments is more than about 1 cm, less than about 2 cm, less than about 4 cm, less than about 6 cm, less than about 8 cm, less than about 10 cm, less than about 20 cm, less than about 40 cm, less than about 60 cm, less than about 80 cm, less than about 1 m, less than about 2 m, less than about 4 m. In some embodiments, the typical thickness of the distribution compartment within the vessel containing the ion-exchange compartments is from about 1 cm to about 2 cm, from about 2 cm to about 4 cm, from about 4 cm to about 8 cm, from about 8 cm to about 20 cm, from about 20 cm to about 40 cm, from about 40 cm to about 80 cm, from about 80 cm to about 120 cm, from about 120 cm to about 2 m, from about 2 m to about 4 m.

In some embodiments, the typical thickness of the compartment containing ion-exchange beads within the vessel containing the ion-exchange compartments is less than about 1 cm, less than about 2 cm, less than about 4 cm, less than about 6 cm, less than about 8 cm, less than about 10 cm, less than about 20 cm, less than about 40 cm, less than about 60 cm, less than about 80 cm, less than about 1 m, less than about 2 m, less than about 4 m. In some embodiments, the typical thickness of the compartment containing ion-exchange beads within the vessel containing the ion-exchange compartments is more than about 1 cm, less than about 2 cm, less than about 4 cm, less than about 6 cm, less than about 8 cm, less than about 10 cm, less than about 20 cm, less than about 40 cm, less than about 60 cm, less than about 80 cm, less than about 1 m, less than about 2 m, less than about 4 m. In some embodiments, the typical thickness of the compartment containing ion-exchange beads within the vessel containing the ion-exchange compartments is from about 1 cm to about 2 cm, from about 2 cm to about 4 cm, from about 4 cm to about 8 cm, from about 8 cm to about 20 cm, from about 20 cm to about 40 cm, from about 40 cm to about 80 cm, from about 80 cm to about 120 cm, from about 120 cm to about 2 m, from about 2 m to about 4 m.

In some embodiments, an alternate phase is contacted with the ion exchange material within an ion exchange device. In some embodiments, contact between the ion exchange beads and the alternate phase is maximized and made possible by the design of this ion exchange device.

In some embodiments, the alternate phase improves lithium extraction performance by reducing the time required to absorb hydrogen to generate hydrogen-enriched beads and release lithium to generate a lithium-enriched solution; reducing the time and water required for washing the hydrogen-enriched beads with water to generate hydrogen-enriched beads substantially free of residual acid; reducing the time required for treating the hydrogen-enriched beads with the liquid resource under conditions suitable to absorb lithium to generate lithium-enriched beads; reducing the time and water required for washing the lithium-enriched beads with water to generate lithium-enriched beads substantially free of liquid resource; improving the life-time and total lithium produce by the ion exchange material; improving the speed of pH adjustment using alkali; improving the solid-liquid mixing efficiency; and reducing the time required to drain liquids from the ion exchange vessel.

In some embodiments, the alternate phase is a liquid or gas. In some embodiments, said alternate phase is a non-aqueous liquid. In some embodiments, the alternate phase is non-aqueous liquid. In some embodiments, the alternate phase is a non-aqueous solution. In some embodiments, the alternate phase is an organic liquid such as an alkane, alcohol, oil, bio-organic oil, ester, ether, hydrocarbon, or a combination thereof. In some embodiments, the alternate phase is butane, pentane, hexane, acetone, diethyl ether, butanol, or combinations thereof. In some embodiments, the alternate is a gas such as air, nitrogen, argon, or a combination thereof. In some embodiments, the alternate phase comprises a compressed or pressurized gas.

In some embodiments, the ion exchange bed is a fixed bed that does move during the ion exchange process. In some embodiments, the ion exchange bed is a fluidized bed that is agitated at one or more periods during the ion exchange process.

### Methods of Modulating pH for the Extraction of Lithium

An aspect of the invention described herein is a method of extracting lithium ions from a liquid resource, comprising: flowing the liquid resource through the column of the system described above to produce a lithiated ion exchange material; and treating the resulting lithiated ion exchange material with an acid solution to produce a salt solution comprising lithium ions.

An aspect of the invention described herein is a method of extracting lithium ions from a liquid resource, comprising: flowing the liquid resource through the plurality of columns of the system described above to produce a lithiated ion exchange material; and treating the resulting lithiated ion exchange material with an acid solution to produce a salt solution comprising lithium ions.

An aspect of the invention described herein is a method of extracting lithium ions from a liquid resource, comprising: flowing the liquid resource through the tank of the system described above to produce a lithiated ion exchange material; and treating the resulting lithiated ion exchange material with an acid solution to produce a salt solution comprising lithium ions.

An aspect of the invention described herein is a method of extracting lithium ions from a liquid resource, comprising: flowing the liquid resource through the column of the system described above to produce a lithiated ion exchange material; and treating the resulting lithiated ion exchange material with an acid solution to produce a salt solution comprising lithium ions.

In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof. In some embodiments, the liquid resource is optionally pre-treated prior to entering the ion exchange reactor to remove suspended solids, hydrocarbons, or organic molecules. In some embodiments, the liquid resource is optionally entered the ion exchange reactor without any pre-treatment following from its source.

In an embodiment, the liquid resource is a natural brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

In some embodiments, the liquid resource is selected with a lithium concentration selected from the following list: less than 100,000 ppm, less than 10,000 ppm, less than 1,000 ppm, less than 100 ppm, less than 10 ppm, or combinations thereof. In some embodiments, a liquid resource is selected with a lithium concentration selected from the following list: less than 5,000 ppm, less than 500 ppm, less than 50 ppm, or combinations thereof.

In some embodiments, the acid used for recovering lithium from the ion exchange reactor is selected from the following list: hydrochloric acid, sulfuric acid, phosphoric acid, hydrobromic acid, chloric acid, perchloric acid, nitric acid, formic acid, acetic acid, or combinations thereof. In some embodiments, the acid used for recovering lithium from the porous ion exchange beads is selected from the following list: hydrochloric acid, sulfuric acid, nitric acid, or combinations thereof.

In an embodiment, the acid solution comprises hydrochloric acid, sulfuric acid, phosphoric acid, hydrobromic acid, chloric acid, perchloric acid, nitric acid, formic acid, acetic acid, or combinations thereof.

In some embodiments, the acid used for recovering lithium from the ion exchange system has a concentration selected from the following list: less than 0.1 M, less than 1.0 M, less than 5 M, less than 10 M, or combinations thereof. In some embodiments, the acid used for recovering lithium from the porous ion exchange beads has a concentration greater than 10 M.

In an embodiment, acids with distinct concentrations are used during the elution process. In an embodiment, acid with a lower concentration is first added to elute lithium from the ion exchange material and then additional acid of a greater concentration is added to elute more lithium into the solution and increase the concentration of lithium in the eluate.

In some embodiments, the ion exchange beads perform the ion exchange reaction repeatedly while maintaining adequate lithium uptake capacity over a number of cycles selected from the following list: greater than 10 cycles, greater than 30 cycles, greater than 100 cycles, greater than 300 cycles, or greater than 1,000 cycles. In some embodiments, the porous ion exchange beads perform the ion exchange reaction repeatedly over a number of cycles selected from the following list: greater than 50 cycles, greater than 100 cycles, or greater than 200 cycles. In some embodiments, adequate lithium uptake capacity is optionally defined as a percentage of initial uptake capacity selected from the following list: greater than 95%, greater than 90%, greater than 80%, greater than 60%, or greater than 20%. In some embodiments, adequate lithium uptake capacity is optionally defined as a percentage of initial uptake capacity such as less than 20%.

In some embodiments, the concentrated lithium solution that is yielded from the ion exchange reactor is further processed into lithium raw materials using methods selected from the following list: solvent extraction, ion exchange, chemical precipitation, electrodialysis, electrowinning, electrolysis, evaporation with direct solar energy, evaporation with concentrated solar energy, evaporation with a heat transfer medium heated by concentrated solar energy, evaporation with heat from a geothermal brine, evaporation with heat from combustion, pH neutralization, or combinations thereof. In some embodiments, the concentrated lithium solution that is yielded from the ion exchange reactor is concentrated using reverse osmosis or membrane technologies.

In some embodiments, the concentrated lithium solution that is yielded from the ion exchange reactor is further processed into lithium chemicals selected from the following list: lithium chloride, lithium carbonate, lithium hydroxide, lithium metal, lithium metal oxide, lithium metal phosphate, lithium sulfide, or combinations thereof. In some embodiments, the concentrated lithium solution that is yielded from the porous ion exchange beads is further processed into lithium chemicals that are solid, liquid, hydrated, or anhydrous.

In some embodiments, the lithium chemicals produced using the ion exchange reactor are used in an industrial application selected from the following list: lithium batteries, metal alloys, glass, grease, or combinations thereof. In some embodiments, the lithium chemicals produced using the coated ion exchange particles are used in an application selected from the following list: lithium batteries, lithium-ion batteries, lithium sulfur batteries, lithium solid-state batteries, and combinations thereof.

In some embodiments, the ion exchange materials are synthesized in a lithiated state with a sublattice fully or partly occupied by lithium. In some embodiments, the ion exchange materials are synthesized in a hydrated state with a sublattice fully or partly occupied by hydrogen.

In some embodiments, the ion exchange material extracts lithium ions from a liquid resource. During the extraction of lithium ions from a liquid resource by the ion exchange material, the pH of the liquid resource optionally decreases. Increasing the pH of the liquid resource in the system by using a pH modulating setup maintains the pH in a range that is suitable for lithium ion uptake by the ion exchange material. In an embodiment, the pH modulating setup comprises measuring the pH of the system and adjusting the pH of the system to an ideal pH range for lithium extraction. In an embodiment, for ion exchange material to absorb lithium from brine, an ideal pH range for the brine is optionally 6 to 9, a preferred pH range is optionally 4 to 9, and an acceptable pH range is optionally 2 to 9. In an embodiment, the pH modulating setup comprises measuring the pH of the system and wherein the pH of the system is less than 6, less than 4, or less than 2, the pH of the system is adjusted to a pH of 2 to 9, a pH of 4 to 9, or a pH of 6 to 9.

Another aspect described herein is a method of extracting lithium ions from a liquid resource, comprising: a) flowing the liquid resource into a system comprising a tank to produce a lithiated ion exchange material, wherein the tank further comprises (i) one or more compartments, (ii) an ion exchange material, (iii) a mixing device, and (iv) a pH modulating setup for changing the pH of the liquid resource in the system; and b) treating the lithiated ion exchange material from a) with an acid solution to produce a hydrogen-rich ion exchange material and a salt solution comprising lithium ions.

In some embodiments, the method further comprises, prior to b), washing the lithiated ion exchange material with an aqueous solution. In some embodiments, the method further comprises, subsequent to b), washing the hydrogen-rich ion exchange material with an aqueous solution. In some embodiments, the aqueous solution is water.

In some embodiments, the method further comprises, prior to b), flowing the lithiated ion exchange material into a washing system. In some embodiments, the method further comprises, prior to b), transferring a suspension comprising the lithiated ion exchange material. In some embodiments, the method further comprises, prior to b), flowing the lithiated ion exchange material into a washing system and washing the lithiated ion exchange material with a solution. In some embodiments, the method further comprises, prior to b), flowing the lithiated ion exchange material into a washing system and washing the lithiated ion exchange material with a solution comprising water. In some embodiments, the method further comprises, prior to b), flowing the lithiated ion exchange material into a washing system and washing the lithiated ion exchange material with an aqueous solution. In some embodiments, the lithiated ion exchange material is washed with an aqueous solution.

In some embodiments, the method further comprises, prior to b), flowing the lithiated ion exchange material into a stripping system. In some embodiments, the method further comprises, prior to b), flowing the lithiated ion exchange material into a stripping system and stripping the lithiated ion exchange material. In some embodiments, the method further comprises, prior to b), flowing the lithiated ion exchange material into a stripping system and stripping volatile components from the lithiated ion exchange material. In some embodiments, the method further comprises, prior to b), flowing the lithiated ion exchange material into a stripping system and stripping volatile components comprising water from the lithiated ion exchange material.

In some embodiments, the pH modulating setup comprises a pH measuring device and an inlet for adding base to the tank. In some embodiments, the pH measuring device is a pH probe. In some embodiments, the inlet is a pipe. In some embodiments, the inlet is an injection port.

In some embodiments, the method further comprises, during a), measuring a change in pH of the liquid resource using the pH modulating setup. In some embodiments, the measured change in pH triggers adding a base to maintain lithium uptake. In some embodiments, a change in pH to below a pH value of about 2 to about 9 triggers the addition of a base to maintain lithium uptake. In some embodiments, a change in pH to below a pH value of about 2, of about 3, of about 4, of about 5, of about 6, of about 7, of about 8, or of about 9 triggers the addition of a base to maintain lithium uptake. In some embodiments, a change in pH to below a pH of about 2 to about 4, of about 3 to about 5, of about 4 to about 6, of about 5 to about 7, of about 6 to about 8, or of about 7 to about 9 triggers the addition of a base to maintain lithium uptake. In some embodiments, base is added to the liquid resource to maintain the pH of the liquid resource in a range of about 2-3, 3-4, 4-5, 5-6, 6-7, 7-8, or 8-9. In some embodiments, base is added to the liquid resource to maintain the pH of the liquid resource in a range of about 4-5, 5-6, 6-7, or 7-8. In some embodiments, base is added to the liquid resource to maintain the pH of the liquid resource in a range of about 4.0-4.5, 4.5-5.0, 5.0-5.5, 5.5-6.0, 6.0-6.5, 6.5-7.0, 7.0-7.5, or 7.5-8.0. In some embodiments, the pH of a liquid resource is maintained in a target range that is high enough to facilitate lithium uptake and low enough to avoid precipitation of metal salts from the liquid resource. In some embodiments, the pH of a liquid resource is maintained below a pH of about 8 to avoid precipitation of Mg salts. In some embodiments, the pH of a liquid resource is maintained below a pH of about 2, below a pH of about 3, below a pH of about 4, below a pH of about 5, below a pH of about 6, below a pH of about 7, below a pH of about 8, or below a pH of about 9 to avoid precipitation of metal salts. In some embodiments, the pH of the liquid resource may drop out of a target pH range due to release of protons from an ion exchange material and a pH modulating setup may adjust the pH of the liquid resource back to within a target pH range. In some embodiments, the pH of the liquid resource may be (e.g., is) adjusted above a target pH range prior to the liquid resource entering the system and then protons released from the ion exchange material may decrease the pH of the system into the target range. In some embodiments, the pH of the liquid resource may be (e.g., is) controlled in a certain range and the range may be changed over time. In some embodiments, the pH of the liquid resource may be (e.g., is) controlled in a certain range and then the pH of the liquid resource may be allowed to drop. In some embodiments, the pH of the liquid resource may be (e.g., is) controlled in a certain range and then the pH of the liquid resource may be allowed to drop to solubilize colloids or solids. In some embodiments, base may be (e.g., is) added to a liquid resource to neutralize protons without measuring pH. In some embodiments, base may be (e.g., is) added to a liquid resource to neutralize protons with monitoring of volumes or quantities of the base. In some embodiments, the pH of the liquid resource may be (e.g., is) measured to monitor lithium uptake by an ion exchange material. In some embodiments, the pH of the liquid resource may be (e.g., is) monitored to determine when to separate a liquid resource from an ion exchange material. In some embodiments, the rate of change of the pH of the liquid resource may be (e.g., is) measured to monitor the rate of lithium uptake. In some embodiments, the rate of change of the pH of the liquid resource may be (e.g., is) measured to determine when to separate a liquid resource from an ion exchange material.

In some embodiments, the tank further comprises a porous partition. In some embodiments, the porous partition is a porous polymer partition. In some embodiments, the porous partition is a mesh or membrane. In some embodiments, the porous partition is a polymer mesh or polymer membrane. In some embodiments, the porous partition comprises one or more layers of mesh, membrane, or other porous structure. In some embodiments, the porous partition comprises one or more coarse meshes that provide structural support and one or more fine meshes and/or membranes that provide filtration. In some embodiments, the porous partition comprises a polyether ether ketone mesh, a polypropylene mesh, a polyethylene mesh, a polysulfone mesh, a polyester mesh, a polyamide mesh, a polytetrafluoroethylene mesh, an ethylene tetrafluoroethylene polymer mesh, a stainless steel mesh, a stainless steel mesh coated in polymer, a stainless steel mesh coated in ceramic, or a combination thereof, wherein the mesh is a course mesh, a fine mesh, or a combination thereof. In some embodiments, the porous polymer partition comprises a mesh comprising one or more blends of two or more of a polyether ether ketone, a polypropylene, a polyethylene, a polysulfone, a polyester, a polyamide, a polytetrafluoroethylene, or an ethylene tetrafluoroethylene polymer. In some embodiments, the porous partition comprises a polyether ether ketone membrane, a polypropylene membrane, a polyethylene membrane, a polysulfone membrane, a polyester membrane, a polyamide membrane, a polytetrafluoroethylene membrane, an ethylene tetrafluoroethylene polymer membrane, or combinations thereof.

In some embodiments, the method further comprises, after a), draining the liquid resource through the porous partition after the production of the lithiated ion exchange material.

In some embodiments, the method further comprises, after b), draining the salt solution comprising lithium ions through the porous partition after the production of the hydrogen-rich ion exchange material.

In some embodiments, the method further comprises, subsequent to a), flowing the lithiated ion exchange material into another system comprising a tank to produce the hydrogen-rich ion exchange material and the salt solution comprising lithium ions, wherein the tank of the other system further comprises (i) one or more compartments, and (ii) a mixing device.

In some embodiments, the system comprises a plurality of tanks and each of the plurality of tanks further comprises (i) one or more compartments, (ii) an ion exchange material, (iii) a mixing device, and (iv) a pH modulating setup for changing the pH of the system.

An aspect described herein is a method of extracting lithium ions from a liquid resource, comprising: a) flowing the liquid resource into a first system comprising a tank, wherein the tank of the first system further comprises (i) one or more compartments, (ii) an ion exchange material, (iii) a mixing device, and (iv) a pH modulating setup for changing the pH of the liquid resource in the first system, to produce a lithiated ion exchange material; b) flowing the lithiated ion exchange material of a) into a second system comprising a tank, wherein the tank of the second system further comprises (i) one or more compartments, and (ii) a mixing device; and c) treating the lithiated ion exchange from b) with an acid solution to produce a hydrogen-rich ion exchange material and a salt solution comprising lithium ions.

In some embodiments, the method further comprises, subsequent to a), washing the lithiated ion exchange material with an aqueous solution.

In some embodiments, the method further comprises, prior to b), adding an aqueous solution to the lithiated ion exchange material to form a fluidized lithiated ion exchange material.

In some embodiments, the method further comprises, subsequent to c), washing the hydrogen-rich ion exchange material with an aqueous solution. In some embodiments, the aqueous solution is water.

In some embodiments, the pH modulating setup comprises a pH measuring device and an inlet for adding base. In some embodiments, the pH measuring device is a pH probe. In some embodiments, the inlet is a pipe. In some embodiments, the inlet is an injection port.

In some embodiments, the method further comprises, during a), measuring a change in pH of the liquid resource using the pH modulating setup. In some embodiments, the change in pH triggers adding a base to maintain lithium uptake.

An aspect described herein is a method of extracting lithium ions from a liquid resource, comprising: a) flowing the liquid resource into a first system comprising a plurality of tanks to produce a lithiated ion exchange material, wherein each of the plurality of tanks in the first system is in fluid communication with every other one of the plurality of tanks in the first system and, each of the plurality of tanks in the first system further comprises (i) one or more compartments, (ii) an ion exchange material, (iii) a mixing device, and (iv) a pH modulating setup for changing the pH of each of the plurality of tanks in the first system; b) flowing the lithiated ion exchange material into a second system comprising a plurality of tanks, wherein each of the plurality of tanks in the second system is in fluid communication with every other one of the plurality of tanks in the second system and, each of the plurality of tanks in the second system further comprises (i) one or more compartments, and (ii) a mixing device; and c) treating the lithiated ion exchange material from b) with an acid solution in at least one of the plurality of tanks in the second system to produce a hydrogen-rich ion exchange material and a salt solution comprising lithium ions.

In some embodiments, the method further comprises, subsequent to c), washing the hydrogen-rich ion exchange material with an aqueous solution in at least one of the plurality of tanks in the second system.

In some embodiments, the method is operated in a batch mode. In some embodiments, the method is operated in a continuous mode. In some embodiments, the method is operated in continuous and batch mode. In some embodiments, the method is operated in continuous mode, a batch mode, a semi-continuous mode, or combinations thereof.

In some embodiments, the pH modulating setup comprises a pH measuring device and an inlet for adding base. In some embodiments, the pH measuring device is a pH probe. In some embodiments, the inlet is a pipe. In some embodiments, the inlet is an injection port.

In some embodiments, the method further comprises, during a), measuring a change in pH of the liquid resource using the pH modulating setup. In some embodiments, the change in pH triggers adding a base to maintain lithium uptake.

An aspect described herein is a method of extracting lithium ions from a liquid resource, comprising: a) flowing the liquid resource into a first system comprising a tank to produce a lithiated ion exchange material, wherein the tank further comprises (i) one or more compartments, (ii) ion exchange material, and (iii) a mixing device; b) flowing the lithiated ion exchange material from a) into a second system comprising a tank, wherein the tank further comprises (i) one or more compartments, (ii) an acid solution, and (iii) a mixing device; and c) stripping the lithiated ion exchange material to produce hydrogen-rich ion exchange material and a salt solution comprising lithium ions.

In some embodiments, prior to b), the lithiated ion exchange material is washed. In some embodiments, the lithiated ion exchange material is washed with an aqueous solution.

An aspect described herein is a method of extracting lithium ions from a liquid resource, comprising: a) providing a system comprising an ion exchange material, a tank comprising one or more compartments; and a mixing device, wherein (i) the ion exchange material is oxide-based and exchanges hydrogen ions with lithium ions, and (ii) the mixing device is capable of moving the liquid resource around the tank comprising one or more compartments; b) flowing the liquid resource into the system of a), thereby contacting the liquid resource with the ion exchange material, wherein the ion exchange material exchanges hydrogen ions with lithium ions in the liquid resource to produce lithiated ion exchange material; c) removing the liquid resource from the system of b); d) flowing an acid solution into the system of c) thereby contacting the acid solution with the lithiated ion exchange material, wherein the lithiated ion exchange material exchanges lithium ions with the hydrogen ions in the acid solution to produce the ion exchange material and a salt solution comprising lithium ions from the lithiated ion exchange material; and e) collecting the salt solution comprising the lithium ions for further processing.

In some embodiments, the salt solution comprising lithium ions undergoes crystallization.

A method of extracting lithium ions from a liquid resource, comprising: a) flowing the liquid resource through a system comprising an ion exchange material and a plurality of columns, wherein the plurality of columns is configured to transport the ion exchange material along the length of the column, to produce a lithiated ion exchange material; and b) treating the lithiated ion exchange material from a) with an acid solution to produce a salt solution comprising lithium ions.

An aspect described herein is a method of extracting lithium ions from a liquid resource, comprising: a) providing a system comprising an ion exchange material and a plurality of columns, wherein each of the plurality of columns is configured to transport the ion exchange material along the length of the column; b) flowing the liquid resource through a first one of the plurality of columns to produce a lithiated ion exchange material; c) flowing the lithiated ion exchange material from b) into a second one of the plurality of columns; and d) treating the lithiated ion exchange material from c) with an acid solution to produce a hydrogen-rich ion exchange material and a salt solution comprising lithium ions.

In some embodiments, the method further comprises, subsequent to b), flowing the lithiated ion exchange material into another one of the plurality of columns and washing the lithiated ion exchange material with an aqueous solution. In some embodiments, the method further comprises, subsequent to d), flowing the hydrogen-rich ion exchange material into another one of the plurality of columns and washing the hydrogen-rich ion exchange material with an aqueous solution.

An aspect described herein is a method of extracting lithium ion from a liquid resource, comprising: a) providing a system comprising an ion exchange material and a plurality of columns, wherein each of the plurality of columns is configured to transport the ion exchange material along the length of the column; b) flowing the liquid resource through a first one of the plurality of columns to produce a lithiated ion exchange material; c) flowing the lithiated ion exchange material from b) into a second one of the plurality of columns; d) washing the lithiated ion exchange material from c) with an aqueous solution; e) flowing the lithiated ion exchange material from d) into a third one of the plurality of columns; and f) treating the lithiated ion exchange material from e) with an acid solution to produce a hydrogen-rich ion exchange material and a salt solution comprising lithium ions.

In some embodiments, the method further comprises: g) flowing the hydrogen-rich ion exchange material into a fourth one of the plurality of columns; and h) washing the hydrogen-rich ion exchange material with an aqueous solution. In some embodiments, each of the plurality of columns is configured to transport the ion exchange material by a pipe system or an internal conveyer system. In some embodiments, each of the plurality of columns is configured to transport the ion exchange material by a pipe system. In some embodiments, each of the plurality of columns is configured to transport the ion exchange material by an internal conveyer system.

In some embodiments of the methods described herein, the liquid resource is a natural brine, a dissolved salt flat, seawater, concentrated seawater, a desalination effluent, a concentrated brine, a processed brine, waste brine from a bromine-extraction process, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof. In some embodiments of the methods described herein, the liquid resource is a brine. In some embodiments of the methods described herein, the liquid resource comprises a natural brine, a synthetic brine, or a mixture of a natural and a synthetic brine. In some embodiments of the methods described herein, the liquid resource is a natural brine, a dissolved salt flat, seawater, concentrated seawater, a desalination effluent, a concentrated brine, a processed brine, waste brine from a bromine-extraction process, an oilfield brine, a liquid from an ion exchange process, or combinations thereof.

In some embodiments of the methods described herein, the acid solution comprises hydrochloric acid, sulfuric acid, phosphoric acid, hydrobromic acid, chloric acid, perchloric acid, nitric acid, formic acid, acetic acid, or combinations thereof. In some embodiments of the methods described herein, the acid solution comprises hydrochloric acid, sulfuric acid, phosphoric acid, nitric acid, or combinations thereof. In some embodiments of the methods described herein, the acid solution comprises hydrochloric acid, sulfuric acid, phosphoric acid, or combinations thereof. In some embodiments of the methods described herein the acid solution comprises hydrochloric acid. In some embodiments of the methods described herein the acid solution comprises sulfuric acid. In some embodiments of the methods described herein the acid solution comprises phosphoric acid.

### Continuous Process for Lithium Extraction

Lithium is an essential element for batteries and other technologies. Lithium is found in a variety of liquid resources, including natural and synthetic brines and leachate solutions from minerals, clays, and recycled products. Lithium can be extracted from such liquid resources using an ion exchange process based on inorganicion exchange materials. These inorganic ion exchange materials absorb lithium from a liquid resource while releasing hydrogen, and then elute lithium in acid while absorbing hydrogen. This ion exchange process can be repeated to extract lithium from a liquid resource and yield a concentrated lithium solution. The concentrated lithium solution can be further processed into chemicals for the battery industry or other industries.

Ion exchange materials are typically small particles, which together constitute a fine powder. Small particle size is required to minimize the diffusion distance that lithium must travel into the core of the ion exchange particles. In some cases, these particles may be (e.g., are) coated with protective surface coatings to minimize dissolution of the ion exchange materials while allowing efficient transfer of lithium and hydrogen to and from the particles, as disclosed in co-pending U.S. provisional application 62/421,934, filed on Nov. 14, 2016, entitled “Lithium Extraction with Coated Ion Exchange Particles,” and incorporated in its entirety by reference.

One major challenge for lithium extraction using inorganic ion exchange particles is the loading of the particles into an ion exchange column in such a way that brine and acid can be pumped efficiently through the column with minimal clogging. The materials can be formed into beads, and the beads can be loaded into the column. This bead loading creates void spaces between the beads, and these void spaces facilitate pumping through the column. The beads hold the ion exchange particles in place and prevent free movement of the particles throughout the column. When the materials are formed into beads, the penetration of brine and acid solutions into the beads may become (e.g., becomes) slow and challenging. A slow rate of convection and diffusion of the acid and brine solutions into the bead slows the kinetics of lithium absorption and release. Such slow kinetics can create problems for column operation. Slow kinetics can require slow pumping rates through the column. Slow kinetics can also lead to low lithium recovery from the brine and inefficient use of acid to elute the lithium.

In one embodiment, an alternate phase is contacted with the ion exchange beads during on ore more of the steps of the process step. In some embodiments, the use of alternate phase speeds up the kinetics of ion exchange, enhances the forming of the ion exchange bed, controls liquid level height in one or more process tanks, or a combination thereof. In some embodiments, contact between the ion exchange beads and the alternate phase is maximized and made possible by the design of this ion exchange device.

In some embodiments, the alternate phase is a liquid or gas. In some embodiments, said alternate phase is a non-aqueous liquid. In some embodiments, the alternate phase is non-aqueous liquid. In some embodiments, the alternate phase is a non-aqueous solution. In some embodiments, the alternate phase is an organic liquid such as an alkane, alcohol, oil, bio-organic oil, ester, ether, hydrocarbon, or a combination thereof. In some embodiments, the alternate phase is butane, pentane, hexane, acetone, diethyl ether, butanol, or combinations thereof. In some embodiments, the alternate is a gas such as air, nitrogen, argon, or a combination thereof. In some embodiments, the alternate phase comprises a compressed or pressurized gas.

In some embodiments, the ion exchange beads are porous ion exchange beads with networks of pores that facilitate the transport into the beads of solutions that are pumped through an ion exchange column. Pore networks can be strategically controlled to provide fast and distributed access for the brine and acid solutions to penetrate into the bead and deliver lithium and hydrogen to the ion exchange particles.

In some embodiments, the ion exchange beads are formed by mixing of ion exchange particles, a matrix material, and a filler material. These components are mixed and formed into a bead. Then, the filler material is removed from the bead to leave behind pores. The filler material is dispersed in the bead in such a way to leave behind a pore structure that enables transport of lithium and hydrogen with fast kinetics. This method may involve multiple ion exchange materials, multiple polymer materials, and multiple filler materials.

Another major challenge for lithium extraction using inorganic ion exchange materials is dissolution and degradation of the materials, especially during lithium elution in acid but also during lithium uptake in liquid resources. To yield a concentrated lithium solution from the ion exchange process, it is desirable to use a concentrated acid solution to elute the lithium. However, concentrated acid solutions dissolve and degrade inorganic ion exchange materials, which decreases the performance and lifespan of the materials. Therefore, the porous ion exchange beads may contain coated ion exchange particle for lithium extraction that are comprised of an ion exchange material and a coating material protecting the particle surface. The coating protects the ion exchange material from dissolution and degradation during lithium elution in acid, during lithium uptake from a liquid resource, and during other aspects of an ion exchange process. This coated particle enables the use of concentrated acids in the ion exchange process to yield concentrated lithium solutions.

In one aspect described herein, the ion exchange material is selected for high lithium absorption capacity, high selectivity for lithium in a liquid resource relative to other ions such as sodium and magnesium, strong lithium uptake in liquid resources including those with low concentrations of lithium, facile elution of lithium with a small excess of acid, and fast ionic diffusion. In one aspect described herein, a coating material is selected to protect the particle from dissolution and chemical degradation during lithium recovery in acid and also during lithium uptake in various liquid resources. In some embodiments, the coating material may also be selected to facilitate one or more of the following objectives: diffusion of lithium and hydrogen between the particles and the liquid resources, enabling adherence of the particles to a structural support, and suppressing structural and mechanical degradation of the particles.

When the porous ion exchange beads are used in an ion exchange column, the liquid resource containing lithium is pumped through the ion exchange column so that the ion exchange particles absorb lithium from the liquid resource while releasing hydrogen. After the beads have absorbed lithium, an acid solution is pumped through the column so that the particles release lithium into the acid solution while absorbing hydrogen. The column may be operated in co-flow mode with the liquid resource and acid solution alternately flowing through the column in the same direction, or the column may be operated in counter-flow mode with a liquid resource and acid solution alternately flowing through the column in opposite directions. Between flows of the liquid resource and the acid solution, the column may be treated or washed with water or other solutions for purposes such as adjusting pH in the column or removing potential contaminants. The beads may form a fixed or moving bed, and the moving bed may move in counter-current to the brine and acid flows. The beads may be moved between multiple columns with moving beds where different columns are used for brine, acid, water, or other flows. Before or after the liquid resource flows through the column, the pH of the liquid may be adjusted with NaOH or other chemicals to facilitate the ion exchange reaction as well as handling or disposal of the spent liquid resource. Before or after the liquid resource flows through the column, the liquid resource may be subjected to other processes including other ion exchange processes, solvent extraction, evaporation, chemical treatment, or precipitation to remove lithium, to remove other chemical species, or to otherwise treat the brine.

When the ion exchange particles are treated with acid, a lithium solution is produced. This lithium solution may be further processed to produce lithium chemicals. These lithium chemicals may be supplied for an industrial application.

In some embodiments, an ion exchange material is selected from the following list: an oxide, a phosphate, an oxyfluoride, a fluorophosphate, or combinations thereof. In some embodiments, an ion exchange material is selected from the following list: Li₄Mn₅O₁₂, Li₄Ti₅O₁₂, Li₂MO₃ (M=Ti, Mn, Sn), LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, LiFePO₄, LiMnPO₄, Li₂CuP₂O₇, Al(OH)₃, LiCl·xAl(OH)₃·yH₂O, SnO₂·xSb₂O₅·yH₂O, TiO₂·xSb₂O₅·yH₂O, solid solutions thereof, or combinations thereof. In some embodiments, an ion exchange material is selected from the following list: Li₄Mn₅O₁₂, Li₄Ti₅O₁₂, Li_{1.6}Mn_{1.6}O₄, Li₂MO₃ (M=Ti, Mn, Sn), LiFePO₄, solid solutions thereof, or combinations thereof.

In some embodiments, a coating material for protecting the surface of the ion exchange material is selected from the following list: a carbide, a nitride, an oxide, a phosphate, a fluoride, a polymer, carbon, a carbonaceous material, or combinations thereof. In some embodiments, a coating material is selected from the following list: TiO₂, ZrO₂, MoO₂, SnO₂, Nb₂O₅, Ta₂O₅, SiO₂, Li₂TiO₃, Li₂ZrO₃, Li₂SiO₃, Li₂MnO₃, Li₂MoO₃, LiNbO₃, LiTaO₃, AlPO₄, LaPO₄, ZrP₂O₇, MoP₂O₇, Mo₂P₃O₁₂, BaSO₄, AlF₃, SiC, TiC, ZrC, Si₃N₄, ZrN, BN, carbon, graphitic carbon, amorphous carbon, hard carbon, diamond-like carbon, solid solutions thereof, or combinations thereof. In some embodiments, a coating material is selected from the following list: TiO₂, ZrO₂, MoO₂, SiO₂, Liz TiO₃, Li₂ZrO₃, Li₂SiO₃, Li₂MnO₃, LiNbO₃, AlF₃, SiC, Si₃N₄, graphitic carbon, amorphous carbon, diamond-like carbon, or combinations thereof.

In some embodiments, the ion exchange particles may have (e.g., have) an average diameter that is selected from the following list: less than 10 nm, less than 100 nm, less than 1,000 nm, less than 10,000 nm, or less than 100,000 nm. In some embodiments, the ion exchange particles may have (e.g., have) an average size that is selected from the following list: less than 200 nm, less than 2,000 nm, or less than 20,000 nm.

In some embodiments, the ion exchange particles may be (e.g., are) secondary particles comprised of smaller primary particles that may have (e.g., have) an average diameter selected from the following list: less than 10 nm, less than 100 nm, less than 1,000 nm, or less than 10,000 nm.

In some embodiments, the ion exchange particles have a coating material with a thickness selected from the following list: less than 1 nm, less than 10 nm, less than 100 nm, or less than 1,000 nm. In some embodiments, the coating material has a thickness selected from the following list: less than 1 nm, less than 10 nm, or less than 100 nm.

In some embodiments, the ion exchange material and a coating material may form (e.g., form) one or more concentration gradients where the chemical composition of the particle ranges between two or more compositions. In some embodiments, the ion exchange materials and the coating materials may form (e.g., form) a concentration gradient that extends over a thickness selected from the following list: less than 1 nm, less than 10 nm, less than 100 nm, less than 1,000 nm, less than 10,000 nm, or less than 100,000 nm.

In some embodiments, the ion exchange material is synthesized by a method selected from the following list: hydrothermal, solvothermal, sol-gel, solid state, molten salt flux, ion exchange, microwave, ball milling, precipitation, or vapor deposition. In some embodiments, the ion exchange material is synthesized by a method selected from the following list: hydrothermal, solid state, or microwave.

In some embodiments, a coating material is deposited by a method selected from the following list: chemical vapor deposition, atomic layer deposition, physical vapor deposition, hydrothermal, solvothermal, sol-gel, solid state, molten salt flux, ion exchange, microwave, wet impregnation, precipitation, titration, aging, ball milling, or combinations thereof. In some embodiments, the coating material is deposited by a method selected from the following list: chemical vapor deposition, hydrothermal, titration, solvothermal, wet impregnation, sol-gel, precipitation, microwave, or combinations thereof.

In some embodiments, a coating material is deposited with physical characteristics selected from the following list: crystalline, amorphous, full coverage, partial coverage, uniform, non-uniform, or combinations thereof.

In some embodiments, multiple coatings may be (e.g., are) deposited on the ion exchange material in an arrangement selected from the following list: concentric, patchwork, or combinations thereof.

In some embodiments, the matrix is selected from the following list: a polymer, an oxide, a phosphate, or combinations thereof. In some embodiments, a structural support is selected from the following list: polyvinyl fluoride, polyvinylidene difluoride, polyvinyl chloride, polyvinylidene dichloride, polyethylene, polypropylene, polyphenylene sulfide, polytetrafluoroethylene, polytetrofluoroethylene, sulfonated polytetrofluoroethylene, polystyrene, polydivinylbenzene, polybutadiene, sulfonated polymer, carboxylated polymer, Nafion, copolymers thereof, and combinations thereof. In some embodiments, a structural support is selected from the following list: polyvinylidene difluoride, polyvinyl chloride, sulfonated polytetrofluoroethylene, polystyrene, polydivinylbenzene, copolymers thereof, or combinations thereof. In some embodiments, a structural support is selected from the following list: titanium dioxide, zirconium dioxide, silicon dioxide, solid solutions thereof, or combinations thereof. In some embodiments, the matrix material is selected for thermal resistance, acid resistance, and/or other chemical resistance.

In some embodiments, the porous bead is formed by mixing the ion exchange particles, the matrix material, and the filler material together at once. In some embodiments, the porous bead is formed by first mixing the ion exchange particles and the matrix material, and then mixing with the filler material. In some embodiments, the porous bead is formed by first mixing the ion exchange particles and the filler material, and then mixing with the matrix material. In some embodiments, the porous bead is formed by first mixing the matrix material and the filler material, and then mixing with the ion exchange particles.

In some embodiments, the porous bead is formed by mixing the ion exchange particles, the matrix material, and/or the filler material with a solvent that dissolves once or more of the components. In some embodiments, the porous bead is formed by mixing the ion exchange particles, the matrix material, and/or the filler material as dry powders in a mixer or ball mill. In some embodiments, the porous bead is formed by mixing the ion exchange particles, the matrix material, and/or the filler material in a spray drier.

In some embodiments, the matrix material is a polymer that is dissolved and mixed with the ion exchange particles and/or filler material using a solvent from the following list: n-methyl-2-pyrrolidone, dimethyl sulfoxide, tetrahydrofuran, dimethylformamide, dimethylacetamide, methyl ethyl ketone, or combinations thereof. In some embodiments, the filler material is a salt that is dissolved and mixed with the ion exchange particles and/or matrix material using a solvent from the following list: water, ethanol, iso-propyl alcohol, acetone, or combinations thereof.

In some embodiments, the filler material is a salt that is dissolved out of the bead to form pores using a solution selected from the following list: water, ethanol, iso-propyl alcohol, a surfactant mixture, an acid a base, or combinations thereof. In some embodiments, the filler material is a material that thermally decomposes to form a gas at high temperature so that the gas can leave the bead to form pores, where the gas is selected from the following list: water vapor, oxygen, nitrogen, chlorine, carbon dioxide, nitrogen oxides, organic vapors, or combinations thereof.

In some embodiments, the porous ion exchange bead is formed from dry powder using a mechanical press, a pellet press, a tablet press, a pill press, a rotary press, or combinations thereof. In some embodiments, the porous ion exchange bead is formed from a solvent slurry by dripping the slurry into a different liquid solution. The solvent slurry may be formed using a solvent of n-methyl-2-pyrrolidone, dimethyl sulfoxide, tetrahydrofuran, dimethylformamide, dimethylacetamide, methyl ethyl ketone, or combinations thereof. The different liquid solution may be formed using water, ethanol, iso-propyl alcohol, acetone, or combinations thereof.

In some embodiments, the porous ion exchange bead is approximately spherical with an average diameter selected from the following list: less than 10 μm, less than 100 μm, less than 1 mm, less than 1 cm, or less than 10 cm. In some embodiments, the porous ion exchange bead is approximately spherical with an average diameter selected from the following list: less than 200 μm, less than 2 mm, or less than 20 mm.

In some embodiments, the porous ion exchange bead is tablet-shaped with a diameter of less than 1 mm, less than 2 mm, less than 4 mm, less than 8 mm, or less than 20 mm and with a height of less than 1 mm, less than 2 mm, less than 4 mm, less than 8 mm, or less than 20 mm.

In some embodiments, the porous ion exchange bead is embedded in a support structure, which may be (e.g., is) a membrane, a spiral-wound membrane, a hollow fiber membrane, or a mesh. In some embodiments, the porous ion exchange bead is embedded on a support structure comprised of a polymer, a ceramic, or combinations thereof. In some embodiments, the porous ion exchange bead is loaded directly into an ion exchange column with no additional support structure.

In some embodiments, the liquid resource is selected from the following list: a natural brine, a dissolved salt flat, a geothermal brine, seawater, concentrated seawater, desalination effluent, a concentrated brine, a processed brine, liquid from an ion exchange process, liquid from a solvent extraction process, a synthetic brine, leachate from ores, leachate from minerals, leachate from clays, leachate from recycled products, leachate from recycled materials, or combinations thereof. In some embodiments, a liquid resource is selected from the following list: a natural brine, a dissolved salt flat, a concentrated brine, a processed brine, a synthetic brine, a geothermal brine, liquid from an ion exchange process, liquid from a solvent extraction process, leachate from minerals, leachate from clays, leachate from recycled products, leachate from recycled materials, or combinations thereof.

In some embodiments, the liquid resource is selected with a lithium concentration selected from the following list: less than 100,000 ppm, less than 10,000 ppm, less than 1,000 ppm, less than 100 ppm, less than 10 ppm, or combinations thereof. In some embodiments, a liquid resource is selected with a lithium concentration selected from the following list: less than 5,000 ppm, less than 500 ppm, less than 50 ppm, or combinations thereof.

In some embodiments, the acid used for recovering lithium from the porous ion exchange beads is selected from the following list: hydrochloric acid, sulfuric acid, phosphoric acid, hydrobromic acid, chloric acid, perchloric acid, nitric acid, formic acid, acetic acid, or combinations thereof. In some embodiments, the acid used for recovering lithium from the porous ion exchange beads is selected from the following list: hydrochloric acid, sulfuric acid, nitric acid, or combinations thereof.

In some embodiments, the acid used for recovering lithium from the porous ion exchange beads has a concentration selected from the following list: less than 0.1 M, less than 1.0 M, less than 5 M, less than 10 M, or combinations thereof.

In some embodiments, the porous ion exchange beads perform the ion exchange reaction repeatedly over a number of cycles selected from the following list: greater than 10 cycles, greater than 30 cycles, greater than 100 cycles, greater than 300 cycles, or greater than 1,000 cycles. In some embodiments, the porous ion exchange beads perform the ion exchange reaction repeatedly over a number of cycles selected from the following list: greater than 50 cycles, greater than 100 cycles, or greater than 200 cycles.

In some embodiments, the concentrated lithium solution that is yielded from the porous ion exchange beads is further processed into lithium raw materials using methods selected from the following list: solvent extraction, ion exchange, chemical precipitation, electrodialysis, electrowinning, evaporation with direct solar energy, evaporation with concentrated solar energy, evaporation with a heat transfer medium heated by concentrated solar energy, evaporation with heat from a geothermal brine, evaporation with heat from combustion, or combinations thereof.

In some embodiments, the concentrated lithium solution that is yielded from the porous ion exchange beads is further processed into lithium chemicals selected from the following list: lithium chloride, lithium carbonate, lithium hydroxide, lithium metal, lithium metal oxide, lithium metal phosphate, lithium sulfide, or combinations thereof. In some embodiments, the concentrated lithium solution that is yielded from the porous ion exchange beads is further processed into lithium chemicals that are solid, liquid, hydrated, or anhydrous.

In some embodiments, the lithium chemicals produced using the porous ion exchange beads are used in an industrial application selected from the following list: lithium batteries, metal alloys, glass, grease, or combinations thereof. In some embodiments, the lithium chemicals produced using the coated ion exchange particles are used in an application selected from the following list: lithium batteries, lithium-ion batteries, lithium sulfur batteries, lithium solid-state batteries, and combinations thereof.

In some embodiments, the ion exchange materials are synthesized in a lithiated state with a sublattice fully or partly occupied by lithium. In some embodiments, the ion exchange materials are synthesized in a hydrated state with a sublattice fully or partly occupied by hydrogen.

### Base and Acid Generation

In one embodiment of this invention, acid and base are generated using an electrochemical cell. In one embodiment, acid and base are generated using electrodes. In one embodiment, acid and base are generated using a membrane.

In one embodiment, said ion-conducting membrane is a cation-conducting membrane, an anion-conducting membrane or combinations thereof. In one embodiment, said ion-conducting membrane comprises sulfonated tetrafluoroethylene-based fluoropolymer-copolymer, sulfonated tetrafluoroethylene, sulfonated fluoropolymer, MK-40, co-polymers, or combinations thereof. In one embodiment, said anion-conducting membrane comprises a functionalized polymer structure.

In one embodiment, said functionalized polymer structure comprises polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In one embodiment, said cation-conducting membrane allows for transfer of lithium ions but prevents transfer of anion groups. In one embodiment, said ion-conducting membrane has a thickness from about 1 μm to about 1000 μm. In one embodiment, said ion-conducting membrane has a thickness from about 1 mm to about 10 mm.

In one embodiment, said electrodes are comprised of titanium, niobium, zirconium, tantalum, magnesium, titanium dioxide, oxides thereof, or combinations thereof. In one embodiment, said electrodes further comprise a coating of platinum, TiO₂, ZrO₂, Nb₂O₅, Ta₂O₅, SnO₂, IrO₂, RuO₂, mixed metal oxides, graphene, derivatives thereof, or combinations thereof.

In one embodiment of an integrated system, a chlor-alkali setup is used to generate HCl and NaOH from an aqueous NaCl solution. In one embodiment, the HCl is used to elute lithium from an ion exchange system for selective lithium uptake to produce a lithium eluate solution. In one embodiment, the NaOH from the chlor-alkali setup is used to control the pH of the brine in the ion exchange system for selective lithium uptake. In one embodiment, the NaOH is used to precipitate impurities from a lithium eluate solution.

In one embodiment, the system includes one or more electrochemical or electrolysis systems. The terms “electrochemical” and “electrolysis” are used interchangeably in the present specification and these terms are synonymous unless specifically noted to the contrary. In one embodiment, an electrolysis system is comprised of one or more electrochemical cells. In one embodiment, an electrochemical system is used to produce HCl and NaOH. In one embodiment, an electrochemical system converts a salt solution into acid in base. In one embodiment, an electrochemical system converts a salt solution containing NaCl, KCl, and/or other chlorides into a base and an acid. In one embodiment, a salt solution precipitated or recovered from the brine is fed into an electrochemical system to produce acid and base. In one embodiment, an electrolysis system converts a lithium salt solution to form a lithium hydroxide solution, an acidified solution, and optionally a dilute lithium salt solution. In one embodiment, the lithium salt solution is or is derived from a lithium eluate solution, produced by an ion exchange system that has optionally been concentrated and/or purified. In one embodiment, acidified solution from an electrolysis system is returned to an ion exchange system to elute more lithium eluate solution.

In one embodiment of the integrated system, the integrated system includes one or more electrolysis systems. In one embodiment, an electrolysis system is comprised of one or more electrodialysis cells. In one embodiment, an electrolysis system converts a lithium salt solution to form a lithium hydroxide solution, an acidified solution, and optionally a dilute lithium salt solution. In one embodiment, the lithium salt solution is or is derived from a lithium eluate solution, produced by an ion exchange system that has optionally been concentrated and/or purified. In one embodiment, acidified solution from an electrolysis system is returned to an ion exchange system to elute more lithium eluate solution.

In one embodiment, a lithium salt solution contains unreacted acid from the ion exchange system. In one embodiment, unreacted acid in the lithium salt solution from an ion exchange system passes through an electrolysis system and is further acidified to form an acidified solution. In one embodiment, a lithium salt solution derived from an ion exchange system is purified to remove impurities without neutralizing the unreacted acid in the lithium salt solution and is then fed into an electrolysis system.

In one embodiment, an acidified solution produced by an electrolysis system contains lithium ions from the lithium salt solution fed into the electrolysis system. In one embodiment, an acidified solution containing lithium ions leaves the electrolysis system and is fed back to an ion exchange system to elute lithium and produce more lithium salt solution.

In one embodiment of an electrolysis system, the electrolysis cells are electrochemical cells. In one embodiment of an electrochemical cell, the membranes may be (e.g., are) cation-conducting and/or anion-conducting membranes. In one embodiment, the electrochemical cell is a two-compartment cell with a cation-conducting membrane that allows for transfer of lithium ions between the chambers but prevents transfer of anion groups such as chloride, sulfate, and hydroxide groups.

In one embodiment of an electrolysis system, the electrolysis cells are electrodialysis cells. In one embodiment of an electrodialysis cell, the membranes may be (e.g., are) cation-conducting and/or anion-conducting membranes. In one embodiment, the electrodialysis cell is a two-compartment cell with a cation-conducting membrane that allows for transfer of lithium ions between the chambers but prevents transfer of anion groups such as chloride, sulfate, and hydroxide groups.

In one embodiment of an electrolysis system, the electrolysis cells are membrane electrolysis cells. In one embodiment of a membrane electrolysis cell, the membranes may be (e.g., are) cation-conducting and/or anion-conducting membranes. In one embodiment, the membrane electrolysis cell is a two-compartment cell with a cation-conducting membrane that allows for transfer of lithium ions between the chambers but prevents transfer of anion groups such as chloride, sulfate, and hydroxide groups.

In one embodiment, the membrane electrolysis cell is a three-compartment cell with a cation-conducting membrane that allows for transfer of lithium ions separating a compartment with an electrochemically reducing electrode from a central compartment and with an anion-conducting membrane that allows for transfer of anions ions separating a compartment with an electrochemically oxidizing electrode from the central compartment. In one embodiment, the cation-conducting membrane prevents transfer of anions such as chloride, sulfate, or hydroxide. In one embodiment, the anion-conducting membrane prevents transfer of cations such as lithium, sodium, or protons.

In one embodiment of the membrane electrolysis cell, the membranes may be (e.g., are) comprised of Nafion®, sulfonated tetrafluoroethylene, sulfonated fluoropolymer, MK-40, co-polymers, other membrane materials, composites, or combinations thereof. In one embodiment of the membrane electrolysis cell, the cation exchange membranes are comprised of a functionalized polymer structure which may be (e.g., is) Nafion®, sulfonated tetrafluoroethylene, sulfonated fluoropolymer, co-polymers, different polymers, composites of polymers, or combinations thereof. In one embodiment of the membrane electrolysis cell, the polymer structures of the cation exchange membrane are functionalized with sulfone groups, carboxylic acid groups, phosphate groups, other negatively charged functional groups, or combinations thereof.

In one embodiment of the electrochemical cell, the membranes may be (e.g., are) comprised of Nafion®, sulfonated tetrafluoroethylene, sulfonated fluoropolymer, MK-40, co-polymers, other membrane materials, composites, or combinations thereof. In one embodiment of the electrochemical cell, the cation exchange membranes are comprised of a functionalized polymer structure which may be (e.g., is) Nafion®, sulfonated tetrafluoroethylene, sulfonated fluoropolymer, co-polymers, different polymers, composites of polymers, or combinations thereof. In one embodiment of the electrochemical cell, the polymer structures of the cation exchange membrane are functionalized with sulfone groups, carboxylic acid groups, phosphate groups, other negatively charged functional groups, or combinations thereof.

In one embodiment of the electrodialysis cell, the membranes may be (e.g., are) comprised of Nafion®, sulfonated tetrafluoroethylene, sulfonated fluoropolymer, MK-40, co-polymers, other membrane materials, composites, or combinations thereof. In one embodiment of the electrodialysis cell, the cation exchange membranes are comprised of a functionalized polymer structure which may be (e.g., is) Nafion®, sulfonated tetrafluoroethylene, sulfonated fluoropolymer, co-polymers, different polymers, composites of polymers, or combinations thereof. In one embodiment of the electrodialysis cell, the polymer structures of the cation exchange membrane are functionalized with sulfone groups, carboxylic acid groups, phosphate groups, other negatively charged functional groups, or combinations there of.

In one embodiment of the membrane electrolysis cell, an anion exchange membrane is comprised of a functionalized polymer structure. The polymer structure may be (e.g., is) comprised of polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In one embodiment of the membrane, the functional groups are part of the polymer backbone. In one embodiment of the membrane, functional groups are added using plasma techniques, radiation-grafting, or by other functionalization reactions. In one embodiment of the membrane, the functional group may be (e.g., is) benzyltrialkylammonium, alkyl-side-chain quaternary ammonium groups, crosslinking diammonium groups, quinuclidinium-based quaternary ammonium groups, imidazolium groups, pyridinium groups, pentamethylguanidinium groups, alkali stabilised quaternary phosphonium groups, metal containing cation groups, other cation containing groups, or combinations thereof.

In one embodiment of the electrochemical cell, an anion exchange membrane is comprised of a functionalized polymer structure. The polymer structure may be comprised of polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In one embodiment of the membrane, the functional groups are part of the polymer backbone. In one embodiment of the membrane, functional groups are added using plasma techniques, radiation-grafting, or by other functionalization reactions. In one embodiment of the membrane, the functional group may be (e.g., is) benzyltrialkylammonium, alkyl-side-chain quaternary ammonium groups, crosslinking diammonium groups, quinuclidinium-based quaternary ammonium groups, imidazolium groups, pyridinium groups, pentamethylguanidinium groups, alkali stabilised quaternary phosphonium groups, metal containing cation groups, other cation containing groups, or combinations thereof.

In one embodiment of the electrodialysis cell, an anion exchange membrane is comprised of a functionalized polymer structure. The polymer structure may be comprised of polyarylene ethers, polysulfones, polyether ketones, polyphenylenes, perfluorinated polymers, polybenzimidazole, polyepichlorohydrins, unsaturated polypropylene, polyethylene, polystyrene, polyvinylbenzyl chlorides, polyphosphazenes, polyvinyl alcohol, polytetrafluoroethylene, polyvinyl chloride, polyvinylidene fluoride, alterations of these polymers or other kinds of polymers, or composites thereof. In one embodiment of the membrane, the functional groups are part of the polymer backbone. In one embodiment of the membrane, functional groups are added using plasma techniques, radiation-grafting, or by other functionalization reactions. In one embodiment of the membrane, the functional group may be (e.g., is) benzyltrialkylammonium, alkyl-side-chain quaternary ammonium groups, crosslinking diammonium groups, quinuclidinium-based quaternary ammonium groups, imidazolium groups, pyridinium groups, pentamethylguanidinium groups, alkali stabilised quaternary phosphonium groups, metal containing cation groups, other cation containing groups, or combinations thereof.

In one embodiment of the membrane electrolysis cell, the membrane may have (e.g., have) a thickness of less than 10 μm, less than 50 μm, less than 200 μm, less than 400 μm, or less than 1,000 μm. In one embodiment of the membrane electrolysis cell, the membranes may have (e.g., have) a thickness of greater than 1,000 μm. In one embodiment of the membrane electrolysis cell, the membrane may have (e.g., has) a thickness of about 1 μm to about 1000 μm, about 1 μm to about 800 μm, about 1 μm to about 600 μm, about 1 μm to about 400 μm, about 1 μm to about 200 μm, about 1 μm to about 100 μm, about 1 μm to about 90 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 1 μm to about 10 μm.

In one embodiment of the electrochemical cell, the membrane may have (e.g., has) a thickness of less than 10 μm, less than 50 μm, less than 200 μm, less than 400 μm, or less than 1,000 μm. In one embodiment of the electrochemical cell, the membranes may have (e.g., have) a thickness of greater than 1,000 μm. In one embodiment of the electrochemical cell, the membrane may have (e.g., has) a thickness of about 1 μm to about 1000 μm, about 1 μm to about 800 μm, about 1 μm to about 600 μm, about 1 μm to about 400 μm, about 1 μm to about 200 μm, about 1 μm to about 100 μm, about 1 μm to about 90 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 1 μm to about 10 μm.

In one embodiment of the electrodialysis cell, the membrane may have (e.g., has) a thickness of less than 10 μm, less than 50 μm, less than 200 μm, less than 400 μm, or less than 1,000 μm. In one embodiment of the electrodialysis cell, the membranes may have (e.g., have) a thickness of greater than 1,000 μm. In one embodiment of the electrodialysis cell, the membrane may have (e.g., has) a thickness of about 1 μm to about 1000 μm, about 1 μm to about 800 μm, about 1 μm to about 600 μm, about 1 μm to about 400 μm, about 1 μm to about 200 μm, about 1 μm to about 100 μm, about 1 μm to about 90 μm, about 1 μm to about 80 μm, about 1 μm to about 70 μm, about 1 μm to about 60 μm, about 1 μm to about 50 μm, about 1 μm to about 40 μm, about 1 μm to about 30 μm, about 1 μm to about 20 μm, about 1 μm to about 15 μm, or about 1 μm to about 10 μm.

In one embodiment, an electrolysis system contains electrolysis cells that may be (e.g., are) two-compartment electrolysis cells or three-compartment electrolysis cells.

In one embodiment of a two-compartment electrolysis cell, the cell contains a first compartment that contains an electrochemically oxidizing electrode. A lithium salt solution enters the first compartment and is converted into an acidified solution. In one embodiment of a two-compartment electrolysis cell, the cell contains a second compartment containing an electrochemically reducing electrode. This second compartment takes as an input a water or dilute LiOH solution, and produces as an output a more concentrated LiOH solution. In one embodiment, the compartments are separated by a cation-conducting membrane that limits transport of anions.

In one embodiment of a three-compartment electrolysis cell, the cell contains a first compartment containing an electrochemically oxidizing electrode. The first compartment takes as an input water or a dilute salt solution, and produces as an output an acidified solution. In one embodiment of a three-compartment electrolysis cell, the cell contains a second compartment containing an electrochemically reducing electrode. This second compartment takes as an input a water or dilute hydroxide solution, and produces as an output a more concentrated hydroxide solution. In one embodiment of a three-compartment electrolysis cell, the cell contains a third compartment containing no electrode, which is located between the first and second compartment, and takes as an input a concentrated lithium salt solution, and produces as an output a dilute lithium salt solution. In one embodiment, the first and the third compartments are separated by an anion-conducting membrane that limits transport of cations. In one embodiment, the second and the third compartments are separated by a cation-conducting membrane that limits transport of anions.

In one embodiment of the electrolysis cell, the electrodes may be (e.g., are) comprised of titanium, niobium, zirconium, tantalum, magnesium, titanium dioxide, oxides thereof, or combinations thereof. In one embodiment of the electrolysis cell, the electrodes may be (e.g., are) coated with platinum, TiO₂, ZrO₂, Nb₂O₅, Ta₂O₅, SnO₂, IrO₂, RuO₂, PtOₓ, mixed metal oxides, graphene, derivatives thereof, or combinations thereof. In one embodiment of the electrolysis cell, the electrodes may be (e.g., are) comprised of steel, stainless steel, nickel, nickel alloys, steel alloys, or graphite.

In one embodiment of the electrolysis system, the lithium salt solution is a LiCl solution optionally containing HCl. In one embodiment of the electrolysis system, the electrochemically oxidizing electrode oxides chloride ions to produce chlorine gas.

In one embodiment of the electrolysis system, the lithium salt solution is a Li2SO4 solution optionally containing H2SO4. In one embodiment of the electrolysis system, the electrochemically oxidizing electrode oxidizes water, hydroxide, or other species to produce oxygen gas.

In one embodiment of the electrolysis system, the electrochemically reducing electrode reduces hydrogen ions to produce hydrogen gas. In one embodiment of the electrolysis system, the chamber containing the electrochemically reducing electrode produces a hydroxide solution or increases the hydroxide concentration of a solution.

In one embodiment of the electrolysis system, chlorine and hydrogen gas are burned to produce HCl in an HCl burner. In one embodiment, the HCl burner is a column maintained at approximately 100-300 or 300-2,000 degrees Celsius. In one embodiment, HCl produced in the HCl burner is cooled through a heat exchange and absorbed into water in an absorption tower to produce aqueous HCl solution. In one embodiment, the HCl solution produced from the HCl burner is used to elute lithium from an ion exchange system.

In one embodiment, the pH of the acidified solution leaving the electrolysis cell may be (e.g., is) 0 to 1, −2 to 0, 1 to 2, less than 2, less than 1, or less than 0. In some embodiments, the membrane electrolysis cell is an electrodialysis cell with multiple compartments. In some embodiments, the electrodialysis cell may have (e.g., has) more than about two, more than about five, more than about 10, or more than about twenty compartments.

In one embodiment, the base added to precipitate metals from the liquid resource may be calcium hydroxide or sodium hydroxide. In one embodiment, the base may be (e.g., is) added to the liquid resource as an aqueous solution with a base concentration that may be (e.g., is) less than 1 N, 1-2 N, 2-4 N, 4-10 N, 10-20 N, or 20-40 N. In one embodiment, the base may be (e.g., is) added to the liquid resource as a solid.

In one embodiment, the acid may be (e.g., is) added to the precipitated metals to dissolve the precipitated metals before mixing the redissolved metals with the liquid resource. In one embodiment, the acid may be (e.g., is) added to the liquid resource to acidify the liquid resource, and the precipitated metals may be (e.g., is) combined with the acidified liquid resource to redissolve the precipitated metals.

In some embodiments, acid from the electrochemical cell may be (e.g., is) used to elute lithium from the selective ion exchange material. In some embodiments, base from the electrochemical cell may be (e.g., is) used to neutralize protons released from the selective ion exchange material.

### Embodiments for Limiting or Eliminating Precipitation of Impurities in the Eluate Solution

In one embodiment, lithium and non-lithium impurities are absorbed from a lithium resource into an ion exchange material. In one embodiment, lithium and non-lithium impurities are eluted from an ion exchange material into an acidic solution. In one embodiment, lithium and non-lithium impurities are eluted from an ion exchange material into an acidic solution containing dissolved species that may precipitate at certain concentrations. In one embodiment, lithium and non-lithium impurities are eluted from an ion exchange material into an acidic solution containing dissolved species that may be (e.g., are) reduced in concentration to avoid precipitation. In one embodiment, lithium and non-lithium impurities are eluted from an ion exchange material into an acidic solution where said non-lithium impurities may precipitate at certain concentrations.

In one embodiment, lithium and multivalent impurities are absorbed from a lithium resource into an ion exchange material. In one embodiment, lithium and multivalent impurities are eluted from an ion exchange material into an acidic solution. In one embodiment, lithium and multivalent impurities are eluted from an ion exchange material into an acidic solution containing sulfate anions. In one embodiment, lithium and multivalent impurities are eluted from an ion exchange material into an acidic solution containing sulfate anions such that the multivalent impurities and sulfate anions may react to form insoluble salts that can precipitate. In one embodiment, lithium and multivalent impurities are eluted from an ion exchange material into a solution containing sulfate anions such that the multivalent impurities and sulfate anions that may react to form insoluble salts that can precipitate. In one embodiment, lithium and multivalent cations are eluted from an ion exchange material into a solution containing sulfate anions wherein the concentrations of sulfate anions and multivalent cations are limited to avoid precipitation of insoluble sulfate compounds.

In one embodiment, lithium and multivalent cations are eluted from an ion exchange material into a solution containing sulfate anions wherein the concentrations of multivalent cations are limited to avoid precipitation of insoluble sulfate compounds. In one embodiment, lithium and multivalent cations are eluted from an ion exchange material into a solution containing sulfate anions wherein the concentrations of multivalent cations are limited using nanofiltration to avoid precipitation of insoluble sulfate compounds. In one embodiment, lithium and multivalent cations are eluted from a first ion exchange material into a solution containing sulfate anions wherein the concentrations of multivalent cations are decreased using a second ion exchange material to avoid precipitation of insoluble sulfate compounds. In one embodiment, lithium and multivalent cations are eluted from a first ion exchange material into a solution containing sulfate anions wherein the concentrations of multivalent cations are limited using a second ion exchange material that is selective for multivalent cations to avoid precipitation of insoluble sulfate compounds.

In one embodiment, lithium and multivalent cations are eluted from an ion exchange material into a solution containing sulfate anions wherein the concentrations of multivalent cations are decreased to avoid precipitation of insoluble sulfate compounds. In one embodiment, lithium and multivalent cations are eluted from an ion exchange material into a solution containing sulfate anions and the concentration of multivalent cations in the sulfate solution is decreased to avoid precipitation of insoluble sulfate compounds.

In one embodiment, a sulfate solution is contacted with an ion exchange material to elute lithium along with impurities, the sulfate solution is processed to reduce the concentration of impurities, and the sulfate solution is again contacted with an ion exchange material to elute more lithium along with impurities. In one embodiment, a sulfate solution is contacted with an ion exchange material to elute lithium along with impurities, the sulfate solution is processed to reduce the concentration of multivalent cations, and the sulfate solution is again contacted with an ion exchange material to elute more lithium along with impurities. In one embodiment, a sulfate solution is contacted with an ion exchange material to elute lithium along with impurities, the sulfate solution is processed to reduce the concentration of multivalent cations, the sulfate solution is again contacted with an ion exchange material to elute more lithium along with impurities, and the concentration of multivalent cations is maintained at a sufficiently low level to avoid precipitation of insoluble salts.

In one embodiment, a sulfate solution is contacted with an ion exchange material to elute a target metal along with impurities, the sulfate solution is processed to reduce the concentration of impurities, and the sulfate solution is again contacted with an ion exchange material to elute more of the target metal along with impurities. In one embodiment, a sulfate solution is contacted with an ion exchange material to elute a target metal along with impurities, the sulfate solution is processed to reduce the concentration of multivalent cations, and the sulfate solution is again contacted with an ion exchange material to elute more of the target metal along with impurities. In one embodiment, a sulfate solution is contacted with an ion exchange material to elute a target metal along with impurities, the sulfate solution is processed to reduce the concentration of multivalent cations, the sulfate solution is again contacted with an ion exchange material to elute more of the target metal along with impurities, and the concentration of multivalent cations is maintained at a sufficiently low level to avoid precipitation of insoluble salts.

In one embodiment, an acidic sulfate solution is contacted with an ion exchange material to elute lithium along with impurities, the acidic sulfate solution is processed to reduce the concentration of impurities, and the acidic sulfate solution is again contacted with an ion exchange material to elute more lithium along with more impurities. In one embodiment, the pH of the acidic sulfate solution is regulated to control elution of lithium and/or impurities. In one embodiment, pH of the acidic sulfate solution is regulated by measuring pH with a pH probe and adding sulfuric acid and/or a solution containing sulfuric acid to the acidic sulfate solution. In one embodiment, pH of the acidic sulfate solution is regulated adding sulfuric acid and/or a solution containing sulfuric acid to the acidic sulfate solution.

In one embodiment, the sulfate solution used to elute lithium from the ion exchange material is replaced with a different solution. In one embodiment, the sulfate solution used to elute lithium from the ion exchange material is replaced with a solution comprising sulfate, nitrate, phosphate, chloride, bromide, fluoride, borate, iodide, carbonate, or combinations thereof. In one embodiment, a solution comprising anions is contacted with an ion exchange material to elute lithium along with impurities, the solution is processed to reduce the concentration of impurities, and the solution is again contacted with an ion exchange material to elute more lithium along with impurities, where the anions are selected from a list including sulfate, nitrate, phosphate, chloride, bromide, fluoride, borate, iodide, carbonate, or combinations thereof.

In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution to avoid the formation of precipitates. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic sulfate solution to elute lithium into the acidic solution, and multivalent impurities are removed from the acidic solution to avoid the formation of sulfate precipitates.

In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a unit for removing multivalent impurities before the acidic solution is returned to the fluidized bed. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a nanofiltration unit for selective removal of multivalent impurities, and then the acidic solution is returned to the fluidized bed. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a second ion exchange unit containing a second ion exchange material that is selective for removing multivalent impurities, and then the acidic solution is returned to the fluidized bed.

In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a unit for removing multivalent impurities before the acidic solution is passed to a second fluidized bed of ion exchange material for elution of more lithium into the acidic solution. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a nanofiltration unit for selective removal of multivalent impurities, and then the acidic solution is passed to a second fluidized bed of ion exchange material for elution of more lithium into the acidic solution. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a second ion exchange unit containing a second ion exchange material that is selective for removing multivalent impurities, and then the acidic solution is passed to a second fluidized bed of ion exchange material for elution of more lithium into the acidic solution. In one embodiment, the acidic solution flows through multiple fluidized beds of ion exchange material for elution of lithium and impurities, and impurities are removed from the acidic solution between the multiple fluidized beds. In one embodiment, the acidic solution flows through multiple fluidized beds of ion exchange material for elution of lithium and impurities, and impurities are removed from the acidic solution between the multiple fluidized beds using nanofiltration. In one embodiment, the acidic solution flows through multiple fluidized beds of a first ion exchange material which is lithium-selective for elution of lithium and impurities, and impurities are removed from the acidic solution between the multiple fluidized beds using a second ion exchange material that is selective for multivalent ions.

In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution to avoid the formation of precipitates. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic sulfate solution to elute lithium into the acidic solution, and multivalent impurities are removed from the acidic solution to avoid the formation of sulfate precipitates.

In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a unit for removing multivalent impurities before the acidic solution is returned to the packed bed. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a nanofiltration unit for selective removal of multivalent impurities, and then the acidic solution is returned to the packed bed. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a second ion exchange unit containing a second ion exchange material that is selective for removing multivalent impurities, and then the acidic solution is returned to the packed bed.

In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a unit for removing multivalent impurities before the acidic solution is passed to a second packed bed of ion exchange material for elution of more lithium into the acidic solution. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a nanofiltration unit for selective removal of multivalent impurities, and then the acidic solution is passed to a second packed bed of ion exchange material for elution of more lithium into the acidic solution. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a second ion exchange unit containing a second ion exchange material that is selective for removing multivalent impurities, and then the acidic solution is passed to a second packed bed of ion exchange material for elution of more lithium into the acidic solution. In one embodiment, the acidic solution flows through multiple packed beds of ion exchange material for elution of lithium and impurities, and impurities are removed from the acidic solution between the multiple packed beds. In one embodiment, the acidic solution flows through multiple packed beds of ion exchange material for elution of lithium and impurities, and impurities are removed from the acidic solution between the multiple packed beds using nanofiltration. In one embodiment, the acidic solution flows through multiple packed beds of a first ion exchange material which is lithium-selective for elution of lithium and impurities, and impurities are removed from the acidic solution between the multiple packed beds using a second ion exchange material that is selective for multivalent ions.

In some embodiments, the packed beds may be (e.g., are) partially or occasionally fluidized. In some embodiments, the fluidized beds may be (e.g., are) partially or occasionally packed. In some embodiments, the packed or fluidized beds may be (e.g., are) washed before and/or after contracting with brine and/or acid using water or washing solutions containing water, salt, chelating compounds, ethylenediaminetetraacetic acid, salt of ethylenediaminetetraacetate, compounds of ethylenediaminetetraacetate, and/or anti-scalants. In some embodiments, the acidic solution used to elute lithium from the lithium-selective ion exchange material may contain (e.g., contains) water, salt, chelating compounds, ethylenediaminetetraacetic acid, salt of ethylenediaminetetraacetate, compounds of ethylenediaminetetraacetate, and/or anti-scalants. In some embodiments, dilution water is used to limit and/or prevent formation of insoluble precipitates.

In some embodiments, multivalent impurities may be (e.g., are) removed from a lithium salt solution using precipitation. In some embodiments, multivalent impurities may be (e.g., are) removed from a lithium salt solution using precipitation through addition of base. In some embodiments, multivalent impurities may be (e.g., are) removed from a lithium salt solution using precipitation through addition of sodium hydroxide, sodium carbonate, and/or other compounds.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, and the lithium selective ion exchange material is contacted with an acidic solution to elute lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, more protons are added to the acidic solution, and the acidic solution is again contacted with the lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, more acid is added to the acidic solution, and the acidic solution is again contacted with the lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution in a first vessel, more protons are added to the acidic solution, and the acidic solution is again contacted with lithium selective ion exchange material to elute more lithium into the acidic solution in a second vessel. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution in a vessel, more protons are added to the acidic solution, and the acidic solution is again contacted with lithium selective ion exchange material to elute more lithium into the acidic solution in the vessel.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, impurities are removed from the acidic solution, more protons are added to the acidic solution, and the acidic solution is again contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, more protons are added to the acidic solution, impurities are removed from the acidic solution, and the acidic solution is again contacted with lithium selective ion exchange material to elute more lithium into the acidic solution.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, impurities are removed from the acidic solution using nanofiltration or multivalent-selective ion exchange materials, more protons are added to the acidic solution, and the acidic solution is again contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, more protons are added to the acidic solution, impurities are removed from the acidic solution using nanofiltration or multivalent-selective ion exchange materials, and the acidic solution is again contacted with lithium selective ion exchange material to elute more lithium into the acidic solution.

In some embodiments, an acidic solution is contacted with a lithium selective ion exchange material that has previously been loaded with lithium by contacting the lithium selective ion exchange material with a liquid resource, the acidic solution is treated to remove multivalent impurities, and the acidic solutions is again contacted with a lithium selective ion exchange material that has previously been loaded with lithium by contacting the lithium selective ion exchange material with a liquid resource. In some embodiments, an acidic solution is contacted with a lithium selective ion exchange material to elute lithium, the acidic solution is treated to remove multivalent impurities, and the acidic solutions is again contacted with a lithium selective ion exchange material to elute lithium. In some embodiments, an acidic solution is contacted with a lithium selective ion exchange material to elute lithium, the acidic solution is treated to remove multivalent impurities, more protons are added to the acidic solution, and the acidic solutions is again contacted with a lithium selective ion exchange material to elute lithium. In some embodiments, an acidic solution is contacted with a lithium selective ion exchange material to elute lithium, more protons are added to the acidic solution, the acidic solution is treated to remove multivalent impurities, and the acidic solutions is again contacted with a lithium selective ion exchange material to elute lithium. In some embodiments, an acidic solution is contacted with a lithium selective ion exchange material to elute lithium in a vessel, the acidic solution is treated to remove multivalent impurities, and the acidic solutions is contacted with a lithium selective ion exchange material to elute lithium in said vessel. In some embodiments, an acidic solution is contacted with a lithium selective ion exchange material to elute lithium in a first vessel, the acidic solution is treated to remove multivalent impurities, and the acidic solutions is contacted with a lithium selective ion exchange material to elute lithium in a second vessel. In some embodiments, multivalent impurities are removed with a multivalent cation selective ion exchange material. In some embodiments, multivalent impurities are removed using nanofiltration membranes. In some embodiments, the lithium selective ion exchange materials is in a tank, a column, or a stirred tank reactor. In some embodiments, the lithium selective ion exchange material is in a fixed or fluidized bed.

In some embodiments, an acidic solution is flowed through multiple vessels loaded with a lithium selective ion exchange material to elute lithium. In some embodiments, an acidic solution is flowed through multiple vessels loaded with a lithium selective ion exchange material to elute lithium and multivalent cation impurities are removed between the vessels. In some embodiments, an acidic solution is flowed through multiple vessels loaded with a lithium selective ion exchange material to elute lithium. In some embodiments, an acidic solution is flowed through multiple vessels loaded with a lithium selective ion exchange material to elute lithium, multivalent cation impurities are removed between the multiple vessels, and more protons are added to the acid solution between the multiple vessels. In some embodiments, an acidic solution is recirculated through a vessel loaded a lithium selective ion exchange material to elute lithium. In some embodiments, an acidic solution is recirculated through a vessel loaded a lithium selective ion exchange material to elute lithium and multivalent cation impurities are removed between the recirculations. In some embodiments, an acidic solution is recirculated through a vessel loaded a lithium selective ion exchange material to elute lithium, multivalent cation impurities are removed between the recirculations, and more protons are added to the acid solution between the recirculations.

In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, and the acidic solution is prepared in an acidic solution mixing unit. In one embodiment, the acidic solution mixing unit is a tank, an in-line mixing device, a stirred tank reactor, another mixing unit, or combinations thereof. In one embodiment, the acid solution mixing tank is used to service one vessel containing lithium selective ion exchange material. In one embodiment, the acid solution mixing tank is used to service multiple vessels containing lithium selective ion exchange material in parallel or series. In one embodiment, the acid solution mixing tank is used to service multiple vessels containing lithium selective ion exchange material in sequence.

In one embodiment, the acidic solution is comprised of sulfuric acid, phosphoric acid, hydrochloric acid, hydrobromic acid, carbonic acid, nitric acid, or combinations thereof. In one embodiment, lithium is eluted from a lithium selective ion exchange material using sulfuric acid, phosphoric acid, hydrochloric acid, nitric acid, or combinations thereof. In one embodiment, lithium is eluted from a lithium selective ion exchange material using an acid solution comprising sulfate, phosphate, nitrate, borate, or combinations thereof.

In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed using a combination of nanofiltration, multivalent cation selective ion exchange material, other methods of removing multivalent impurities, or combinations thereof. In one embodiment, impurities are removed from an acidic lithium solutions using combinations of nanofiltration, multivalent cation selective ion exchange material, other methods of removing multivalent impurities in parallel, series, or combinations thereof.

In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using nanofiltration membrane units arranged in series and/or parallel, more protons are added to the acidic solution, and the acid solutions is contacted with lithium selective ion exchange material to elute more lithium into the acidic solution. In one embodiment, anti-scalants, chelants, or other means of anti-scaling are used to avoid scaling in the nanofiltration membrane units.

In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange materials, more protons are added to the acidic solution, and the acid solutions is contacted with lithium selective ion exchange material to elute more lithium into the acidic solution. In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material in a packed bed, more protons are added to the acidic solution, and the acid solutions is contacted with lithium selective ion exchange material to elute more lithium into the acidic solution. In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material arranged in a network of columns, more protons are added to the acidic solution, and the acid solutions is contacted with lithium selective ion exchange material to elute more lithium into the acidic solution. In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material arranged in a network of columns with a first absorption column position for absorbing impurities and a last absorption column position for absorbing trace amounts of impurities, more protons are added to the acidic solution, and the acid solutions is contacted with lithium selective ion exchange material to elute more lithium into the acidic solution. In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material arranged in a lead-lag configuration, and the acid solutions is contacted with lithium selective ion exchange material to elute more lithium into the acidic solution. In one embodiment, a multivalent cation selective ion exchange material is arranged in a variation of a lead-lag setup. In one embodiment, a multivalent cation selective ion exchange material is eluted using a second acidic solution. In one embodiment, a multivalent cation selective ion exchange material is eluted using hydrochloric acid. In one embodiment, a multivalent cation selective ion exchange material is regenerated using sodium hydroxide. In one embodiment, a multivalent cation selective ion exchange material is operated in stirred tank reactors, fluidized beds, or packed beds arranged in series and/or parallel. In one embodiment, a lithium selective ion exchange material is operated in stirred tank reactors, fluidized beds, or packed beds arranged in series and/or parallel.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution by adding phosphate to precipitate phosphate compounds, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution by adding phosphoric acid to precipitate phosphate compounds, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, Ca, Mg, Sr, and/or Ba are removed from the acidic solution by adding phosphoric acid to precipitate Ca, Mg, Sr, and/or Ba phosphate compounds, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated from the acidic solution by adding oxalate, oxalic acid, citrate, citric acid, or combinations thereof, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated from the acidic solution by adding a precipitant comprising oxalate, oxalic acid, citrate, citric acid, or combinations thereof, the precipitant concentration is decreased by adding cations to the acidic solution, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated and removed from the acidic solution by adding oxalate, oxalate anions are precipitated and removed from the acidic solution by adding zinc, iron, manganese, other transition metals, other cations, or combinations thereof, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated and removed from the acidic solution by adding citrate, citrate anions are precipitated and removed from the acidic solution by adding cations, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, cation impurities are precipitated from the acidic solution by adding anion precipitants, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, cation impurities are precipitated and removed from the acidic solution by adding anion precipitants, the anions precipitants are precipitated and removed from the acidic solution by adding cation precipitants, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are precipitated by temporarily reducing the temperature of the acidic solution, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are precipitated by changing the temperature of the acidic solution, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are precipitated by decreasing the temperature of the acidic solution, protons are added to the acidic solution and the acidic solution is heated or allowed to warm, and the acid solutions is contacted with lithium selective ion exchange material to elute more lithium into the acidic solution.

In one embodiment, a chelating agent or anti-scalant is used to form a soluble complex to avoid precipitation in an acidic lithium solution. In one embodiment, a chelating agent or anti-scalant is used to form a soluble complex to avoid or redissolve precipitates. In one embodiment, a chelating agent or anti-scalants is used to limit or reduce precipitation of multivalent cations and the chelating agent or antiscalant is selected from the list of ethylenediaminetetraacetic acid (EDTA), disodium EDTA, calcium disodium EDTA, tetrasodium EDTA, citric acid, maleic acid, silicate compounds, amorphous silicate compounds, crystalline layered silicate compounds, phosphonic acid compounds, aminotris(methylenephosphonic acid) (ATMP), nitrilotrimethylphosphonic acid (NTMP), ethylenediamine tetra(methylene phosphonic acid) (EDTMP), diethylenetriamine penta(methylene phosphonic acid) (DTPMP), polyphosphonate, polyacrylate, polyacrylic acid, nitrilotriacetic acid (NTA), sodium hexametaphosphate (SHMP), or combinations thereof. In one embodiment, a threshold inhibitor is used to block development of nuclei in an acidic lithium solution. In one embodiment, a retarded is used to block the growth of precipitates in an acidic lithium solution. In one embodiment, compounds are used to limit, control, eliminate, or redissolve precipitates including phosphinopolycarboxylic acid, sulfonated polymer, polyacrylic acid, p-tagged sulfonated polymer, diethylenetriamine penta, bis-hexamethylene triamine, compounds thereof, modifications thereof, or combinations thereof.

In one embodiment, the acidic solution comprises lithium sulfate, lithium hydrogen sulfate, sulfuric acid, or combinations thereof. In one embodiment, the acidic solution comprises lithium sulfate, lithium hydrogen sulfate, sulfuric acid, lithium chloride, hydrochloric acid, lithium nitrate, nitric acid, lithium phosphate, lithium hydrogen phosphate, lithium dihydrogen phosphate, phosphoric acid, lithium bromide, bromic acid, or combinations thereof. In some embodiments, lithium and other metals are recovered from the liquid resource. In some embodiments, the methods described for lithium recovery are applied to recover other metals.

### Methods of Generating a Lithium Eluate

An aspect of the invention described herein is a method of generating a lithium eluate solution from a liquid resource, comprising: providing an ion exchange reactor comprising a tank, ion exchange particles that selectively absorb lithium from a liquid resource and elute a lithium eluate solution when treated with an acid solution after absorbing lithium ions from said liquid resource, one or more particle traps, and provision to modulate pH of said liquid resource; flowing a liquid resource into said ion exchange reactor thereby allowing said ion exchange particles to selectively absorb lithium from said liquid resource; treating said ion exchange particles with an acid solution to yield said lithium eluate solution; and passing said lithium eluate solution through said one or more particle traps to collect said lithium eluate solution.

In some embodiments, the tank has a conical shape. In some embodiments, the tank has a partial conical shape. In some embodiments, the conical shape allows the ion exchange particles to settle into a settled bed so that liquid can be removed from above the settled bed. In some embodiments, the partial conical shape allows the ion exchange particles to settle into a settled bed so that liquid can be removed from above the settled bed.

In some embodiments, modulation of the pH of the liquid resource occurs in the tank. In some embodiment, modulation of the pH of the liquid resource occurs prior to injection into the tank. In some embodiments, one or more particle traps comprise one or more filters inside the tank. In some embodiments, one or more particle traps comprise one filter. In some embodiments, one or more particle traps comprise one filter. In some embodiments, one or more particle traps comprise two filters. In some embodiments, one or more particle traps comprise three filters. In some embodiments, one or more particle traps comprise four filters. In some embodiments, one or more particle traps comprise five filters.

In some embodiments, one or more particle traps is located at the bottom of the tank. In some embodiments, one or more particle traps is located close to the bottom of the tank. In some embodiments, one or more particle traps is located above the bottom of the tank.

In some embodiments, one or more particle traps comprise one or more meshes. In some embodiments, one or more particle traps comprises one mesh. In some embodiments, one or more particle traps comprises two meshes. In some embodiments, one or more particle traps comprises three meshes. In some embodiments, one or more particle traps comprises four meshes. In some embodiments, one or more particle traps comprises five meshes. In some embodiments, all the meshes of the one or more particle traps are identical. In some embodiments, at least one of the meshes of the one or more particle traps is not identical to the rest of the meshes of the one or more particle traps.

In some embodiments, one or more meshes comprise a pore space of less than about 200 microns, less than about 175 microns, less than about 150 microns, less than about 100 microns, less than about 75 microns, less than about 50 microns, less than about 25 microns, less than about 10 microns, more than about 1 micron, more than about 5 micron, more than about 10 microns, more than about 20 microns, more than about 30 microns, more than about 40 microns, more than about 50 microns, more than about 60 microns, more than about 70 microns, more than about 80 microns, more than about 90 microns, more than about 100 microns, more than about 125 microns, more than about 150 microns, more than about 175 microns from about 1 micron to about 200 microns, from about 5 microns to about 175 microns, from about 10 microns to about 150 microns, from about 10 microns to about 100 microns, from about 10 microns to about 90 microns, from about 10 microns to about 80 microns, from about 10 microns to about 70 microns, from about 10 microns to about 60 microns, or from about 10 microns to about 50 microns.

In some embodiments, one or more particle traps comprise multi-layered meshes. In some embodiments, the multi-layered meshes comprise at least one finer mesh for filtration and at least one coarser mesh for structural support. In some embodiments, one or more particle traps comprise one or more meshes supported by a structural support. In some embodiments, one or more particle traps comprise one or more polymer meshes. In some embodiments, the one or more polymer meshes are selected from the group consisting of polyetheretherketone, ethylene tetrafluorethylene, polyethylene terephthalate, polypropylene, and combinations thereof.

In some embodiments, one or more particle traps comprise one or more meshes comprising a metal wire mesh. In some embodiments, the metal wire mesh is coated with a polymer. In some embodiments, the ion exchange reactor is configured to move said ion exchange particles into one or more columns for washing. In some embodiments, the ion exchange reactor is configured to allow the ion exchange particles to settle into one or more columns for washing. In some embodiments, the columns are affixed to the bottom of said tank. In some embodiments, the one or more particle traps comprise one or more filters mounted in one or more ports through the wall of said tank.

In some embodiments, the one or more particle traps comprise one or more filters external to said tank, and with provision for fluid communication between said one or more filters and said tank. In some embodiments, the one or more particle traps comprise one or more gravity sedimentation devices external to said tank, and with provision for fluid communication between said one or more gravity sedimentation devices and said tank.

In some embodiments, one or more particle traps comprise one or more gravity sedimentation devices internal to said tank. In some embodiments, one or more particle traps comprise one or more centrifugal sedimentation devices external to said tank, and with provision for fluid communication between said one or more centrifugal sedimentation devices and said tank In some embodiments, one or more particle traps comprise one or more centrifugal sedimentation devices internal to said tank. In some embodiments, one or more particle traps comprise one or more settling tanks, one or more centrifugal devices, or combinations thereof external to said tank, and with provision for fluid communication between said one or more settling tanks, centrifugal devices, or combinations thereof, and said tank. In some embodiments, one or more particle traps comprise one or more meshes, one or more centrifugal devices, or combinations thereof external to said tank, and with provision for fluid communication between said one or more meshes, centrifugal devices, or combinations thereof, and said tank. In some embodiments, one or more particle traps comprise one or more settling tanks, one or more meshes, or combinations thereof external to said tank, and with provision for fluid communication between said one or more settling tanks, meshes, or combinations thereof, and said tank. In some embodiments, one or more particle traps comprise one or more meshes, one or more settling tanks, one or more centrifugal devices, or combinations thereof external to said tank, and with provision for fluid communication between said one or more meshes, one or more settling tanks, centrifugal devices, or combinations thereof, and said tank.

In some embodiments, the ion exchange particles are stirred. In some embodiments, the ion exchange particles are stirred by a mixer. In some embodiments, the ion exchange particles are stirred by a propeller. In some embodiments, the ion exchange particles are fluidized by pumping solution into the tank near the bottom of the tank. In some embodiments, the ion exchange particles are fluidized by pumping solution from the tank back into the tank near the bottom of the tank. In some embodiments, the ion exchange particles are fluidized by pumping a slurry of the ion exchange particles from near the bottom of the tank to a higher level in the tank.

In some embodiments, the method further comprises one or more staged elution tanks, wherein intermediate eluate solutions comprising mixtures of protons and lithium ions are stored and used further to elute lithium from said ion exchange particles that are freshly lithiated. In some embodiments, the method further comprises one or more staged elution tanks, wherein intermediate eluate solutions comprising mixtures of protons and lithium ions are mixed with additional acid and used further to elute lithium from said ion exchange particles.

In some embodiments, the ion exchange particles further comprise a coating material. In some embodiments, the coating material is a polymer. In some embodiments, the coating of the coating material comprises a chloro-polymer, a fluoro-polymer, a chloro-fluoro-polymer, a hydrophilic polymer, a hydrophobic polymer, co-polymers thereof, mixtures thereof, or combinations thereof.

As disclosed herein, in some embodiments, and for any process of lithium extraction disclosed herein, the pH of the lithium-enriched acidic eluent solution is regulated to control elution of lithium and/or non-lithium impurities. In some embodiments, pH of the lithium-enriched acidic solution is regulated by adding protons, such as an acid and/or an acidic solution, to the lithium-enriched acidic solution. In some embodiments, pH of the lithium-enriched acidic solution is regulated by adding protons, such as an acid and/or an acidic solution, to the impurities-enriched lithiated acidic solution prior to removing impurities.

In some embodiments, the acid comprises sulfuric acid, phosphoric acid, hydrochloric acid, hydrobromic acid, carbonic acid, nitric acid, or combinations thereof. In some embodiments, the acidic solution is the same as the acidic solution originally contacted with the first lithium-enriched ion exchange material. In some embodiments, the acidic solution is the different from the acidic solution originally contacted with the first lithium-enriched ion exchange material.

In some embodiments, more protons are added to the lithium-enriched acidic solution, forming a protonated lithium-enriched acidic solution that is again contacted with a lithium-enriched ion exchange material to elute more lithium into the protonated lithium-enriched acidic solution. In some embodiments, more protons are added to the lithium-enriched acidic solution by adding an acid or acidic solution thereto to form the protonated lithium-enriched acidic solution. In some embodiments, protons are added to a lithium-enriched acidic solution before passing through each vessel in a network of lithium-selective ion exchange vessels, as described herein.

### Embodiments for Limiting or Eliminating Precipitation of Impurities in the Eluate Solution

In one embodiment, lithium and non-lithium impurities are absorbed from a lithium resource into an ion exchange material. In one embodiment, lithium and non-lithium impurities are eluted from an ion exchange material into an acidic solution. In one embodiment, lithium and non-lithium impurities are eluted from an ion exchange material into an acidic solution containing dissolved species that may precipitate at certain concentrations. In one embodiment, lithium and non-lithium impurities are eluted from an ion exchange material into an acidic solution containing dissolved species that may be (e.g., are) reduced in concentration to avoid precipitation. In one embodiment, lithium and non-lithium impurities are eluted from an ion exchange material into an acidic solution where said non-lithium impurities may precipitate (e.g., precipitate) at certain concentrations.

In one embodiment, lithium and multivalent impurities are absorbed from a lithium resource into an ion exchange material. In one embodiment, lithium and multivalent impurities are eluted from an ion exchange material into an acidic solution. In one embodiment, lithium and multivalent impurities are eluted from an ion exchange material into an acidic solution containing sulfate anions. In one embodiment, lithium and multivalent impurities are eluted from an ion exchange material into an acidic solution containing sulfate anions such that the multivalent impurities and sulfate anions may react to form insoluble salts that can precipitate. In one embodiment, lithium and multivalent impurities are eluted from an ion exchange material into a solution containing sulfate anions such that the multivalent impurities and sulfate anions that may react to form insoluble salts that can precipitate. In one embodiment, lithium and multivalent cations are eluted from an ion exchange material into a solution containing sulfate anions wherein the concentrations of sulfate anions and multivalent cations are limited to avoid precipitation of insoluble sulfate compounds.

In one embodiment, lithium and multivalent cations are eluted from an ion exchange material into a solution containing sulfate anions wherein the concentrations of multivalent cations are limited to avoid precipitation of insoluble sulfate compounds. In one embodiment, lithium and multivalent cations are eluted from an ion exchange material into a solution containing sulfate anions wherein the concentrations of multivalent cations are limited using nanofiltration to avoid precipitation of insoluble sulfate compounds. In one embodiment, lithium and multivalent cations are eluted from a first ion exchange material into a solution containing sulfate anions wherein the concentrations of multivalent cations are decreased using a second ion exchange material to avoid precipitation of insoluble sulfate compounds. In one embodiment, lithium and multivalent cations are eluted from a first ion exchange material into a solution containing sulfate anions wherein the concentrations of multivalent cations are limited using a second ion exchange material that is selective for multivalent cations to avoid precipitation of insoluble sulfate compounds.

In one embodiment, lithium and multivalent cations are eluted from an ion exchange material into a solution containing sulfate anions wherein the concentrations of multivalent cations are decreased to avoid precipitation of insoluble sulfate compounds. In one embodiment, lithium and multivalent cations are eluted from an ion exchange material into a solution containing sulfate anions and the concentration of multivalent cations in the sulfate solution is decreased to avoid precipitation of insoluble sulfate compounds.

In one embodiment, a sulfate solution is contacted with an ion exchange material to elute lithium along with impurities, the sulfate solution is processed to reduce the concentration of impurities, and the sulfate solution is again contacted with an ion exchange material to elute more lithium along with impurities. In one embodiment, a sulfate solution is contacted with an ion exchange material to elute lithium along with impurities, the sulfate solution is processed to reduce the concentration of multivalent cations, and the sulfate solution is again contacted with an ion exchange material to elute more lithium along with impurities. In one embodiment, a sulfate solution is contacted with an ion exchange material to elute lithium along with impurities, the sulfate solution is processed to reduce the concentration of multivalent cations, the sulfate solution is again contacted with an ion exchange material to elute more lithium along with impurities, and the concentration of multivalent cations is maintained at a sufficiently low level to avoid precipitation of insoluble salts.

In one embodiment, a sulfate solution is contacted with an ion exchange material to elute a target metal along with impurities, the sulfate solution is processed to reduce the concentration of impurities, and the sulfate solution is again contacted with an ion exchange material to elute more of the target metal along with impurities. In one embodiment, a sulfate solution is contacted with an ion exchange material to elute a target metal along with impurities, the sulfate solution is processed to reduce the concentration of multivalent cations, and the sulfate solution is again contacted with an ion exchange material to elute more of the target metal along with impurities. In one embodiment, a sulfate solution is contacted with an ion exchange material to elute a target metal along with impurities, the sulfate solution is processed to reduce the concentration of multivalent cations, the sulfate solution is again contacted with an ion exchange material to elute more of the target metal along with impurities, and the concentration of multivalent cations is maintained at a sufficiently low level to avoid precipitation of insoluble salts.

In one embodiment, an acidic sulfate solution is contacted with an ion exchange material to elute lithium along with impurities, the acidic sulfate solution is processed to reduce the concentration of impurities, and the acidic sulfate solution is again contacted with an ion exchange material to elute more lithium along with more impurities. In one embodiment, the pH of the acidic sulfate solution is regulated to control elution of lithium and/or impurities. In one embodiment, pH of the acidic sulfate solution is regulated by measuring pH with a pH probe and adding sulfuric acid and/or a solution containing sulfuric acid to the acidic sulfate solution. In one embodiment, pH of the acidic sulfate solution is regulated adding sulfuric acid and/or a solution containing sulfuric acid to the acidic sulfate solution.

In one embodiment, the sulfate solution used to elute lithium from the ion exchange material is replaced with a different solution. In one embodiment, the sulfate solution used to elute lithium from the ion exchange material is replaced with a solution comprising sulfate, nitrate, phosphate, chloride, bromide, fluoride, borate, iodide, carbonate, or combinations thereof. In one embodiment, a solution comprising anions is contacted with an ion exchange material to elute lithium along with impurities, the solution is processed to reduce the concentration of impurities, and the solution is again contacted with an ion exchange material to elute more lithium along with impurities, where the anions are selected from a list including sulfate, nitrate, phosphate, chloride, bromide, fluoride, borate, iodide, carbonate, or combinations thereof.

In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution to avoid the formation of precipitates. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic sulfate solution to elute lithium into the acidic solution, and multivalent impurities are removed from the acidic solution to avoid the formation of sulfate precipitates.

In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a unit for removing multivalent impurities before the acidic solution is returned to the fluidized bed. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a nanofiltration unit for selective removal of multivalent impurities, and then the acidic solution is returned to the fluidized bed. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a second ion exchange unit containing a second ion exchange material that is selective for removing multivalent impurities, and then the acidic solution is returned to the fluidized bed.

In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a unit for removing multivalent impurities before the acidic solution is passed to a second fluidized bed of ion exchange material for elution of more lithium into the acidic solution. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a nanofiltration unit for selective removal of multivalent impurities, and then the acidic solution is passed to a second fluidized bed of ion exchange material for elution of more lithium into the acidic solution. In one embodiment, a fluidized bed of ion exchange material is contacted with brine to absorb lithium from the brine into the ion exchange material, the fluidized bed of ion exchange material is optionally washed to remove residual brine from the ion exchange material, the fluidized bed of ion exchange material is contacted with an acidic solution to elute lithium into the acidic solution, and multivalent impurities are removed from the acidic solution by circulating the acidic solution from the fluidized bed to a second ion exchange unit containing a second ion exchange material that is selective for removing multivalent impurities, and then the acidic solution is passed to a second fluidized bed of ion exchange material for elution of more lithium into the acidic solution. In one embodiment, the acidic solution flows through multiple fluidized beds of ion exchange material for elution of lithium and impurities, and impurities are removed from the acidic solution between the multiple fluidized beds. In one embodiment, the acidic solution flows through multiple fluidized beds of ion exchange material for elution of lithium and impurities, and impurities are removed from the acidic solution between the multiple fluidized beds using nanofiltration. In one embodiment, the acidic solution flows through multiple fluidized beds of a first ion exchange material which is lithium-selective for elution of lithium and impurities, and impurities are removed from the acidic solution between the multiple fluidized beds using a second ion exchange material that is selective for multivalent ions.

In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution to avoid the formation of precipitates. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic sulfate solution to elute lithium into the acidic solution, and multivalent impurities are removed from the acidic solution to avoid the formation of sulfate precipitates.

In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a unit for removing multivalent impurities before the acidic solution is returned to the packed bed. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a nanofiltration unit for selective removal of multivalent impurities, and then the acidic solution is returned to the packed bed. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a second ion exchange unit containing a second ion exchange material that is selective for removing multivalent impurities, and then the acidic solution is returned to the packed bed.

In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a unit for removing multivalent impurities before the acidic solution is passed to a second packed bed of ion exchange material for elution of more lithium into the acidic solution. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a nanofiltration unit for selective removal of multivalent impurities, and then the acidic solution is passed to a second packed bed of ion exchange material for elution of more lithium into the acidic solution. In one embodiment, a packed bed of ion exchange material is contacted with brine to absorb lithium from the brine into the ion exchange material, the packed bed of ion exchange material is optionally washed to remove residual brine from the ion exchange material, the packed bed of ion exchange material is contacted with an acidic solution to elute lithium into the acidic solution, and multivalent impurities are removed from the acidic solution by circulating the acidic solution from the packed bed to a second ion exchange unit containing a second ion exchange material that is selective for removing multivalent impurities, and then the acidic solution is passed to a second packed bed of ion exchange material for elution of more lithium into the acidic solution. In one embodiment, the acidic solution flows through multiple packed beds of ion exchange material for elution of lithium and impurities, and impurities are removed from the acidic solution between the multiple packed beds. In one embodiment, the acidic solution flows through multiple packed beds of ion exchange material for elution of lithium and impurities, and impurities are removed from the acidic solution between the multiple packed beds using nanofiltration. In one embodiment, the acidic solution flows through multiple packed beds of a first ion exchange material which is lithium-selective for elution of lithium and impurities, and impurities are removed from the acidic solution between the multiple packed beds using a second ion exchange material that is selective for multivalent ions.

In some embodiments, the packed beds may be (e.g., are) partially or occasionally fluidized. In some embodiments, the fluidized beds may be (e.g., are) partially or occasionally packed. In some embodiments, the packed or fluidized beds may be (e.g., are) washed before and/or after contracting with brine and/or acid using water or washing solutions containing water, salt, chelating compounds, ethylenediaminetetraacetic acid, salt of ethylenediaminetetraacetate, compounds of ethylenediaminetetraacetate, and/or anti-scalants. In some embodiment, the acidic solution used to elute lithium from the lithium-selective ion exchange material may contain (e.g., contains) water, salt, chelating compounds, ethylenediaminetetraacetic acid, salt of ethylenediaminetetraacetate, compounds of ethylenediaminetetraacetate, and/or anti-scalants. In some embodiments, dilution water is used to limit and/or prevent formation of insoluble precipitates.

In some embodiments, multivalent impurities may be (e.g., are) removed from a lithium salt solution using precipitation. In some embodiments, multivalent impurities may be (e.g., are) removed from a lithium salt solution using precipitation through addition of base. In some embodiments, multivalent impurities may be (e.g., are) removed from a lithium salt solution using precipitation through addition of sodium hydroxide, sodium carbonate, and/or other compounds.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, and the lithium selective ion exchange material is contacted with an acidic solution to elute lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, more protons are added to the acidic solution, and the acidic solution is again contacted with the lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, more acid is added to the acidic solution, and the acidic solution is again contacted with the lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution in a first vessel, more protons are added to the acidic solution, and the acidic solution is again contacted with lithium selective ion exchange material to elute more lithium into the acidic solution in a second vessel. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution in a vessel, more protons are added to the acidic solution, and the acidic solution is again contacted with lithium selective ion exchange material to elute more lithium into the acidic solution in the vessel.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, impurities are removed from the acidic solution, more protons are added to the acidic solution, and the acidic solution is again contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, more protons are added to the acidic solution, impurities are removed from the acidic solution, and the acidic solution is again contacted with lithium selective ion exchange material to elute more lithium into the acidic solution.

In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, impurities are removed from the acidic solution using nanofiltration or multivalent-selective ion exchange materials, more protons are added to the acidic solution, and the acidic solution is again contacted with lithium selective ion exchange material to elute more lithium into the acidic solution. In some embodiments, a lithium selective ion exchange material is contacted with a liquid resource to load lithium onto the lithium selective ion exchange material, the lithium selective ion exchange material is optionally washed to remove residual liquid resource from the selective ion exchange material, lithium selective ion exchange material is contacted with an acidic solution to elute lithium into the acidic solution, more protons are added to the acidic solution, impurities are removed from the acidic solution using nanofiltration or multivalent-selective ion exchange materials, and the acidic solution is again contacted with lithium selective ion exchange material to elute more lithium into the acidic solution.

In some embodiments, an acidic solution is contacted with a lithium selective ion exchange material that has previously been loaded with lithium by contacting the lithium selective ion exchange material with a liquid resource, the acidic solution is treated to remove multivalent impurities, and the acidic solutions is again contacted with a lithium selective ion exchange material that has previously been loaded with lithium by contacting the lithium selective ion exchange material with a liquid resource. In some embodiments, an acidic solution is contacted with a lithium selective ion exchange material to elute lithium, the acidic solution is treated to remove multivalent impurities, and the acidic solutions is again contacted with a lithium selective ion exchange material to elute lithium. In some embodiments, an acidic solution is contacted with a lithium selective ion exchange material to elute lithium, the acidic solution is treated to remove multivalent impurities, more protons are added to the acidic solution, and the acidic solutions is again contacted with a lithium selective ion exchange material to elute lithium. In some embodiments, an acidic solution is contacted with a lithium selective ion exchange material to elute lithium, more protons are added to the acidic solution, the acidic solution is treated to remove multivalent impurities, and the acidic solutions is again contacted with a lithium selective ion exchange material to elute lithium. In some embodiments, an acidic solution is contacted with a lithium selective ion exchange material to elute lithium in a vessel, the acidic solution is treated to remove multivalent impurities, and the acidic solutions is contacted with a lithium selective ion exchange material to elute lithium in said vessel. In some embodiments, an acidic solution is contacted with a lithium selective ion exchange material to elute lithium in a first vessel, the acidic solution is treated to remove multivalent impurities, and the acidic solutions is contacted with a lithium selective ion exchange material to elute lithium in a second vessel. In some embodiments, multivalent impurities are removed with a multivalent cation selective ion exchange material. In some embodiments, multivalent impurities are removed using nanofiltration membranes. In some embodiments, the lithium selective ion exchange materials is in a tank, a column, or a stirred tank reactor. In some embodiments, the lithium selective ion exchange material is in a fixed or fluidized bed.

In some embodiments, an acidic solution is flowed through multiple vessels loaded with a lithium selective ion exchange material to elute lithium. In some embodiments, an acidic solution is flowed through multiple vessels loaded with a lithium selective ion exchange material to elute lithium and multivalent cation impurities are removed between the vessels. In some embodiments, an acidic solution is flowed through multiple vessels loaded with a lithium selective ion exchange material to elute lithium. In some embodiments, an acidic solution is flowed through multiple vessels loaded with a lithium selective ion exchange material to elute lithium, multivalent cation impurities are removed between the multiple vessels, and more protons are added to the acid solution between the multiple vessels. In some embodiments, an acidic solution is recirculated through a vessel loaded a lithium selective ion exchange material to elute lithium. In some embodiments, an acidic solution is recirculated through a vessel loaded a lithium selective ion exchange material to elute lithium and multivalent cation impurities are removed between the recirculations. In some embodiments, an acidic solution is recirculated through a vessel loaded a lithium selective ion exchange material to elute lithium, multivalent cation impurities are removed between the recirculations, and more protons are added to the acid solution between the recirculations.

In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, and the acidic solution is prepared in an acidic solution mixing unit. In one embodiment, the acidic solution mixing unit is a tank, an in-line mixing device, a stirred tank reactor, another mixing unit, or combinations thereof. In one embodiment, the acid solution mixing tank is used to service one vessel containing lithium selective ion exchange material. In one embodiment, the acid solution mixing tank is used to service multiple vessels containing lithium selective ion exchange material in parallel or series. In one embodiment, the acid solution mixing tank is used to service multiple vessels containing lithium selective ion exchange material in sequence.

In one embodiment, the acidic solution is comprised of sulfuric acid, phosphoric acid, hydrochloric acid, hydrobromic acid, carbonic acid, nitric acid, or combinations thereof. In one embodiment, lithium is eluted from a lithium selective ion exchange material using sulfuric acid, phosphoric acid, hydrochloric acid, nitric acid, or combinations thereof. In one embodiment, lithium is eluted from a lithium selective ion exchange material using an acid solution comprising sulfate, phosphate, nitrate, borate, or combinations thereof.

In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed using a combination of nanofiltration, multivalent cation selective ion exchange material, other methods of removing multivalent impurities, or combinations thereof. In one embodiment, impurities are removed from an acidic lithium solutions using combinations of nanofiltration, multivalent cation selective ion exchange material, other methods of removing multivalent impurities in parallel, series, or combinations thereof.

In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using nanofiltration membrane units arranged in series and/or parallel, more protons are added to the acidic solution, and the acid solutions is contacted with lithium selective ion exchange material to elute more lithium into the acidic solution. In one embodiment, anti-scalants, chelants, or other means of anti-scaling are used to avoid scaling in the nanofiltration membrane units.

In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange materials, more protons are added to the acidic solution, and the acid solutions is contacted with lithium selective ion exchange material to elute more lithium into the acidic solution. In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material in a packed bed, more protons are added to the acidic solution, and the acid solutions is contacted with lithium selective ion exchange material to elute more lithium into the acidic solution. In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material arranged in a network of columns, more protons are added to the acidic solution, and the acid solutions is contacted with lithium selective ion exchange material to elute more lithium into the acidic solution. In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material arranged in a network of columns with a first absorption column position for absorbing impurities and a last absorption column position for absorbing trace amounts of impurities, more protons are added to the acidic solution, and the acid solutions is contacted with lithium selective ion exchange material to elute more lithium into the acidic solution. In some embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution using multivalent cation selective ion exchange material arranged in a lead-lag configuration, and the acid solutions is contacted with lithium selective ion exchange material to elute more lithium into the acidic solution. In one embodiment, a multivalent cation selective ion exchange material is arranged in a variation of a lead-lag setup. In one embodiment, a multivalent cation selective ion exchange material is eluted using a second acidic solution. In one embodiment, a multivalent cation selective ion exchange material is eluted using hydrochloric acid. In one embodiment, a multivalent cation selective ion exchange material is regenerated using sodium hydroxide. In one embodiment, a multivalent cation selective ion exchange material is operated in stirred tank reactors, fluidized beds, or packed beds arranged in series and/or parallel. In one embodiment, a lithium selective ion exchange material is operated in stirred tank reactors, fluidized beds, or packed beds arranged in series and/or parallel.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution by adding phosphate to precipitate phosphate compounds, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are removed from the acidic solution by adding phosphoric acid to precipitate phosphate compounds, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, Ca, Mg, Sr, and/or Ba are removed from the acidic solution by adding phosphoric acid to precipitate Ca, Mg, Sr, and/or Ba phosphate compounds, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated from the acidic solution by adding oxalate, oxalic acid, citrate, citric acid, or combinations thereof, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated from the acidic solution by adding a precipitant comprising oxalate, oxalic acid, citrate, citric acid, or combinations thereof, the precipitant concentration is decreased by adding cations to the acidic solution, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated and removed from the acidic solution by adding oxalate, oxalate anions are precipitated and removed from the acidic solution by adding zinc, iron, manganese, other transition metals, other cations, or combinations thereof, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, multivalent impurities are precipitated and removed from the acidic solution by adding citrate, citrate anions are precipitated and removed from the acidic solution by adding cations, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, cation impurities are precipitated from the acidic solution by adding anion precipitants, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, cation impurities are precipitated and removed from the acidic solution by adding anion precipitants, the anions precipitants are precipitated and removed from the acidic solution by adding cation precipitants, more protons are added to the acidic solution, and the acid solutions is contacted with lithium selective ion exchange material to elute more lithium into the acidic solution.

In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are precipitated by temporarily reducing the temperature of the acidic solution, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are precipitated by changing the temperature of the acidic solution, more protons are added to the acidic solution, and the acid solutions is contacted with lithium selective ion exchange material to elute more lithium into the acidic solution. In one embodiment, a lithium selective ion exchange material is contacted with a liquid resource to load lithium onto the lithium selective ion exchange material, the lithium selective ion exchange material is optionally washed to remove residual liquid resource from the selective ion exchange material, the lithium selective ion exchange material is contacted with an acidic solution to elute lithium into the acidic solution, impurities are precipitated by decreasing the temperature of the acidic solution, protons are added to the acidic solution and the acidic solution is heated or allowed to warm, and the acid solutions is contacted with lithium selective ion exchange material to elute more lithium into the acidic solution.

In one embodiment, a chelating agent or anti-scalant is used to form a soluble complex to avoid precipitation in an acidic lithium solution. In one embodiment, a chelating agent or anti-scalant is used to form a soluble complex to avoid or redissolve precipitates. In one embodiment, a chelating agent or anti-scalants is used to limit or reduce precipitation of multivalent cations and the chelating agent or antiscalant is selected from the list of ethylenediaminetetraacetic acid (EDTA), disodium EDTA, calcium disodium EDTA, tetrasodium EDTA, citric acid, maleic acid, silicate compounds, amorphous silicate compounds, crystalline layered silicate compounds, phosphonic acid compounds, aminotris(methylenephosphonic acid) (ATMP), nitrilotrimethylphosphonic acid (NTMP), ethylenediamine tetra(methylene phosphonic acid) (EDTMP), diethylenetriamine penta(methylene phosphonic acid) (DTPMP), polyphosphonate, polyacrylate, polyacrylic acid, nitrilotriacetic acid (NTA), sodium hexametaphosphate (SHMP), or combinations thereof. In one embodiment, a threshold inhibitor is used to block development of nuclei in an acidic lithium solution. In one embodiment, a retarded is used to block the growth of precipitates in an acidic lithium solution. In one embodiment, compounds are used to limit, control, eliminate, or redissolve precipitates including phosphinopolycarboxylic acid, sulfonated polymer, polyacrylic acid, p-tagged sulfonated polymer, diethylenetriamine penta, bis-hexamethylene triamine, compounds thereof, modifications thereof, or combinations thereof.

In one embodiment, the acidic solution comprises lithium sulfate, lithium hydrogen sulfate, sulfuric acid, or combinations thereof. In one embodiment, the acidic solution comprises lithium sulfate, lithium hydrogen sulfate, sulfuric acid, lithium chloride, hydrochloric acid, lithium nitrate, nitric acid, lithium phosphate, lithium hydrogen phosphate, lithium dihydrogen phosphate, phosphoric acid, lithium bromide, bromic acid, or combinations thereof.

In some embodiments, lithium and other metals are recovered from the liquid resource. In some embodiments, the methods described for lithium recovery are applied to recover other metals.

Compositions of Eluates Produced by Lithium Extraction from a Liquid Resource Using Ion Exchange

Lithium extraction via any of the aforementioned methods produces an eluate enriched in lithium, whereby the majority of impurities in the liquid resource are rejected and a purified lithium stream is produced. The concentrated lithium solution is an aqueous solution comprising lithium and other dissolved ions, and is donated as an eluate. Said eluate is produced by treatment of an ion exchange material that has absorbed lithium with an acidic eluent to produce an eluent. Said eluent is acidic and contains lithium in combination with other cations and anions that are present in the liquid resource from which lithium is extracted.

Said eluent can be contacted with ion exchange material in one or more of the aforementioned ion exchange vessels to produce an eluate. Said eluate is stored in one or more different vessels that are part of an ion exchange network.

The concentration of lithium and other ions in solution vary depending on the liquid resource from which lithium is extracted. In some embodiments, the eluate is produced by contacting the lithiated ion exchange materials with an acidic solution which comprises sulfuric acid, phosphoric acid, hydrochloric acid, hydrobromic acid, carbonic acid, nitric acid, or combinations thereof. In one embodiment, lithium is eluted from a lithium selective ion exchange material using sulfuric acid, phosphoric acid, hydrochloric acid, nitric acid, or combinations thereof. In one embodiment, lithium is eluted from a lithium selective ion exchange material using an acid solution comprising sulfate, phosphate, nitrate, borate, or combinations thereof.

Exemplary embodiments of the present invention include compositions of the concentrated lithium eluate produced by contacting an acid with an ion exchange material lithiated by lithium from a liquid resource. In some embodiments, the concentrated lithium solution contains other ions, comprising but not limited to one or more ions of lithium, sodium, calcium, magnesium, potassium, boron, strontium, barium, zirconium, titanium, vanadium, iron, copper, manganese, molybdenum, aluminum, niobium, sulfate, chloride, fluoride, bromide, nitrate, carbonate, bicarbonate, hydrogencarbonate, phosphate, borate, mixtures thereof or combinations thereof.

In some embodiments, the concentration of lithium is greater than about 200.0 milligrams per liter and less than about 8000 milligrams per liter. In some embodiments, the concentration of lithium is greater than about 200 milligrams per liter and less than about 4000 milligrams per liter. In some embodiments, the concentration of lithium is greater than about 2000 milligrams per liter and less than about 8000 milligrams per liter. In some embodiments, the concentration of lithium is greater than about 200 milligrams per liter and less than about 1000 milligrams per liter. In some embodiments, the concentration of lithium is greater than about 200 milligrams per liter and less than about 500 milligrams per liter. In some embodiments, the concentration of lithium is greater than about 1000 milligrams per liter and less than about 4000 milligrams per liter. In some embodiments, the concentration of lithium is greater than about 1000.0 milligrams per liter and less than about 2000.0 milligrams per liter. In some embodiments, the concentration of lithium is greater than about 2000.0 milligrams per liter and less than about 3000.0 milligrams per liter. In some embodiments, the concentration of lithium is greater than about 3000.0 milligrams per liter and less than about 4000.0 milligrams per liter. In some embodiments, the concentration of lithium is greater than about 4000.0 milligrams per liter and less than about 5000.0 milligrams per liter. In some embodiments, the concentration of lithium is greater than about 5000.0 milligrams per liter and less than about 6000.0 milligrams per liter. In some embodiments, the concentration of lithium is greater than about 6000.0 milligrams per liter and less than about 8000.0 milligrams per liter. In some embodiments, the concentration of lithium is greater than about 8000.0 milligrams per liter and less than about 10000.0 milligrams per liter. In some embodiments, the concentration of lithium is greater than about 10000.0 milligrams per liter and less than about 12000.0 milligrams per liter. In some embodiments, the concentration of lithium is greater than about 12000.0 milligrams per liter and less than about 20000.0 milligrams per liter.

In some embodiments, the concentration of barium is greater than about 0.1 milligrams per liter and less than about 750 milligrams per liter. In some embodiments, the concentration of barium is greater than about 1 milligrams per liter and less than about 50 milligrams per liter. In some embodiments, the concentration of barium is greater than about 50 milligrams per liter and less than about 100 milligrams per liter. In some embodiments, the concentration of barium is greater than about 100 milligrams per liter and less than about 200 milligrams per liter. In some embodiments, the concentration of barium is greater than about 200 milligrams per liter and less than about 300 milligrams per liter. In some embodiments, the concentration of barium is greater than about 300 milligrams per liter and less than about 400 milligrams per liter. In some embodiments, the concentration of barium is greater than about 400.0 milligrams per liter and less than about 500.0 milligrams per liter. In some embodiments, the concentration of barium is greater than about 500.0 milligrams per liter and less than about 600.0 milligrams per liter. In some embodiments, the concentration of barium is greater than about 600.0 milligrams per liter and less than about 700.0 milligrams per liter. In some embodiments, the concentration of barium is greater than about 700.0 milligrams per liter and less than about 800.0 milligrams per liter.

In some embodiments, the concentration of boron is greater than about 10.0 milligrams per liter and less than about 5000 milligrams per liter. In some embodiments, the concentration of boron is greater than about 20 milligrams per liter and less than about 1000 milligrams per liter. In some embodiments, the concentration of boron is greater than about 1000 milligrams per liter and less than about 2000 milligrams per liter. In some embodiments, the concentration of boron is greater than about 2000 milligrams per liter and less than about 3000 milligrams per liter. In some embodiments, the concentration of boron is greater than about 3000 milligrams per liter and less than about 4000 milligrams per liter. In some embodiments, the concentration of boron is greater than about 4000 milligrams per liter and less than about 6000 milligrams per liter. In some embodiments, the concentration of boron is greater than about 10.0 milligrams per liter and less than about 500.0 milligrams per liter. In some embodiments, the concentration of boron is greater than about 500.0 milligrams per liter and less than about 1000.0 milligrams per liter. In some embodiments, the concentration of boron is greater than about 6000.0 milligrams per liter and less than about 10000.0 milligrams per liter.

In some embodiments, the concentration of calcium is greater than about 10.0 milligrams per liter and less than about 5000 milligrams per liter. In some embodiments, the concentration of calcium is greater than about 20 milligrams per liter and less than about 1000 milligrams per liter. In some embodiments, the concentration of calcium is greater than about 1000 milligrams per liter and less than about 2000 milligrams per liter. In some embodiments, the concentration of calcium is greater than about 2000 milligrams per liter and less than about 3000 milligrams per liter. In some embodiments, the concentration of calcium is greater than about 3000 milligrams per liter and less than about 4000 milligrams per liter. In some embodiments, the concentration of calcium is greater than about 4000 milligrams per liter and less than about 6000 milligrams per liter. In some embodiments, the concentration of calcium is greater than about 10.0 milligrams per liter and less than about 500.0 milligrams per liter. In some embodiments, the concentration of calcium is greater than about 500.0 milligrams per liter and less than about 1000.0 milligrams per liter. In some embodiments, the concentration of calcium is greater than about 6000.0 milligrams per liter and less than about 10000.0 milligrams per liter.

In some embodiments, the concentration of magnesium is greater than about 10.0 milligrams per liter and less than about 5000 milligrams per liter. In some embodiments, the concentration of magnesium is greater than about 20 milligrams per liter and less than about 1000 milligrams per liter. In some embodiments, the concentration of magnesium is greater than about 1000 milligrams per liter and less than about 2000 milligrams per liter. In some embodiments, the concentration of magnesium is greater than about 2000 milligrams per liter and less than about 3000 milligrams per liter. In some embodiments, the concentration of magnesium is greater than about 3000 milligrams per liter and less than about 4000 milligrams per liter. In some embodiments, the concentration of magnesium is greater than about 4000 milligrams per liter and less than about 6000 milligrams per liter. In some embodiments, the concentration of magnesium is greater than about 10.0 milligrams per liter and less than about 500.0 milligrams per liter. In some embodiments, the concentration of magnesium is greater than about 500.0 milligrams per liter and less than about 1000.0 milligrams per liter. In some embodiments, the concentration of magnesium is greater than about 6000.0 milligrams per liter and less than about 10000.0 milligrams per liter.

In some embodiments, the concentration of potassium is greater than about 10.0 milligrams per liter and less than about 5000 milligrams per liter. In some embodiments, the concentration of potassium is greater than about 20 milligrams per liter and less than about 1000 milligrams per liter. In some embodiments, the concentration of potassium is greater than about 1000 milligrams per liter and less than about 2000 milligrams per liter. In some embodiments, the concentration of potassium is greater than about 2000 milligrams per liter and less than about 3000 milligrams per liter. In some embodiments, the concentration of potassium is greater than about 3000 milligrams per liter and less than about 4000 milligrams per liter. In some embodiments, the concentration of potassium is greater than about 4000 milligrams per liter and less than about 6000 milligrams per liter. In some embodiments, the concentration of potassium is greater than about 10.0 milligrams per liter and less than about 500.0 milligrams per liter. In some embodiments, the concentration of potassium is greater than about 500.0 milligrams per liter and less than about 1000.0 milligrams per liter. In some embodiments, the concentration of potassium is greater than about 6000.0 milligrams per liter and less than about 10000.0 milligrams per liter.

In some embodiments, the concentration of sodium is greater than about 10.0 milligrams per liter and less than about 5000 milligrams per liter. In some embodiments, the concentration of sodium is greater than about 20 milligrams per liter and less than about 1000 milligrams per liter. In some embodiments, the concentration of sodium is greater than about 1000 milligrams per liter and less than about 2000 milligrams per liter. In some embodiments, the concentration of sodium is greater than about 2000 milligrams per liter and less than about 3000 milligrams per liter. In some embodiments, the concentration of sodium is greater than about 3000 milligrams per liter and less than about 4000 milligrams per liter. In some embodiments, the concentration of sodium is greater than about 4000 milligrams per liter and less than about 6000 milligrams per liter. In some embodiments, the concentration of sodium is greater than about 10.0 milligrams per liter and less than about 500.0 milligrams per liter. In some embodiments, the concentration of sodium is greater than about 500.0 milligrams per liter and less than about 1000.0 milligrams per liter. In some embodiments, the concentration of sodium is greater than about 6000.0 milligrams per liter and less than about 10000.0 milligrams per liter.

In some embodiments, the concentration of strontium is greater than about 10.0 milligrams per liter and less than about 5000 milligrams per liter. In some embodiments, the concentration of strontium is greater than about 20 milligrams per liter and less than about 1000 milligrams per liter. In some embodiments, the concentration of strontium is greater than about 1000 milligrams per liter and less than about 2000 milligrams per liter. In some embodiments, the concentration of strontium is greater than about 2000 milligrams per liter and less than about 3000 milligrams per liter. In some embodiments, the concentration of strontium is greater than about 3000 milligrams per liter and less than about 4000 milligrams per liter. In some embodiments, the concentration of strontium is greater than about 4000 milligrams per liter and less than about 6000 milligrams per liter. In some embodiments, the concentration of strontium is greater than about 10.0 milligrams per liter and less than about 500.0 milligrams per liter. In some embodiments, the concentration of strontium is greater than about 500.0 milligrams per liter and less than about 1000.0 milligrams per liter. In some embodiments, the concentration of strontium is greater than about 6000.0 milligrams per liter and less than about 10000.0 milligrams per liter.

In some embodiments, the concentration of aluminum is greater than about 0.1 milligrams per liter and less than about 750 milligrams per liter. In some embodiments, the concentration of aluminum is greater than about 1 milligrams per liter and less than about 50 milligrams per liter. In some embodiments, the concentration of aluminum is greater than about 50 milligrams per liter and less than about 100 milligrams per liter. In some embodiments, the concentration of aluminum is greater than about 100 milligrams per liter and less than about 200 milligrams per liter. In some embodiments, the concentration of aluminum is greater than about 200 milligrams per liter and less than about 300 milligrams per liter. In some embodiments, the concentration of aluminum is greater than about 300 milligrams per liter and less than about 400 milligrams per liter. In some embodiments, the concentration of aluminum is greater than about 400.0 milligrams per liter and less than about 500.0 milligrams per liter. In some embodiments, the concentration of aluminum is greater than about 500.0 milligrams per liter and less than about 600.0 milligrams per liter. In some embodiments, the concentration of aluminum is greater than about 600.0 milligrams per liter and less than about 700.0 milligrams per liter. In some embodiments, the concentration of aluminum is greater than about 700.0 milligrams per liter and less than about 800.0 milligrams per liter.

In some embodiments, the concentration of copper is greater than about 0.1 milligrams per liter and less than about 750 milligrams per liter. In some embodiments, the concentration of copper is greater than about 1 milligrams per liter and less than about 50 milligrams per liter. In some embodiments, the concentration of copper is greater than about 50 milligrams per liter and less than about 100 milligrams per liter. In some embodiments, the concentration of copper is greater than about 100 milligrams per liter and less than about 200 milligrams per liter. In some embodiments, the concentration of copper is greater than about 200 milligrams per liter and less than about 300 milligrams per liter. In some embodiments, the concentration of copper is greater than about 300 milligrams per liter and less than about 400 milligrams per liter. In some embodiments, the concentration of copper is greater than about 400.0 milligrams per liter and less than about 500.0 milligrams per liter. In some embodiments, the concentration of copper is greater than about 500.0 milligrams per liter and less than about 600.0 milligrams per liter. In some embodiments, the concentration of copper is greater than about 600.0 milligrams per liter and less than about 700.0 milligrams per liter. In some embodiments, the concentration of copper is greater than about 700.0 milligrams per liter and less than about 800.0 milligrams per liter.

In some embodiments, the concentration of iron is greater than about 0.1 milligrams per liter and less than about 750 milligrams per liter. In some embodiments, the concentration of iron is greater than about 1 milligrams per liter and less than about 50 milligrams per liter. In some embodiments, the concentration of iron is greater than about 50 milligrams per liter and less than about 100 milligrams per liter. In some embodiments, the concentration of iron is greater than about 100 milligrams per liter and less than about 200 milligrams per liter. In some embodiments, the concentration of iron is greater than about 200 milligrams per liter and less than about 300 milligrams per liter. In some embodiments, the concentration of iron is greater than about 300 milligrams per liter and less than about 400 milligrams per liter. In some embodiments, the concentration of iron is greater than about 400.0 milligrams per liter and less than about 500.0 milligrams per liter. In some embodiments, the concentration of iron is greater than about 500.0 milligrams per liter and less than about 600.0 milligrams per liter. In some embodiments, the concentration of iron is greater than about 600.0 milligrams per liter and less than about 700.0 milligrams per liter. In some embodiments, the concentration of iron is greater than about 700.0 milligrams per liter and less than about 800.0 milligrams per liter.

In some embodiments, the concentration of manganese is greater than about 0.1 milligrams per liter and less than about 750 milligrams per liter. In some embodiments, the concentration of manganese is greater than about 1 milligrams per liter and less than about 50 milligrams per liter. In some embodiments, the concentration of manganese is greater than about 50 milligrams per liter and less than about 100 milligrams per liter. In some embodiments, the concentration of manganese is greater than about 100 milligrams per liter and less than about 200 milligrams per liter. In some embodiments, the concentration of manganese is greater than about 200 milligrams per liter and less than about 300 milligrams per liter. In some embodiments, the concentration of manganese is greater than about 300 milligrams per liter and less than about 400 milligrams per liter. In some embodiments, the concentration of manganese is greater than about 400.0 milligrams per liter and less than about 500.0 milligrams per liter. In some embodiments, the concentration of manganese is greater than about 500.0 milligrams per liter and less than about 600.0 milligrams per liter. In some embodiments, the concentration of manganese is greater than about 600.0 milligrams per liter and less than about 700.0 milligrams per liter. In some embodiments, the concentration of manganese is greater than about 700.0 milligrams per liter and less than about 800.0 milligrams per liter.

In some embodiments, the concentration of molybdenum is greater than about 0.1 milligrams per liter and less than about 750 milligrams per liter. In some embodiments, the concentration of molybdenum is greater than about 1 milligrams per liter and less than about 50 milligrams per liter. In some embodiments, the concentration of molybdenum is greater than about 50 milligrams per liter and less than about 100 milligrams per liter. In some embodiments, the concentration of molybdenum is greater than about 100 milligrams per liter and less than about 200 milligrams per liter. In some embodiments, the concentration of molybdenum is greater than about 200 milligrams per liter and less than about 300 milligrams per liter. In some embodiments, the concentration of molybdenum is greater than about 300 milligrams per liter and less than about 400 milligrams per liter. In some embodiments, the concentration of molybdenum is greater than about 400.0 milligrams per liter and less than about 500.0 milligrams per liter. In some embodiments, the concentration of molybdenum is greater than about 500.0 milligrams per liter and less than about 600.0 milligrams per liter. In some embodiments, the concentration of molybdenum is greater than about 600.0 milligrams per liter and less than about 700.0 milligrams per liter. In some embodiments, the concentration of molybdenum is greater than about 700.0 milligrams per liter and less than about 800.0 milligrams per liter.

In some embodiments, the concentration of niobium is greater than about 0.1 milligrams per liter and less than about 750 milligrams per liter. In some embodiments, the concentration of niobium is greater than about 1 milligrams per liter and less than about 50 milligrams per liter. In some embodiments, the concentration of niobium is greater than about 50 milligrams per liter and less than about 100 milligrams per liter. In some embodiments, the concentration of niobium is greater than about 100 milligrams per liter and less than about 200 milligrams per liter. In some embodiments, the concentration of niobium is greater than about 200 milligrams per liter and less than about 300 milligrams per liter. In some embodiments, the concentration of niobium is greater than about 300 milligrams per liter and less than about 400 milligrams per liter. In some embodiments, the concentration of niobium is greater than about 400.0 milligrams per liter and less than about 500.0 milligrams per liter. In some embodiments, the concentration of niobium is greater than about 500.0 milligrams per liter and less than about 600.0 milligrams per liter. In some embodiments, the concentration of niobium is greater than about 600.0 milligrams per liter and less than about 700.0 milligrams per liter. In some embodiments, the concentration of niobium is greater than about 700.0 milligrams per liter and less than about 800.0 milligrams per liter.

In some embodiments, the concentration of titanium is greater than about 0.1 milligrams per liter and less than about 750 milligrams per liter. In some embodiments, the concentration of titanium is greater than about 1 milligrams per liter and less than about 50 milligrams per liter. In some embodiments, the concentration of titanium is greater than about 50 milligrams per liter and less than about 100 milligrams per liter. In some embodiments, the concentration of titanium is greater than about 100 milligrams per liter and less than about 200 milligrams per liter. In some embodiments, the concentration of titanium is greater than about 200 milligrams per liter and less than about 300 milligrams per liter. In some embodiments, the concentration of titanium is greater than about 300 milligrams per liter and less than about 400 milligrams per liter. In some embodiments, the concentration of titanium is greater than about 400.0 milligrams per liter and less than about 500.0 milligrams per liter. In some embodiments, the concentration of titanium is greater than about 500.0 milligrams per liter and less than about 600.0 milligrams per liter. In some embodiments, the concentration of titanium is greater than about 600.0 milligrams per liter and less than about 700.0 milligrams per liter. In some embodiments, the concentration of titanium is greater than about 700.0 milligrams per liter and less than about 800.0 milligrams per liter.

In some embodiments, the concentration of vanadium is greater than about 0.1 milligrams per liter and less than about 750 milligrams per liter. In some embodiments, the concentration of vanadium is greater than about 1 milligrams per liter and less than about 50 milligrams per liter. In some embodiments, the concentration of vanadium is greater than about 50 milligrams per liter and less than about 100 milligrams per liter. In some embodiments, the concentration of vanadium is greater than about 100 milligrams per liter and less than about 200 milligrams per liter. In some embodiments, the concentration of vanadium is greater than about 200 milligrams per liter and less than about 300 milligrams per liter. In some embodiments, the concentration of vanadium is greater than about 300 milligrams per liter and less than about 400 milligrams per liter. In some embodiments, the concentration of vanadium is greater than about 400.0 milligrams per liter and less than about 500.0 milligrams per liter. In some embodiments, the concentration of vanadium is greater than about 500.0 milligrams per liter and less than about 600.0 milligrams per liter. In some embodiments, the concentration of vanadium is greater than about 600.0 milligrams per liter and less than about 700.0 milligrams per liter. In some embodiments, the concentration of vanadium is greater than about 700.0 milligrams per liter and less than about 800.0 milligrams per liter.

In some embodiments, the concentration of zirconium is greater than about 0.1 milligrams per liter and less than about 750 milligrams per liter. In some embodiments, the concentration of zirconium is greater than about 1 milligrams per liter and less than about 50 milligrams per liter. In some embodiments, the concentration of zirconium is greater than about 50 milligrams per liter and less than about 100 milligrams per liter. In some embodiments, the concentration of zirconium is greater than about 100 milligrams per liter and less than about 200 milligrams per liter. In some embodiments, the concentration of zirconium is greater than about 200 milligrams per liter and less than about 300 milligrams per liter. In some embodiments, the concentration of zirconium is greater than about 300 milligrams per liter and less than about 400 milligrams per liter. In some embodiments, the concentration of zirconium is greater than about 400.0 milligrams per liter and less than about 500.0 milligrams per liter. In some embodiments, the concentration of zirconium is greater than about 500.0 milligrams per liter and less than about 600.0 milligrams per liter. In some embodiments, the concentration of zirconium is greater than about 600.0 milligrams per liter and less than about 700.0 milligrams per liter. In some embodiments, the concentration of zirconium is greater than about 700.0 milligrams per liter and less than about 800.0 milligrams per liter.

In some embodiments, the concentration of bicarbonate is greater than about 1000.0 milligrams per liter and less than about 30000 milligrams per liter. In some embodiments, the concentration of bicarbonate is greater than about 10 milligrams per liter and less than about 100 milligrams per liter. In some embodiments, the concentration of bicarbonate is greater than about 100 milligrams per liter and less than about 500 milligrams per liter. In some embodiments, the concentration of bicarbonate is greater than about 500 milligrams per liter and less than about 1000 milligrams per liter. In some embodiments, the concentration of bicarbonate is greater than about 1000 milligrams per liter and less than about 5000 milligrams per liter. In some embodiments, the concentration of bicarbonate is greater than about 5000 milligrams per liter and less than about 10000 milligrams per liter. In some embodiments, the concentration of bicarbonate is greater than about 10000.0 milligrams per liter and less than about 50000.0 milligrams per liter. In some embodiments, the concentration of bicarbonate is greater than about 50000.0 milligrams per liter and less than about 100000.0 milligrams per liter. In some embodiments, the concentration of bicarbonate is greater than about 100000.0 milligrams per liter and less than about 200000.0 milligrams per liter. In some embodiments, the concentration of bicarbonate is greater than about 200000.0 milligrams per liter and less than about 300000.0 milligrams per liter. In some embodiments, the concentration of bicarbonate is greater than about 300000.0 milligrams per liter and less than about 500000.0 milligrams per liter.

In some embodiments, the concentration of borate is greater than about 1000.0 milligrams per liter and less than about 30000 milligrams per liter. In some embodiments, the concentration of borate is greater than about 10 milligrams per liter and less than about 100 milligrams per liter. In some embodiments, the concentration of borate is greater than about 100 milligrams per liter and less than about 500 milligrams per liter. In some embodiments, the concentration of borate is greater than about 500 milligrams per liter and less than about 1000 milligrams per liter. In some embodiments, the concentration of borate is greater than about 1000 milligrams per liter and less than about 5000 milligrams per liter. In some embodiments, the concentration of borate is greater than about 5000 milligrams per liter and less than about 10000 milligrams per liter. In some embodiments, the concentration of borate is greater than about 10000.0 milligrams per liter and less than about 50000.0 milligrams per liter. In some embodiments, the concentration of borate is greater than about 50000.0 milligrams per liter and less than about 100000.0 milligrams per liter. In some embodiments, the concentration of borate is greater than about 100000.0 milligrams per liter and less than about 200000.0 milligrams per liter. In some embodiments, the concentration of borate is greater than about 200000.0 milligrams per liter and less than about 300000.0 milligrams per liter. In some embodiments, the concentration of borate is greater than about 300000.0 milligrams per liter and less than about 500000.0 milligrams per liter.

In some embodiments, the concentration of bromide is greater than about 1000.0 milligrams per liter and less than about 30000 milligrams per liter. In some embodiments, the concentration of bromide is greater than about 10 milligrams per liter and less than about 100 milligrams per liter. In some embodiments, the concentration of bromide is greater than about 100 milligrams per liter and less than about 500 milligrams per liter. In some embodiments, the concentration of bromide is greater than about 500 milligrams per liter and less than about 1000 milligrams per liter. In some embodiments, the concentration of bromide is greater than about 1000 milligrams per liter and less than about 5000 milligrams per liter. In some embodiments, the concentration of bromide is greater than about 5000 milligrams per liter and less than about 10000 milligrams per liter. In some embodiments, the concentration of bromide is greater than about 10000.0 milligrams per liter and less than about 50000.0 milligrams per liter. In some embodiments, the concentration of bromide is greater than about 50000.0 milligrams per liter and less than about 100000.0 milligrams per liter. In some embodiments, the concentration of bromide is greater than about 100000.0 milligrams per liter and less than about 200000.0 milligrams per liter. In some embodiments, the concentration of bromide is greater than about 200000.0 milligrams per liter and less than about 300000.0 milligrams per liter. In some embodiments, the concentration of bromide is greater than about 300000.0 milligrams per liter and less than about 500000.0 milligrams per liter.

In some embodiments, the concentration of carbonate is greater than about 1000.0 milligrams per liter and less than about 30000 milligrams per liter. In some embodiments, the concentration of carbonate is greater than about 10 milligrams per liter and less than about 100 milligrams per liter. In some embodiments, the concentration of carbonate is greater than about 100 milligrams per liter and less than about 500 milligrams per liter. In some embodiments, the concentration of carbonate is greater than about 500 milligrams per liter and less than about 1000 milligrams per liter. In some embodiments, the concentration of carbonate is greater than about 1000 milligrams per liter and less than about 5000 milligrams per liter. In some embodiments, the concentration of carbonate is greater than about 5000 milligrams per liter and less than about 10000 milligrams per liter. In some embodiments, the concentration of carbonate is greater than about 10000.0 milligrams per liter and less than about 50000.0 milligrams per liter. In some embodiments, the concentration of carbonate is greater than about 50000.0 milligrams per liter and less than about 100000.0 milligrams per liter. In some embodiments, the concentration of carbonate is greater than about 100000.0 milligrams per liter and less than about 200000.0 milligrams per liter. In some embodiments, the concentration of carbonate is greater than about 200000.0 milligrams per liter and less than about 300000.0 milligrams per liter. In some embodiments, the concentration of carbonate is greater than about 300000.0 milligrams per liter and less than about 500000.0 milligrams per liter.

In some embodiments, the concentration of chloride is greater than about 1000.0 milligrams per liter and less than about 30000 milligrams per liter. In some embodiments, the concentration of chloride is greater than about 10 milligrams per liter and less than about 100 milligrams per liter. In some embodiments, the concentration of chloride is greater than about 100 milligrams per liter and less than about 500 milligrams per liter. In some embodiments, the concentration of chloride is greater than about 500 milligrams per liter and less than about 1000 milligrams per liter. In some embodiments, the concentration of chloride is greater than about 1000 milligrams per liter and less than about 5000 milligrams per liter. In some embodiments, the concentration of chloride is greater than about 5000 milligrams per liter and less than about 10000 milligrams per liter. In some embodiments, the concentration of chloride is greater than about 10000.0 milligrams per liter and less than about 50000.0 milligrams per liter. In some embodiments, the concentration of chloride is greater than about 50000.0 milligrams per liter and less than about 100000.0 milligrams per liter. In some embodiments, the concentration of chloride is greater than about 100000.0 milligrams per liter and less than about 200000.0 milligrams per liter. In some embodiments, the concentration of chloride is greater than about 200000.0 milligrams per liter and less than about 300000.0 milligrams per liter. In some embodiments, the concentration of chloride is greater than about 300000.0 milligrams per liter and less than about 500000.0 milligrams per liter.

In some embodiments, the concentration of fluoride is greater than about 1000.0 milligrams per liter and less than about 30000 milligrams per liter. In some embodiments, the concentration of fluoride is greater than about 10 milligrams per liter and less than about 100 milligrams per liter. In some embodiments, the concentration of fluoride is greater than about 100 milligrams per liter and less than about 500 milligrams per liter. In some embodiments, the concentration of fluoride is greater than about 500 milligrams per liter and less than about 1000 milligrams per liter. In some embodiments, the concentration of fluoride is greater than about 1000 milligrams per liter and less than about 5000 milligrams per liter. In some embodiments, the concentration of fluoride is greater than about 5000 milligrams per liter and less than about 10000 milligrams per liter. In some embodiments, the concentration of fluoride is greater than about 10000.0 milligrams per liter and less than about 50000.0 milligrams per liter. In some embodiments, the concentration of fluoride is greater than about 50000.0 milligrams per liter and less than about 100000.0 milligrams per liter. In some embodiments, the concentration of fluoride is greater than about 100000.0 milligrams per liter and less than about 200000.0 milligrams per liter. In some embodiments, the concentration of fluoride is greater than about 200000.0 milligrams per liter and less than about 300000.0 milligrams per liter. In some embodiments, the concentration of fluoride is greater than about 300000.0 milligrams per liter and less than about 500000.0 milligrams per liter.

In some embodiments, the concentration of hydrogencarbonate is greater than about 1000.0 milligrams per liter and less than about 30000 milligrams per liter. In some embodiments, the concentration of hydrogencarbonate is greater than about 10 milligrams per liter and less than about 100 milligrams per liter. In some embodiments, the concentration of hydrogencarbonate is greater than about 100 milligrams per liter and less than about 500 milligrams per liter. In some embodiments, the concentration of hydrogencarbonate is greater than about 500 milligrams per liter and less than about 1000 milligrams per liter. In some embodiments, the concentration of hydrogencarbonate is greater than about 1000 milligrams per liter and less than about 5000 milligrams per liter. In some embodiments, the concentration of hydrogencarbonate is greater than about 5000 milligrams per liter and less than about 10000 milligrams per liter. In some embodiments, the concentration of hydrogencarbonate is greater than about 10000.0 milligrams per liter and less than about 50000.0 milligrams per liter. In some embodiments, the concentration of hydrogencarbonate is greater than about 50000.0 milligrams per liter and less than about 100000.0 milligrams per liter. In some embodiments, the concentration of hydrogencarbonate is greater than about 100000.0 milligrams per liter and less than about 200000.0 milligrams per liter. In some embodiments, the concentration of hydrogencarbonate is greater than about 200000.0 milligrams per liter and less than about 300000.0 milligrams per liter. In some embodiments, the concentration of hydrogencarbonate is greater than about 300000.0 milligrams per liter and less than about 500000.0 milligrams per liter.

In some embodiments, the concentration of nitrate is greater than about 1000.0 milligrams per liter and less than about 30000 milligrams per liter. In some embodiments, the concentration of nitrate is greater than about 10 milligrams per liter and less than about 100 milligrams per liter. In some embodiments, the concentration of nitrate is greater than about 100 milligrams per liter and less than about 500 milligrams per liter. In some embodiments, the concentration of nitrate is greater than about 500 milligrams per liter and less than about 1000 milligrams per liter. In some embodiments, the concentration of nitrate is greater than about 1000 milligrams per liter and less than about 5000 milligrams per liter. In some embodiments, the concentration of nitrate is greater than about 5000 milligrams per liter and less than about 10000 milligrams per liter. In some embodiments, the concentration of nitrate is greater than about 10000.0 milligrams per liter and less than about 50000.0 milligrams per liter. In some embodiments, the concentration of nitrate is greater than about 50000.0 milligrams per liter and less than about 100000.0 milligrams per liter. In some embodiments, the concentration of nitrate is greater than about 100000.0 milligrams per liter and less than about 200000.0 milligrams per liter. In some embodiments, the concentration of nitrate is greater than about 200000.0 milligrams per liter and less than about 300000.0 milligrams per liter. In some embodiments, the concentration of nitrate is greater than about 300000.0 milligrams per liter and less than about 500000.0 milligrams per liter.

In some embodiments, the concentration of phosphate is greater than about 1000.0 milligrams per liter and less than about 30000 milligrams per liter. In some embodiments, the concentration of phosphate is greater than about 10 milligrams per liter and less than about 100 milligrams per liter. In some embodiments, the concentration of phosphate is greater than about 100 milligrams per liter and less than about 500 milligrams per liter. In some embodiments, the concentration of phosphate is greater than about 500 milligrams per liter and less than about 1000 milligrams per liter. In some embodiments, the concentration of phosphate is greater than about 1000 milligrams per liter and less than about 5000 milligrams per liter. In some embodiments, the concentration of phosphate is greater than about 5000 milligrams per liter and less than about 10000 milligrams per liter. In some embodiments, the concentration of phosphate is greater than about 10000.0 milligrams per liter and less than about 50000.0 milligrams per liter. In some embodiments, the concentration of phosphate is greater than about 50000.0 milligrams per liter and less than about 100000.0 milligrams per liter. In some embodiments, the concentration of phosphate is greater than about 100000.0 milligrams per liter and less than about 200000.0 milligrams per liter. In some embodiments, the concentration of phosphate is greater than about 200000.0 milligrams per liter and less than about 300000.0 milligrams per liter. In some embodiments, the concentration of phosphate is greater than about 300000.0 milligrams per liter and less than about 500000.0 milligrams per liter.

In some embodiments, the concentration of sulfate is greater than about 1000.0 milligrams per liter and less than about 30000 milligrams per liter. In some embodiments, the concentration of sulfate is greater than about 10 milligrams per liter and less than about 100 milligrams per liter. In some embodiments, the concentration of sulfate is greater than about 100 milligrams per liter and less than about 500 milligrams per liter. In some embodiments, the concentration of sulfate is greater than about 500 milligrams per liter and less than about 1000 milligrams per liter. In some embodiments, the concentration of sulfate is greater than about 1000 milligrams per liter and less than about 5000 milligrams per liter. In some embodiments, the concentration of sulfate is greater than about 5000 milligrams per liter and less than about 10000 milligrams per liter. In some embodiments, the concentration of sulfate is greater than about 10000.0 milligrams per liter and less than about 50000.0 milligrams per liter. In some embodiments, the concentration of sulfate is greater than about 50000.0 milligrams per liter and less than about 100000.0 milligrams per liter. In some embodiments, the concentration of sulfate is greater than about 100000.0 milligrams per liter and less than about 200000.0 milligrams per liter. In some embodiments, the concentration of sulfate is greater than about 200000.0 milligrams per liter and less than about 300000.0 milligrams per liter. In some embodiments, the concentration of sulfate is greater than about 300000.0 milligrams per liter and less than about 500000.0 milligrams per liter.

In some embodiments, the value of pH is greater than about 1.0 and less than about 4.0. In some embodiments, the value of pH is greater than about 0.0 and less than about 1.0. In some embodiments, the value of pH is greater than about 1.0 and less than about 2.0. In some embodiments, the value of pH is greater than about 2.0 and less than about 3.0. In some embodiments, the value of pH is greater than about 3.0 and less than about 4.0. In some embodiments, the value of pH is greater than about 4.0 and less than about 5.0. In some embodiments, the value of pH is greater than about 5.0 and less than about 6.0. In some embodiments, the value of pH is greater than about 6.0 and less than about 7.0. In some embodiments, the value of pH is greater than about 7.0 and less than about 8.0. In some embodiments, the value of pH is greater than about 8.0 and less than about 9.0. In some embodiments, the value of pH is greater than about 9.0 and less than about 10.0. In some embodiments, the value of pH is greater than about 10.0 and less than about 11.0. In some embodiments, the value of pH is greater than about 11.0 and less than about 12.0.

In some embodiments, the value of oxidation-reduction potential is greater than about 50.0 m V and less than about 800.0 mV. In some embodiments, the value of oxidation-reduction potential is greater than about 100.0 mV and less than about 500.0 mV. In some embodiments, the value of oxidation-reduction potential is greater than about 200.0 mV and less than about 400.0 mV. In some embodiments, the value of oxidation-reduction potential is greater than about −450.0 mV and less than about 0.0 mV. In some embodiments, the value of oxidation-reduction potential is greater than about −200.0 mV and less than about 50.0 mV. In some embodiments, the value of oxidation-reduction potential is greater than about −50.0 mV and less than about 100.0 mV. In some embodiments, the value of oxidation-reduction potential is greater than about 50.0 m V and less than about 300.0 mV. In some embodiments, the value of oxidation-reduction potential is greater than about 100.0 mV and less than about 400.0 mV. In some embodiments, the value of oxidation-reduction potential is greater than about 200.0 mV and less than about 600.0 mV. In some embodiments, the value of oxidation-reduction potential is greater than about 300.0 mV and less than about 800.0 mV. In some embodiments, the value of oxidation-reduction potential is greater than about 500.0 m V and less than about 1000.0 mV. In some embodiments, the value of oxidation-reduction potential is greater than about 750.0 m V and less than about 1100.0 mV.

Treatment of the Eluate Produced from Lithium Extraction to Produce Lithium Products

In some embodiments, the lithium eluate solution that is yielded from the ion exchange reactor is further processed into lithium chemicals selected from the following list: lithium sulfate, lithium chloride, lithium carbonate, lithium phosphate, lithium hydroxide, lithium metal, lithium metal oxide, lithium metal phosphate, lithium sulfide, or combinations thereof. In some embodiments, the lithium eluate solution that is yielded from the ion exchange reactor is further processed into lithium chemicals that are solid, aqueous, liquid, slurry form, hydrated, or anhydrous.

In some embodiments, the lithium eluate solution that is yielded from the ion exchange reactor is further processed using acid recovery, acid recycling, acid regeneration, distillation, reverse osmosis, evaporation, purification, chemical precipitation, membrane electrolysis, or combinations thereof. In some embodiments the lithium eluate (e.g., the synthetic lithium solution) is purified using a purification unit. In some embodiments, the purification unit configured to purify the synthetic lithium solution. In some embodiments, the purification unit configured to purify the synthetic lithium solution and further configured to modify the pH of the synthetic lithium solution. In some embodiments, the purification unit comprises a water removal unit. In some embodiments, the water removal unit is configured to concentrate the synthetic lithium solution.

In some embodiments, the lithium eluate is purified using hydroxide precipitation, carbonate precipitation, other precipitate, ion exchange, solvent extraction, and/or other extraction methods to remove divalent ions, multivalent ions, boron, or other chemical species. In some embodiments, the lithium eluate is concentrated using reverse osmosis, mechanical evaporation, mechanical vapor recompression, solar thermal heating, concentrated solar thermal heating, and/or solar evaporation.

In some embodiments, a lithium eluate is processed into a lithium stream that is treated with sodium carbonate to precipitate lithium carbonate. In some embodiments, a lithium chloride stream is treated with sodium carbonate to precipitate lithium carbonate. In some embodiments, a lithium sulfate stream is treated with sodium carbonate to precipitate lithium carbonate. In some embodiments, a lithium nitrate stream is treated with sodium carbonate to precipitate lithium carbonate.

In some embodiments, a lithium eluate is processed into a lithium stream that is treated with sodium hydroxide to crystallize a lithium hydroxide product. In some embodiments, a lithium sulfate stream is treated with sodium hydroxide to crystallize a lithium hydroxide product. In some embodiments, a lithium chloride stream is treated with sodium hydroxide to crystallize a lithium hydroxide product. In some embodiments, a lithium nitrate stream is treated with sodium hydroxide to crystallize a lithium hydroxide product.

### Removal of Impurities

In some embodiments, impurities are removed from an IEL eluate and/or new IEL eluate using an impurities selective ion exchange material, nanofiltration, chemical precipitation, electrochemical separation, temperature reduction precipitation, other methods of removing impurities, or combinations thereof. In some embodiments, impurities are removed using combinations of impurities selective ion exchange material, nanofiltration, chemical precipitation, electrochemical separation, temperature reduction precipitation, other methods of removing multivalent impurities, or combinations thereof, in parallel, in series, or combinations thereof. In some embodiments, the purification unit is configured to remove impurities from the synthetic lithium solution using an impurities selective ion exchange material, nanofiltration, chemical precipitation, electrochemical separation, temperature reduction precipitation, other methods of removing impurities, or combinations thereof.

### Impurities Selective Ion Exchange Material

In some embodiments, for any lithium extraction process or system described herein, impurities are at least removed by contacting an impurities-enriched lithiated (IEL) acidic solution (e.g., a lithium eluate, a synthetic lithium solution) with an impurities selective ion exchange material. In some embodiments, impurities selective ion exchange material comprises multivalent impurities selective ion exchange material. In some embodiments, the multivalent impurities selective ion exchange material comprises multivalent cation selective (MCS) ion exchange material. In some embodiments, MCS ion exchange material is provided in a packed bed. In some embodiments, MCS ion exchange material is provided in a fluidized bed. In some embodiments, MCS ion exchange material is located in a MCS vessel. In some embodiments, MCS ion exchange material is arranged in a network of MCS vessels. In some embodiments, MCS ion exchange material is arranged in a network of MCS vessels, wherein IEL acidic solution is sequentially passed through the network of MCS vessels, such that multivalent cations are absorbed from the IEL acidic solution as it passes through each MCS vessel. In some embodiments, the amount of multivalent cations absorbed from a IEL acidic solution passing through a network of MCS vessels decreases from a first MCS vessel in the sequence of IEL acidic solution flow to a last MCS vessel in said sequence. In some embodiments, the last MCS vessel in said sequence absorbs trace amounts of multivalent cations. In some embodiments, the sequence of the plurality of MCS vessels is rearranged based on the saturation of the MCS ion exchange material in each MCS vessel. In some embodiments, MCS ion exchange material is arranged in a lead-lag configuration. In some embodiments, the MCS ion exchange material is arranged in a variation of a lead-lag setup. In some embodiments, the MCS ion exchange material is eluted using a second acidic solution. In some embodiments, the MCS ion exchange material is eluted using hydrochloric acid. In some embodiments, the MCS ion exchange material is regenerated using sodium hydroxide, potassium hydroxide, or a combination thereof. In some embodiments, the MCS ion exchange material is provided in one or more stirred tank reactors, tanks, columns, fluidized beds, packed beds, or combinations thereof, and arranged in series and/or parallel.

In one embodiment, a multivalent cation selective (MCS) ion exchange material is selective for cations with a charge of 2+, 3+, 4+, 5+, 6+, or combinations thereof.

In one embodiment, the multivalent selective cation exchange material is comprised of polystyrene, polybutadiene, mixtures thereof, modifications thereof, or combinations thereof. In one embodiment, the multivalent selective cation exchange material is comprised of poly styrene, polystyrene functionalized with sulfonate, polystyrene-polybutadiene copolymer functionalized with sulfonate group and/or phosphonate group, poly(2-acrylamido-2-methyl-1-propanesulfonic acid) (Poly AMPS), poly(styrene-co-divinylbenzene) copolymer functionalized with sulfonate group, phosphonate group, iminodiacetic group, carboxylic acid group, mixtures thereof, modifications thereof, or combinations thereof. In one embodiment, the ion exchange material for impurity removal is comprised of polystyrene, polybutadiene, mixtures thereof, modifications thereof, or combinations thereof. In one embodiment, the ion exchange material for impurity removal is comprised of polystyrene, polybutadiene, poly divinyl benzene, divinyl benzene, polystyrene functionalized with sulfonate, polystyrene-polybutadiene copolymer functionalized with sulfonate group and/or phosphonate group, poly(2-acrylamido-2-methyl-1-propanesulfonic acid) (Poly AMPS), poly(styrene-co-divinylbenzene) copolymer functionalized with sulfonate group, phosphonate group, iminodiacetic group, carboxylic acid group, mixtures thereof, modifications thereof, or combinations thereof. In one embodiment, the multivalent selective cation exchange material is comprised of a zeolite, clinoptilolite, bentonite, glauconite, mixtures thereof, modifications thereof, or combinations thereof. In one embodiment, the ion exchange material for impurity removal is comprised a strong acidic cation exchange resin. In one embodiment, a strong acidic cation exchange resin is used to remove multivalent cations from an acidic solution containing lithium. In one embodiment, the ion exchange material for impurity removal is comprised a gel-type strong acidic cation exchange resin. In one embodiment, a gel-type strong acidic cation exchange resin is used to remove multivalent cations from an acidic solution containing lithium. In one embodiment, the ion exchange material for impurity removal is comprised a gel-type strong acidic cation exchange resin with a gaussian, narrow, or other particle size distribution. In one embodiment, the ion exchange material for impurity removal is operated in co-flow or counter-flow. In one embodiment, the ion exchange material for impurity removal is contacted with alternating flows of acidic eluate solution containing lithium and impurities, and flows of hydrochloric acid solution. In one embodiment, the ion exchange material for impurity removal is contacted with alternating flows of acidic eluate solution containing lithium and impurities, and flows of hydrochloric acid solution in the same or opposite directions.

In one embodiment, the ion exchange material for impurity removal from the acidic lithium solution (e.g., impurities-enriched lithiated (IEL) acidic solution, as described herein) is a styrene divinylbenzene copolymer. In one embodiment, the ion exchange material for impurity removal from the acidic lithium solution is a styrene divinylbenzene copolymer with sulfonic acid functional groups. In one embodiment, the ion exchange material for impurity removal from the acidic lithium solution is a styrene copolymer with sulfonic acid functional groups. In one embodiment, the ion exchange material for impurity removal from the acidic lithium solution is a styrene butadiene copolymer with sulfonic acid functional groups. In one embodiment, the ion exchange material for impurity removal comprises beads with a mean diameter of about 10-50 microns, 50-100 microns, 100-200 microns, 200-400 microns, 300-500 microns, 400-600 microns, 600-800 microns, 200-500 microns, 400-800 microns, 500-1000 microns, 800-1600 microns, or 1000-2000 microns. In one embodiment, the ion exchange material for selective lithium extraction from the liquid resources comprises beads with a mean diameter of about 10-50 microns, 50-100 microns, 100-200 microns, 200-400 microns, 300-500 microns, 400-600 microns, 600-800 microns, 200-500 microns, 400-800 microns, 500-1000 microns, 800-1600 microns, or 1000-2000 microns.

In one embodiment, the ion exchange material for impurity removal from the acidic lithium solution is a copolymer of styrene, divinylbenzene, butadiene, or combinations thereof. In one embodiment, the ion exchange material for impurity removal from the acidic lithium solution is a mixture of styrene, divinylbenzene, butadiene, or combinations thereof.

In one embodiment, the ion exchange material for impurity removal from the acidic lithium solution is a copolymer of styrene, divinylbenzene, butadiene, or combinations thereof functionalized with sulfonic-acid groups. In one embodiment, the ion exchange material for impurity removal from the acidic lithium solution is a mixture of styrene, divinylbenzene, butadiene, or combinations thereof functionalized with sulfonic-acid groups.

In one embodiment, the ion exchange material for impurity removal from the acidic lithium solution is a copolymer of styrene, divinylbenzene, butadiene, or combinations thereof functionalized with phosphonic-acid groups. In one embodiment, the ion exchange material for impurity removal from the acidic lithium solution is a mixture of styrene, divinylbenzene, butadiene, or combinations thereof functionalized with phosphonic-acid groups.

In one embodiment, the ion exchange material for impurity removal from the acidic lithium solution is a copolymer functionalized with sulfonic-acid groups. In one embodiment, the ion exchange material for impurity removal from the acidic lithium solution is a polymer functionalized with sulfonic-acid groups.

In one embodiment, the ion exchange material for impurity removal from the acidic lithium solution is a copolymer functionalized with phosphonic-acid groups. In one embodiment, the ion exchange material for impurity removal from the acidic lithium solution is a polymer functionalized with phosphonic-acid groups.

In one embodiment, the ion exchange material for impurity removal from the acidic lithium solution is a styrene-divinylbenzene copolymer functionalized with sulfonic acid groups. In one embodiment, the ion exchange material for impurity removal from the acidic lithium solution is a styrene-butadiene copolymer functionalized with sulfonic acid groups. In one embodiment, the ion exchange material for impurity removal from the acidic lithium solution is a divinylbenzene-butadiene copolymer functionalized with sulfonic acid groups. In one embodiment, the ion exchange material for impurity removal from the acidic lithium solution is a styrene-butadiene-divinylbenzene copolymer functionalized with sulfonic acid groups.

In one embodiment, the ion exchange material for impurity removal from the acidic lithium solution is a styrene-divinylbenzene copolymer functionalized with phosphonic acid groups. In one embodiment, the ion exchange material for impurity removal from the acidic lithium solution is a styrene-butadiene copolymer functionalized with phosphonic acid groups. In one embodiment, the ion exchange material for impurity removal from the acidic lithium solution is a divinylbenzene-butadiene copolymer functionalized with phosphonic acid groups. In one embodiment, the ion exchange material for impurity removal from the acidic lithium solution is a styrene-butadiene-divinylbenzene copolymer functionalized with phosphonic acid groups.

In one embodiment, the ion exchange material for impurity removal from the acidic lithium solution is a vinylbenzene copolymer functionalized with sulfonic acid or phosphonic acid groups. In one embodiment, the ion exchange material for impurity removal from the acidic lithium solution is a vinylbenzene chloride copolymer functionalized with sulfonic acid or phosphonic acid groups. In one embodiment, the ion exchange material for impurity removal from the acidic lithium solution is a vinylidene copolymer functionalized with sulfonic acid or phosphonic acid groups. In one embodiment, the ion exchange material for impurity removal from the acidic lithium solution is an acrylonitrile copolymer functionalized with sulfonic acid or phosphonic acid groups.

In some embodiments, the ion exchange material for impurity removal from the acidic lithium solution is a polymer functionalized with phosphoric or phosphinic acid groups.

### Nanofiltration

In some embodiments, for any lithium extraction process or system described herein, impurities are at least removed by passing an impurities-enriched lithiated (IEL) acidic solution through one or more nanofiltration membrane units arranged in series and/or parallel. In some embodiments, the one or more nanofiltration membrane units comprises nanofiltration membrane material.

In one embodiment, impurities are removed from an acidic solution using a nanofiltration membrane material. In one embodiment, the nanofiltration membrane material is comprised of cellulose, cellulose acetate, cellulose diacetate, cellulose triacetate, polyamide, poly(piperazine-amide), mixtures thereof, modifications thereof, or combinations thereof. In one embodiment, the nanofiltration membrane material is comprised of a thin-film composite. In one embodiment, the nanofiltration membrane material is comprised of polyamide with a support comprised of polyacrylonitrile (PAN), polyethersulfone, polysulfone, polyphenylene sulfone, cellulose acetate, polyimide, polypropylene, polyketone, polyethylene terephthalate, mixtures thereof, modifications thereof, or combinations thereof. In one embodiment, the nanofiltration membrane material is comprised of polyethylene terephthalate. In one embodiment, the nanofiltration membrane material is comprised of ceramic material. In one embodiment, the nanofiltration membrane material is comprised of alumina, zirconia, yttria stabilized zirconia, titania, silica, mixtures thereof, modifications thereof, or combinations thereof. In one embodiment, the nanofiltration membrane material is comprised of carbon, carbon nanotubes, graphene oxide, mixtures thereof, modifications thereof, or combinations thereof. In one embodiment, the nanofiltration membrane material is comprised of zeolite mixed matrix membrane with polyamide and/or polysulfone support, alumina filled polyvinyl alcohol mixed matrix membrane materials, mixtures thereof, modifications thereof, or combinations thereof.

In some embodiments, anti-scalants, chelants, and/or other means of anti-scaling are used to avoid scaling in the nanofiltration membrane units. In some embodiments, anti-scalants are flowed through nanofiltration membrane units or ion exchange vessels to avoid formation of scalants.

### Precipitation

In one embodiment, impurities are removed from the acidic solution (e.g., synthetic lithium solution) using precipitation. In one embodiment, impurities are removed from the acidic solution using electrochemical precipitation. In one embodiment, impurities are removed from the acidic solution using chemical, carbonate precipitation, hydroxide precipitation, phosphate precipitation, or combinations thereof. In one embodiment, impurities are removed from the acidic solution by adding phosphate to precipitate calcium phosphate, magnesium phosphate, barium phosphate, and/or other phosphate compounds. In one embodiment, impurities are removed from the acidic solution by adding sodium phosphate, potassium phosphate, phosphoric acid, or other phosphate compounds to precipitate calcium phosphate, magnesium phosphate, barium phosphate, and/or other phosphate compounds. In one embodiment, residual phosphate is removed from the acidic solution. In one embodiment, residual phosphate is removed from the acidic solution using ion exchange or precipitation. In one embodiment, residual phosphate is removed from the acidic solution using precipitation with aluminum or iron.

In some embodiments, for any lithium extraction process or system described herein, impurities are at least removed from an impurities-enriched lithiated (IEL) acidic solution using chemically induced precipitation. In some embodiments, multivalent impurities are removed from the IEL acidic solution through carbonate precipitation, hydroxide precipitation, phosphate precipitation, or combinations thereof. In some embodiments, multivalent impurities are removed from the IEL acidic solution by adding phosphate to precipitate calcium phosphate, magnesium phosphate, barium phosphate, and/or other phosphate compounds. In some embodiments, multivalent impurities are removed from the IEL acidic solution by adding sodium phosphate, potassium phosphate, phosphoric acid, and/or other phosphate compounds to precipitate calcium phosphate, magnesium phosphate, barium phosphate, and/or other phosphate compounds. In some embodiments, residual phosphate is removed from the IEL acidic solution. In some embodiments, residual phosphate is removed from the IEL acidic solution using ion exchange or precipitation. In some embodiments, residual phosphate is removed from the IEL acidic solution using precipitation with aluminum or iron.

In some embodiments, multivalent impurities are removed from the IEL acidic solution by adding phosphoric acid to precipitate phosphate compounds. In some embodiments, adding phosphoric acid removes Ca, Mg, Sr, and/or Ba from the IEL acidic solution through precipitation of Ca, Mg, Sr, and/or Ba phosphate compounds.

In some embodiments, multivalent impurities are removed from the IEL acidic solution by adding an oxalate, oxalic acid, citrate, citric acid, or combinations thereof. In some embodiments, the oxalate, oxalic acid, citrate, citric acid, or combinations thereof are added as a precipitant, such that multivalent impurities are precipitated. In some embodiments, the precipitant concentration in the IEL acidic solution is subsequently decreased through precipitation by adding cation precipitants to the IEL acidic solution. In some embodiments, multivalent impurities are removed from the IEL acidic solution by adding oxalate to the IEL acidic solution to precipitate the multivalent impurities. In some embodiments, residual oxalate anions are precipitated and removed from the resulting lithium enriched acidic solution by adding cation precipitants. In some embodiments, cation precipitants comprise zinc, iron, manganese, other transition metals, other cations, or combinations thereof. In some embodiments, multivalent impurities are removed from the IEL acidic solution by adding citrate to the IEL acidic solution to precipitate the multivalent impurities. In some embodiments, residual citrate anions are precipitated and removed from the resulting lithium enriched acidic solution by adding cation precipitants. In some embodiments, cation precipitants comprise zinc, iron, manganese, other transition metals, other cations, or combinations thereof. In some embodiments, multivalent impurities are removed from the IEL acidic solution by adding anion precipitants to the IEL acidic solution to precipitate the multivalent impurities. In some embodiments, residual anions are precipitated and removed from the resulting lithium enriched acidic solution by adding cation precipitants. In some embodiments, cation precipitants comprise zinc, iron, manganese, other transition metals, other cations, or combinations thereof.

### Electrodialysis Separation

In some embodiments, for any lithium extraction process or system described herein, impurities are at least removed from an impurities-enriched lithiated (IEL) acidic solution by passing through one or more electrodialysis membranes to separate multivalent impurities.

In some embodiments, electrodialysis is used to remove impurities from an acidic lithium solution. In some embodiments, electrodialysis is a membrane separation technology in which certain charged species are allowed to pass through a membrane with assistance from an applied electric field. In some embodiments, electrodialysis is used to remove impurities from an acidic lithium solution where water is retained in the feed phase while charged ions pass through selective ion exchange membranes. In some embodiments, electrodialysis is used to remove impurities from an acidic lithium solution where selective cation exchange membranes are used to obtain separation of monovalent and multivalent ions by means of different transport kinetics through the membrane. In some embodiments, electrodialysis is used to remove impurities from an acidic lithium solution using a polymer-based membrane with functional groups. In some embodiments, electrodialysis is used to remove impurities from an acidic lithium solution using cation exchange membranes that are functionalized with negatively charged functional groups such as sulfonic, carboxyl, other functional groups, or combinations thereof which allows cations to pass through while preventing anions from passing. In some embodiments, electrodialysis is used to remove impurities from an acidic lithium solution with a rinse solution or additional membranes near the electrodes to wash out ions near the electrodes to prevent the generation of chlorine or hydrogen gas on the electrodes. In some embodiments, electrodialysis is used to remove impurities from an acidic lithium solution where divalent or multivalent cations would move through a membrane slower than monovalent ions.

### Temperature Reduction Precipitation

In some embodiments, for any lithium extraction process or system described herein, impurities are at least removed from an impurities-enriched lithiated (IEL) acidic solution (e.g., synthetic lithium solution) by reducing the temperature of the IEL acidic solution to precipitate multivalent impurities. In some embodiments, the temperature of the IEL acidic solution is reduced using a heat exchanger. In some embodiments, the temperature is reduced by passing the IEL acidic solution through a heat exchanger. In some embodiments, the temperature of the lithium-enriched eluate, following reduction of the temperature to precipitate multivalent impurities, is heated or allowed to warm.

### Precipitation of Metal Ions by Adjustment of pH and Oxidation Reduction Potential

In some embodiments, the pH of the lithium eluate is adjusted following elution by treatment with other acidic or basic substances. In some embodiments, the purification unit is configured to adjust the pH of the lithium eluate by treatment with other acidic or basic substances. The lithium eluate can be further treated and subjected to other separation processes to result in a changed relative concentration of lithium and other ions. The lithium eluate can further be diluted or concentrated to result in varying concentrations of lithium and other ions. In some embodiments, the acidic solution comprises dissolved species that may precipitate at certain concentrations. In some embodiments, the acidic solution comprises dissolved species that may precipitate at certain values of pH. In some embodiments, the acidic solution comprises dissolved species that may precipitate at certain values of oxidation-reduction potential.

In some embodiments, the acidic solution comprises dissolved species that may precipitate at certain concentrations. In some embodiments, the acidic solution comprises dissolved species that may be (e.g., are) reduced in concentration to avoid precipitation. In some embodiments, the dissolved species in an acidic solution comprises sulfate anions, nitrate anions, phosphate anions, chloride anions, bromide anions, fluoride anions, borate anions, iodide anions, carbonate anions, or combinations thereof. In some embodiments, lithium and non-lithium impurities are eluted into the acidic solution from the first lithium-enriched ion exchange material, forming a impurities-enriched lithiated (“IEL”) acidic solution, wherein the eluted impurities react with one or more said anions in the acidic solution to form insoluble salts, which may precipitate. In some embodiments, the concentrations of said anions and non-lithium impurities in the IEL acidic solution are independently limited so as to reduce or inhibit precipitation of insoluble salts. In one embodiment, the acidic solution comprises sulfate anions.

In some embodiments, the acidic solution further comprises water, salt, chelating compounds, ethylenediaminetetraacetic acid, salt of ethylenediaminetetraacetate, compounds of ethylenediaminetetraacetate, anti-scalants, or combinations thereof. In some embodiments, dilution water is added to the acidic solution to limit and/or prevent formation of insoluble precipitates.

In some embodiments, the acidic solution comprises dissolved species that may precipitate at certain concentrations. In some embodiments, the acidic solution comprises dissolved species that may be (e.g., are) reduced in concentration to avoid precipitation. In some embodiments, the dissolved species in an acidic solution comprises sulfate anions, nitrate anions, phosphate anions, chloride anions, bromide anions, fluoride anions, borate anions, iodide anions, carbonate anions, or combinations thereof. In some embodiments, lithium and non-lithium impurities are eluted into the acidic solution from the first lithium-enriched ion exchange material, forming a impurities-enriched lithiated (“IEL”) acidic solution, wherein the eluted impurities react with one or more said anions in the acidic solution to form insoluble salts, which may precipitate. In some embodiments, the concentrations of said anions and non-lithium impurities in the IEL acidic solution are independently limited so as to reduce or inhibit precipitation of insoluble salts. In one embodiment, the acidic solution comprises sulfate anion.

In some embodiments, the acidic solution further comprises water, salt, chelating compounds, ethylenediaminetetraacetic acid, salt of ethylenediaminetetraacetate, compounds of ethylenediaminetetraacetate, anti-scalants, or combinations thereof. In some embodiments, dilution water is added to the acidic solution to limit and/or prevent formation of insoluble precipitates.

In some embodiments, the pH is increased until precipitation of non-lithium impurities is observed. In some embodiments, the pH is increased by using a base comprising sodium hydroxide, calcium hydroxide, lithium hydroxide, magnesium hydroxide, potassium hydroxide, strontium hydroxide, barium hydroxide, as pure solids or in aqueous, mixtures thereof, or combination thereof.

In some embodiments, the value of oxidation-reduction potential is adjusted until precipitation of non-lithium impurities is observed. In some embodiments, oxidation-reduction potential using hydrogen peroxide, sodium hypochlorite, hypochlorous acid, ozone, potassium monopersulphate, chloramines, cyanuric acid, urea, sodium metabisulphite, mixtures thereof or combinations thereof.

In some embodiments, a precipitate is formed when the pH and/or oxidation-reduction potential of the eluate is adjusted. In some embodiments said precipitates comprise solids comprising lithium, sodium, calcium, magnesium, potassium, boron, strontium, barium, zirconium, titanium, vanadium, iron, copper, manganese, molybdenum, aluminum, niobium, sulfate, chloride, fluoride, bromide, nitrate, carbonate, bicarbonate, hydrogencarbonate, phosphate, borate, mixtures thereof or combinations thereof.

### Methods for Adjusting the pH of the Lithium Eluate

In one embodiment, the acidic lithium eluate is neutralized by adjusting the pH of the lithium eluate. In some embodiments, the purification unit is configured to adjust the pH of the lithium eluate (e.g., the synthetic lithium solution). In some embodiments, the purification unit is configured to neutralize the lithium eluate (e.g., the synthetic lithium solution). In some embodiments, the pH is raised to between 7 and 8, 8 and 9, 9 and 10, 10 and 11. In some embodiments, the pH is raised by adding NaOH, KOH, LiOH, RbOH, Mg(OH)₂, Ca(OH)₂, Sr(OH)₂, Ba(OH)₂, NH₄OH, Sr(OH)₂ or other basic compounds, or combinations thereof.

In some embodiments, the adjustment of the pH is performed in an agitated vessel. In some embodiments, said vessel is a jacked vessel. In some embodiments, said jacket is used to add heat to or remove heat from said vessel. In some embodiments, said vessel contains two or more baffles. In some embodiments, said vessel contains nozzles for injecting liquid, air, gas, or a combination thereof. In some embodiments, said nozzles are used for recirculating the contents of said vessel. In some embodiments, said nozzles are used for mixing said vessel. In some embodiments, air is used to recirculate the contents of said vessel. In some embodiments, the adjustment of the pH is performed using an inline mixer that mixes the lithium eluate with a liquid base.

In one embodiment, the acidic lithium eluate is neutralized by performing acid distillation. In some embodiments, said volatile acid is i) fresh or virgin volatile acid, ii) the recycled volatile acid, or iii) both. In some embodiments, said volatile acid is a volatile mineral acid comprising nitric acid, hydrochloric acid, hydrofluoric acid, hydrobromic acid, hydroiodic acid, or carbonic acid. In some embodiments, said volatile acid is nitric acid. In some embodiments, said volatile acid is hydrochloric acid. In some embodiments, the distillation unit operates at temperatures of about 50 to about 150 degrees Celsius. In some embodiments, the distillation unit operates at temperatures of about 100 to about 200 degrees Celsius. In some embodiments, the distillation unit operates at temperatures of about 100 to about 300 degrees Celsius. In some embodiments, the distillation unit operates at temperatures of about 200 to about 400 degrees Celsius. In some embodiments, the distillation unit operates at temperatures of about 400 to about 600 degrees Celsius. In some embodiments, the distillation unit operates at temperatures of above 600 degrees Celsius. In some embodiments, the distillation unit yields said lithium sulfate in aqueous form. In some embodiments, the distillation unit yields said lithium sulfate in solid form. In some embodiments, the distillation unit comprises a spray dryer to produce said lithium sulfate in solid form. In some embodiments, the distillation unit operates at pressures from about 0.01 atm to about 0.1 atm. In some embodiments, the distillation unit operates at pressures from about 0.1 atm to about 1.0 atm. In some embodiments, the distillation unit operates at pressures from about 1.0 atm to about 10 atm. In some embodiments, the distillation unit operates at pressures above 10 atm. In some embodiments, the condensation unit operates at pressures from about 1 atm to about 10 atm. In some embodiments, the condensation unit operates at pressures from about 10 atm to about 100 atm. In some embodiments, the condensation unit operates at pressures from about 100 atm to about 1,000 atm. In some embodiments, the condensation unit operates at temperatures from about −200 degrees Celsius to about −100 degrees Celsius. In some embodiments, the condensation unit operates at temperatures from about −100 degrees Celsius to about −50 degrees Celsius. In some embodiments, the condensation unit operates at temperatures from about −50 degrees Celsius to about 0 degrees Celsius. In some embodiments, the condensation unit operates at temperatures from about −30 degrees Celsius to about 20 degrees Celsius. In some embodiments, the condensation unit operates at temperatures from about 0 degrees Celsius to about 50 degrees Celsius. In some embodiments, the condensation unit operates at temperatures above 50 degrees Celsius.

### Methods for Precipitating Dissolved Transition Metals

In one embodiment, the methods and systems described herein comprise a purification unit or a purification step. Transition metals may optionally be found in solution in the synthetic lithium eluate (e.g., synthetic lithium solution). For final purification of the synthetic lithium eluate to produce lithium products, said dissolved transition metals must be removed. In some embodiments, a purification unit is configured to remove transition metals from the synthetic lithium solution. In some embodiments, a purification unit is configured to remove transition metals from the synthetic lithium solution by precipitation. In one embodiment, said transition metal impurities are removed from solution by precipitating them from the eluate in order to form a solid, and said solid is removed from the eluate through a solid-liquid separation method. In some embodiments, precipitation comprises the formation of a slurry comprising a) a solid comprising a transition metal species, and b) a liquid that used to contain said transition metal in solution prior to precipitation.

In one embodiment, said transition metal impurities are precipitated by raising the pH of the eluate, resulting in the precipitation of the transition metal such that the liquid eluate is devoid of such transition metal and is thereby concentrated in lithium. In some embodiments, the pH is raised to between about 3 and about 4, about 4 and about 5, about 5 and about 6, about 6 and about 7, about 7 and about 8, about 8 and about 9, about 9 and about 10, about 10 and about 11, about 11 and about 12. In some embodiments, the pH is raised by adding NaOH, KOH, LiOH, RbOH, Mg(OH)₂, Ca(OH)₂, Sr(OH)₂, Ba(OH)₂, NH₄OH, or other basic compounds, mixtures thereof, or combinations thereof.

In some embodiments, titanium is the transition metal, and the pH is raised to above 6. In some embodiments, zirconium is the transition metal, and the pH is raised to above 7. In some embodiments, vanadium is the transition metal, and the pH is raised to above 6. In some embodiments, iron is the transition metal, and the pH is raised to above 9. In some embodiments, copper is the transition metal, and the pH is raised to above 5. In some embodiments, manganese is the transition metal, and the pH is raised to above 7. In some embodiments, molybdenum is the transition metal, and the pH is raised to above 4. In some embodiments, aluminum is the transition metal, and the pH is raised to above 5. In some embodiments, niobium is the transition metal, and the pH is raised to above 2.

In one embodiment, said transition metals are precipitated by changing the oxidation state of the transition metal to an insoluble state. In one embodiment, the oxidation state of said transition metal is changed by altering the oxidation-reduction potential (also known as ORP) of the eluate. In some embodiments, the ORP is changed to between about −200 mV and about −100 mV, between about −100 mV and about 100 mV, between about 100 mV and about 200 mV, between about 200 mV and about 500 mV, between about 500 mV and about 1000 mV, or combinations thereof. In one embodiment, the oxidation state of said transition metal is changed by adding a redox agent to the eluate. In one embodiment, said redox agent is an oxidant. In some embodiments, said oxidant is air, oxygen, ozone, bleach, sodium hypochlorite, fluorine, chlorine, chlorate, perchlorate, hydrogen peroxide, potassium permanganate, nitric acid, or other oxidation agents, or combinations thereof. In some embodiments, said redox agent is a reductant. In some embodiments, said reductant is sodium bisulfite, sodium metabisulfite, sodium borohydride, formic acid, ascorbic acid, oxalic acid, potassium iodide, or other reducing agents, or combinations thereof. In one embodiment, the oxidation state of said transition metal is changed via electrolysis or electrowinning.

In some embodiments, Ti is the transition metal, and the ORP is raised to above about −100 mV. In some embodiments, Zr is the transition metal, and the ORP is raised to above about −1.5 V and below about 1.5 V. In some embodiments, V is the transition metal, and the ORP is raised to above about −600 mV. In some embodiments, Fe is the transition metal, and the ORP is raised to above about 1200 mV. In some embodiments, Cu is the transition metal, and the ORP is raised to above about −400 mV. In some embodiments, Mn is the transition metal, and the ORP is raised to above about 200 m V. In some embodiments, Mo is the transition metal, and the ORP is raised to above about −200 mV. In some embodiments, Al is the transition metal, and the ORP is raised to above about −1.75 V and below about 2 V. In some embodiments, Nb is the transition metal, and the ORP is raised to above about −250 mV.

In some embodiments, only the pH of the synthetic eluate is modified. In some embodiments, only the ORP of the synthetic eluate is modified. In some embodiments, a combination of both the pH and ORP of the eluate are modified.

In one embodiment, said transition metal impurities are precipitated by adding transition metal seed crystals to the eluate. In one embodiment, transition metal seed crystals are recirculated. In some embodiments, transition metal seed crystals are mixed with a solution comprising the same transition metal as the seed crystals. In some embodiments, transition metal seed crystals are mixed with a solution comprising a different transition metal as the seed crystals. In some embodiments, the addition of transition metal seed crystals to a tank where transition metals precipitate results in the formation of larger precipitates. In some embodiments, the formation of larger precipitates facilities solid-liquid separation of said precipitates.

In some embodiments, the precipitated solids comprise zirconium, titanium, vanadium, iron, copper, manganese, molybdenum, aluminum, niobium, mixtures or combinations thereof. In some embodiments, the precipitated solids comprise zirconium, titanium, vanadium, iron, copper, manganese, molybdenum, aluminum, niobium, lithium, sodium, calcium, magnesium, potassium, boron, strontium, barium, mixtures or combinations thereof. In some embodiments, the precipitated solids comprise sulfate, chloride, fluoride, bromide, nitrate, carbonate, bicarbonate, hydrogencarbonate, phosphate, borate, mixtures or combinations thereof. In some embodiments, the precipitated solids comprise a transition metal hydroxide, oxide, carbonate, sulfate, chloride, phosphate, bicarbonate, nitrate, bormide, borate, mixtures or combinations thereof.

In some embodiments, the molar ratio of lithium to the sum of all precipitated cations is about 1000:1. In some embodiments, said molar ratio is about 500:1. In some embodiments, said molar ratio is about 100:1. In some embodiments, said molar ratio is about 50:1. In some embodiments, said molar ratio is about 10:1. In some embodiments, said molar ratio is about 5:1. In some embodiments, said molar ratio is about 2:1. In some embodiments, said molar ratio is about 1:1.

In some embodiments, said transition metal impurities are precipitated from the lithium eluate in order to form a solid, and said solid is removed from the lithium eluate through a solid-liquid separation method.

In some embodiments, said filter retains particles smaller than about 0.01 microns, smaller than about 0.1 microns, smaller than about 0.5 microns, smaller than about 1 micron, smaller than about 5 microns, smaller than about 10 microns, smaller than about 100 microns, smaller than about 1 millimeter, smaller than about 1 centimeter.

In one embodiment, coordinating ligands are added to the eluate during precipitation of the transition metals. In one embodiment, said ligands are chelating agents. In one embodiment, said chelating agent is EDTA, oxalate, or other chelators, mixtures, or combinations thereof.

In one embodiment, said transition metal impurities are precipitated by adding anions to the eluate that form insoluble salts with dissolved transition metals. In one embodiment, said complimentary anion comprises sulfide, phosphate, carbonate, or combinations thereof. In one embodiment, said sulfide is H₂S, Na₂S, K₂S, CaS, MgS, other sulfide compounds, or combinations thereof. In one embodiment, said phosphate is Na₃PO₄, K₃PO₄, Rb₃PO₄, (NH₄)₃PO₄, other phosphate salts, or combinations thereof. In one embodiment, said carbonate is MgCO₃, CaCO₃, SrCO₃, CO₂, or other carbonate salts, or combinations thereof.

In one embodiment, base is added to lithium eluate solution, to precipitate undesirable metals followed by separation from the lithium eluate solution through solid-liquid separations. In one embodiment, base is added to lithium eluate solution to precipitated undesirable metals followed by the addition of an oxidizing agent to further precipitate undesirable metals followed by separation from lithium eluate solution using solid-liquid separations. In one embodiment, base is added to lithium eluate solution followed by the addition of an oxidizing agent to precipitate the undesirable solids, followed by separation from the lithium eluate solution through solid-liquid separations, followed by the addition of base for precipitation of undesirable metals followed by the separation from lithium eluate solution through solid-liquid separations.

### Methods for Removal of Dissolved Impurities in the Eluate

In some embodiments, some amount of dissolved transition metal impurities removed directly from solution by treatment of the synthetic eluate solution (e.g., synthetic lithium solution). In some embodiments, a purification unit is configured to directly remove transition metal impurities from the synthetic lithium solution. In some embodiments, the methods and systems described herein comprise a purification unit or purification step.

In one embodiment, the dissolved transition metal impurities are removed from the lithium eluate using solvent extraction with an organic liquid phase that preferentially binds transition metal ions. In one embodiment, a lithium eluate solution is purified using solvent extraction with an organic liquid phase to preferentially bind monovalent ions or to preferentially bind divalent ions or to preferentially bind multivalent ions. In some embodiments, said multivalent ions comprise calcium, magnesium, strontium, boron, manganese, zirconium, barium, titanium, tin, iron, cobalt, nickel, zinc, aluminum, other cations, combinations or mixture thereof. In one embodiment, the solvent extraction is performed using neodecanoic acid, di-(2-ethylhexyl)phosphoric acid, mixtures or combinations thereof. In one embodiment, a flow of lithium salt solution or lithium acid eluate solution is pumped through a series of one or more columns/tanks counter-current to a flow of other liquid phase, which may be (e.g., is) kerosene or other solvent containing neodecanoic acid, di-(2-ethylhexyl)phosphoric acid, other extractants, mixture or combinations thereof.

In one embodiment, the dissolved transition metal impurities are removed using cation-exchange resins to preferentially absorb impurities. In one embodiment, a lithium eluate solution is purified using cation-exchange resins to preferentially absorb multivalent ions while releasing sodium. In one embodiment, a lithium eluate solution is purified using cation-exchange resins to preferentially absorb multivalent ions while releasing hydrogen. In one embodiment, a lithium eluate solution is purified using cation-exchange resins to preferentially absorb multivalent ions while releasing lithium. In one embodiment, the cation-exchange resin may be (e.g., is) a sulfonated polymer or a carboxylated polymer. In one embodiment, the cation-exchange resin may be (e.g., is) a sulfonated polystyrene polymer, a sulfonated polystyrene-butadiene polymer, or a carboxylated polyacrylic polymer. In one embodiment, the cation-exchange resin may be (e.g., is) loaded with Na (e.g., Na ions) so that Na is released as multi-valent ions are absorbed. In one embodiment, the cation-exchange resin may be (e.g., is) loaded with Li (eg . . . , Li ions) so that Li is released as multi-valent ions are absorbed.

In one embodiment, the dissolved transition metal impurities are removed using anion-exchange resins to preferentially absorb anionic impurities.

Methods for Separating Precipitated Solids from Liquid Eluate

In some embodiments, solids precipitated form the synthetic eluate solution are removed from said eluate by solid-liquid separation, resulting in a liquid eluate stream that is purified in its lithium content. In some embodiments, the methods and systems described herein comprise a purification unit that purifies the liquid eluate stream (synthetic lithium solution). In some embodiments, the purification unit is configured to remove precipitates from the synthetic lithium solution by solid-liquid separation.

In one embodiment, the precipitated metals are separated from the lithium eluate solution utilizing filtration, gravity sedimentation, centrifugal sedimentation, centrifugation, magnetic fields, other methods of solid-liquid separation, or combinations thereof. In some embodiments, said separating of the undesirable metal precipitate comprises using a filter, a settling tank, a clarifier, a hydrocyclone, a centrifuge, or combinations thereof. In some embodiments, precipitated metals are removed from the eluate using a filter. In some embodiments, the filter is a belt filter, plate-and-frame filter press, pressure vessel containing filter elements, rotary drum filter, rotary disc filter, a candle filter, a bag filter, cartridge filter, a centrifugal filter with a fixed or moving bed, a metal screen, a perforated basket centrifuge, a three-point centrifuge, a peeler type centrifuge, or a pusher centrifuge. In some embodiments, the filter may use a scroll or a vibrating device. In some embodiments, the filter is horizontal, vertical, or may use a siphon. In some embodiments, the eluate is recirculated through the solid-liquid separator.

In some embodiments, said filter retains particles smaller than about 0.01 microns, smaller than about 0.1 microns, smaller than about 0.5 microns, smaller than about 1 micron, smaller than about 5 microns, smaller than about 10 microns, smaller than about 100 microns, smaller than about 1 millimeter, smaller than about 1 centimeter.

In one embodiment, a filter cake is prevented, limited, or removed by using gravity, centrifugal force, an electric field, vibration, brushes, liquid jets, scrapers, intermittent reverse flow, vibration, crow-flow filtration, or pumping suspensions across the surface of the filter. In some embodiments, the precipitated metals and a liquid is moved tangentially to the filter to limit cake growth. In one embodiment, gravitational, magnetic, centrifugal sedimentation, or other means of solid-liquid separation are used before, during, or after filtering to prevent cake formation. In one embodiment, a filter comprises a screen, a metal screen, a sieve, a sieve bend, a bent sieve, a high frequency electromagnetic screen, a resonance screen, or combinations thereof. In one embodiment, one or more particle traps are a solid-liquid separation apparatus. In some embodiments, one or more solid-liquid separation apparatuses may be (e.g., are) used in series or parallel. In one embodiment, a dilute slurry is removed from the tank, transferred to an external solid-liquid separation apparatus, and separated into a concentrated slurry and a solution with low or no suspended solids. In one embodiment, the concentrated slurry is returned to the tank or transferred to a different tank. In one embodiment, precipitate metals are transferred from a brine tank to another brine tank, from an acid tank to another acid tank, from a washing tank to another washing tank, from a brine tank to a washing tank, from a washing tank to an acid tank, from an acid tank to a washing tank, or from an acid tank to a brine tank.

In one embodiment, solid-liquid separation apparatuses may use gravitational sedimentation. In some embodiments, solid-liquid separation apparatuses may include a settling tank, a thickener, a clarifier, a gravity thickener. In some embodiments, solid-liquid separation apparatuses are operated in batch mode, semi-batch mode, semi-continuous mode, or continuous mode. In some embodiments, solid-liquid separation apparatuses include a circular basin thickener with slurry entering through a central inlet such that the slurry is dispersed into the thickener with one or more raking components that rotate and concentrate the ion exchange particles into a zone where the particles can leave through the bottom of the thickener.

In one embodiment, solid-liquid separation apparatuses include a deep cone, a deep cone tank, a deep cone compression tank, or a tank wherein the slurry is compacted by weight. In some embodiments, solid-liquid separation apparatuses include a tray thickener with a series of thickeners oriented vertically with a center axle and raking components. In some embodiments, solid-liquid separation apparatuses include a lamellar-type thickener with inclined plates or tubes that may be (e.g., are) smooth, flat, rough, or corrugated. In some embodiments, solid-liquid separation apparatuses include a gravity clarifier that may be (e.g., is) a rectangular basin with feed at one end and overflow at the opposite end optionally with paddles and/or a chain mechanism to move particles. In some embodiments, the solid-liquid separation apparatuses may be (e.g., comprise) a particle trap.

In some embodiments, the solid-liquid separation apparatuses use centrifugal sedimentation. In some embodiments, solid-liquid separation apparatuses may include a tubular centrifuge, a multi-chamber centrifuge, a conical basket centrifuge, a scroll-type centrifuge, a sedimenting centrifuge, or a disc centrifuge. In some embodiments, precipitated metals are discharged continuously or intermittently from the centrifuge. In some embodiments, the solid-liquid separation apparatus is a hydrocyclone. In some embodiments, solid-liquid separation apparatus is an array of hydrocyclones or centrifuges in series and/or in parallel. In some embodiments, sumps are used to reslurry the precipitated metals. In some embodiments, the hydrocyclones may have (e.g., have) multiple feed points. In some embodiments, a hydrocyclone is used upside down. In some embodiments, liquid is injected near the apex of the cone of a hydrocyclone to improve sharpness of cut. In some embodiments, a weir rotates in the center of the particle trap with a feed of slurried precipitated metals entering near the middle of the apparatus, and precipitated metals get trapped at the bottom and center of the apparatus due to a “teacup effect”.

In one embodiment, the solid-liquid separation apparatuses may use a membrane filter. In one embodiment, solid-liquid separations membrane filters are operated in batch mode, semi-batch mode, semi-continuous mode or continuous mode. In one embodiment, solid-liquid separation membrane filters are operated in cross-flow with concentrate routed to solid-liquid feed. In one embodiment, solid-liquid separation membrane filters are operated in cross-flow with concentrate fed back into the lithium eluate solution along with the base. In one embodiment, solid-liquid separation membrane filters are operated in cross-flow with concentrate fed back into the lithium eluate solution along with the oxidizing agent. In one embodiment, solid-liquid separation membrane filters are operated without cross-flow (dead end mode), and back-washed at intervals with back-wash stream fed back into the lithium eluate solution along with the base. In one embodiment, solid-liquid separation membrane filters are operated without cross-flow (dead end mode), and back-washed at intervals with back-wash stream fed back into the lithium eluate solution along with the oxidizing agent.

In one embodiment, the precipitated metal solids separated by one or more of the above embodiments are split into two or more streams and fed back into the lithium eluate solution along with base. In some embodiments, the solids in said stream act as nucleation sites on which other metals precipitate. In some embodiments, this method serves to grow larger precipitate crystals faster. In one embodiment, the precipitated metal solids separated by one or more of the above embodiments are split into two or more streams and fed back into the lithium eluate solution along with the oxidizing agent as nucleation sites on which the metals precipitate.

In one embodiment of the metal precipitation system, the tanks include a mixing tank where the base or acid is mixed with the lithium eluate solution to adjust its pH. In one embodiment, this mixing tank is mixed using one or more submerged stirrers, pumped circulation, injection of compressed gas, such as air or ozone. In one embodiment, the tanks include a settling tank, where precipitates optionally settle to the bottom of the settling tank to concentrate the solid precipitates. In one embodiment, the tanks include a storage tank where the eluate is stored prior to mixing tank, settling tank, or other tanks. In one embodiment, some tanks in the recirculating reactor optionally serve a combination of purposes including pH adjustment, ORP adjustment, base mixing tank, settling tank, or storage tank. In any embodiment, a tank optionally does not fulfil two functions at the same time. For example, a tank is not a base mixing tank and a settling tank.

### Device for Removal of Precipitation of Impurities in the Eluate

Disclosed herein are systems and processes for extracting transition metal impurities from a lithium eluate using one or more agitated vessels where transition metals are precipitated form said eluate. In some embodiments, a purification unit is configured to remove impurities by precipitation.

In one embodiment, transitions metals are 1) precipitated from a liquid resource, and 2) removed from the liquid resource. In one embodiment, transitions metals are removed from a liquid resource through precipitation by addition of base, oxidant, or combinations thereof, followed by removal of the resulting solids (via said precipitation of the undesirable metals) from the liquid resource, followed by disposal of said solid undesirable metals. In one embodiment, transitions metals are removed from a liquid resource through precipitation by addition of base, oxidant, or combinations thereof, followed by removal of the resulting solids from the liquid resource, followed by reprocessing of resulting solids into ion exchange materials. In one embodiment, removed transitions metals may be (e.g., are) redissolved using acid and reductant, followed by mixing with raffinate, waste water, liquid resource, water, or other liquids. In one embodiment, redissolved transitions metals may be (e.g., are) mixed with raffinate, waste water, liquid resource, water, or other liquids for disposal. In one embodiment, solids of transitions metals may be (e.g., are) dissolved in raffinate, waste water, liquid resource, water, or other liquids for disposal. In one embodiment, transitions metals may be (e.g., are) mixed with raffinate, waste water, liquid resource, water, or other liquids for disposal. In one embodiment of the metal precipitation system, the tanks include a mixing tank where the base is mixed with the lithium eluate solution. In one embodiment, this mixing tank is mixed using one or more submerged stirrers, pumped circulation, injection of compressed gas, such as air or ozone. In one embodiment, the tanks include a settling tank, where precipitates optionally settle to the bottom of the settling tank to concentrate the solid precipitates. In one embodiment, the tanks include a storage tank where the eluate is stored prior to mixing tank, settling tank, or other tanks. In one embodiment, some tanks in the recirculating reactor optionally serve a combination of purposes including base mixing tank, settling tank, or storage tank. In any embodiment, a tank optionally does not fulfil two functions at the same time. For example, a tank is not a base mixing tank or a settling tank.

In one embodiment of the metal precipitation system, base is added to a mixing tank, which is optionally a continuous stirred tank system, a confluence of lithium eluate solution flow and base flow followed by a static mixer, a confluence of lithium eluate solution flow and base flow followed by a paddle mixer, a confluence of lithium eluate flow and base flow followed by a turbine impeller mixer, or a continuous stirred tank system in the shape of a vertical column which is well mixed at the bottom and settled near the top. In one embodiment, the base is optionally added as a solid or as an aqueous solution. In one embodiment, the base is optionally added continuously at a constant or variable rate. In one embodiment, the base is optionally added discretely in constant or variable aliquots or batches. In one embodiment, the base is optionally added according to one or more pH meters, which optionally samples lithium eluate solution downstream of the mixing tank or elsewhere in the recirculating system.

In one embodiment of the metal precipitation system, oxidant is added to a mixing tank, which is optionally a continuous stirred tank system, a confluence of lithium eluate solution flow and oxidant flow followed by a static mixer, a confluence of lithium eluate solution flow and oxidant flow followed by a paddle mixer, a confluence of lithium eluate flow and oxidant flow followed by a turbine impeller mixer, or a continuous stirred tank system in the shape of a vertical column which is well mixed at the bottom and settled near the top. In one embodiment, the oxidant is optionally added as a solid or as an aqueous solution. In one embodiment, the oxidant is optionally added continuously at a constant or variable rate. In one embodiment, the oxidant is optionally added discretely in constant or variable aliquots or batches. In one embodiment, the base is optionally added according to one or more oxidation-reduction potential meters, which optionally samples lithium eluate solution downstream of the mixing tank or elsewhere in the recirculating system.

In some embodiments, the oxidant is chosen from one of more of oxygen, air, ozone, hydrogen peroxide, fluorine, chlorine, bromine, iodine, nitric acid, a nitrate compound, sodium hypochlorite, bleach, a chlorite, a chlorate, a perchlorate, potassium permanganate, a permanganate, sodium perborate, a perborate, mixtures thereof or combinations thereof.

In one embodiment of the metal precipitation system, base, oxidant, or a combination there of is added to a mixing tank, which is optionally a continuous stirred tank system, which is a conical bottom tank. In one embodiment, the mixing tank is a false bottom tank.

### Lithium Carbonate Precipitation

In some embodiments, lithium chloride present in a lithium solution may be (e.g., is) converted to lithium carbonate. In some embodiments, a lithium solution is a synthetic lithium solution. In some embodiments, a lithium solution is a lithium eluate. In some embodiments, soda ash, or equivalently sodium carbonate, is added to a lithium solution to increase the carbonate concentration of the solution. In some embodiments, soda ash may be (e.g., is) added to a lithium solution as a solid. In some embodiments, soda ash may be (e.g., is) added to a lithium solution as a liquid solution. In some embodiments, soda ash may be (e.g., is) added to a lithium solution as a slurry.

In some embodiments, lithium hydroxide present in a lithium solution is converted to lithium carbonate. In some embodiments, lithium hydroxide present in a lithium solution is converted to lithium bicarbonate. In some embodiments, a lithium solution is a lithium eluate. In some embodiments, carbon dioxide is added to a lithium solution to increase the carbonate concentration of the solution (e.g., provide a lithium solution with an increased carbonate concentration). In some embodiments, carbon dioxide is added to a lithium solution as a gas. In some embodiments, carbon dioxide is added to a lithium solution as a solution. In some embodiments, carbon dioxide is added to a lithium solution as a supercritical fluid. In some embodiments, carbon dioxide is added to a lithium solution as a solid.

In some embodiments, a lithium solution with an increased carbonate concentration may be (e.g., is) heated to generate solid lithium carbonate. In some embodiments, the lithium solution and the soda ash are independently heated before they are combined, but the lithium solution with an increased carbonate concentration is not in itself heated. In some embodiments, a lithium solution with an increased carbonate concentration reaches a temperature about 355 K to generate solid lithium carbonate. In some embodiments, a lithium solution with an increased carbonate concentration reaches a temperature about 345 K to about 365 K to generate solid lithium carbonate. In some embodiments, the generation of solid lithium carbonate may take place in a single tank. In some embodiments, the generation of solid lithium carbonate may take place in multiple tanks. In some embodiments, the generation of solid lithium carbonate may take place in multiple tanks arranged so that the outlet of one tank is fed into a subsequent tank. In some embodiment, each subsequent tank has a higher solids content than the previous tank. In some embodiments, the generation of solid lithium carbonate may take place in multiple tanks in fluid contact or communication with one another.

In some embodiments, the tanks where lithium carbonate precipitates are crystallizers. In some embodiments, the crystallization tanks are heated. In some embodiments, the crystallization tanks are not heated. In some embodiments, the crystallization tanks are insulated. In some embodiments, the crystallization tanks are agitated tanks. In some embodiments, the crystallization tanks are mechanical vapor recompression units. In some embodiments, the crystallization tanks comprise one or more draft tube baffle crystallizers, which comprise an agitator, a center tube, and a cylindrical baffle to allowed clarified liquor to be withdrawn and thicken the operating slurry magma density. In some embodiments, only one crystallizer is present in the system. In some embodiments, two crystallizers in series are present in the system. In some embodiments, three crystallizers in series are present in the system. In some embodiments, four crystallizers in series are present in the system. In some embodiments, five or more crystallizers are present in the system. In some embodiments, soda ash is added only to the first crystallizer in a series of crystallization tanks. In some embodiments, soda ash is added to the first two crystallizers in the series of crystallization tanks. In some embodiments, soda ash is added to the first three crystallizers in the series of crystallization tanks. In some embodiments, soda ash is added to all crystallizers in the series of crystallization tanks.

In some embodiments, solid crystals of lithium carbonate are added to the first tank. In some embodiments, this facilitates the precipitation of lithium carbonate with desired properties. In some embodiments, solid crystals of lithium carbonate are added to several of the tanks where crystallization occurs. In some embodiments, said solid crystals are fed into the first tank as a slurry. In some embodiments, said slurry is collected from a thickener at the outlet of a series of lithium carbonate crystallization tanks.

In some embodiments, sodium carbonate is added as a solution. In some embodiments, the concentration of sodium carbonate in said solution is approximately 30% on a weight basis. In some embodiments, the concentration of sodium carbonate in said solution is higher than 25% but lower than 35% on a weight basis. In some embodiments, the concentration of sodium carbonate in said solution is higher than 10% but lower than 20% on a weight basis. In some embodiments, the concentration of sodium carbonate in said solution is higher than 20% but lower than 30% on a weight basis. In some embodiments, the concentration of sodium carbonate in said solution is higher than 30% but lower than 40% on a weight basis. In some embodiments, said solution is added at a temperature of about 70 to about 80° C. In some embodiments, said solution is added at a temperature of about 75 to about 85° C. In some embodiments, said solution is added at a temperature of about 80 to about 90° C. In some embodiments, said solution is added at a temperature of about 90 to about 100° C. In some embodiments, said solution is filtered prior to addition to the lithium carbonate precipitation tanks.

In some embodiments, said solution of sodium carbonate is prepared by dissolving sodium carbonate in a liquid. In some embodiments, said liquid is water. In some embodiments, said liquid is water that has been used to wash lithium carbonate crystals. In some embodiments, said liquid contains dissolved lithium carbonate. In some embodiments, said liquid is filtered.

In some embodiments, the size of solids produced in the crystallizers is from about 60 to about 70 microns. In some embodiments, the size of solids produced in the crystallizers is from about 75 to about 85 microns. In some embodiments, the side of the solids produced in the crystallizers is 80 microns. In some embodiments, the size of solids produced in the crystallizers is from about 60 to about 70 microns. In some embodiments, the size of solids produced in the crystallizers is from about 70 to about 80 microns. In some embodiments, the size of solids produced in the crystallizers is from about 80 to about 90 microns. In some embodiments, the size of solids produced in the crystallizers is from about 90 to about 100 microns. In some embodiments, the size of solids produced in the crystallizers is from about 100 to about 120 microns. In some embodiments, the size of solids produced in the crystallizers is from about 120 to about 140 microns. In some embodiments, the size of solids produced in the crystallizers is from about 140 to about 200 microns. In some embodiments, the individual lithium carbonate crystals have a size of from about 20 to about 40 microns, but these crystals aggregate to form larger solids. In some embodiments, the final lithium carbonate crystals are micronized to a size of about 5 microns.

In some embodiments, solid lithium carbonate may be (e.g., is) separated from its mother liquor. In some embodiments, solid lithium carbonate may be (e.g., is) separated from its mother liquor by centrifugation. In some embodiments, solid lithium carbonate may be (e.g., is) separated from its mother liquor by employing a filter press. In some embodiments, solid lithium carbonate may be (e.g., is) separated from its mother liquor by employing a belt filter. In some embodiments, the solids are washed with water to remove impurities.

In some embodiments, the lithium carbonate solids are redissolved in water and recrystallized with a second system as the one described above, resulting in a solid lithium carbonate product with reduced impurities. In some embodiments, the lithium carbonate solids are re-slurried in pure water, re-separated in a solid-liquid separator, and re-washed. In some embodiments, the lithium carbonate solids are re-slurried in water, carbon dioxide is added to dissolve the solids, and said solids are recrystallized, resulting in solids of higher purity. In some embodiments, said dissolution occurs at ambient temperature. In some embodiments, the solids are recrystallized with a second system as the one described above, resulting in a solid lithium carbonate product with reduced impurities.

System for Removing Carbonates from the Mother Liquor

In some embodiments, a mother liquor is a solution that contains lithium carbonate. In some embodiments, a mother liquor is a solution that contains lithium carbonate that is a liquid byproduct of a process for generating solid lithium carbonate.

In some embodiments, the concentration of carbonate in a mother liquor is greater than about 1000.0 milligrams per liter and less than about 30000 milligrams per liter. In some embodiments, the concentration of carbonate in a mother liquor is greater than about 10 milligrams per liter and less than about 100 milligrams per liter. In some embodiments, the concentration of carbonate in a mother liquor is greater than about 100 milligrams per liter and less than about 500 milligrams per liter. In some embodiments, the concentration of carbonate in a mother liquor is greater than about 500 milligrams per liter and less than about 1000 milligrams per liter. In some embodiments, the concentration of carbonate in a mother liquor is greater than about 1000 milligrams per liter and less than about 5000 milligrams per liter. In some embodiments the concentration of carbonate in a mother liquor is greater than about 5000 milligrams per liter and less than about 10000 milligrams per liter. In some embodiments, the concentration of carbonate in a mother liquor is greater than about 10000 milligrams per liter and less than about 50000 milligrams per liter. In some embodiments, the concentration of carbonate in a mother liquor is greater than about 50000 milligrams per liter and less than about 100000 milligrams per liter. In some embodiments, the concentration of carbonate in a mother liquor is greater than about 100000 milligrams per liter and less than about 200000 milligrams per liter. In some embodiments the concentration of carbonate in a mother liquor is greater than about 200000 milligrams per liter and less than about 300000 milligrams per liter. In some embodiments, the concentration of carbonate in a mother liquor is greater than about 300000 milligrams per liter and less than about 500000 milligrams per liter.

In some embodiments, the concentration of lithium carbonate in a mother liquor is greater than about 1000.0 milligrams per liter and less than about 30000 milligrams per liter. In some embodiments, the concentration of lithium carbonate in a mother liquor is greater than about 10 milligrams per liter and less than about 100 milligrams per liter. In some embodiments, the concentration of lithium carbonate in a mother liquor is greater than about 100 milligrams per liter and less than about 500 milligrams per liter. In some embodiments, the concentration of lithium carbonate in a mother liquor is greater than about 500 milligrams per liter and less than about 1000 milligrams per liter. In some embodiments, the concentration of lithium carbonate in a mother liquor is greater than about 1000 milligrams per liter and less than about 5000 milligrams per liter. In some embodiments the concentration of lithium carbonate in a mother liquor is greater than about 5000 milligrams per liter and less than about 10000 milligrams per liter. In some embodiments, the concentration of lithium carbonate in a mother liquor is greater than about 10000 milligrams per liter and less than about 50000 milligrams per liter. In some embodiments, the concentration of lithium carbonate in a mother liquor is greater than about 50000 milligrams per liter and less than about 100000 milligrams per liter. In some embodiments, the concentration of lithium carbonate in a mother liquor is greater than about 100000 milligrams per liter and less than about 200000 milligrams per liter. In some embodiments the concentration of lithium carbonate in a mother liquor is greater than about 200000 milligrams per liter and less than about 300000 milligrams per liter. In some embodiments, the concentration of lithium carbonate in a mother liquor is greater than about 300000 milligrams per liter and less than about 500000 milligrams per liter.

In some embodiments, the pH value of a mother liquor is greater than 7.0 but less than 13.0. In some embodiments, the pH value of a mother liquor is greater than 7.0 but less than 10.0. In some embodiments, the pH value of a mother liquor is greater than 10.0 but less than 13.0. In some embodiments, the pH value of a mother liquor is greater than 7.0 but less than 12.0. In some embodiments, the pH value of a mother liquor is greater than 7.0 but less than 11.0. In some embodiments, the pH value of a mother liquor is greater than 8.0 but less than 13.0. In some embodiments, the pH value of a mother liquor is greater than 9.0 but less than 13.0. In some embodiments, the pH value of a mother liquor is greater than 8.0 but less than 12.0. In some embodiments, the pH value of a mother liquor is greater than 9.0 but less than 12.0. In some embodiments, the pH value of a mother liquor is greater than 8.0 but less than 11.0. In some embodiments, the pH value of a mother liquor is greater than 9.0 but less than 11.0. In some embodiments, the pH value of a mother liquor is greater than 8.0 but less than 10.0.

In some embodiments a mother liquor comprises lithium. In some embodiments a mother liquor may comprise sodium. In some embodiments a mother liquor comprises sodium. In some embodiments a mother liquor may comprise potassium. In some embodiments a mother liquor comprises potassium. In some embodiments a mother liquor may comprise boron. In some embodiments a mother liquor comprises boron. In some embodiments a mother liquor may comprise chloride. In some embodiments a mother liquor comprises chloride. In some embodiments, a mother liquor may comprise sulfate. In some embodiments, a mother liquor comprises lithium, sodium, potassium, boron, chloride, or combinations thereof. In some embodiments, a mother liquor comprises lithium, sodium, potassium, boron, sulfate or combinations thereof. In some embodiments, a mother liquor comprises chloride and sulfate anions. In some embodiments, a mother liquor comprises lithium, sodium, potassium, boron, magnesium, calcium, and strontium. In some embodiments, the concentration of monovalent cations to multivalent cations on a mass bases is more than about 10:1, more than about 100:1, more than about 1000:1, more than about 10,000:1, more than about 100,000:1, more than about 1,000,000:1, more than about 10,000,000:1.

In some embodiments, the concentration of sodium in a mother liquor is greater than about 1000.0 milligrams per liter and less than about 30000 milligrams per liter. In some embodiments, the concentration of sodium in a mother liquor is greater than about 10 milligrams per liter and less than about 100 milligrams per liter. In some embodiments, the concentration of sodium in a mother liquor is greater than about 100 milligrams per liter and less than about 500 milligrams per liter. In some embodiments, the concentration of sodium in a mother liquor is greater than about 500 milligrams per liter and less than about 1000 milligrams per liter. In some embodiments, the concentration of sodium in a mother liquor is greater than about 1000 milligrams per liter and less than about 5000 milligrams per liter. In some embodiments the concentration of sodium in a mother liquor is greater than about 5000 milligrams per liter and less than about 10000 milligrams per liter. In some embodiments, the concentration of sodium in a mother liquor is greater than about 10000 milligrams per liter and less than about 50000 milligrams per liter. In some embodiments, the concentration of sodium in a mother liquor is greater than about 50000 milligrams per liter and less than about 100000 milligrams per liter. In some embodiments, the concentration of sodium in a mother liquor is greater than about 100000 milligrams per liter and less than about 200000 milligrams per liter. In some embodiments the concentration of sodium in a mother liquor is greater than about 200000 milligrams per liter and less than about 300000 milligrams per liter. In some embodiments, the concentration of sodium in a mother liquor is greater than about 300000 milligrams per liter and less than about 500000 milligrams per liter.

In some embodiments, the concentration of potassium in a mother liquor is greater than about 1000.0 milligrams per liter and less than about 30000 milligrams per liter. In some embodiments, the concentration of potassium in a mother liquor is greater than about 10 milligrams per liter and less than about 100 milligrams per liter. In some embodiments, the concentration of potassium in a mother liquor is greater than about 100 milligrams per liter and less than about 500 milligrams per liter. In some embodiments, the concentration of potassium in a mother liquor is greater than about 500 milligrams per liter and less than about 1000 milligrams per liter. In some embodiments, the concentration of potassium in a mother liquor is greater than about 1000 milligrams per liter and less than about 5000 milligrams per liter. In some embodiments the concentration of potassium in a mother liquor is greater than about 5000 milligrams per liter and less than about 10000 milligrams per liter. In some embodiments, the concentration of potassium in a mother liquor is greater than about 10000 milligrams per liter and less than about 50000 milligrams per liter. In some embodiments, the concentration of potassium in a mother liquor is greater than about 50000 milligrams per liter and less than about 100000 milligrams per liter. In some embodiments, the concentration of potassium in a mother liquor is greater than about 100000 milligrams per liter and less than about 200000 milligrams per liter. In some embodiments the concentration of potassium in a mother liquor is greater than about 200000 milligrams per liter and less than about 300000 milligrams per liter. In some embodiments, the concentration of potassium in a mother liquor is greater than about 300000 milligrams per liter and less than about 500000 milligrams per liter.

In some embodiments, the concentration of sodium in a mother liquor is greater than about 1000.0 milligrams per liter and less than about 30000 milligrams per liter. In some embodiments, the concentration of boron in a mother liquor is greater than about 10 milligrams per liter and less than about 100 milligrams per liter. In some embodiments, the concentration of boron in a mother liquor is greater than about 100 milligrams per liter and less than about 500 milligrams per liter. In some embodiments, the concentration of boron in a mother liquor is greater than about 500 milligrams per liter and less than about 1000 milligrams per liter. In some embodiments, the concentration of boron in a mother liquor is greater than about 1000 milligrams per liter and less than about 5000 milligrams per liter. In some embodiments the concentration of boron in a mother liquor is greater than about 5000 milligrams per liter and less than about 10000 milligrams per liter. In some embodiments, the concentration of boron in a mother liquor is greater than about 10000 milligrams per liter and less than about 50000 milligrams per liter. In some embodiments, the concentration of boron in a mother liquor is greater than about 50000 milligrams per liter and less than about 100000 milligrams per liter. In some embodiments, the concentration of boron in a mother liquor is greater than about 100000 milligrams per liter and less than about 200000 milligrams per liter. In some embodiments the concentration of boron in a mother liquor is greater than about 200000 milligrams per liter and less than about 300000 milligrams per liter. In some embodiments, the concentration of boron in a mother liquor is greater than about 300000 milligrams per liter and less than about 500000 milligrams per liter.

In some embodiments, the carbonate content of a mother liquor may be (e.g., is) lowered. In some embodiments, the carbonate content of a mother liquor may be (e.g., is) lowered such that the mother liquor becomes essentially free of carbonate. In some embodiments, the carbonate content of a mother liquor may be (e.g., is) lowered by the addition of acid to the mother liquor to generate carbon dioxide. In some embodiments, carbonates are converted into carbon dioxide by addition of an acid. In some embodiments, said acid is hydrochloric acid, sulfuric acid, nitric acid, phosphoric acid, a solid acid, mixtures thereof or combinations thereof.

In some embodiments, a mother liquor that has been treated to lower or eliminate its carbonate content is a depleted carbonate mother liquor.

In some embodiments, the carbonate content of a mother liquor may be (e.g., is) reduced by placing the mother liquor in contact with an ion exchange material that absorbs lithium while releasing protons to generate carbon dioxide. In some embodiments, the carbonate content of a mother liquor is reduced by placing the mother liquor in contact with an ion exchange material that absorbs lithium while releasing protons, leading to a decrease in pH to generate carbon dioxide. In some embodiments, the carbonate content of a mother liquor may be (e.g., is) reduced by lowering the pH of the mother liquor to a neutral pH to generate carbon dioxide. In some embodiments, the carbonate content of a mother liquor may be (e.g., is) reduced by lowering the pH of the mother liquor to an acidic pH to generate carbon dioxide.

In some embodiments, the pH value of a mother liquor after treatment to lower or eliminate its carbonate content is less than the pH of the mother liquor. In some embodiments, the pH value of a mother liquor after treatment to lower or eliminate its carbonate content is greater than 0.0 but less than 1.0. In some embodiments, the pH value of a mother liquor after treatment to lower or eliminate its carbonate content is greater than 1.0 but less than 2.0. In some embodiments, the pH value of a mother liquor after treatment to lower or eliminate its carbonate content is greater than 2.0 but less than 3.0. In some embodiments, the pH value of a mother liquor after treatment to lower or eliminate its carbonate content is greater than 3.0 but less than 4.0. In some embodiments, the pH value of a mother liquor after treatment to lower or eliminate its carbonate content is greater than 4.0 but less than 5.0. In some embodiments, the pH value of a mother liquor after treatment to lower or eliminate its carbonate content is greater than 5.0 but less than 6.0. In some embodiments, the pH value of a mother liquor after treatment to lower or eliminate its carbonate content is greater than 6.0 but less than 7.0.

In some embodiments, the pH of a mother liquor is altered from about 14 to about 7 as a result of treatment (e.g., removal or elimination of carbonates, neutralization, concentration, or a combination thereof). In some embodiments, the pH of a mother liquor is altered from about 13 to about 7 as a result of treatment. In some embodiments, the pH of a mother liquor is altered from about 12 to about 7 as a result of treatment. In some embodiments, the pH of a mother liquor is altered from about 11 to about 7 as a result of treatment. In some embodiments, the pH of a mother liquor is altered from about 10 to about 7 as a result of treatment. In some embodiments, the pH of a mother liquor is altered from about 9 to about 7 as a result of treatment. In some embodiments, the pH of a mother liquor is altered from about 8 to about 7 as a result of treatment. In some embodiments, the pH of a mother liquor is altered from about 14 to about 8 as a result of treatment. In some embodiments, the pH of a mother liquor is altered from about 13 to about 8 as a result of treatment. In some embodiments, the pH of a mother liquor is altered from about 12 to about 8 as a result of treatment. In some embodiments, the pH of a mother liquor is altered from about 11 to about 8 as a result of treatment. In some embodiments, the pH of a mother liquor is altered from about 10 to about 8 as a result of treatment. In some embodiments, the pH of a mother liquor is altered from about 9 to about 8 as a result of treatment. In some embodiments, the pH of a mother liquor is altered from about 14 to about 6 as a result of treatment. In some embodiments, the pH of a mother liquor is altered from about 13 to about 6 as a result of treatment. In some embodiments, the pH of a mother liquor is altered from about 12 to about 6 as a result of treatment. In some embodiments, the pH of a mother liquor is altered from about 11 to about 6 as a result of treatment. In some embodiments, the pH of a mother liquor is altered from about 10 to about 6 as a result of treatment. In some embodiments, the pH of a mother liquor is altered from about 9 to about 6 as a result of treatment. In some embodiments, the pH of a mother liquor is altered from about 14 to about 5 as a result of treatment. In some embodiments, the pH of a mother liquor is altered from about 13 to about 5 as a result of treatment. In some embodiments, the pH of a mother liquor is altered from about 12 to about 5 as a result of treatment. In some embodiments, the pH of a mother liquor is altered from about 11 to about 5 as a result of treatment. In some embodiments, the pH of a mother liquor is altered from about 10 to about 5 as a result of treatment. In some embodiments, the pH of a mother liquor is altered from about 9 to about 5 as a result of treatment. In some embodiments, the pH of a mother liquor is altered from about 14 to about 4 as a result of treatment. In some embodiments, the pH of a mother liquor is altered from about 13 to about 4 as a result of treatment. In some embodiments, the pH of a mother liquor is altered from about 12 to about 4 as a result of treatment. In some embodiments, the pH of a mother liquor is altered from about 11 to about 4 as a result of treatment. In some embodiments, the pH of a mother liquor is altered from about 10 to about 4 as a result of treatment. In some embodiments, the pH of a mother liquor is altered from about 9 to about 4 as a result of treatment. In some embodiments, the pH of a mother liquor is altered from about 14 to below 4 as a result of treatment. In some embodiments, the pH of a mother liquor is altered from about 13 to below 4 as a result of treatment. In some embodiments, the pH of a mother liquor is altered from about 12 to about 6 as a result of treatment. In some embodiments, the pH of a mother liquor is altered from about 11 to below 4 as a result of treatment. In some embodiments, the pH of a mother liquor is altered from about 10 to below 4 a result of treatment. In some embodiments, the pH of a mother liquor is altered from about 9 to below 4 as a result of treatment. In some embodiments, the pH of a mother liquor is altered from about 8 to below 4 as a result of treatment. In some embodiments, the pH of a mother liquor is altered from about 7 to below 4 as a result of treatment. In some embodiments, the pH of a mother liquor is altered from above 9 to below 4 as a result of treatment. In some embodiments, the pH of a mother liquor is altered from above 10 to below 3 as a result of treatment. In some embodiments, the pH of a mother liquor is altered from above 9 to below 2 as a result of treatment. In some embodiments, the pH of a mother liquor is altered from above 9 to below 1 as a result of treatment.

In some embodiments, the acid used in the treatment to lower or eliminate carbonate content in a mother liquor is hydrochloric acid, and lithium carbonate is converted into lithium chloride. In some embodiments, the acid used in the treatment to lower or eliminate carbonate content in a mother liquor is sulfuric acid, and lithium carbonate is converted into lithium sulfate. In some embodiments, the acid used in the treatment to lower or eliminate carbonate content in a mother liquor is phosphoric acid, and lithium carbonate is converted into lithium phosphate. In some embodiments, the acid used in the treatment to lower or eliminate carbonate content in a mother liquor is nitric acid, and lithium carbonate is converted into lithium nitrate. In some embodiments, the concentration of carbonate in a depleted carbonate mother liquor is greater than about 1000.0 milligrams per liter and less than about 30000 milligrams per liter. In some embodiments, the concentration of carbonate in a depleted carbonate mother liquor is greater than about 10 milligrams per liter and less than about 100 milligrams per liter. In some embodiments, the concentration of carbonate in a depleted carbonate mother liquor is greater than about 100 milligrams per liter and less than about 500 milligrams per liter. In some embodiments, the concentration of carbonate in a depleted carbonate mother liquor is greater than about 500 milligrams per liter and less than about 1000 milligrams per liter. In some embodiments, the concentration of carbonate in a depleted carbonate mother liquor is greater than about 1000 milligrams per liter and less than about 5000 milligrams per liter. In some embodiments the concentration of carbonate in a depleted carbonate mother liquor is greater than about 5000 milligrams per liter and less than about 10000 milligrams per liter. In some embodiments, the concentration of carbonate in a depleted carbonate mother liquor is greater than about 10000 milligrams per liter and less than about 50000 milligrams per liter. In some embodiments, the concentration of carbonate in a depleted carbonate mother liquor is greater than about 50000 milligrams per liter and less than about 100000 milligrams per liter. In some embodiments, the concentration of carbonate in a depleted carbonate mother liquor is less than 10 milligrams per liter. In some embodiments, the concentration of carbonate in a depleted carbonate mother liquor is less than 5 milligrams per liter. In some embodiments, the concentration of carbonate in a depleted carbonate mother liquor is less than 1 milligrams per liter. In some embodiments, the concentration of carbonate in a depleted carbonate mother liquor is less than 0.5 milligrams per liter. In some embodiments, the concentration of carbonate in a depleted carbonate mother liquor is less than 0.1 milligrams per liter. In some embodiments, the concentration of carbonate in a depleted carbonate mother liquor is less than 0.01 milligrams per liter. In some embodiments, the concentration of carbonate in a depleted carbonate mother liquor is sufficiently low that it is not detectable or measurable.

In some embodiments, the carbonate content of a mother liquor may be (e.g., is) converted to carbon dioxide. In some embodiments, carbon dioxide may be (e.g., is) removed from a mother liquor by injecting a gas stream free of carbon dioxide into the mother liquor. In some embodiments, said gas is air free of carbon dioxide. In some embodiments, said gas is nitrogen. In some embodiments, said gas is steam. In some embodiments, carbon dioxide may be (e.g., is) removed from a mother liquor by employing a steam stripping column. In some embodiments, the carbon dioxide may be (e.g., is) removed from a mother liquor by a stripping column wherein said mother liquor is contacted with a gas stream free of carbon dioxide.

In some embodiments, the mother liquor is treated to lower or eliminate its carbonate content at room temperature. In some embodiments, the mother liquor is treated to lower or eliminate its carbonate content above room temperature. In some embodiments, the mother liquor is treated to lower or eliminate its carbonate content below room temperature. In some embodiments, the mother liquor is treated to lower or eliminate its carbonate content at a temperature of about 0 to about 10 degrees Celsius. In some embodiments, the mother liquor is treated to lower or eliminate its carbonate content at a temperature of about 10 to about 20 degrees Celsius. In some embodiments, the mother liquor is treated to lower or eliminate its carbonate content at a temperature of about 20 to about 30 degrees Celsius. In some embodiments, the mother liquor is treated to lower or eliminate its carbonate content at a temperature of about 30 to about 40 degrees Celsius. In some embodiments, the mother liquor is treated to lower or eliminate its carbonate content at a temperature of about 40 to about 50 degrees Celsius. In some embodiments, the mother liquor is treated to lower or eliminate its carbonate content at a temperature of about 50 to about 60 degrees Celsius. In some embodiments, the mother liquor is treated to lower or eliminate its carbonate content at a temperature of about 60 to about 70 degrees Celsius. In some embodiments, the mother liquor is treated to lower or eliminate its carbonate content at a temperature of about 70 to about 80 degrees Celsius. In some embodiments, the mother liquor is treated to lower or eliminate its carbonate content at a temperature of about 80 to about 90 degrees Celsius. In some embodiments, the mother liquor is treated to lower or eliminate its carbonate content at a temperature of about 90 to about 100 degrees Celsius. In some embodiments, the mother liquor is treated to lower or eliminate its carbonate content at a temperature of about 100 to about 110 degrees Celsius. In some embodiments, the mother liquor is treated to lower or eliminate its carbonate content at a temperature of about 110 to about 120 degrees Celsius. In some embodiments, the mother liquor is treated to lower or eliminate its carbonate content at a temperature of about 120 to about 130 degrees Celsius. In some embodiments, the mother liquor is treated to lower or eliminate its carbonate content at a temperature of about 130 to about 140 degrees Celsius. In some embodiments, the mother liquor is treated to lower or eliminate its carbonate content at a temperature of about 140 to about 150 degrees Celsius. In some embodiments, the mother liquor is treated to lower or eliminate its carbonate content at a temperature of about 150 to about 160 degrees Celsius. In some embodiments, the mother liquor is treated to lower or eliminate its carbonate content at a temperature of about 160 to about 200 degrees Celsius.

In some embodiments, the mass ratio of mother liquor treated to acid added to lower or eliminate its carbonate content is approximately 1:1, 5:1, 10:1, 50:1, 100:1, 500:1, 1,000:1, 5,000:1, 10,000:1, 50,000:1, 100,000:1, 500,000:1, 1,000,000:1, 5,000,000:1, 10,000,000:1.

In some embodiments, the depleted carbonate mother liquor is acidic, and its pH is adjusted to a higher value before further treatment. In some embodiments, the pH value is adjusted to a value greater than 0.0 but less than 1.0, adjusted to a value greater than 1.0 but less than 2.0, adjusted to a value greater than 2.0 but less than 3.0, adjusted to a value greater than 3.0 but less than 4.0, adjusted to a value greater than 4.0 but less than 5.0, adjusted to a value greater than 5.0 but less than 6.0, adjusted to a value greater than 6.0 but less than 7.0, adjusted to a value greater than 7.0 but less than 8.0, adjusted to a value greater than 8.0 but less than 9.0, adjusted to a value greater than 9.0 but less than 10.0, adjusted to a value greater than 10.0 but less than 11.0, adjusted to a value greater than 11.0 but less than 12.0, adjusted to a value greater than 12.0 but less than 13.0, adjusted to a value greater than 13.0 but less than 14.0. In some embodiments, the pH value is adjusted to a value greater than 7.0 but less than 8.0.

In some embodiments, the depleted carbonate mother liquor is acidic, and its pH is adjusted to a higher value before further treatment by treatment of said depleted carbonate mother liquor with a base. In some embodiments, said base comprises sodium hydroxide, calcium hydroxide, lithium hydroxide, magnesium hydroxide, potassium hydroxide, strontium hydroxide, barium hydroxide, as pure solids or in aqueous, mixtures thereof, or combination thereof. In some embodiments, the mass ratio of mother liquor treated to base added for adjustment of pH is approximately 1:1, 5:1, 10:1, 50:1, 100:1, 500:1, 1,000:1, 5,000:1, 10,000:1, 50,000:1, 100,000:1, 500,000:1, 1,000,000:1, 5,000,000:1, 10,000,000:1.

In some embodiments, the adjustment of the pH to reduce or eliminate the carbonate content of the mother liquor, and the adjustment of pH to a higher value are done in the same system. In some embodiments, the adjustment of the pH to reduce or eliminate the carbonate content of the mother liquor, and the adjustment of pH to a higher value are done in the separate systems. In some embodiments, said system comprises a vessel or tank. In some embodiments, said vessel or tank is agitated or stirred to ensure good mixing of reagents. In some embodiments, said vessel or tank is heated. In some embodiments, said vessel or tank is made of metal. In some embodiments, said vessel or tank is designed for venting of carbon dioxide. In some embodiments, said vessel contains baffles. In some embodiments, the adjustment of the pH is performed in an agitated vessel. In some embodiments, said vessel is a jacked vessel. In some embodiments, said jacket is used to add heat to or remove heat from said vessel. In some embodiments, said vessel contains two or more baffles. In some embodiments, said vessel contains nozzles for injecting liquid, air, gas, or a combination thereof. In some embodiments, said nozzles are used for recirculating the contents of said vessel. In some embodiments, said nozzles are used for mixing said vessel. In some embodiments, air is used to recirculate the contents of said vessel. In some embodiments, the adjustment of the pH is performed using an inline mixer that mixes the acid or base with the mother liquor.

In some embodiments, the carbon dioxide released from the mother liquor is captured. In some embodiments, said captured carbon dioxide is used for production of lithium carbonate. In some embodiments, said captured carbon dioxide is sequestered. In some embodiments, said sequestration results in a lower carbon emissions for the lithium carbonate production process.

Example 5 and 6 describe certain non-limiting embodiments wherein the carbonate is destroyed by addition of hydrochloric acid. Example 4 describes a non-limiting embodiment wherein carbonates are destroyed by addition of sulfuric acid.

System for Recovering Water and Salts from the Mother Liquor

In some embodiments, the water content of a mother liquor may be (e.g., is) lowered to generate water and a concentrated mother liquor (e.g., a concentrated lithium solution). In some embodiments, the water content of a mother liquor may be (e.g., is) lowered after the carbonate content of the mother liquor has been lowered by a prior-implemented process. In some embodiments, the water content of a mother liquor may be (e.g., is) lowered before any process has been implemented that lowers the carbonate content of the mother liquor.

In some embodiments, a water removal unit is configured to lower the water content of a mother liquor. In some embodiments, the water content of a mother liquor may be (e.g., is) lowered by employing a mechanical vapor recompression system. In some embodiments, the water content of a mother liquor may be (e.g., is) lowered by employing a multiple effects evaporator. In some embodiments, the water content of a mother liquor may be (e.g., is) lowered by employing an evaporation pond. In some embodiments, an evaporation pond is an open vessel or depression configured to expose a liquid solution to air currents and optionally sunlight for the purpose of lowering the water content of the liquid solution. In some embodiments, the water content of a mother liquor may be (e.g., is) lowered by distillation of water from the mother liquor. In some embodiments, distillation involves the evaporation, condensation and collection of water from a liquid solution. In some embodiments, the water content of a mother liquor may be (e.g., is) lowered by heating the mother liquor. In some embodiments, heating of a mother liquor may optionally involve boiling the mother liquor.

In some embodiments, a water removal unit is configured to affect the temperature of the mother liquor as its water content is being lowered. In some embodiments, the mother liquor may be (e.g., is) at a temperature of −20 to 150° C. when its water content is being lowered. In some embodiments, the mother liquor may be (e.g., is) at a temperature of −20 to 120° C. when its water content is being lowered. In some embodiments, the mother liquor may be (e.g., is) at a temperature of −20 to 100° C. when its water content is being lowered. In some embodiments, the mother liquor may be (e.g., is) at a temperature of −20 to 80° C. when its water content is being lowered. In some embodiments, the mother liquor may be (e.g., is) at a temperature of 0 to 150° C. when its water content is being lowered. In some embodiments, the mother liquor may be (e.g., is) at a temperature of 20 to 150° C. when its water content is being lowered. In some embodiments, the mother liquor may be (e.g., is) at a temperature of 40 to 120° C. when its water content is being lowered. In some embodiments, the mother liquor may be (e.g., is) at a temperature of 40 to 100° C. when its water content is being lowered.

In some embodiments, the system where the water content of the mother liquor is lowered comprises one or more crystallization systems. In some embodiments, a water removal unit comprises one or more crystallization systems. In some embodiments, said one or more crystallization systems comprise a crystallizer. In some embodiments, said one or more crystallization systems comprise an evaporative crystallizer. In some embodiments, the crystallizers are heated. In some embodiments, the crystallizers are insulated. In some embodiments, the crystallizers are agitated tanks. In some embodiments, the crystallizers are mechanical vapor recompression units. In some embodiments, the crystallizers comprise one or more draft tube baffle crystallizers, which independently comprise an agitator, a center tube, and a cylindrical baffle to allow clarified liquor to be withdrawn and thicken the operating slurry magma density. In some embodiments, only one crystallizer is present in the system. In some embodiments, two crystallizers in series are present in the system. In some embodiments, three crystallizers in series are present in the system. In some embodiments, four crystallizers in series are present in the system. In some embodiments, five or more crystallizers are present in the system. In some embodiments, and acid, a base, or a combination thereof are added to said crystallizers. In some embodiments, solids (e.g., solid salts) crystallize in said crystallizer. In some embodiments, solids are removed from said crystallizers. In some embodiments, said solids are removed continuously, semi-continuously, in batches, or a combination thereof. In some embodiments, solids are removed from the bottom, the top, or the middle of the crystallizer. In some embodiments, said solids are removed from a specially designed section of said crystallizer. In some embodiments, liquids are removed from said crystallizers. In some embodiments, said liquids are removed continuously, semi-continuously, in batches, or a combination thereof. In some embodiments, liquids are removed from the bottom, the top, or the middle of the crystallizer. In some embodiments, said liquids are removed from a specially designed section of said crystallizer. In some embodiments, said liquids are removed from the baffled section of said crystallizer.

In some embodiments, a water removal unit is configured to provide a concentrated lithium solution. In some embodiments, a concentrated mother liquor (e.g., a concentrated lithium solution) is one of the products generated by lowering the water content of a mother liquor. In some embodiments, a concentrated mother liquor (e.g., a concentrated lithium solution) may have (e.g., has) a higher lithium concentration than the mother liquor from which it was generated. In some embodiments, a concentrated mother liquor (e.g., a concentrated lithium solution) may have (e.g., has) a higher sodium concentration than the mother liquor from which it was generated. In some embodiments, a concentrated mother liquor (e.g., a concentrated lithium solution) may have (e.g., has) a higher potassium concentration than the mother liquor from which it was generated. In some embodiments, a concentrated mother liquor (e.g., a concentrated lithium solution) may have (e.g., has) a higher chloride concentration than the mother liquor from which it was generated. In some embodiments, a concentrated mother liquor (e.g., a concentrated lithium solution) may have (e.g., has) a higher carbonate concentration than the mother liquor from which it was generated.

In some embodiments, the concentration of lithium in a concentrated mother liquor (e.g., a concentrated lithium solution) is greater than about 1000.0 milligrams per liter and less than about 30000 milligrams per liter. In some embodiments, the concentration of lithium in a concentrated mother liquor (e.g., a concentrated lithium solution) is greater than about 10 milligrams per liter and less than about 100 milligrams per liter. In some embodiments, the concentration of lithium in a concentrated mother liquor (e.g., a concentrated lithium solution) is greater than about 100 milligrams per liter and less than about 500 milligrams per liter. In some embodiments, the concentration of lithium in a concentrated mother liquor (e.g., a concentrated lithium solution) is greater than about 500 milligrams per liter and less than about 1000 milligrams per liter. In some embodiments, the concentration of lithium in a concentrated mother liquor (e.g., a concentrated lithium solution) is greater than about 1000 milligrams per liter and less than about 5000 milligrams per liter. In some embodiments the concentration of lithium in a concentrated mother liquor (e.g., a concentrated lithium solution) is greater than about 5000 milligrams per liter and less than about 10000 milligrams per liter. In some embodiments, the concentration of lithium in a concentrated mother liquor (e.g., a concentrated lithium solution) is greater than about 10000 milligrams per liter and less than about 50000 milligrams per liter. In some embodiments, the concentration of lithium in a concentrated mother liquor (e.g., a concentrated lithium solution) is greater than about 50000 milligrams per liter and less than about 100000 milligrams per liter. In some embodiments, the concentration of lithium in a concentrated mother liquor (e.g., a concentrated lithium solution) is greater than about 100000 milligrams per liter and less than about 200000 milligrams per liter. In some embodiments the concentration of lithium in a concentrated mother liquor (e.g., a concentrated lithium solution) is greater than about 200000 milligrams per liter and less than about 300000 milligrams per liter. In some embodiments, the concentration of lithium in a concentrated mother liquor (e.g., a concentrated lithium solution) is greater than about 300000 milligrams per liter and less than about 500000 milligrams per liter.

In some embodiments, the concentration of sodium in a concentrated mother liquor (e.g., a concentrated lithium solution) is greater than about 1000.0 milligrams per liter and less than about 30000 milligrams per liter. In some embodiments, the concentration of sodium in a concentrated mother liquor (e.g., a concentrated lithium solution) is greater than about 10 milligrams per liter and less than about 100 milligrams per liter. In some embodiments, the concentration of sodium in a concentrated mother liquor (e.g., a concentrated lithium solution) is greater than about 100 milligrams per liter and less than about 500 milligrams per liter. In some embodiments, the concentration of sodium in a concentrated mother liquor (e.g., a concentrated lithium solution) is greater than about 500 milligrams per liter and less than about 1000 milligrams per liter. In some embodiments, the concentration of sodium in a concentrated mother liquor (e.g., a concentrated lithium solution) is greater than about 1000 milligrams per liter and less than about 5000 milligrams per liter. In some embodiments the concentration of sodium in a concentrated mother liquor (e.g., a concentrated lithium solution) is greater than about 5000 milligrams per liter and less than about 10000 milligrams per liter. In some embodiments, the concentration of sodium in a concentrated mother liquor (e.g., a concentrated lithium solution) is greater than about 10000 milligrams per liter and less than about 50000 milligrams per liter. In some embodiments, the concentration of sodium in a concentrated mother liquor (e.g., a concentrated lithium solution) is greater than about 50000 milligrams per liter and less than about 100000 milligrams per liter. In some embodiments, the concentration of sodium in a concentrated mother liquor (e.g., a concentrated lithium solution) is greater than about 100000 milligrams per liter and less than about 200000 milligrams per liter. In some embodiments the concentration of sodium in a concentrated mother liquor (e.g., a concentrated lithium solution) is greater than about 200000 milligrams per liter and less than about 300000 milligrams per liter. In some embodiments, the concentration of sodium in a concentrated mother liquor (e.g., a concentrated lithium solution) is greater than about 300000 milligrams per liter and less than about 500000 milligrams per liter.

In some embodiments, the concentration of potassium in a concentrated mother liquor (e.g., a concentrated lithium solution) is greater than about 1000.0 milligrams per liter and less than about 30000 milligrams per liter. In some embodiments, the concentration of potassium in a concentrated mother liquor (e.g., a concentrated lithium solution) is greater than about 10 milligrams per liter and less than about 100 milligrams per liter. In some embodiments, the concentration of potassium in a concentrated mother liquor (e.g., a concentrated lithium solution) is greater than about 100 milligrams per liter and less than about 500 milligrams per liter. In some embodiments, the concentration of potassium in a concentrated mother liquor (e.g., a concentrated lithium solution) is greater than about 500 milligrams per liter and less than about 1000 milligrams per liter. In some embodiments, the concentration of potassium in a concentrated mother liquor (e.g., a concentrated lithium solution) is greater than about 1000 milligrams per liter and less than about 5000 milligrams per liter. In some embodiments the concentration of potassium in a concentrated mother liquor (e.g., a concentrated lithium solution) is greater than about 5000 milligrams per liter and less than about 10000 milligrams per liter. In some embodiments, the concentration of potassium in a concentrated mother liquor (e.g., a concentrated lithium solution) is greater than about 10000 milligrams per liter and less than about 50000 milligrams per liter. In some embodiments, the concentration of potassium in a concentrated mother liquor (e.g., a concentrated lithium solution) is greater than about 50000 milligrams per liter and less than about 100000 milligrams per liter. In some embodiments, the concentration of potassium in a concentrated mother liquor (e.g., a concentrated lithium solution) is greater than about 100000 milligrams per liter and less than about 200000 milligrams per liter. In some embodiments the concentration of potassium in a concentrated mother liquor (e.g., a concentrated lithium solution) is greater than about 200000 milligrams per liter and less than about 300000 milligrams per liter. In some embodiments, the concentration of potassium in a concentrated mother liquor (e.g., a concentrated lithium solution) is greater than about 300000 milligrams per liter and less than about 500000 milligrams per liter.

In some embodiments, solid salts are generated in the course of lowering the water content of a mother liquor. In some embodiments, solid salts are crystallized in the course of lowering the water content of a mother liquor. In some embodiments, the solid salts comprise sodium chloride and potassium chloride. In some embodiments, the solid salts comprise sodium chloride. In some embodiments, the solid salts are essentially free of lithium. In some embodiments, the solid salts are collected for further use. In some embodiments, the solid salts are dissolved in water to yield a solution of solid salts. In some embodiments, the solid salts are dissolved in water obtained as a product of lowering the water content of a mother liquor to yield a solution of solid salts. In some embodiments, the solid salts comprise less than 1% of carbonate salts. In some embodiments, the solid salts contain a negligible amount of carbonate salts.

In some embodiments, a removal system is used generated solid salts in the course of lowering the water content of a mother liquor. In some embodiments, more than one water removal system is used, wherein one removal system produces solids of different type and purity. In some embodiments, multiple removal systems are utilized. In some embodiments, a first removal system is utilized to generate solid that is 80% or more sodium chloride by weight of the solid, and a second removal system us utilized to generate a mixture of sodium chloride and potassium chloride in which sodium chloride is present in less than 80% by weight.

In some embodiments, the methods, processes, and systems disclosed herein comprise a liquid-solid separation method to remove the generated solid salts and separate them from the mother liquor. In some embodiments, the mother liquor recovered from the solid salts recovered by said method are recycled to the water removal system. In some embodiments said water removal system is an evaporative crystallizer. In some embodiments, the recycling of said mother liquor ensures that any lithium contained within said mother liquor is further recovered when mother liquor is removed from the water removal system.

In some embodiments, said methods for removal of the solid salts generated comprise filtration, gravity sedimentation, centrifugal sedimentation, magnetic fields, other methods of solid-liquid separation, or combinations thereof. In some embodiments, said method comprises filtration. In some embodiments, the filter is a belt filter, filter press, plate-and-frame filter press, recessed-chamber filter press, pressure vessel containing filter elements, candle filter, pressure filter, pressure-leaf filter, Nutsche filter, rotary drum filter, rotary disc filter, cartridge filter, bag filter, a centrifugal filter with a fixed or moving bed, a metal screen, a perforated basket centrifuge, a three-point centrifuge, a peeler type centrifuge, a decanter centrifuge, or a pusher centrifuge. In some embodiments, the filter uses a scroll or a vibrating device. In some embodiments, the filter is horizontal, vertical, or may use a siphon. In some embodiments, a liquid-solid separation method is used to collect the solids salts for further use. In some embodiments, the method of liquid-solid separation is configured to wash the separated solids. In some embodiments, said solids are washed with water. In some embodiments, said water is recycled into the water removal system such that the water is recovered from said wash water, and reused.

In some embodiments, the solids salts comprise sodium chloride. In some embodiments, the solids salts comprise potassium chloride. In some embodiments, the solids salts comprise a mixture of sodium chloride and potassium chloride. In some embodiments, the solids salts comprise lithium chloride. In some embodiments, the purity of the solid salts on a mass basis is greater than 50%, greater than 60%, greater than 70%, greater than 80%, greater than 90%, greater than 95%, greater than 99%, greater than 99.5%, or greater than 99.9%.

In some embodiments, said solids salt are recovered and used in a separate process. In some embodiments, a solution of solid salts may be (e.g., is) used as a chemical precursor for generating acid and base. In some embodiments, a solution of solid salts may be (e.g., is) used as a chemical precursor for generating hydrochloric acid and sodium hydroxide. In some embodiments, a solution of solid salts may be (e.g., is) further purified and used as a chemical precursor for generating hydrochloric acid and sodium hydroxide. In some embodiments, a solution of solid salts may be (e.g., is) used as a chemical precursor for generating hydrochloric acid, sodium hydroxide, and potassium hydroxide.

In some embodiments, a solution of solid salts may be (e.g., is) used as an input to a chloralkali plant that generates acid and base. In some embodiments, a solution of solid salts may be (e.g., is) used an input to a chloralkali plant that generates hydrochloric acid and sodium hydroxide. In some embodiments, a solution of solid salts may be (e.g., is) used as an input to a chloralkali plant that generates hydrochloric acid, sodium hydroxide, and potassium hydroxide. In some embodiments, a chloralkali plant may comprise (e.g., comprises) a system for electrolysis of an aqueous solution containing sodium and chloride to generate chlorine, hydrogen, and sodium hydroxide. In some embodiments, a chloralkali plant may comprise (e.g., comprises) a system for electrolysis of an aqueous solution containing sodium, potassium, and chloride to generate chlorine, hydrogen, potassium hydroxide and sodium hydroxide. In some embodiments, a chloralkali plant may comprise (e.g., comprises) a unit that promotes conversion of chlorine and hydrogen gases into hydrochloric acid. In some embodiments, the hydrochloric acid generated by a chloralkali plant may be (e.g., is) used as a reagent in lithium-selective ion exchange processes. In some embodiments, the sodium hydroxide generated by a chloralkali plant may be (e.g., is) used as a reagent in lithium-selective ion exchange processes. In some embodiments, the potassium hydroxide generated by a chloralkali plant may be (e.g., is) used as a reagent in lithium-selective ion exchange processes.

In some embodiments, a solution of solid salts may be (e.g., is) used as an input to a plant that generates acid and base. In some embodiments, a said plant may comprise (e.g., comprises) a 3-compartment bipolar electrodialysis plant. In some embodiments, said plant may comprise (e.g., comprises) a 2-compartment bipolar electrodialysis plant. In some embodiments, said plant may comprise (e.g., comprises) a multiple electrodialysis circuits. In some embodiments, said plant may comprise (e.g., comprises) an electrolysis cell.

System for Recovering Lithium from the Mother Liquor

In some embodiments, a mother liquor or concentrated mother liquor (e.g., a concentrated lithium solution) may be (e.g., is) directed to enter a system or subsystem for the purpose of recovering the lithium content of the mother liquor or concentrated mother liquor (e.g., a concentrated lithium solution). In some embodiments, the mother liquor or a concentrated lithium solution is generated by removal of carbonates from said mother liquor (e.g., reducing, lowering or eliminating the carbonate content of the mother liquor). In some embodiments, the mother liquor or a concentrated lithium solution is generated by pH adjustment of said mother liquor. In some embodiments, the mother liquor or a concentrated lithium solution is generated by removal of water from said mother liquor. In some embodiments, the mother liquor or a concentrated lithium solution is generated by 1) removal of carbonates from said mother liquor, 2) optional pH adjustment of said mother liquor, and 3) removal of water from said mother liquor.

In some embodiments a mother liquor or a concentrated lithium solution comprises lithium. In some embodiments a mother liquor or a concentrated lithium solution comprises sodium. In some embodiments a mother liquor or a concentrated lithium solution comprises potassium. In some embodiments a mother liquor or a concentrated lithium solution comprises boron. In some embodiments a mother liquor or a concentrated lithium solution comprises chloride. In some embodiments, a mother liquor or a concentrated lithium solution comprises sulfate. In some embodiments, a mother liquor or a concentrated lithium solution may comprise lithium, sodium, potassium, boron, chloride, or combinations thereof. In some embodiments, a mother liquor or a concentrated lithium solution comprises lithium, sodium, potassium, boron, sulfate or combinations thereof. In some embodiments, a mother liquor or a concentrated lithium solution comprises chloride and sulfate anions. In some embodiments, a mother liquor or a concentrated lithium solution comprises lithium, sodium, potassium, boron, magnesium, calcium, and strontium. In some embodiments, the concentration of monovalent cations to multivalent cations on a mass bases is more than about 10:1, more than about 100:1, more than about 1000:1, more than about 10,000:1, more than about 100,000:1, more than about 1,000,000:1, more than about 10,000,000:1.

In some embodiments, a mother liquor or concentrated mother liquor (e.g., a concentrated lithium solution) may be (e.g., is) combined with a liquid resource to yield a combined stream that enters a lithium extraction unit containing a lithium-selective sorbent. In some embodiments, the mother liquor is combined with a liquid resource wherein the ratio of lithium in the mother liquor or a concentrated lithium solution to lithium in the liquid resource is from about 1:1 to about 1:1000. In some embodiments, the ratio of lithium in the mother liquor or a concentrated lithium solution to lithium in the liquid resource is about 1000:1, about 500:1, about 250:1, about 150:1, about 100:1, about 90:1, about 80:1, about 70:1, about 60:1, about 50:1, about 40:1, about 30:1, about 20:1, about 10:1, about 5:1, about 2:1, about 1:1, about 1:2, about 1:5, about 1:10, about 1:20, about 1:30, about 1:40, 1:about 50, about 1:60, about 1:70, about 1:80, about 1:90, about 1:100, about 1:150, about 1:250, about 1:500, about 1:1000, or any intermediate value between these values. In some embodiments, a mother liquor or a concentrated lithium solution is combined with a liquid resource and solids may precipitate from the combined liquid. In some embodiments, a mother liquor or a concentrated lithium solution is combined with a liquid resource and solids may precipitate from the combined liquid, and said liquid filtered to removed said precipitated solids. In some embodiments, solids comprise carbonates, wherein at least a portion of said carbonates originate from the mother liquor. In some embodiments, a mother liquor or a concentrated lithium solution is combined with a liquid resource, and said combined liquid is sent to a lithium extraction system. In some embodiments, said lithium extraction system comprises an ion exchange material which selectively absorbs lithium.

In some embodiments, a mother liquor or a concentrated lithium solution may be (e.g., is) combined with a synthetic lithium solution or lithium eluate to yield a combined solution that enters a purification circuit configured to remove impurities from the combined solution. In some embodiments, a mother liquor or a concentrated lithium solution is combined with a synthetic lithium solution or lithium eluate to yield a combined solution. In some embodiments, said synthetic lithium solution or lithium eluate has been purified to a yield a similar lithium and impurity composition as the concentrated lithium solution, such that no further purification is required. In some embodiments, the mother liquor or a concentrated lithium solution is combined with a synthetic lithium solution or lithium eluate wherein the ratio of lithium in the mother liquor or a concentrated lithium solution to lithium in the synthetic lithium solution or lithium eluate is from about 1:1 to about 1:1000. In some embodiments, the ratio of lithium in the mother liquor or a concentrated lithium solution to lithium in the synthetic lithium solution or lithium eluate is about 1000:1, about 500:1, about 250:1, about 150:1, about 100:1, about 90:1, about 80:1, about 70:1, about 60:1, about 50:1, about 40:1, about 30:1, about 20:1, about 10:1, about 5:1, about 2:1, about 1:1, about 1:2, about 1:5, about 1:10, about 1:20, about 1:30, about 1:40, 1:about 50, about 1:60, about 1:70, about 1:80, about 1:90, about 1:100, about 1:150, about 1:250, about 1:500, about 1:1000, or any intermediate value between these values.

In some embodiments, a mother liquor or concentrated mother liquor (e.g., a concentrated lithium solution) may be (e.g., is) combined with a synthetic lithium solution or lithium eluate to yield a combined solution. In some embodiments, said combined solution is sent to a lithium extraction system. In some embodiments, said lithium extraction system comprises an ion exchange material which selectively absorbs lithium. In some embodiments, said combined solution undergoes further purification or chemical modification treatment to yield a treated combined solution. In some embodiments, said purification or chemical modification treatment comprises the removal of impurities. In some embodiments, said impurities comprise calcium, magnesium, strontium, boron, sodium, potassium, sulfates, other cations, other anions, or a combination thereof. In some embodiments, said combined solution or treated combined solution enters a carbonation unit as described herein, wherein said carbonation unit is configured to increase the carbonate concentration of the combined solution or treated combined solution. In some embodiments, said increase in the carbonate concentration results in the precipitation of lithium carbonate solids.

In some embodiments, the combination of a mother liquor or a concentrated lithium solution with said liquid resource, synthetic lithium solution, or lithium eluate results in the recycling of lithium from the mother liquor or a concentrated lithium solution into the liquid resource or synthetic lithium solution which will undergo lithium extraction or lithium carbonate precipitation. The net result of such embodiments is the recycling and additional recovery of lithium that would have otherwise been left in solution within the mother liquor.

### Circuit Integrations

In some embodiments, said mother liquor or concentrated mother liquor (e.g., a concentrated lithium solution) comprises a liquid concentrated in lithium chloride. In some embodiments, said lithium chloride is recovered to increase the total lithium recovery of the system. In some embodiments, the lithium chloride that is not recovered in the main lithium extraction is found in said mother liquor; the integrated system described herein recovers said lithium in the mother liquor instead of discarding it, thereby increasing to overall recovery of the integrated lithium extraction system. Various embodiments of integrated system to recover lithium from said mother liquor are possible, and some of these integrated systems are described below. In some embodiments, said system integrations result in lower overall costs and higher overall lithium recoveries and lithium production rates.

In some embodiments, the lithium chloride in the concentrated mother liquor (e.g., a concentrated lithium solution) is recovered by a lithium selective ion exchange system. In some embodiments, said lithium selective ion exchange system is separate from the lithium selective ion exchange system that recovers lithium from the liquid resource. In some embodiments, said lithium selective ion exchange system is configured to operate under conditions that are optimal for the recovery of the lithium from the concentrated mother liquor (e.g., a concentrated lithium solution). In some embodiments, the lithium chloride in the concentrated mother liquor (e.g., a concentrated lithium solution) is recovered by a lithium selective ion exchange system that also extracts lithium from the liquid resource; such a configuration is achieved by mixing the concentrated mother liquor (e.g., a concentrated lithium solution) with the liquid resource before the combined stream enters the main lithium extraction system. In some embodiments, additional lithium recovery is therefore achieved from the overall integrated system comprising a lithium extraction system, a lithium carbonate precipitation system that produces a mother liquor, and a system to treat and concentrate the mother liquor that would be otherwise discarded, to instead produce salts from said mother liquor and redirect leftover lithium to the main lithium extraction circuit so that it can be recovered. In some embodiments, said solids salts are additionally used as raw materials to produce an acid and a base in an electrochemical system, thereby resulting in integration of the lithium recovery system with the acid and base production system, wherein said acid and base are used in the ion exchange system that extracts lithium from a liquid resource.

In some embodiments, the lithium chloride in the concentrated mother liquor (e.g., the concentrated lithium solution) is recovered by precipitating said lithium chloride in a lithium carbonate precipitation system. In some embodiments, said lithium carbonate precipitation system is the same precipitation system that produced the mother liquor. In some embodiments, said concentrated mother liquor (e.g., said concentrated lithium solution) is essentially free of divalent impurities, making it suitable to be directly mixed with the purified synthetic lithium chloride stream that is being fed into the lithium carbonate precipitation unit. In some embodiments, said concentrated mother liquor (e.g., said concentrated lithium solution) is directed upstream of the purification system used to purify the concentrated synthetic lithium chloride solution, thereby removing any impurities from the combined stream before lithium carbonate is precipitated from said stream. In some embodiments, there is a separate purification system to purify the concentrated lithium carbonate stream before it is combined with a purified and concentrated lithium chloride stream that is fed to a lithium carbonate precipitation system. In some embodiments, additional lithium recovery is therefore achieved from the overall integrated system comprising a lithium extraction system, a purification system, a lithium carbonate precipitation system that produces a mother liquor, and a system to treat and concentrate the mother liquor that would be otherwise discarded, to instead produce salts from said mother liquor and redirect leftover lithium to the lithium carbonate precipitation system so that it can be recovered. In some embodiments, said recover lithium first passes through the purification system before entering the lithium carbonate precipitation system. In some embodiments, said produced solid salts are additionally used as raw materials to produce an acid and a base in an electrochemical system, thereby resulting in integration of the lithium recovery system with the acid and base production system, wherein said acid and base are used in the ion exchange system that extracts lithium from a liquid resource.

In some embodiments, the lithium chloride in the concentrated lithium solution is recovered by recycling the concentrated lithium solution to one or more subsystems. In some embodiments, the lithium chloride in the concentrated lithium solution is recovered by recycling the concentrated lithium solution to a lithium carbonate precipitation subsystem. In some embodiments, the lithium chloride in the concentrated lithium solution is recovered by recycling the concentrated lithium solution to a liquid resource (e.g., brine) treatment subsystem. In some embodiments, the lithium chloride in the concentrated lithium solution is recovered by recycling the concentrated lithium solution to a brine treatment subsystem that is then fed into a lithium extraction subsystem. In some embodiments, the lithium chloride in the concentrated lithium solution is recovered by recycling the concentrated mother to a combination of a lithium carbonate precipitation system and lithium extraction subsystem. In some embodiments, the ratio of the concentrated lithium solution recycled to the lithium carbonate precipitation subsystem to the concentrated lithium solution recycled to the lithium extraction system is adjusted to prevent the accumulation of impurities in the lithium carbonate product and mother liquor. In some embodiments, said ratio is about 1000:1, about 500:1, about 250:1, about 150:1, about 100:1, about 90:1, about 80:1, about 70:1, about 60:1, about 50:1, about 40:1, about 30:1, about 20:1, about 10:1, about 5:1, about 2:1, about 1:1, about 1:2, about 1:5, about 1:10, about 1:20, about 1:30, about 1:40, 1:about 50, about 1:60, about 1:70, about 1:80, about 1:90, about 1:100, about 1:150, about 1:250, about 1:500, about 1:1000, or any intermediate value between the aforementioned values. In some embodiments, said ratio is continually adjusted between two or more values.

### Additional Embodiments of the Disclosure

Provided below are some non-limiting embodiments of the present disclosure:

Embodiment 1. A system for lithium recovery, the system comprising:
a. an inlet configured to direct a synthetic lithium solution into a first subsystem;
b. the first subsystem configured to yield solid lithium carbonate and a carbonate mother liquor by either:
   i. adding a carbonate base to the synthetic lithium solution, or
   ii. generating carbonate in the synthetic lithium solution;
c. a second subsystem configured to remove carbonates from the carbonate mother liquor to yield a depleted carbonate mother liquor; and
d. a third subsystem configured to remove water from the depleted carbonate mother liquor to yield solid salts and a concentrated lithium solution.

Embodiment 2. The system of Embodiment 1, wherein the synthetic lithium solution comprises (1) a solution produced by evaporation of a liquid resource or direct lithium extraction from a liquid resource; and optionally (2) the concentrated lithium solution of step (d).

Embodiment 3. The system of Embodiment 2, wherein the direct lithium extraction process requires an ion exchange unit.

Embodiment 4. The system of Embodiment 3, wherein the ion exchange unit comprises:
a. a lithium-selective sorbent, wherein the lithium-selective sorbent absorbs lithium ions from a liquid resource and releases lithium upon subsequent exposure to an eluate to yield a synthetic lithium solution;
b. an optional water removal unit, wherein water is removed from the synthetic lithium solution; and
c. an optional purification unit, wherein the synthetic lithium solution is purified.

Embodiment 5. The system of Embodiment 4, further comprising the water removal unit.

Embodiment 6. The system of any one of Embodiments 1 to 5, further comprising a purification unit.

Embodiment 7. The system of any one of Embodiments 2 to 6, further comprising a channel configured to direct the concentrated lithium solution of step (d) to be added to the synthetic lithium solution.

Embodiment 8. The system of Embodiment 7, wherein said addition occurs before the synthetic lithium solution enters the first subsystem.

Embodiment 9. The system of any one of Embodiments 2 to 8, wherein the concentrated lithium solution of step (d) is added to the liquid resource.

Embodiment 10. The system of any one of Embodiments 1 to 9, further comprising an electrochemical system configured to produce acid and hydroxide from the solid salts.

Embodiment 11. The system of Embodiment 10, wherein the acid and hydroxide are recycled for use the system for lithium recovery.

Embodiment 12. The system of any one of Embodiments 1 to 9, further comprising a pH modulation unit, wherein the pH of the liquid resource is modulated to a value of 5 and above with the addition of a base.

Embodiment 13. A system for lithium recovery from a liquid resource, the system comprising:
a. a pH modulation unit, wherein the pH of the liquid resource is modulated to a value of 5 and above with the addition of a base;
b. an ion exchange unit, the ion exchange unit comprising a lithium-selective sorbent, wherein the lithium-selective sorbent absorbs lithium ions from the liquid resource and releases lithium upon subsequent exposure to an acidic eluate to yield a synthetic lithium solution;
c. a purification unit configured to purify the synthetic lithium solution and modulate the pH of the synthetic lithium solution to 6 or above;
d. an inlet configured to direct the synthetic lithium solution into a first subsystem;
e. the first subsystem configured to yield solid lithium carbonate and a carbonate mother liquor by either:
   i. adding a carbonate base to the synthetic lithium solution, or
   ii. generating carbonate in the synthetic lithium solution;
f. a second subsystem configured to remove carbonates from the carbonate mother liquor to yield a depleted carbonate mother liquor;
g. a third subsystem configured to remove water from the depleted carbonate mother liquor to yield solid salts and a concentrated lithium liquid solution;
h. a channel configured to add the concentrated lithium solution to the synthetic lithium solution; and
i. an optional electrochemical system configured to produce acid and hydroxide from the solid salts, wherein the acid is optionally used in the eluate of (b) or in the second subsystem of (f), and wherein the hydroxide base is optionally used as the base in (a) or (c).

Embodiment 14. The system of any one of Embodiments 1 to 13, wherein the pH of the liquid resource is modulated to 6 or above, 7 or above, 8 or above, 9 or above, or 10 or above.

Embodiment 15. The system of any one of Embodiments 1 to 14, wherein the base comprises a hydroxide base or a carbonate base.

Embodiment 16. The system of Embodiment 15, wherein the base comprises NaOH, KOH, LiOH, Na₂CO₃, K₂CO₃, Li₂CO₃, NaKCO₃, NaLiCO₃, or KLiCO₃.

Embodiment 17. The system of any one of Embodiments 1 to 16, wherein the water removal unit is configured to concentrate the synthetic lithium solution.

Embodiment 18. The system of any one of Embodiments 1 to 16, wherein water removal unit comprises a reverse osmosis unit or a evaporation unit.

Embodiment 19. The system of any one of Embodiments 1 to 18, wherein the purification unit removes metal impurities by precipitation, solvent extraction, crystallization, filtration, ion exchange, or electrolysis.

Embodiment 20. The system of any one of Embodiments 1 to 18, wherein the purification unit removes metal impurities hydroxide precipitation, carbonate precipitation, ion exchange, solvent extraction, or membrane electrolysis.

Embodiment 21. The system of any one of Embodiments 1 to 20, wherein the purification unit modulates the pH of the synthetic lithium solution to 7 or above, 8 or above, 9 or above, or 10 or above.

Embodiment 22. The system of any one of Embodiments 1 to 21, wherein the first subsystem is configured to add sodium carbonate to the synthetic lithium solution. Embodiment 23. The system of any one of Embodiments 1 to 21, wherein the first subsystem is configured to form solid lithium carbonate by raising the temperature of the synthetic lithium solution.

Embodiment 24. The system of Embodiment 23, wherein said temperature is between about 340 and 368 K.

Embodiment 25. The system of Embodiment 23, wherein said temperature is between about 350 and 365 K.

Embodiment 26. The system of Embodiment 23, wherein said temperature is between about 350 and 360 K.

Embodiment 27. The system of any one of Embodiments 1 to 26 wherein the carbonate mother liquor exiting the first subsystem comprises sodium, potassium, lithium, chloride, and carbonate.

Embodiment 28. The system of any one of Embodiments 1 to 27, wherein the carbonate mother liquor comprises lithium, potassium, and sodium as more than 95% of the cationic species in solution on a molar basis.

Embodiment 29. The system of any one of Embodiments 1 to 28, wherein the carbonate mother liquor comprises lithium, potassium, and sodium as more than 99.0% of the cationic species in solution on a molar basis.

Embodiment 30. The system of any one of Embodiments 1 to 29, wherein the carbonate mother liquor comprises lithium, potassium, and sodium as more than 99.9% of the cationic species in solution on a molar basis.

Embodiment 31. The system of any one of Embodiments 1 to 30, wherein the first subsystem further comprises a solid-liquid separation device to recover said lithium carbonate solids.

Embodiment 32. The system of Embodiment 31, wherein the solid-liquid separation device is a centrifuge, basket centrifuge, peeler centrifuge, disc centrifuge, filter press, belt filter, vertical pressure filter, hydrocyclone, clarifier, settler, mixture thereof, or other solid-liquid separation device.

Embodiment 33. The system of any one of Embodiments 1 to 32, wherein the second subsystem is configured to remove carbonates from the carbonate mother liquor by treatment of the mother liquor with an acid.

Embodiment 34. The system of Embodiment 32, wherein the acid is selected from hydrochloric acid, sulfuric acid, nitric acid, phosphoric acid, mixtures thereof, or combinations thereof.

Embodiment 35. The system of any one of Embodiments 1 to 33, wherein the second subsystem is configured to remove dissolved carbon dioxide from the mother liquor. Embodiment 36. The system of Embodiment 34, wherein the second subsystem comprises a scrubber column wherein a gas is contacted with the mother liquor to remove dissolved carbon dioxide from the mother liquor.

Embodiment 37. The system of any one of Embodiments 1 to 36, wherein the second subsystem is configured to remove carbonates from the carbonate mother liquor by treatment of the mother liquor with calcium hydroxide, thereby producing calcium carbonate solids and a reduced carbonate mother liquor.

Embodiment 38. The system of any one of Embodiments 1 to 37, wherein the third subsystem is configured to remove water from the reduced carbonate mother liquor by evaporation, resulting in precipitation of solid salts comprising sodium and potassium salts.

Embodiment 39. The system of Embodiment 38, wherein said evaporation occurs in a mechanical vapor recompression system, a multiple effects evaporation system, a thermal vapor recompression system, an evaporation pond, a solar evaporation pond, or a combination thereof.

Embodiment 40. The system of any one of Embodiments 1 to 39, wherein the solid salts produced by the third subsystem comprise sodium, potassium, chloride, and mixtures thereof.

Embodiment 41. The system of Embodiment 40, where in the solid salts comprise at least 99% sodium chloride and potassium chloride on a molar basis.

Embodiment 42. The system of any one of Embodiments 1 to 41, further comprising the electrochemical system configured to produce acid and hydroxide from the solid salts.

Embodiment 43. The system of Embodiment 42, wherein said electrochemical system comprises a chloralkali plant.

Embodiment 44. The system of Embodiment 42, wherein said electrochemical system comprises a bipolar membrane electrodialysis unit.

Embodiment 45. The system of Embodiment 42, wherein the electrochemical system comprises a three-compartment bipolar membrane electrodialysis unit.

Embodiment 46. The system of any one of Embodiments 1 to 45, wherein the concentration of lithium in the concentrated lithium solution is between about 1,000 mg/L and about 50,000 mg/L.

Embodiment 47. The system of any one of the Embodiments 1 to 47, wherein the system is configured to recover lithium from the concentrated lithium liquid solution generated by the third subsystem.

Embodiment 48. The system of Embodiment 47, wherein the system is configured to recover lithium from the concentrated lithium solution by providing the concentrated lithium liquid solution to a unit or subsystem configured to carry out direct lithium extraction.

Embodiment 49. The system of Embodiment 48, wherein the system is configured to recover lithium from the concentrated lithium solution by providing the concentrated lithium solution to the inlet of the first subsystem.

Embodiment 50. The system of Embodiment 49, wherein said third subsystem is configured to remove impurities from the depleted carbonate mother liquor and provide the concentrated lithium solution to the inlet of the first subsystem.

Embodiment 51. The system of any one of Embodiments 3 to 50, wherein the ion exchange unit comprises an ion exchange material which exchanges lithium ions and hydrogen ions.

Embodiment 52. The system of any one of Embodiments 51, wherein the ion exchange material absorbs lithium while releasing hydrogen ions, and absorbs hydrogen ions while releasing lithium.

Embodiment 53. The system of Embodiment 51 or 52, wherein said ion exchange material comprises LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, modifications thereof, solid solutions thereof, or a combination thereof.

Embodiment 54. The system of any one of Embodiments 51 to 53, wherein said ion exchange material is a coated ion exchange material with a coating that is selected from an oxide, a polymer, or combinations thereof.

Embodiment 55. The system of any one of Embodiments 51 to 53, wherein said ion exchange material is a coated ion exchange material with a coating that is selected from SiO₂, TiO₂, ZrO₂, polyvinylidene difluoride, polyvinyl chloride, polystyrene, polybutadiene, polydivinylbenzene, or combinations thereof.

Embodiment 56. The system of any one of Embodiments 51 to 55, wherein the ion exchange material is in the form of porous ion exchange beads.

Embodiment 57. The system of any one of Embodiments 51 to 56, wherein the porous ion exchange beads comprise particles of an ion exchange material that reversibly exchange lithium and hydrogen and a structural matrix material that allows for the construction of a pore network.

Embodiment 58. The system of Embodiment 57, wherein the structural matrix material is selected from the group consisting of polyvinyl fluoride, polyvinylidene difluoride, polyvinyl chloride, polyvinylidene dichloride, polyethylene, polypropylene, polyphenylene sulfide, polytetrafluoroethylene, sulfonated polytetrafluoroethylene, polystyrene, polydivinylbenzene, polybutadiene, sulfonated polymer, carboxylated polymer, poly-ethylene-tetrafluoroethyelene, polyacrylonitrile, tetrafluoroethylene-perfluoro-3,6-dioxa-4-methyl-7-octenesulfonic acid copolymer, copolymers thereof, and combinations thereof.

Embodiment 59. The system of any one of Embodiments 51 to 58, wherein the particle size of the ion exchange material is from about 0.1 microns to about 10 microns, from about 1 micron to about 100 microns, from about 10 microns to about 1000 microns, or from about 100 microns to about 1 cm.

Embodiment 60. The system of any one of Embodiments 51 to 59, wherein the particle size of the ion exchange material is from about 1 micron to about 100 microns.

Embodiment 61. The system of any one of Embodiments 51 to 59, wherein the particle size of the ion exchange material is from about 100 microns to about 1000 microns.

Embodiment 62. The system of any one of Embodiments 51 to 59, wherein the particle size of the ion exchange material is from about 100 microns to about 500 microns.

Embodiment 63. The system of any one of Embodiments 1 to 62, wherein the liquid resource is a natural brine, a pretreated brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

Embodiment 64. The system of any one of Embodiments 1 to 63, wherein the synthetic lithium solution is an acidic lithium solution produced by the ion exchange process.

Embodiment 65. The system of any one of Embodiments 1 to 63, wherein the synthetic lithium solution comprises
a. water;
b. lithium, wherein the concentration of lithium is at least about 100 milligrams per liter and no greater than about 20,000 milligrams per liter;
c. sodium, wherein the concentration of sodium is at least about 10 milligrams per liter and no greater than about 10,000 milligrams per liter;
d. calcium, wherein the concentration of calcium is at least about 1 milligram per liter and no greater than about 10,000 milligrams per liter;
e. magnesium, wherein the concentration of magnesium is at least about 10 milligrams per liter and no greater than about 10,000 milligrams per liter;
f. potassium, wherein the concentration of potassium is at least about 10 milligrams per liter and no greater than about 10,000 milligrams per liter.

Embodiment 66. A method for lithium recovery, the method comprising extracting lithium from a liquid resource with the system of any one of Embodiments 1 to 65.

### EXAMPLES

### Example 1: Lithium Recovery from a Lithium Carbonate Mother Liquor

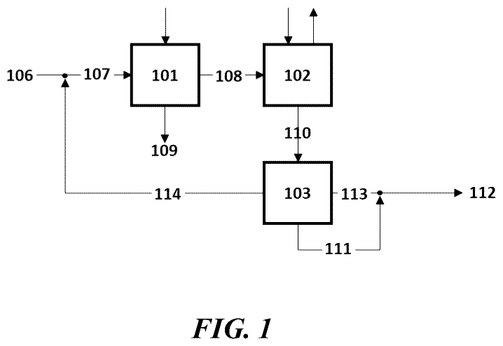

With reference to FIG. 1, liquid stream 106 comprises a synthetic lithium solution produced by a direct lithium extraction process. Said direct lithium extraction process employs a lithium-selective ion exchange material comprising Li₂Mn₂O₅ embedded within a polyethylene matrix to extract lithium from a liquid resource comprising a brine. Said brine is extracted from a natural reservoir, and contains 75,000 mg/L Na, 500 mg/L Ca, 5,000 mg/L Mg, 200 mg/L Li, and other dissolved species.

The synthetic lithium solution 106 comprises about 10,000 mg/L of Li, about 20,000 mg/L of Na, about 10,000 mg/L of K and chloride counter ions. Synthetic lithium solution 106 is mixed with recycle stream 114 to produce stream 107, comprising Li, Na, K and chloride and trace amounts of other cations and anions, which is fed to lithium carbonate precipitation subsystem 101. Lithium carbonate precipitation subsystem 101 comprises one or more agitated tanks wherein sodium carbonate is added to the liquid stream and heated to a temperature of about 358 K to form lithium carbonate crystalline solids slurried in a carbonate mother liquor. Said solids are removed by a solid-liquid separation system comprising centrifuges, to produce a solid lithium carbonate product 109 and the carbonate mother liquor 108. Said carbonate mother liquor 108 comprises about 30,000 mg/L of potassium, about 1,000 mg/L of lithium, about 60,000 mg/L of sodium, about 10,000 mg/L of carbonate.

Carbonate mother liquor 108 is treated in system 102 comprising a mixing tank wherein sufficient hydrochloric acid is added to convert all carbonates present in 108 into carbon dioxide gas, followed by a steam-assisted stripping column to remove dissolved carbon dioxide into the atmosphere. This results in a depleted carbonate mother liquor 110.

Depleted carbonate mother liquor 110 is fed to a salt crystallizer unit 103, comprising a mechanical vapor recompression evaporation system, which removes water vapor 113 while precipitating sodium chloride and potassium chloride solids (e.g., solid salts comprising sodium chloride and potassium chloride) 111. 111 solids are removed and re-dissolved in water, wherein said water includes condensate vapor 113, to produce stream 112, which comprises pure sodium and potassium chloride in solution. 112 serves as a feed to a 3-compartment bipolar electrodialysis plant that produces sodium hydroxide and hydrochloric acid, and these reagents are used in the direct lithium extraction process.

The liquid remaining after evaporation in 103 is concentrate stream 114, which comprises 25,000 mg/L of Li, and is saturated with sodium, potassium, and chloride species. Stream 114 is mixed with feed 106 to form stream 107, which serves as inlet to the system. Accordingly, a concentrated lithium solution is recycled for lithium recovery therefrom by directing said concentrated lithium solution to the ion exchange unit wherein the concentrated lithium solution is combined with the liquid resource.

Thus, LiCl that would otherwise be discarded with the mother liquor is recycled to the inlet of the system, and the overall lithium recovery of the system is increased. Simultaneously, the use of an evaporator system to remove water in 103 enables said water to be recovered for use in redissolving salts 113. This contrast to other methods such as solar evaporation that do not recover said water. As such, this method also improves the water utilization of the lithium recovery system.

### Example 2: Lithium Recovery from a Lithium Carbonate Mother Liquor with Recycle to the Inlet of a Direct Lithium Extraction System

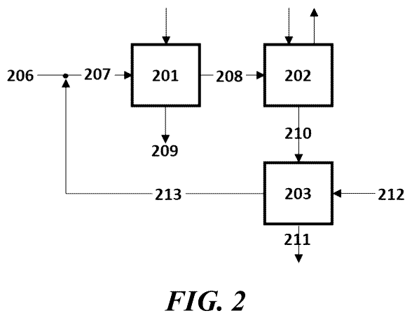

With reference to FIG. 2, liquid stream 206 comprises a brine from a natural reservoir. Said brine contains 75,000 mg/L Na, 500 mg/L Ca, 1,000 mg/L Mg, 2,000 mg/L Li, and other dissolved species. Liquid stream 206 is mixed with mother liquor 213, the pH of the mixture is adjusted to a value of about 8.5, and any solids are removed by filtration to form stream 207 prior to being sent to lithium extraction system 201.

Lithium extraction system 201 comprises a direct lithium extraction system, which employs a lithium-selective ion exchange material comprising Li₂Mn₂O₅ coated with a 10 nm layer of TiO₂, incorporated into a polytetrafluoroethylene (PTFE) matrix material, to extract lithium from a liquid resource comprising a brine. Said lithium extraction system produces a purified acidic synthetic lithium solution 208, while the brine depleted of lithium 209 is removed from the system.

Synthetic lithium solution 208 is a lithium eluate that comprises about 2,000 mg/L of Li and other impurities including calcium, magnesium, potassium, and sodium. Synthetic lithium solution 208 is fed into purification system 202. Said system adjusts the value of pH to neutral, removes multivalent ions by a combination of precipitation and ion exchange, and increases the concentration of said solution by a combination of reverse osmosis and evaporation. The resulting purified synthetic lithium solution 210 comprises about 20,000 mg/L of Li, about 40,000 mg/L of Na, about 5,000 mg/L of K and chloride counter ions.

Said purified synthetic lithium solution 210 is fed to lithium carbonate precipitation subsystem 203. Lithium carbonate precipitation subsystem 203 comprises several agitated tanks where aqueous sodium carbonate (212) is added to the synthetic lithium solution and heated to a temperature of about 355 K to form lithium carbonate crystalline solids. Said solids are removed by a solid-liquid separation system comprising filter presses, to produce a solid lithium carbonate solids 211 and carbonate mother liquor 213. Said carbonate mother liquor comprises about 20,000 mg/L of potassium, about 2,000 mg/L of lithium, about 90,000 mg/L sodium, about 15,000 mg/L of carbonate, boron, and other chemical species, and has a pH value of about 10.

Carbonate mother liquor 213 is recycled and mixed with liquid resource 206 to form stream 207. This results in an increase in the pH value of 206, and in precipitation of calcium carbonate solids, which are removed by filtration before 207 is fed into the direct lithium extraction system 201. Accordingly, the carbonate mother liquor is recycled for recovery of lithium therefrom.

Recirculation of the carbonate mother liquor 213 to mix with liquid resource 206 ahead of the inlet of the direct lithium extraction system 201 results in (i) a decrease in the amount of reagents needed to adjust the pH of 206 to an optimal value, (ii) the conversion of carbonates in 213 to carbon dioxide, and (iii) the recovery of lithium from 213 which would otherwise be discarded and reduce the overall efficiency of the system.

### Example 3: Lithium Recovery from a Lithium Carbonate Mother Liquor by Direct Lithium Extraction

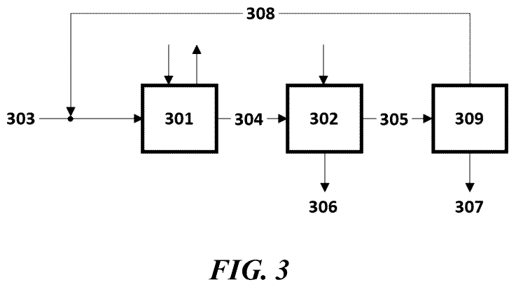

With reference to FIG. 3, liquid stream 303 comprises a synthetic lithium solution produced by a direct lithium extraction process. Said direct lithium extraction process employs a lithium-selective ion exchange material comprising Li₄Ti₅O₁₂ coated with a 10 nm layer of TiO₂ and embedded within a polyvinyl chloride matrix, to extract lithium from a liquid resource comprising a brine. Said brine is extracted from a natural reservoir, and contains 100,000 mg/L Na, 500 mg/L Ca, 500 mg/L Mg, 1,500 mg/L Li, and other dissolved species.

Synthetic lithium solution 303 is a lithium eluate comprising about 1,000 mg/L of Li and other impurities including calcium and magnesium. Synthetic lithium solution 303 is fed into a purification system 301. Said system adjusts the value of pH to neutral, removes multivalent ions by a combination of precipitation and ion exchange steps, and increases the concentration of the solution by a combination of reverse osmosis and evaporation. The resulting purified synthetic lithium solution 304 comprises about 18,000 mg/L of Li, about 35,000 mg/L of Na, about 3,000 mg/L of K and chloride counter ions.

Synthetic lithium solution 304 is fed into lithium carbonate precipitation system 302. Lithium carbonate precipitation subsystem 302 comprises one or more agitated tanks wherein sodium carbonate is added to the synthetic lithium solution and heated to a temperature of about 355 K to form lithium carbonate crystalline solids. Said solids are removed by a solid-liquid separation system comprising a settler and a belt filter, to produce a solid lithium carbonate product 306 and a carbonate mother liquor 305. Said carbonate mother liquor 305 comprises about 1,000 mg/L of potassium, about 1,800 mg/L of lithium, about 105,000 mg/L of sodium, about 20,000 mg/L of carbonate.

Carbonate mother liquor 305 is treated in system 309, comprising a direct lithium extraction system. Said lithium extraction system employs the same or similar lithium-selective ion-exchange material as used to generate 303, which absorbs lithium while releasing protons. The release of protons during this process results in acidification of mother liquor 305, resulting in the transformation of carbonates into carbon dioxide. System 309 recovers 90% of the lithium in carbonate mother liquor 305, while rejecting the sodium and potassium ions, which exit the system as lithium-depleted and carbonate-depleted stream (e.g. the depleted carbonate mother liquor) 307. Stream 307 is fed into a chloralkali plant that produces acid and base, which are both required to operate the direct lithium extraction process. System 309 produces a concentrated lithium solution 308, which is mixed directly with 303.

As such, a majority of the lithium in the carbonate mother liquor 305 is recovered by system 309 as concentrated lithium solution 308, while salts used in the production of acid and base necessary for direct lithium extraction by ion exchange area also recovered as the depleted carbonate mother liquor 307.

### Example 4: Lithium Recovery from a Lithium Carbonate Mother Liquor by Evaporation in Multiple Stages

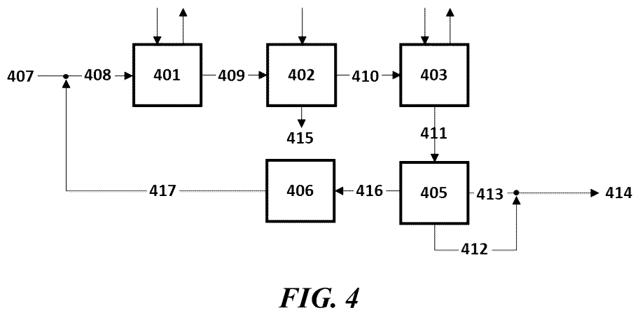

With reference to FIG. 4, liquid stream 407 comprises a synthetic lithium solution produced by a direct lithium extraction process. Said direct lithium extraction process employs a lithium-selective ion exchange material comprising Li₄Mn₅O₁₂ coated with a 10 nm layer of MnO₂, embedded within a polyvinyl chloride matrix, to extract lithium from a liquid resource comprising a brine. Said brine is extracted from a natural reservoir, and contains about 110,000 mg/L Na, 100 mg/L Ca, 10,000 mg/L Mg, 20,000 mg/L of K, 500 mg/L Li, and other dissolved species.

Synthetic lithium solution 407 is a lithium eluate comprising about 2,000 mg/L of Li and other impurities including calcium and magnesium. 407 is combined with lithium-rich stream (e.g., concentrated lithium solution) 417 to form the combined stream 408, which is fed into a purification system 401. Said system adjusts the value of pH of the combined stream 408, removes multivalent ions by a combination of sodium carbonate and sodium hydroxide induced precipitation and divalent ion exchange steps, and increases the concentration of the solution by a combination of reverse osmosis and evaporation. The resulting purified synthetic lithium solution 409 comprises about 20,000 mg/L of Li, about 20,000 mg/L of Na, about 3,000 mg/L of K and chloride counter ions.

Synthetic lithium solution 409 is fed into lithium carbonate precipitation system 402. Lithium carbonate precipitation subsystem 402 comprises one or more agitated tanks where sodium carbonate is added to the synthetic lithium and heated to a temperature of about 355 K to form lithium carbonate crystalline solids. Said solids are removed by a solid-liquid separation system comprising a filter press, to produce a solid lithium carbonate product 415 and a carbonate mother liquor 410. Said carbonate mother liquor 410 comprises about 3,000 mg/L of potassium, about 2, 100 mg/L of lithium, about 100,000 mg/L of sodium, about 15,000 mg/L of carbonate.

Carbonate mother liquor 410 is treated in system 403 comprising a mixing tank wherein sufficient sulfuric acid is added to convert all carbonates in 410 into carbon dioxide gas. System 403 further comprises a stripping column where carbon dioxide-free air is injected into the liquid to remove dissolved carbon dioxide. This results in a depleted carbonate mother liquor 411.

Depleted carbonate mother liquor 411 is fed to a salt crystallizer unit 405, comprising a mechanical vapor recompression evaporation system, which removes water vapor 412 while precipitating sodium chloride solids 413. 413 solids are removed and re-dissolved in water, wherein said water includes the condensate of water vapor 412, to produce stream 414, which comprises pure sodium chloride in solution. 414 serves as a feed to a chloralkali plant that produces sodium hydroxide and hydrochloric acid, and these reagents are used in the direct lithium extraction process (e.g., these reagents are recycled for use in the ion exchange process that generates 407).

The liquid stream 416 that exits crystallizer unit 405 is saturated in sodium and potassium chloride, and contains about 30,000 mg/L of lithium. Stream 416 is fed into solar evaporation pond 406, where additional water is removed to precipitate additional sodium chloride, potassium chloride, and increase the lithium concentration to about 45,000 mg/L. This concentrated liquid stream (e.g., concentrated lithium solution) 417 is mixed with feed 407 to form combined stream 408, which serves as inlet to the system.

Thus, LiCl that would otherwise be discarded with the mother liquor 410 is recycled to the inlet of the system, and the overall lithium recovery of the system is increased. Simultaneously, the use of an evaporator system in 405 to remove water enables said water to be recovered for use in re-dissolving salts 413. These purified salts 413 are further utilized to feed an acid and base plant, decreasing the reagent costs associated with the isolation of a given quantity of lithium. As such, this method also improves the water utilization, lithium recovery, and acid and base generation.

### Example 5: Concentration of a Lithium Carbonate Mother Liquor

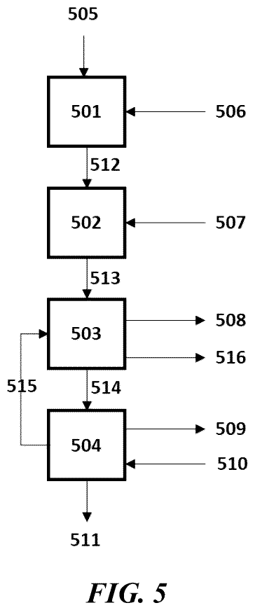

With reference to FIG. 5, liquid stream 505 comprised a lithium carbonate mother liquor with the following composition: about 2,000 mg/L Li, 75,000 mg/L Na, 1,000 mg/L K, and other dissolved species including Ca, Mg, Sr, B, and Fe at concentrations lower than 20 mg/L. Said mother liquor was produced by the precipitation of lithium carbonate from a treated synthetic lithium solution produced by a selective direct lithium extraction process.

In treatment step 501, 37% hydrochloric acid 506 was added to said mother liquor 505 in a mass ratio of 60:1 of 505 to 506, resulting in a mixture with a pH of 0.55, and the mixture heated to boiling for about 20 min. The formation of bubbles was observed, indicating the destruction of carbonates and the release of carbon dioxide. The resulting depleted carbonate mother liquor 512, was neutralized in step 502 by addition of NaOH 507, which was added in a mass ratio of 600,000:1 of 507 to 505. This resulted in a neutralized depleted carbonate mother solution with a pH of 7.5, 513.

Solution 513 was fed into evaporative crystallizer 503, comprising a kettle with electric heating mantle, condensing train, and stainless steel agitator. Stream 513 was continuously fed into 503, wherein the rate of feed addition is approximately double that of the water vapor 508 being evaporated from the system. When slurry (e.g., the formation of solids) was observed in crystallizer 503, approximately 30% of the crystallizer's contents 514 were removed. The liquid portion of this slurry corresponds to concentrated lithium solution 516. The solids were treated in pusher centrifuge 504, wherein they were washed with deionized water in a ratio of 1:10 of deionized wash water 510 to solids 509, thereby producing solids 509. Used wash water 511 was discarded from the system.

Slurry samples of the solid and liquid contents from evaporative crystallizer 503 were collected to analyze the composition of mother liquor product 516 and solids 509. These samples were collected while the system continuously concentrated the mother liquor inside crystallizer 503. In one instance of collecting a sample, the contents of the kettle were boiling at a temperature of 110° C. The mother liquor sample 516 comprised a solution with a specific gravity of 1.2, with a composition of about 11,000 mg/L Li, 90,000 mg/L Na, 6,000 mg/L K. This represented a greater than 5× concentration of LiCl relative to feed 505. The solids 509 comprised NaCl (>99.5% purity by weight) with a moisture content lower than 2%. Approximately 5% of lithium content from the feed mother liquor 505 was lost in solids 509 and discarded wash water 511.

In other embodiments of this system, which is designed for continuous operation, mother liquor would be withdrawn at a constant rate from the baffled section of a crystallizer through stream 516, while slurry would be withdrawn at a constant rate through stream 514, which would be washed with water in a pusher centrifuge, with the used wash water then being redirected to recycle stream 515 and back into crystallizer 503. Additionally, any lithium captured by said wash recycle 515 is additionally recovered in crystallizer 503.

In typical lithium production systems, the mother liquor stream 505 would be discarded, resulting in the loss of lithium in that stream. By treating stream 505 in this system, concentrated lithium solution 516, comprising a LiCl concentration of higher than 11,000 mg/L, can be sent recycled back to a carbonation system, wherein sodium carbonate is added to produce solid lithium carbonate product and a mother liquor. The net effect is to increase the overall recovery of lithium in the lithium carbonate product by avoiding the loss of lithium that would be discarded from the mother liquor. Additionally, the pure NaCl produced in stream 509 is suitable for conversion into acid and base plant in an acid and base plant, and can thus be converted into reagents that can be used in the direct extraction of lithium to produce a synthetic lithium solution. As such, this system improves the water utilization, lithium recovery, and acid and base generation over existing lithium production methods.

### Example 6: Continuous Lithium Recovery Enhanced by Concentration and Recycle of a Mother Liquor

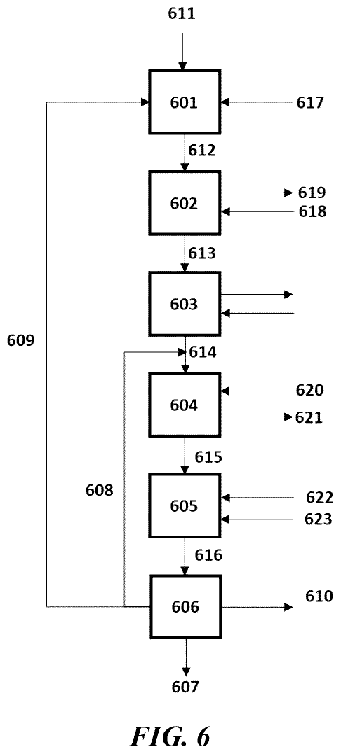

With reference to FIG. 6, liquid stream 611 comprises a brine from a natural reservoir. Said brine contains about 60,000 mg/L Na, 700 mg/L Ca, 1,500 mg/L Mg, 280 mg/L Li, and other dissolved species. In treatment system 601, liquid stream 611 is mixed with concentrated lithium solution recycle 609, the pH of the mixture is adjusted to a value of about 8.0 by the addition of slaked lime (Ca(OH)₂) 617, and the liquid stream is filtered to produce treated brine stream 612, which is sent to a lithium extraction system 602.

Lithium extraction system 602 comprises a direct lithium extraction system, which employs a lithium-selective ion exchange material comprising Li₄Mn₅O₁₂. Said lithium extraction system uses hydrochloric acid, water, and sodium hydroxide reagents 618 to process treated brine stream 612 and produce a purified acidic synthetic lithium solution 613. The brine depleted of lithium 619 is removed from the system.

Synthetic lithium solution 613 is a lithium eluate that comprises about 3,000 mg/L of Li and other impurities including calcium, magnesium, potassium, and sodium. Synthetic lithium solution 613 is fed into purification system 603. Said system increases the value of pH, removes multivalent ions by a combination of precipitation and ion exchange, and increases the concentration of said solution by a combination of reverse osmosis and evaporation. The resulting purified synthetic lithium solution 614 comprises about 22,000 mg/L of Li, about 10,000 mg/L of Na, about 5,000 mg/L of K and chloride counter ions.

Purified synthetic lithium solution 614 is combined with recycled concentrated lithium solution 608, and the combined flow is fed into lithium carbonate precipitation subsystem 604. Lithium carbonate precipitation subsystem 604 comprises one or more agitated tanks wherein a solution of sodium carbonate 620 is added to the liquid stream and heated to a temperature of about 358 K to form lithium carbonate crystalline solids. Said solids are removed by a solid-liquid separation system comprising centrifuges, to produce a solid lithium carbonate product 621, and the centrifuge centrate which comprises mother liquor 615. 615 is denoted as the mother liquor. Said mother liquor 615 comprises about 2,000 mg/L Li, 75,000 mg/L Na, 1,000 mg/L K, and other dissolved species including Ca, Mg, Sr, B, and Fe at concentrations lower than 20 mg/L, balanced by chloride and carbonate anions.

Mother liquor 615 is treated in system 605 comprising a series of two heated and agitated kettles. In the first kettle, 37% hydrochloric acid 622 is added lower the pH to value to less than four, leading to the evolution of gaseous carbon dioxide; the residence time in this kettle is 20 minutes. In the second kettle, the depleted carbonate mother liquor resulting from the prior acidification step is neutralized by addition of NaOH 623, to yield neutralized depleted carbonate mother liquor with a pH of 7.5, 616.

Depleted carbonate mother liquor 616 is fed to a salt crystallizer unit 606, comprising a mechanical vapor recompression evaporation system, which removes water vapor 610 while precipitating sodium chloride solids 607 (>99% purity). As a result of this evaporation and crystallization, the concentration of lithium in the resulting concentrated lithium solution increases to a value of approximately 22,000 mg/L and sodium and potassium are saturated in said solution, which boils at about 115 degrees centigrade.

The concentrated lithium solution is recycled in ratio of 50:1 through 608, to the lithium carbonate crystallizer, and through 609 to the brine that is fed to the lithium extraction system. As such, any impurities that would accumulate in crystallization system if 608 were recycled to 604, would instead be constantly bled through 609 and separated by lithium extraction system 602, which discards impurities through bleed stream 619.

Thus, this system (FIG. 6) recycles lithium chloride that would be discarded with the mother liquor and avoids the accumulation of impurities in the lithium carbonate precipitation system, leading to increased lithium recoveries of lithium from the brine with satisfactory purity.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations or equivalents.

1.-105. (canceled)

106. A method for lithium recovery from a liquid resource, the method comprising:
(a) modulating the pH of the liquid resource to a value of 5 or above with the addition of a base;
(b) contacting the liquid resource with a lithium-selective sorbent, wherein the lithium-selective sorbent absorbs lithium ions from the liquid resource and releases lithium upon subsequent exposure to an acidic eluate to yield a synthetic lithium solution;
(c) purifying the synthetic lithium solution and modulating the pH of the synthetic lithium solution to a value of 6 or above;
(d) processing the synthetic lithium solution to yield solid lithium carbonate and a carbonate mother liquor by either:
i. adding a carbonate base to the synthetic lithium solution, or
ii. generating carbonate in the synthetic lithium solution;
(e) removing carbonates from the carbonate mother liquor to yield a depleted carbonate mother liquor;
(f) removing water from the depleted carbonate mother liquor to yield solid salts and a concentrated lithium solution; and
(g) optionally producing acid and hydroxide from the solid salts using electrolysis, wherein the acid is optionally used in the acidic eluate in (b) or in removing carbonates from the carbonate mother liquor in (e), and wherein the hydroxide base is optionally used in modulating the pH in (a) or (c).

107. The method of claim 106, wherein removing carbonates from the carbonate mother liquor comprises treatment of the carbonate mother liquor with an acid; wherein the acid is selected from hydrochloric acid, sulfuric acid, nitric acid, phosphoric acid, mixtures thereof, or combinations thereof.

108. (canceled)

109. The method of claim 106, wherein removing carbonates from the carbonate mother liquor comprises removing dissolved carbon dioxide from the carbonate mother liquor.

110. (canceled)

111. The method of claim 106, wherein removing carbonates from the carbonate mother liquor comprises treatment of the carbonate mother liquor with calcium hydroxide.

112. The method of claim 106, wherein removing water from the depleted carbonate mother liquor comprises evaporation, resulting in precipitation of solid salts comprising sodium and potassium salts.

113. The method of claim 112, wherein said evaporation occurs in a mechanical vapor recompression system, a multiple effects evaporation system, a thermal vapor recompression system, an evaporation pond, a solar evaporation pond, or a combination thereof.

114. The method of claim 113, wherein said evaporation occurs in a mechanical vapor recompression system configured to reduce the amount of energy required for evaporation.

115. (canceled)

116. (canceled)

117. (canceled)

118. The method of claim 106, comprising producing acid and hydroxide from the solid salts using electrolysis, a chloroalkali plant, or a bipolar membrane electrolysis unit.

119. (canceled)

120. (canceled)

121. (canceled)

122. (canceled)

123. The method of claim 106, further comprising recovering lithium from the concentrated lithium solution.

124. (canceled)

125. The method of claim 106, further comprising adding at least a portion of the concentrated lithium solution to the liquid resource prior to (a).

126. (canceled)

127. The method of claim 106, wherein the concentrated lithium solution is added to the synthetic lithium solution and the liquid resource.

128. The method of claim 127, wherein the ratio of the concentrated lithium solution added to the synthetic lithium solution to the concentrated lithium solution added to the liquid resource is from about 100:1 to about 1:10.

129. (canceled)

130. (canceled)

131. (canceled)

132. (canceled)

133. (canceled)

134. (canceled)

135. (canceled)

136. (canceled)

137. (canceled)

138. (canceled)

139. (canceled)

140. The method of claim 106, wherein purifying the synthetic lithium solution comprises use of a reverse osmosis unit, an ultra high pressure reverse osmosis unit, a forward osmosis unit, an osmotically assisted reverse osmosis unit, an evaporation unit, a multiple effects evaporation unit, a mechanical vapor recompression unit, a crystallization unit, or a combination thereof.

141. (canceled)

142. The method of claim 106, wherein purifying the synthetic lithium solution removes metal impurities by hydroxide precipitation, carbonate precipitation, multi-valent ion exchange, nanofiltration, solvent extraction, or membrane electrolysis.

143. (canceled)

144. The method of claim 106, wherein processing the synthetic lithium solution comprises adding a carbonate base to the synthetic lithium solution.

145. (canceled)

146. (canceled)

147. The method of claim 106, wherein processing the synthetic lithium solution comprises generating carbonate in the synthetic lithium solution; wherein generating carbonate in the synthetic lithium solution comprises adding pressurized gaseous carbon dioxide to the synthetic lithium solution.

148. (canceled)

149. The method of claim 106, wherein processing the synthetic lithium solution generates a suspension of the solid lithium carbonate and the carbonate mother liquor; and the method further comprises raising the temperature of the suspension to increase the amount of solid lithium carbonate formed.

150. (canceled)

151. (canceled)

152. (canceled)

153. (canceled)

154. (canceled)

155. The method of claim 106, wherein the carbonate mother liquor comprises lithium, potassium, and sodium as more than 95% of the cationic species in solution on a molar basis.

156. (canceled)

157. (canceled)

158. The method of claim 149, further comprising separating the solid lithium carbonate from the carbonate mother liquor, wherein separating the solid lithium carbonate from the carbonate mother liquor comprises use of a solid-liquid separation device selected from: a centrifuge, a basket centrifuge, a peeler centrifuge, a disc centrifuge, a filter press, a belt filter, a vertical pressure filter, a hydrocyclone, a clarifier, a settler, a combination thereof, or another solid-liquid separation device.

159. (canceled)

160. The method of claim 106, wherein the lithium-selective sorbent comprises an ion exchange material which exchanges lithium ions and hydrogen ions, wherein said ion exchange material comprises LiFePO₄, LiMnPO₄, Li₂MO₃ (M=Ti, Mn, Sn), Li₄Ti₅O₁₂, Li₄Mn₅O₁₂, LiMn₂O₄, Li_{1.6}Mn_{1.6}O₄, LiMO₂ (M=Al, Cu, Ti), Li₄TiO₄, Li₇Ti₁₁O₂₄, Li₃VO₄, Li₂Si₃O₇, Li₂CuP₂O₇, modifications thereof, solid solutions thereof, or a combination thereof.

161. (canceled)

162. (canceled)

163. (canceled)

164. (canceled)

165. (canceled)

166. (canceled)

167. (canceled)

168. (canceled)

169. The method of claim 160, wherein the particle size of the ion exchange material is from about 1 micron to about 100 microns.

170. (canceled)

171. (canceled)

172. The method of claim 106, wherein the liquid resource is a natural brine, a pretreated brine, a dissolved salt flat, seawater, concentrated seawater, a desalination effluent, a concentrated brine, a processed brine, an oilfield brine, a liquid from an ion exchange process, a liquid from a solvent extraction process, a synthetic brine, a leachate from an ore or combination of ores, a leachate from a mineral or combination of minerals, a leachate from a clay or combination of clays, a leachate from recycled products, a leachate from recycled materials, or combinations thereof.

173. (canceled)

174. (canceled)
